(19) United States
(12) Patent Application Publication
(10) Pub. No.: US 2010/0133046 A1
(43) Pub. Date: Jun. 3, 2010

(54) ELEVATOR SYSTEM, SUSPENSION ELEMENT FOR AN ELEVATOR SYSTEM, AND DEVICE FOR MANUFACTURING A SUSPENSION ELEMENT

(75) Inventors: Anke Allwardt, Beckenried (CH); Adrian Attinger, Merlischachen (CH); Daniel Fischer, Villarsel-sur-Marly (CH); Ernst Ach, Ebikon (CH); Phillipe Henneau, Zurich (CH); Andre' Kreiser, Bietigheim-Bissingen (DE); David Risch, Herrliberg (CH); Urs Baumgartner, Merenschwand (CH); Hans Blochle, Hergiswil (CH); Joseph Muff, Hildisrieden (CH); Nicolas Gremaud, Wadenswil (CH); Steffen Grundmann, Bosnstetten (CH); Karl Weinberger, Immensee (CH); Hans Kocher, Udligenswil (CH); Guntram Begle, Kussnacht a/Rigi (CH); Heinrich Kuttel, Weggis (CH)

Correspondence Address: FRASER CLEMENS MARTIN & MILLER LLC, 28366 KENSINGTON LANE, PERRYSBURG, OH, 43551, US

(73) Assignee: INVENTIO AG, Hergiswil (CH)

(21) Appl. No.: 12/450,133

(22) PCT Filed: Feb. 12, 2008
(86) PCT No.: PCT/EP2008/001068

§ 371 Date: Feb. 11, 2010

(30) Foreign Application Priority Data
Mar. 12, 2007 (EP) 07103969.7
Mar. 28, 2007 (EP) 07105131.2
May 3, 2007 (EP) 07107468.6
Jun. 4, 2007 (EP) 07109521.0
Jun. 20, 2007 (EP) 07110653.8
Jul. 17, 2007 (EP) 07112641.1
Aug. 17, 2007 (EP) 07114522.1
Oct. 17, 2007 (EP) 07118710.8
Nov. 7, 2007 (EP) 07120211.3

(51) Int. Cl. F16G 9/00; B66B 7/06; F16G 9/04; D07B 1/00; D07B 1/22; D07B 1/16; B66B 11/00

(52) U.S. Cl. 187/251; 187/414

(57) ABSTRACT

An elevator system with a car or platform to transport passengers and/or goods as well as with a counterweight, which are arranged as traversable or movable along a travel path, and which are coupled and/or with a drive by a suspension element interrelating their motion. The suspension element is guided and/or driven by a traction sheave and/or a drive shaft and/or a deflecting pulley. The suspension element is sheathed and/or belt-type, with a first layer made of a first plasticizable and/or elastomeric material, containing a first exterior surface, and with at least one tension member—rope-type, tissue-type, or comprising a multitude of partial elements—that is embedded in the first layer of the suspension element. A manufacturing procedure for one of the suspension elements is provided.

### BACKGROUND OF THE INVENTION

1. Area of the Invention

The present invention relates to an elevator system, an elevator system with a suspension element or force transfer arrangement, a suspension element or force transfer arrangement for an elevator system, a belt-type suspension element, as well as a procedure for manufacturing a suspension element, a procedure for manufacturing a belt-type suspension element for an elevator system, a respective device for manufacturing a belt-type suspension element.

2. Technical Background

An elevator system usually comprises at least one elevator car or platform to transport passengers and/or goods, a drive system with at least one hoisting machine to move the at least one elevator car or platform along a track, and at least one suspension element to carry the at least one elevator car or platform and to transfer the forces from the at least one hoisting machine to the at least one elevator car or platform. As suspension elements for mechanical drives, today, rope-type non-sheathed suspension elements (wire ropes, synthetic fibre ropes, etc.), chain-type suspension elements, and in particular also belt-type and/or sheathed suspension elements (and furthermore especially suspension belts or sheathed ropes) can be conceived.

Known belt-type suspension elements or force transfer arrangements include, among others, two-layer suspension belts, comprising of a first belt layer and a second belt layer connected to the first one. In them, usually several tension members are embedded in the moulded body of the suspension belt, in particular rope-type tension members. In known manufacturing procedures, two subsequent manufacturing stations produce first a partial belt constituting the first belt layer and then a finished suspension belt with a second belt layer moulded to the first belt layer. In the first manufacturing station, several rope-type tension members are fed simultaneously and are embedded by half into the first belt layer. First and second belt layer of the suspension belt are each produced by means of an extrusion procedure.

### OBJECT OF THE INVENTION

It is an object of the present invention to provide an improved elevator system, an improved elevator system with a suspension element or force transfer arrangement, an improved suspension element or improved force transfer arrangement for an elevator system, an improved belt-type suspension element or improved procedure for manufacturing a suspension element, an improved procedure for manufacturing a belt-type suspension element for an elevator system, and/or a respective device for manufacturing a belt-type suspension element.

Solution

According to one aspect of the invention, an elevator system is conceived with a car and a counterweight arranged as traversable or movable along a track of motion. Preferably, an elevator system with the features of claim 1 is conceived. Advantageous further formations and embodiments of this invention are the subject of the dependent claims, the description, and the figures. Besides, as to the solution of concrete design problems, EN 81-1: 1998, including CORRIGENDUM 09.99 is referred to.

According to a further aspect of the invention, an elevator system with the features of claim 2 is conceived with a car and a counterweight arranged as traversable or movable along a track of motion. Advantageous further formations and embodiments of this invention are the subject of the dependent claims, the description, and the figures.

The elevator system according to one aspect of the invention has at least one elevator car or platform to transport passengers and/or goods, a drive system with at least one hoisting machine to move the at least one elevator car or platform along a track, and at least one suspension element to carry the at least one elevator car or platform and to transfer the forces from the at least one hoisting machine to the at least one elevator car or platform. The at least one suspension element is preferably a rope-type or belt-type suspension element of the invention or a rope-type or belt-type suspension element produced by means of the manufacturing procedure of the invention. An elevator system according to invention can, in particular, be embodied with a traction drive or a drum drive for the drive system.

According to one aspect of the invention, an elevator system with a suspension element or a force transfer arrangement for a building, a bulk transporting system, a mine facility, a water vehicle, or the like, with the features of claim 3 is conceived. Advantageous further formations and embodiments of this invention are the subject of the dependent claims, the description, and the figures.

According to one aspect of the invention, a suspension element or a force transfer arrangement for an elevator system with the features of claim 4 is conceived, in which a force transfer arrangement comprises a multitude of 3-24 suspension elements, in particular several groups of 3-6 suspension elements each. Here, groups of suspension elements have greater distances from each other than individual suspension elements within a group. Advantageous further formations and embodiments of this invention are the subject of the dependent claims, the description, and the figures. In particular, the distance between two suspension elements within a group is less than half the width of a suspension element. Such a distance is definable in particular in the area of a traction sheave, a deflecting pulley, and/or a guide pulley. Furthermore in particular, a distance between two suspension elements within a group equals about half the width of a suspension element. Such suspension elements and force transfer arrangements are particularly suited to the use in the elevator systems according to invention and are preferably produced by means of the manufacturing procedures according to invention.

According to one aspect of the invention, a belt-type suspension element for an elevator system with the features of claim 5 is conceived. Advantageous further formations and embodiments of this invention are the subject of the dependent claims, the description, and the figures. A belt-type suspension element according to invention (below often simply called “suspension belt”, “belt”, or “traction element”) for an elevator system preferably comprises a first belt layer of a first plasticizable material, with a first exterior surface and a surface constituting a connection plane. Furthermore, the suspension element preferably comprises at least one tension member—rope-type, tissue-type, and/or comprising of a multitude of partial elements—that is embedded in the first belt layer.

Optionally, the tension member partly protrudes from a connection plane of the first belt layer to a second belt layer. Furthermore, a second belt layer is conceived, made of a (second) plasticizable material that is moulded to the first belt layer and the protruding sections of the at least one tension member at the connection plane, and constitutes a second exterior surface of the suspension belt.

In one embodiment of the invention, the surface of the at least one tension member is covered by at least 80%, preferably by at least 95%, with the first plasticizable material, and the clear spaces within the at least one tension member are, at least partly, filled with the first plasticizable material.

The first belt layer and the second belt layer of the suspension belt can optionally be made of the same material, the same material with different properties, or of different materials.

In one embodiment of the invention, the first exterior surface of the first belt layer is embodied with at least one rib extending longitudinally along the suspension element, preferably shaped as a V-rib, having a flank angle of between 60° and 120°, and/or being embodied with a flattened top.

In another embodiment of the invention, the second exterior surface of the second belt layer is embodied with at least one rib extending longitudinally along the suspension element, preferably shaped as a V-rib, having a flank angle of between 60° and 100°, and/or being embodied with a flattened top.

In still another embodiment of the invention, the ratio of total height of the suspension belt to its total width is greater than 1. Alternatively, however, this ratio can also amount to about 1 or be less than 1.

According to another aspect of the invention, a device to manufacture a suspension element with the features of claim 6 is conceived. Advantageous further formations and embodiments of this invention are the subject of the dependent claims as well as of the description and the figures.

According to another aspect of the invention, the manufacturing of a suspension element for an elevator is conceived by a manufacturing process according to claim 7, comprising the steps of placing at least one rope-type tension member, embedding the at least one rope-type tension member within a first belt layer made of a first plasticizable material.

Therein preferably, one belt layer is made having a first exterior surface and a surface constituting a connection plane, with the at least one tension member partly protruding from the connection plane and the protruding section of the at least one tension member being covered at least partly by the first plasticizable material. The second belt layer is preferably made of a second plasticizable material, moulded to the connection plane of the first belt layer and to the protruding sections of the at least one tension member in such a manner that a suspension element is produced with the first exterior surface at the side of the first belt layer and a second exterior surface at the side of the second belt layer.

In this procedure, the tension members are embedded as completely as possible into the first plasticizable material of the first belt layer, so that the second plasticizable material for the second belt layer does not get in touch with the tension members. The protruding of the tension members from the connection plane between the two belt layers increases the size of the connection surface produced in the embedding step, so that a good connection between first and second belt layer can be achieved.

In one embodiment of the invention, the surface of the at least one tension member is covered, in the embedding step, by at least 80%, with the first plasticizable material. Preferably, here also the clear spaces within the at least one tension member are filled in the embedding step, at least partly, with the first plasticizable material.

For the first belt layer and the second belt layer, optionally the same material, the same material with different properties, or different materials can be used. In a further embodiment of the invention, the surface constituting the connection plane of the partial belt is given, at least partly, a surface structure before the step of moulding the second belt layer to it, whereby the surface is enlarged, thus creating a better connection with the second belt layer to be moulded to it later. Here, the surface structure at the connection surface is preferably being shaped during the embedding step. In a modified embodiment example, at least one layer is produced of an at least slightly vulcanizable material.

In a further embodiment of the invention, the first exterior surface and/or the second exterior surface are embodied with at least one rib extending longitudinally along the suspension element. The shaping of the ribs, too, preferably takes place during the embedding step or the moulding step. In another embodiment of the invention, the embedding step is executed as an extrusion procedure of the first plasticizable material, and the moulding step is executed as an extrusion procedure of the second plasticizable material.

In another embodiment of the invention, the first belt layer and the second belt layer are produced with the same or with different procedural parameters (e.g. temperature, pressure, rotation speed of the moulding wheel, etc.), which are optimally fitted to the first or second plasticizable material, respectively. In another embodiment of the invention, the at least one tension member is placed under pre-tension during the embedding step. For a better linking of the tension members with the first belt layer, preferably the at least one tension member is heated during the embedding step, and for a better linking of the first and the second belt layer, preferably the connection surface of the partial belt is heated during the moulding step.

According to another aspect of the invention, a manufacturing device for a belt-type suspension element for an elevator system with the features of claim 7 is conceived. Advantageous further formations and embodiments of this invention are the subject of the dependent claims, the description, and the figures.

The device for manufacturing a belt-type suspension element for an elevator system comprises a first manufacturing station for the production of a partial belt with a first exterior surface and a surface constituting a connection plane, and a second manufacturing station for the production of the suspension belt with the first exterior surface and a second exterior surface. The first manufacturing station comprises a first moulding wheel, a first guide wrapping partly around the circumference of the first moulding wheel, a facility to feed at least one rope-type tension member to the first moulding wheel, and a first extruder to feed a first plasticizable material into a mould cavity formed between the first moulding wheel and the first guide. The second manufacturing station comprises a second moulding wheel, a second guide wrapping partly around the circumference of the second moulding wheel, a device for feeding the partial belt produced at the first manufacturing station to the second moulding wheel, and a second extruder to feed a second plasticizable material into a mould cavity formed between the second moulding wheel and the second guide. According to invention, the external circumferential surface of the first moulding wheel of the first manufacturing station is embodied with at least one longitudinal groove extending in the direction of the circumference of the first moulding wheel, in which the at least one fed tension member is guided and which is dimensioned such that in the partial belt produced in the first manufacturing station the at least one tension member partly protrudes from the connection plane and the protruding section of the at least one tension member is, at least partly, covered by the first plasticizable material. With the use of a manufacturing device according to invention, preferably suspension elements or force transfer arrangements according to invention can be produced, to which end manufacturing procedures according to invention can be used.

In one embodiment of the invention, the width of the longitudinal grooves of the exterior circumferential surface of the first moulding wheel is chosen as smaller than a diameter of the tension members, preferably rangeing from about 70% to 95%, more preferably from about 75% to 90% of the diameter of the tension members. Furthermore, the depth of the longitudinal grooves of the exterior circumferential surface of the first moulding wheel preferably ranges from about 25% to 50%, more preferably from about 30% to 40% of the diameter of the tension members.

In another embodiment of the invention, the first manufacturing station furthermore comprises a device to feed the at least one tension member to the first moulding wheel, under pre-tension, and a first heating device, to heat the at least one tension member before its feeding to the first moulding wheel.

In still another embodiment of the invention, the first guide of the first manufacturing station is given a structure at its side turned towards the first moulding wheel, so as to give the first exterior surface of the partial belt or the suspension belt a profile, e.g. in the form of V-ribs.

In still another embodiment of the invention, the first moulding wheel is given a structure at its exterior circumferential surface, in the area between the longitudinal grooves, so as to give the surface constituting the connection plane of the partial belt a surface structure, so that a better connection between the first and the second belt layer of the suspension belt can be reached.

In another embodiment of the invention, the second manufacturing station furthermore comprises a second heating device, to heat the partial belt before its feeding to the second moulding wheel, and the second guide of the second manufacturing station is equipped at its side turned towards the second moulding wheel with a structure so as to give the second exterior surface of the suspension belt a profile, for instance in the form of V-ribs. Further forms of suspension elements manufacturable according to invention are described in detail elsewhere.

Another embodiment of the invention relates to a force transfer arrangement for an elevator system that may comprise several individual suspension elements in form of (maybe sheathed or partly sheathed) belts, ropes or the like, with a force transfer element or tension member to which a base body is assigned at which the force transfer element or tension member is held in position in such a form-locking manner that the base body encloses the force transfer element at least sectionally. A force transfer arrangement according to invention preferably comprises a suspension element that is produced according to the manufacturing procedures according to invention.

In one embodiment, the height of the base body along a first longitudinal section is lower than the total height of the force transfer arrangement.

Further embodiments of the inventions can be found in the further claims, the drawings, and the related descriptions.

### SHORT DESCRIPTION OF THE PICTURES

The above-mentioned as well as further features and advantages of the invention become better understandable through the following descriptions of preferred, non-restricting embodiment examples referring to the annexed drawings. The figures schematically show the following:

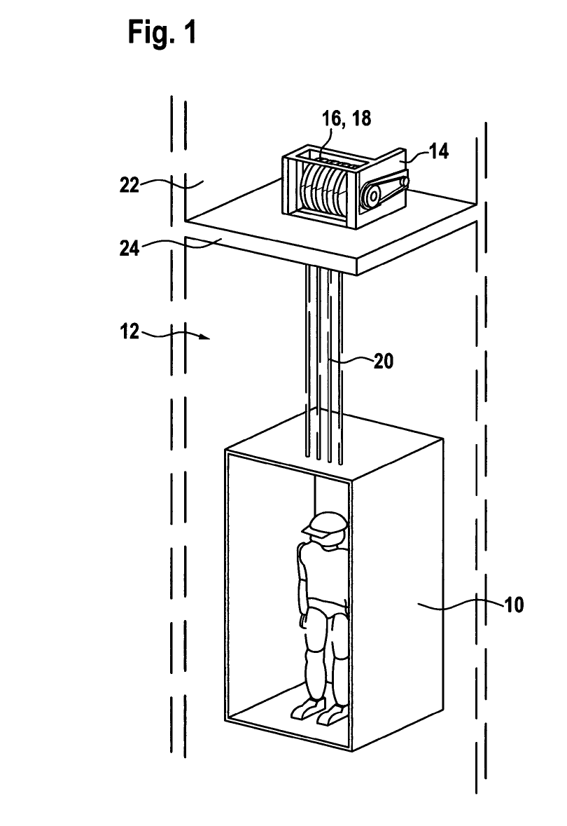

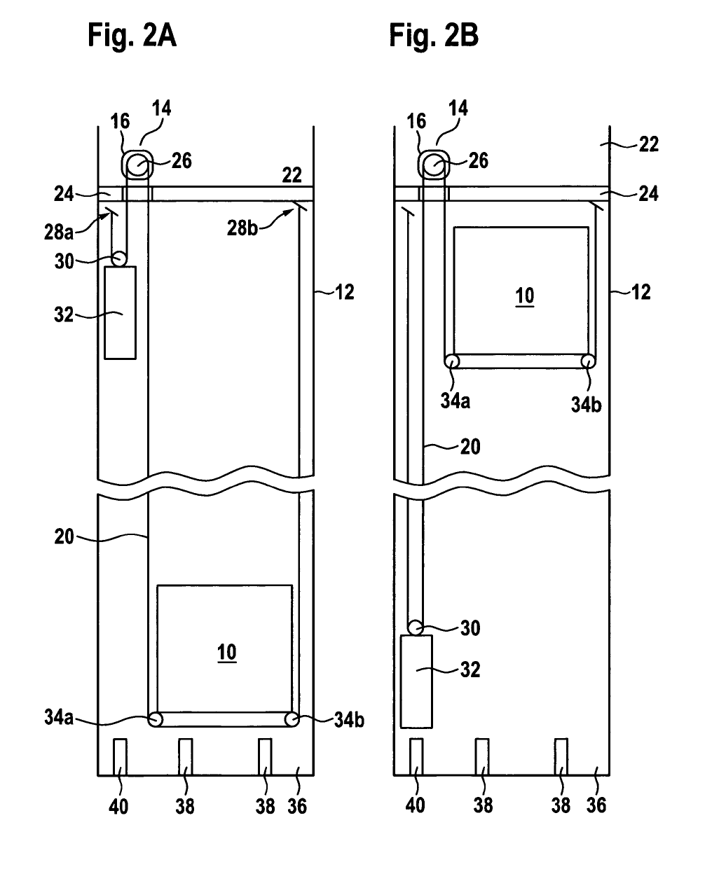

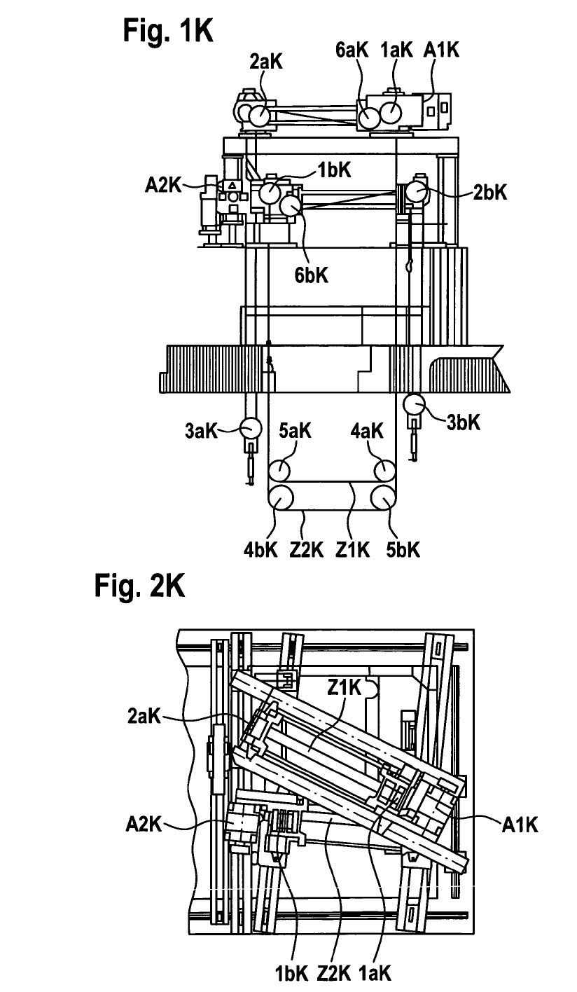

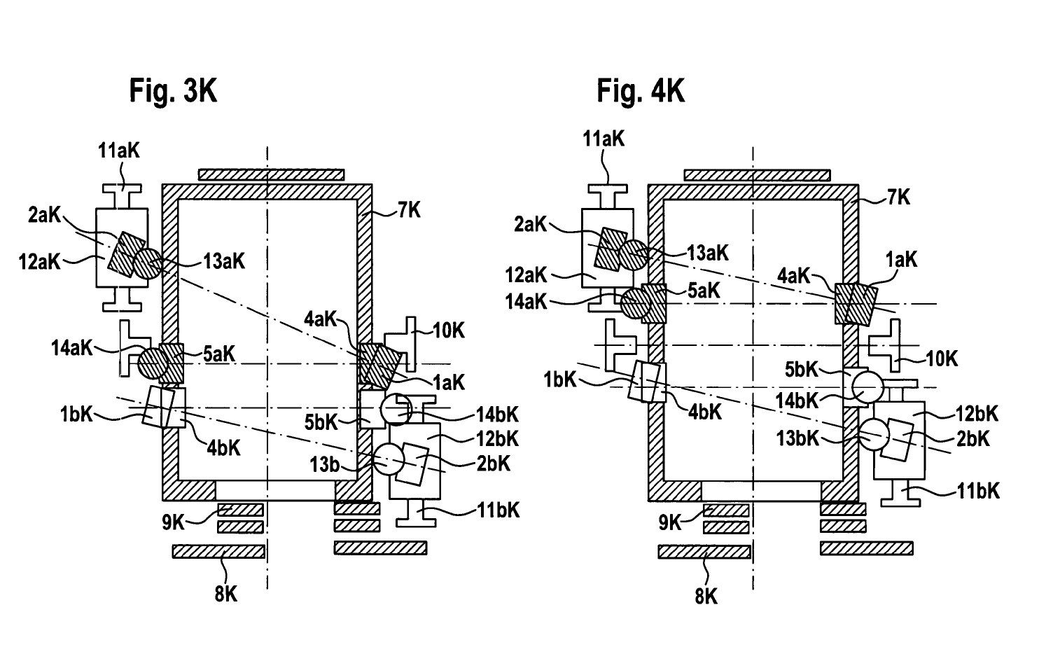

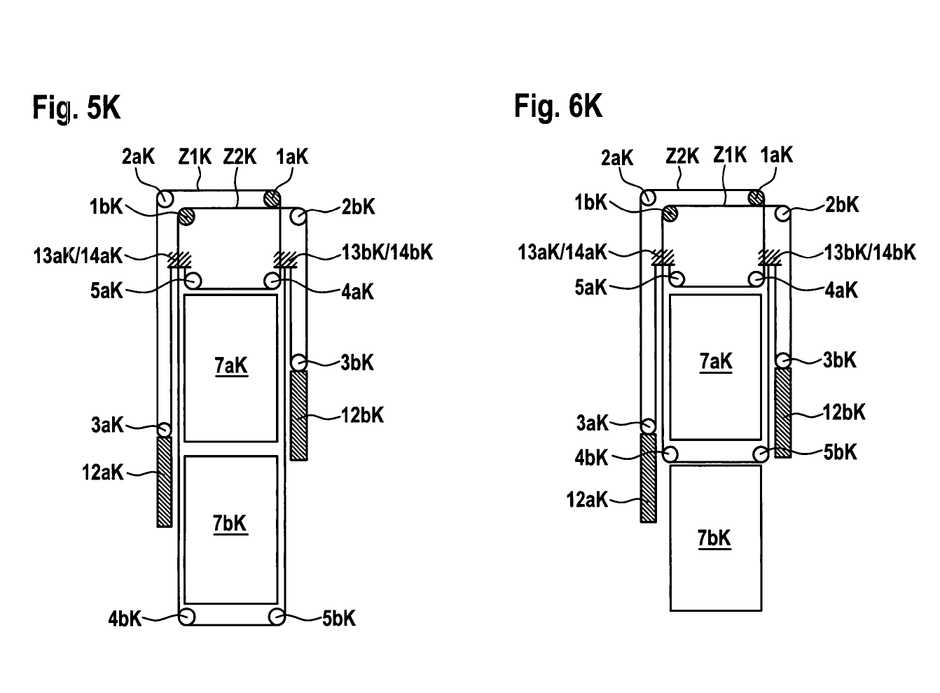

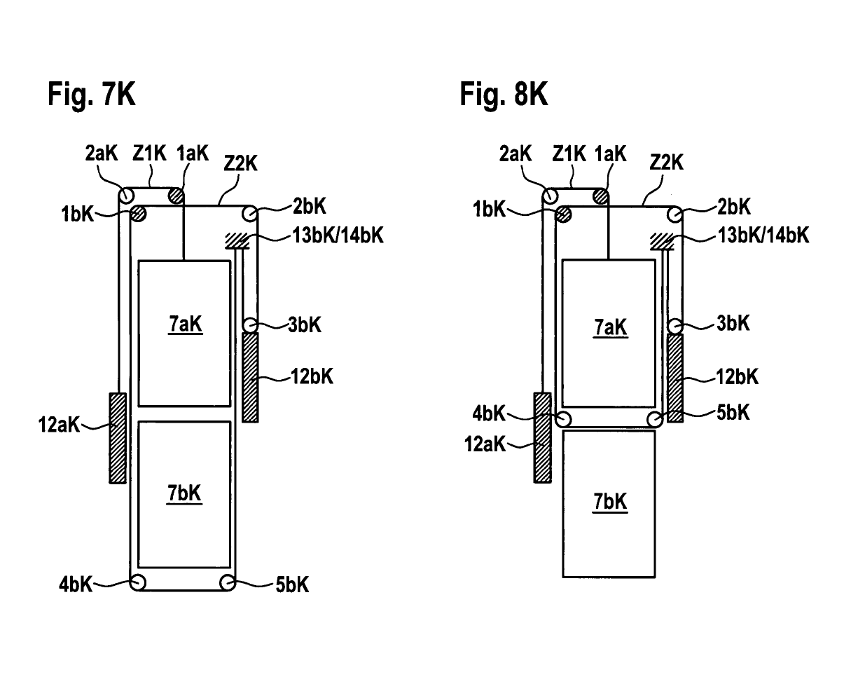

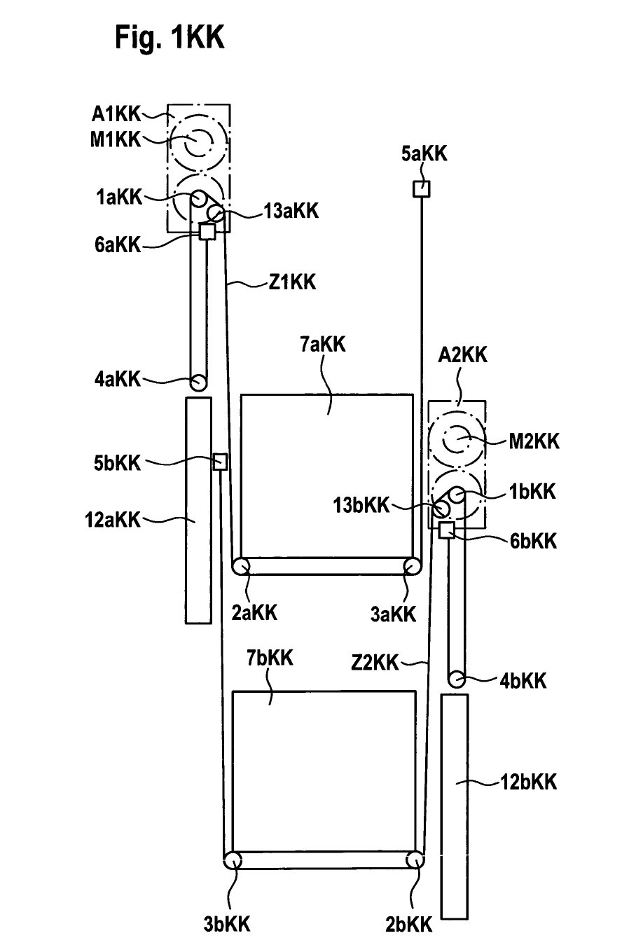

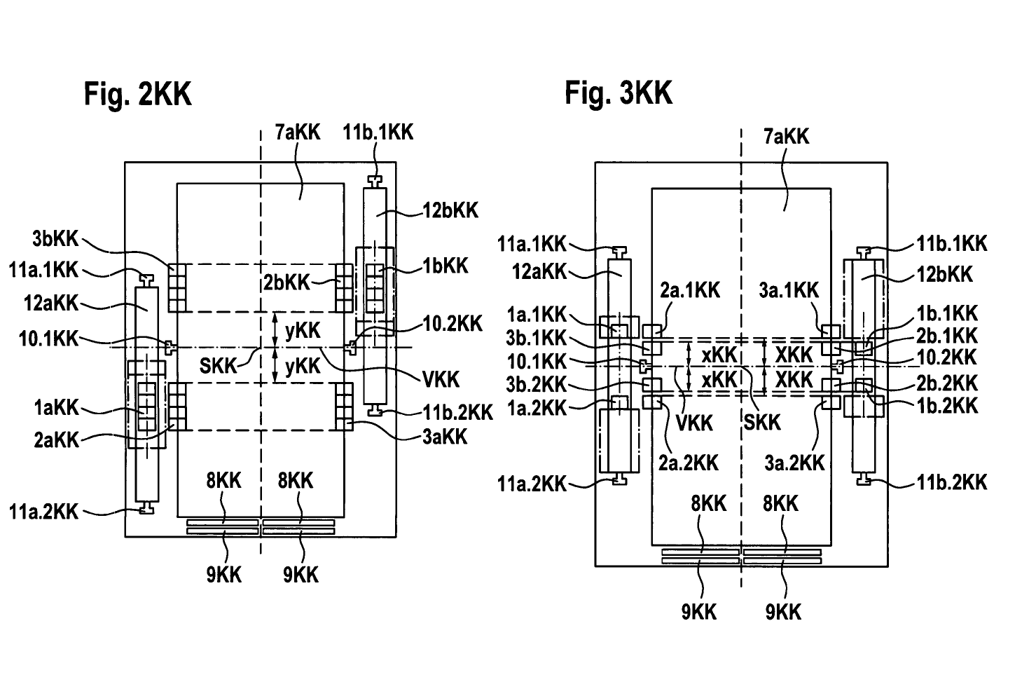

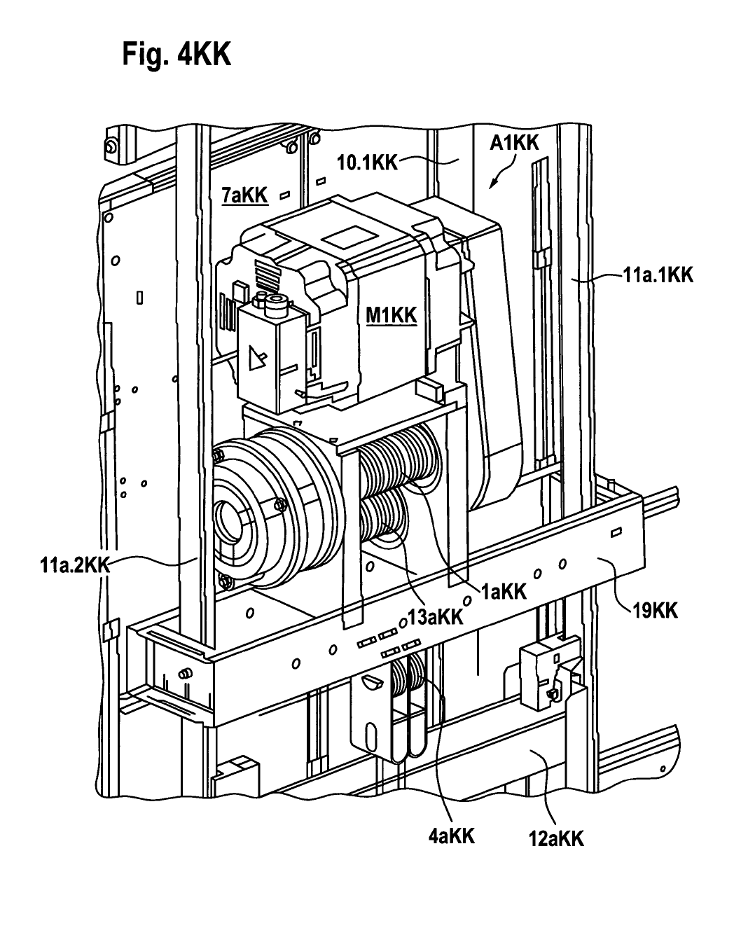

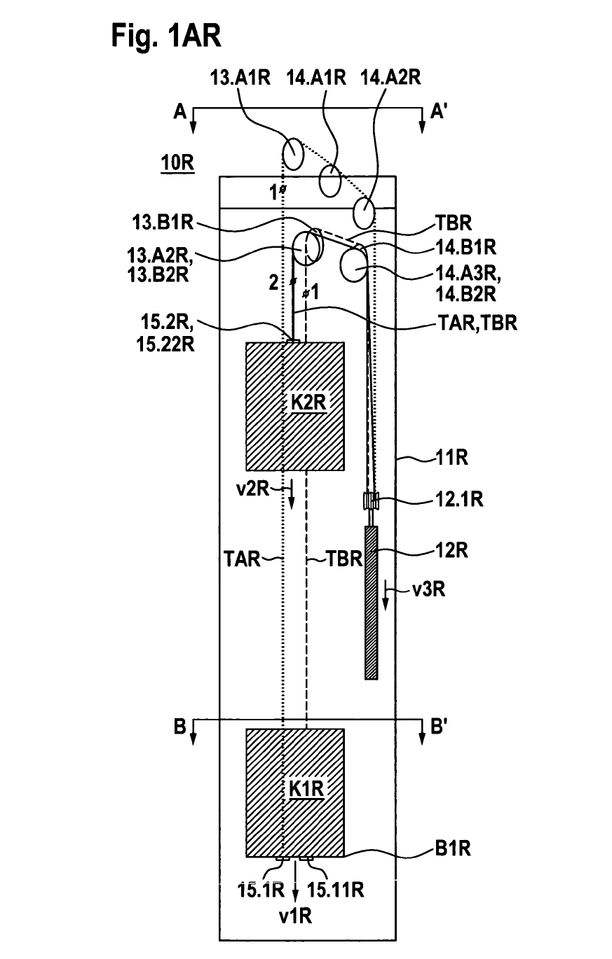

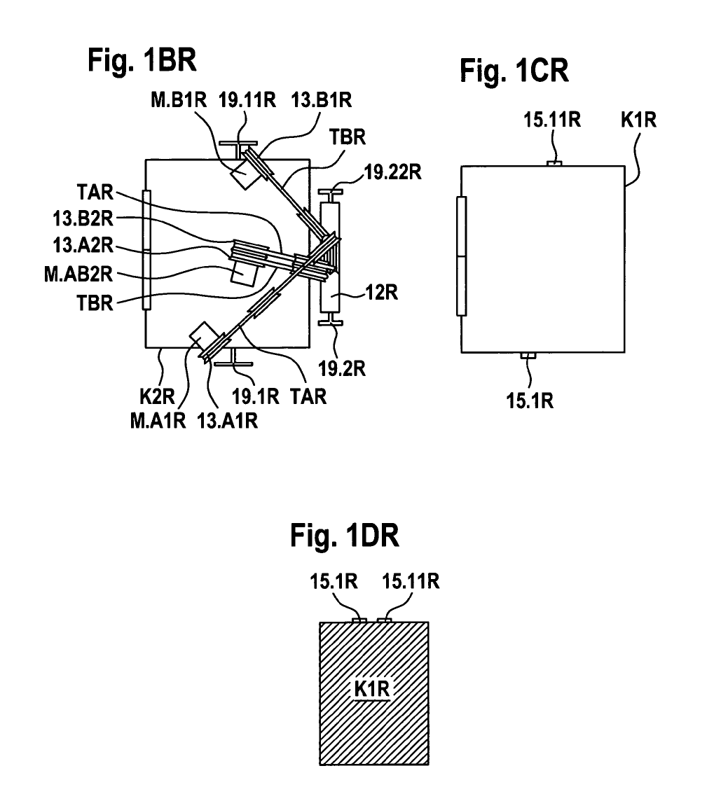

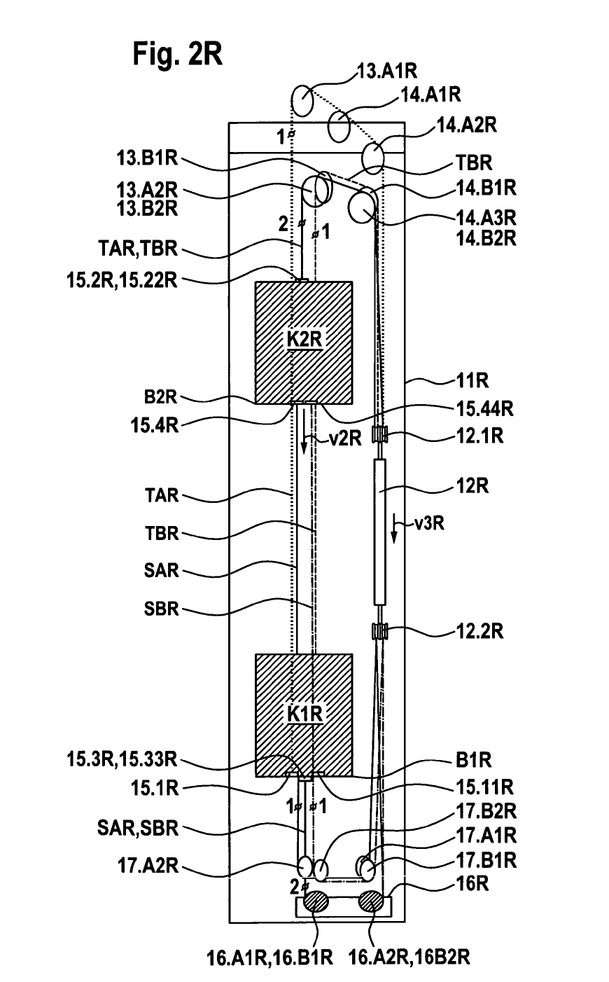

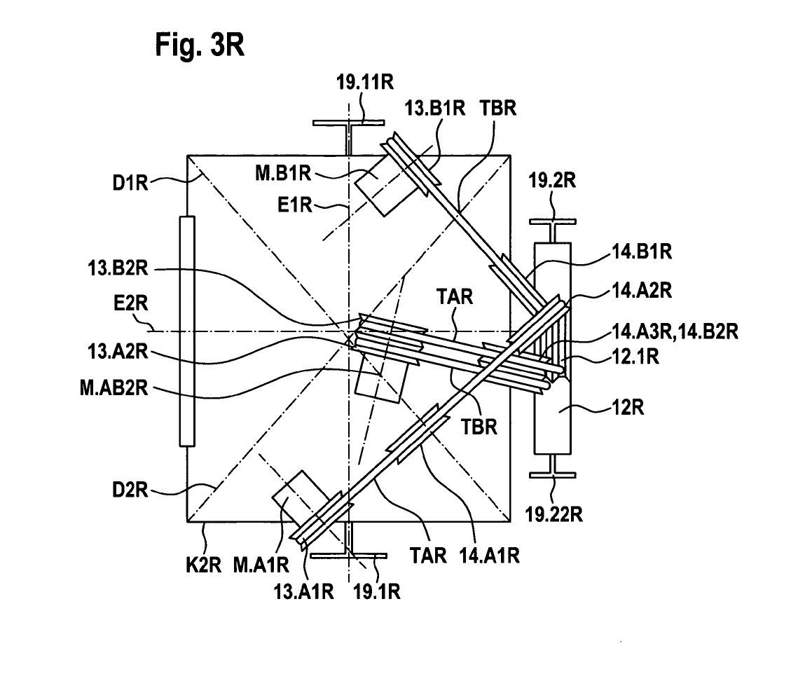

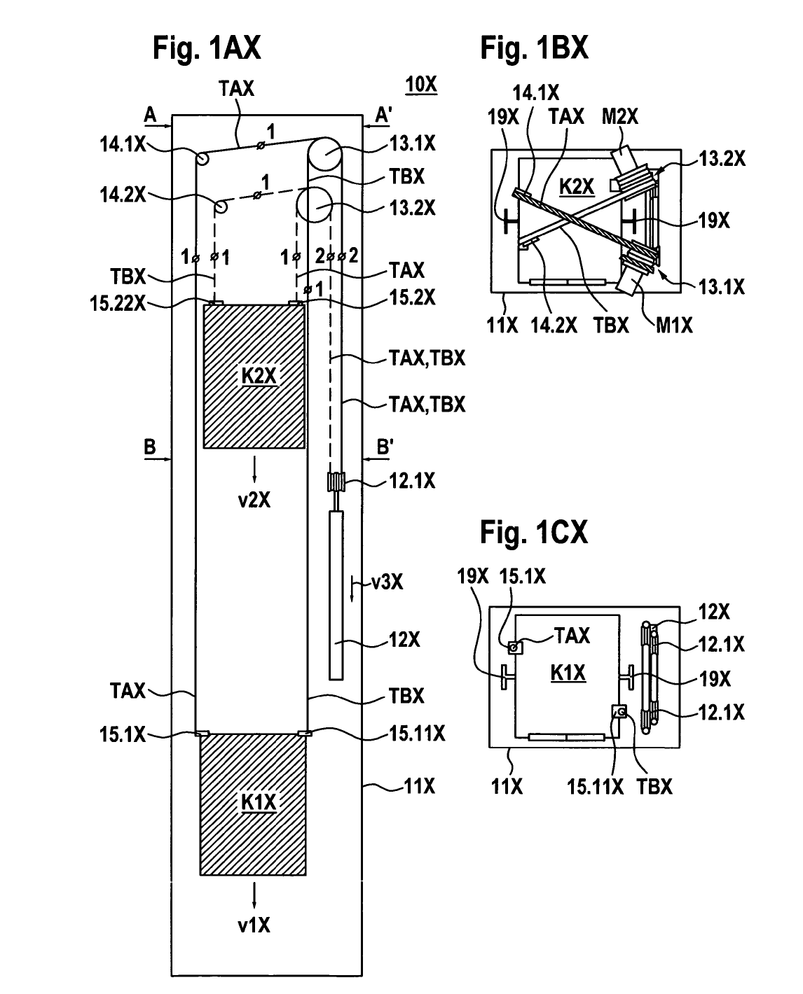

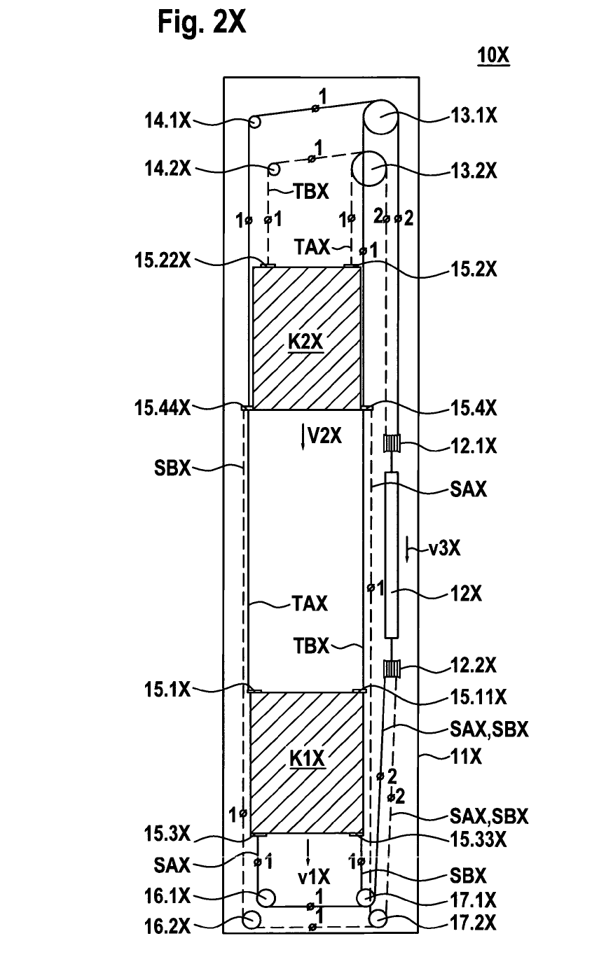

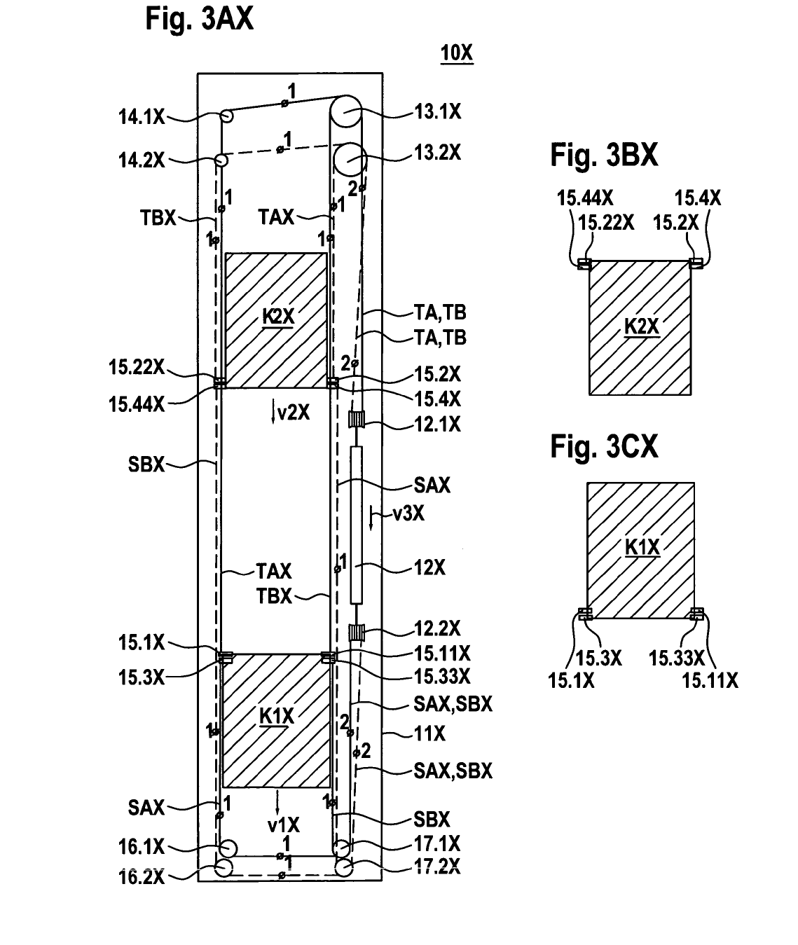

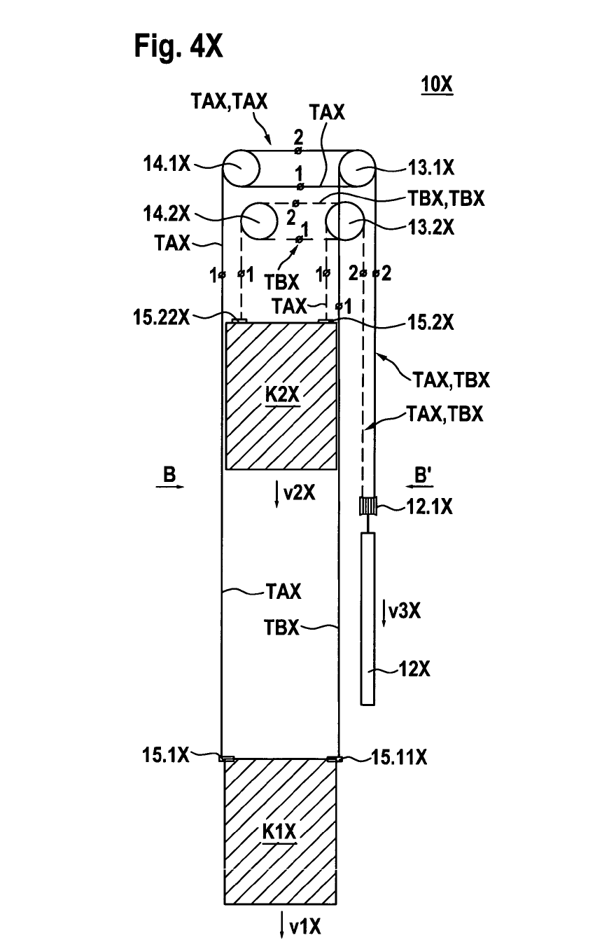

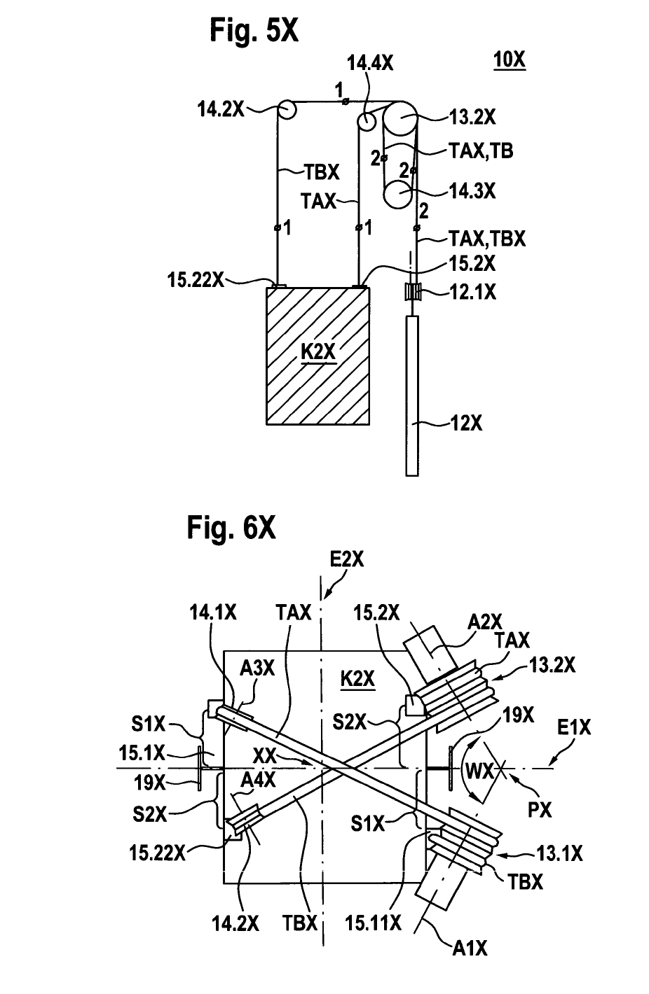

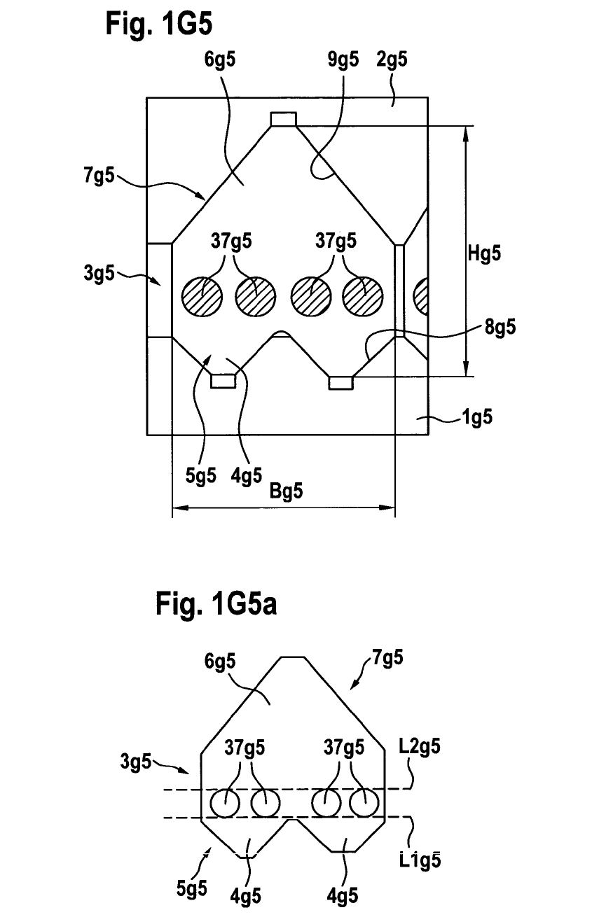

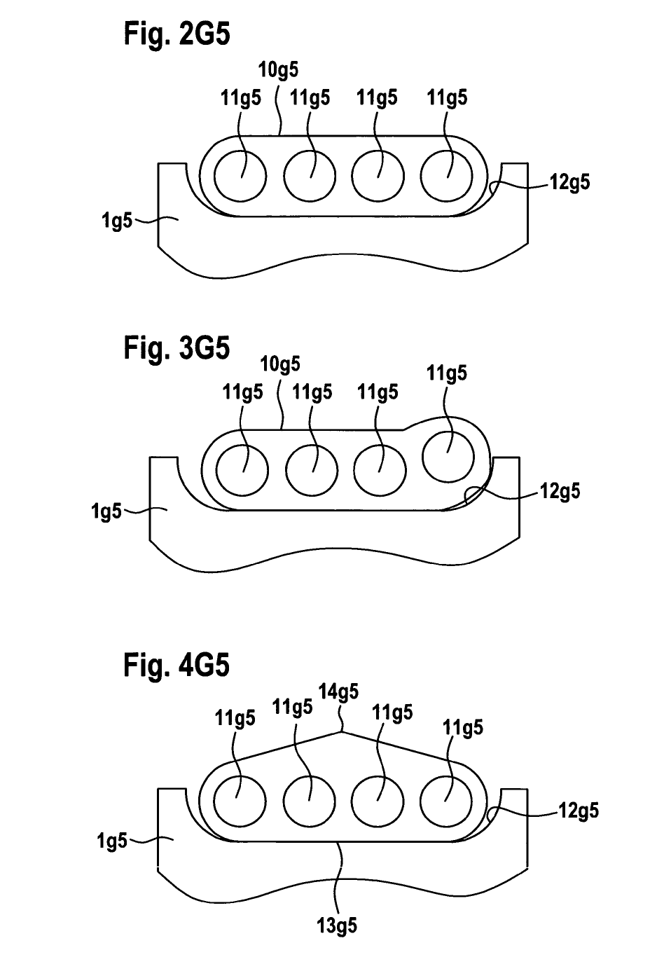

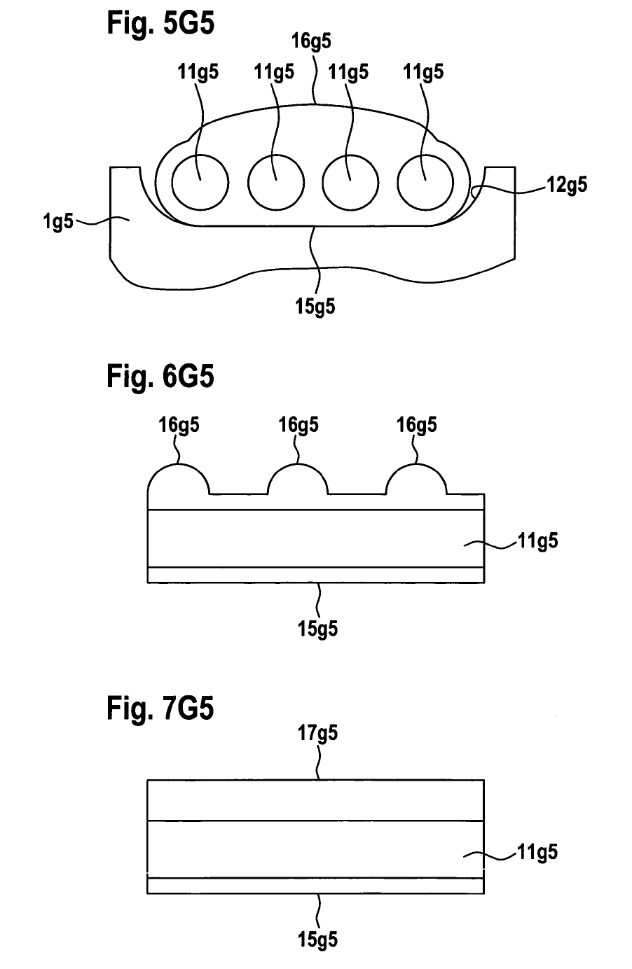

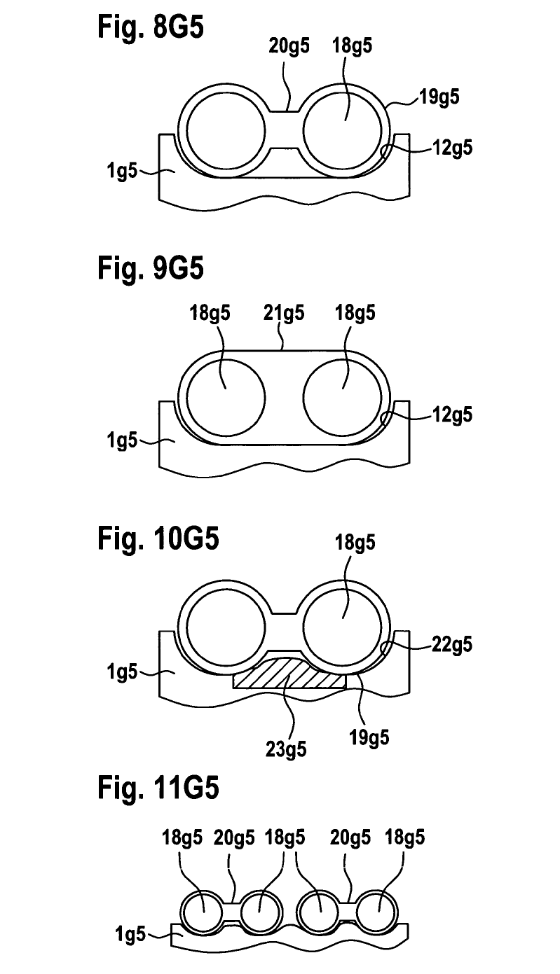

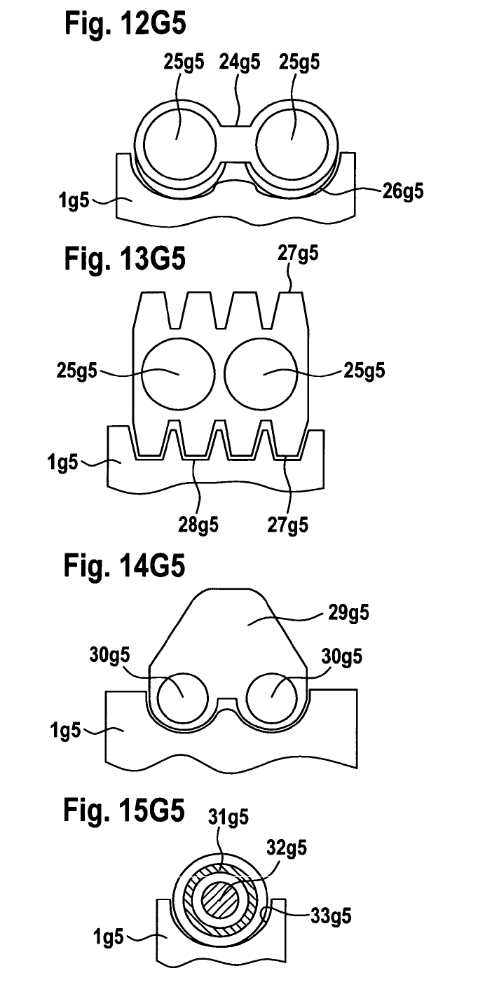

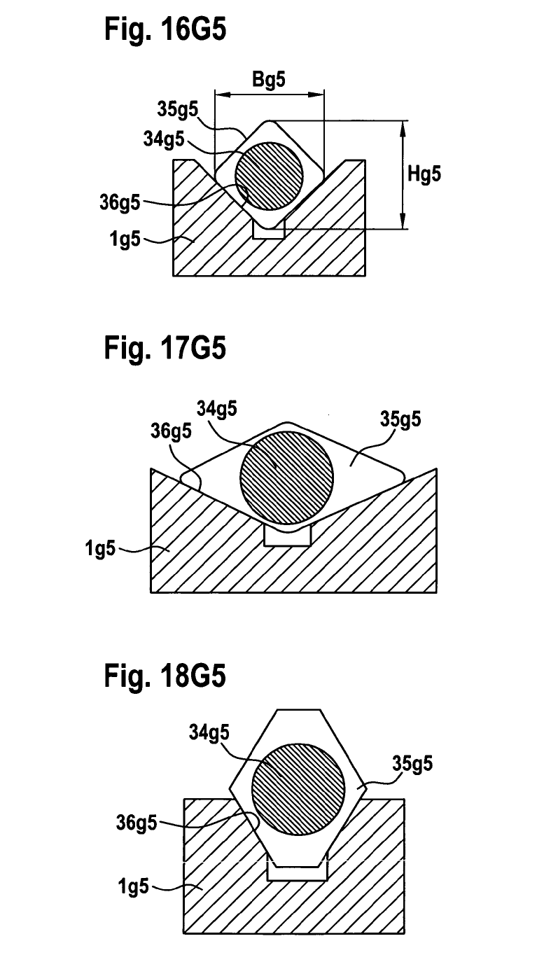

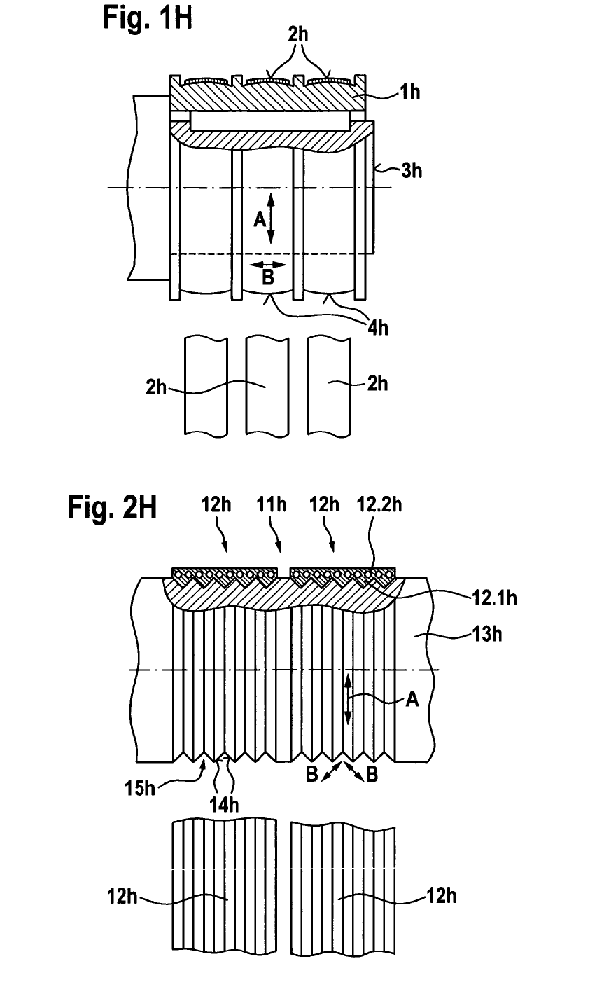

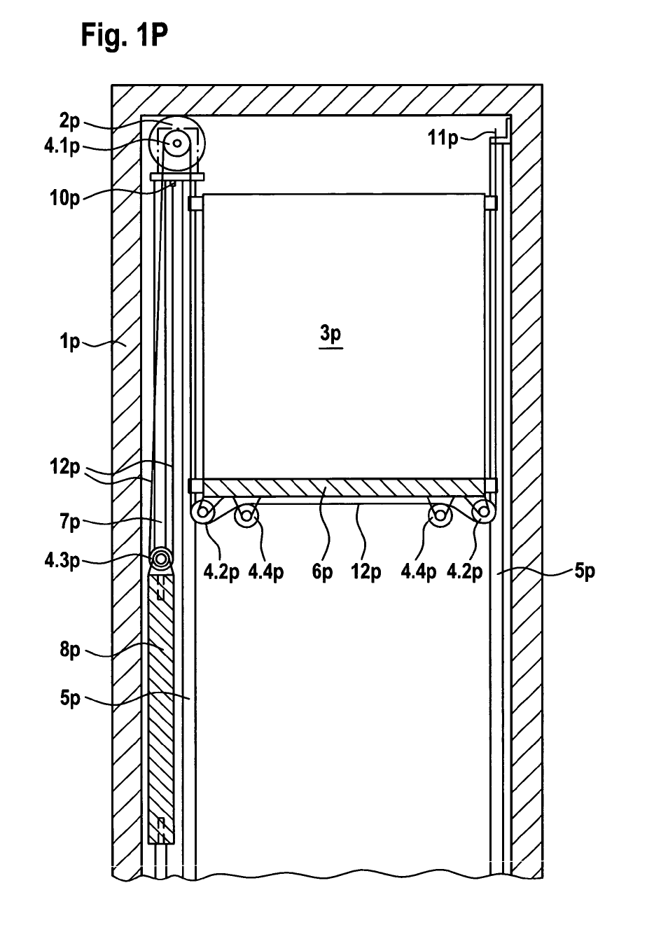

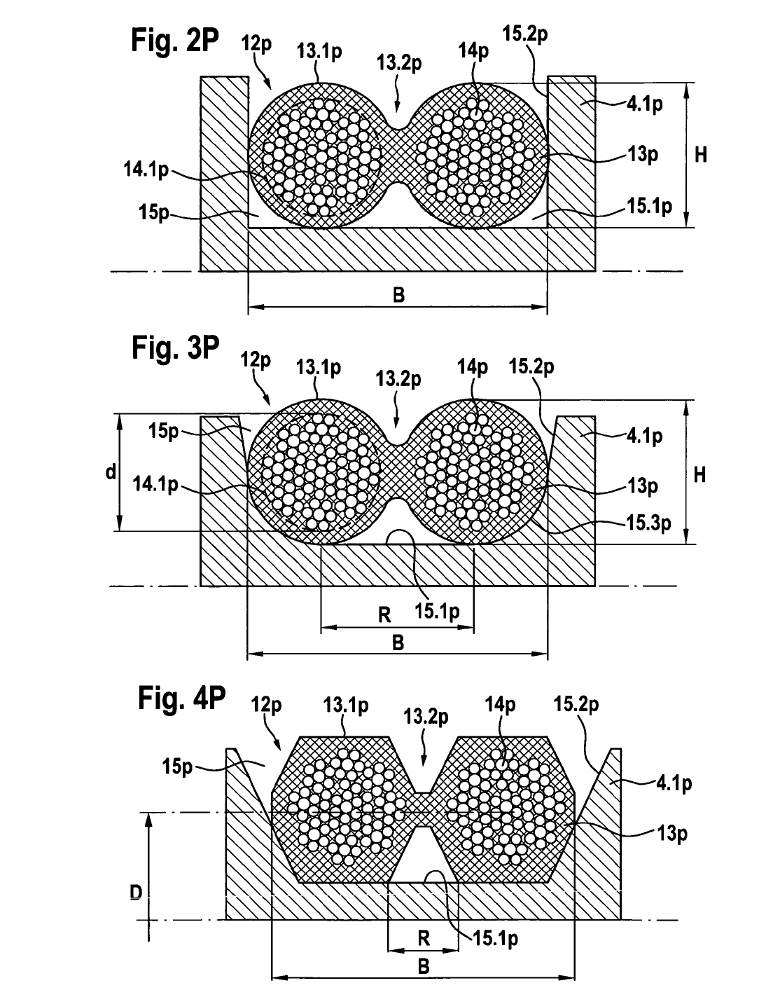

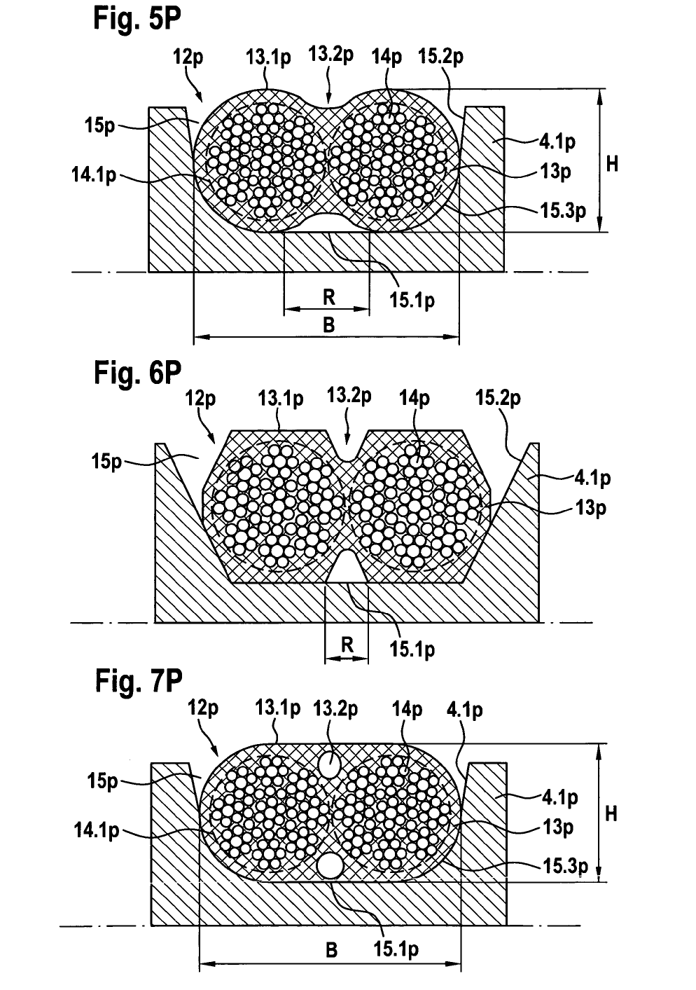

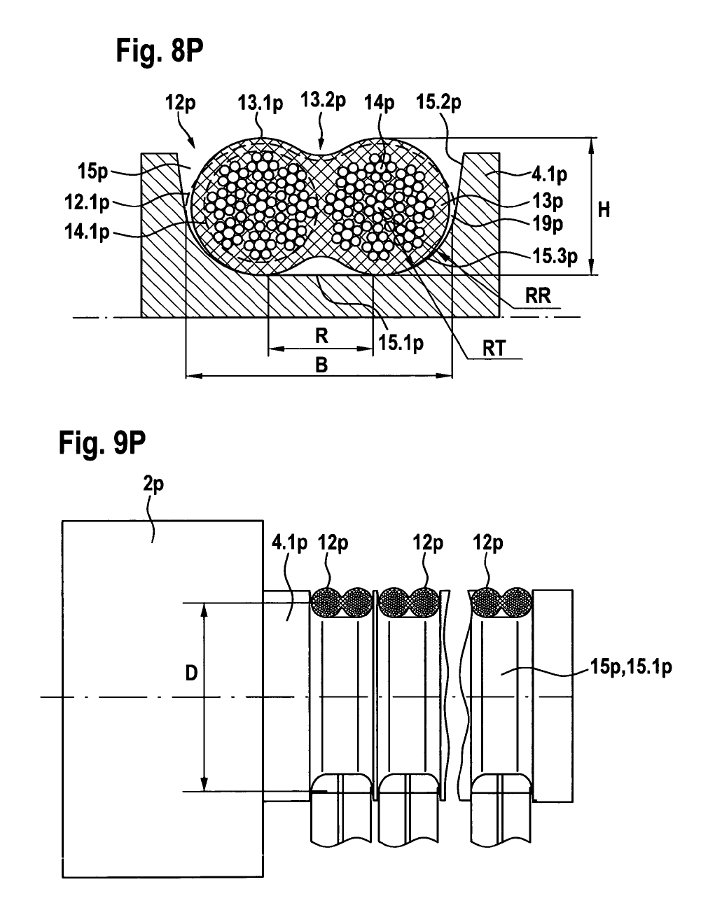

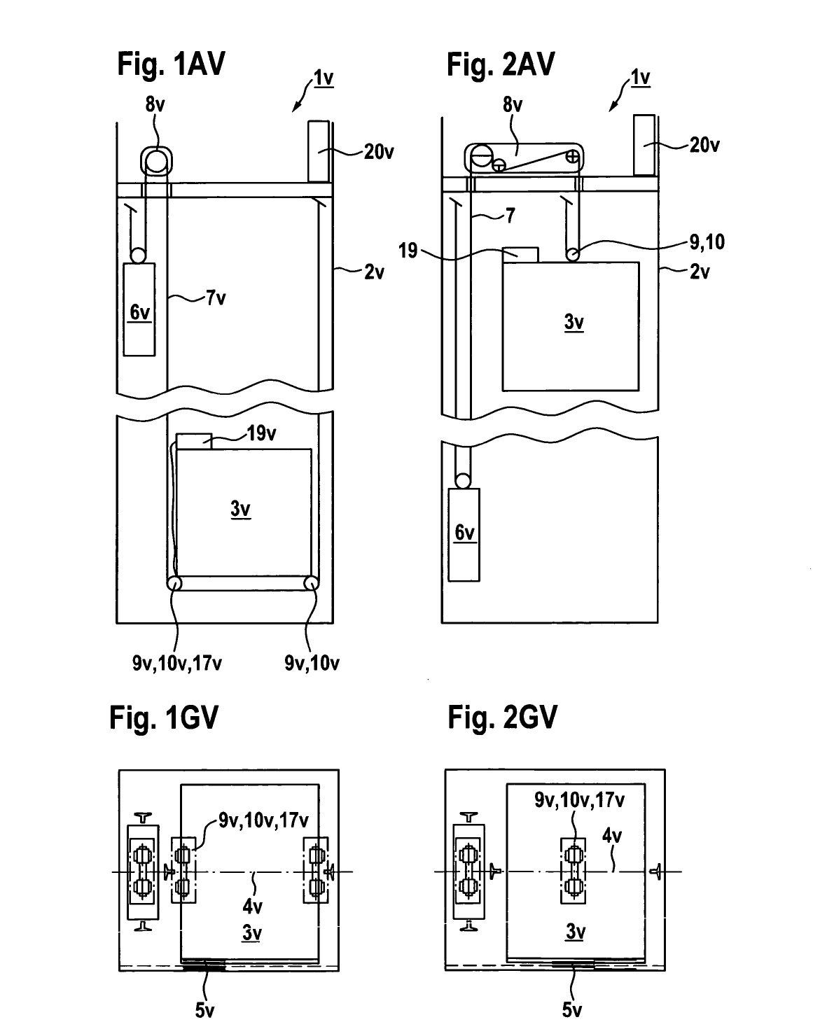

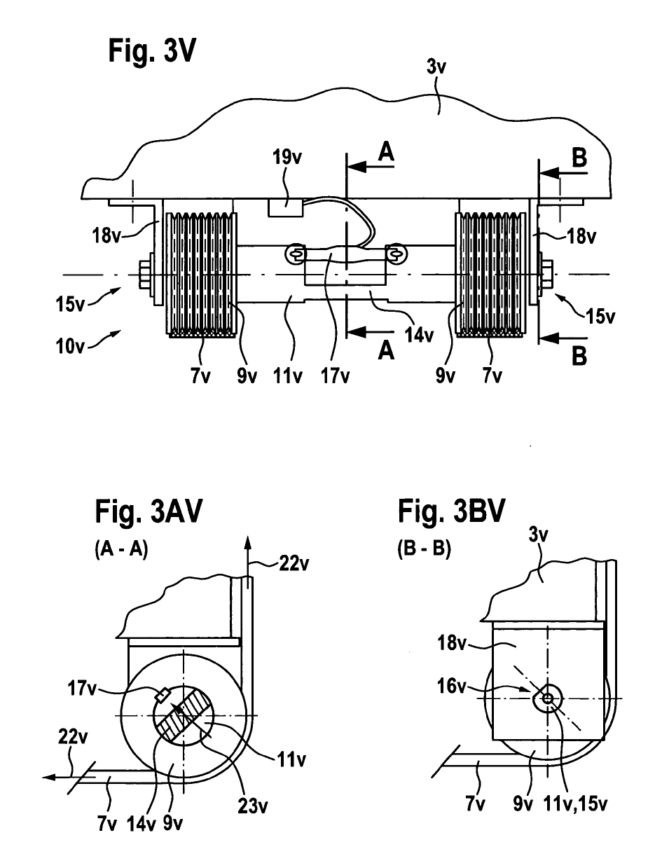

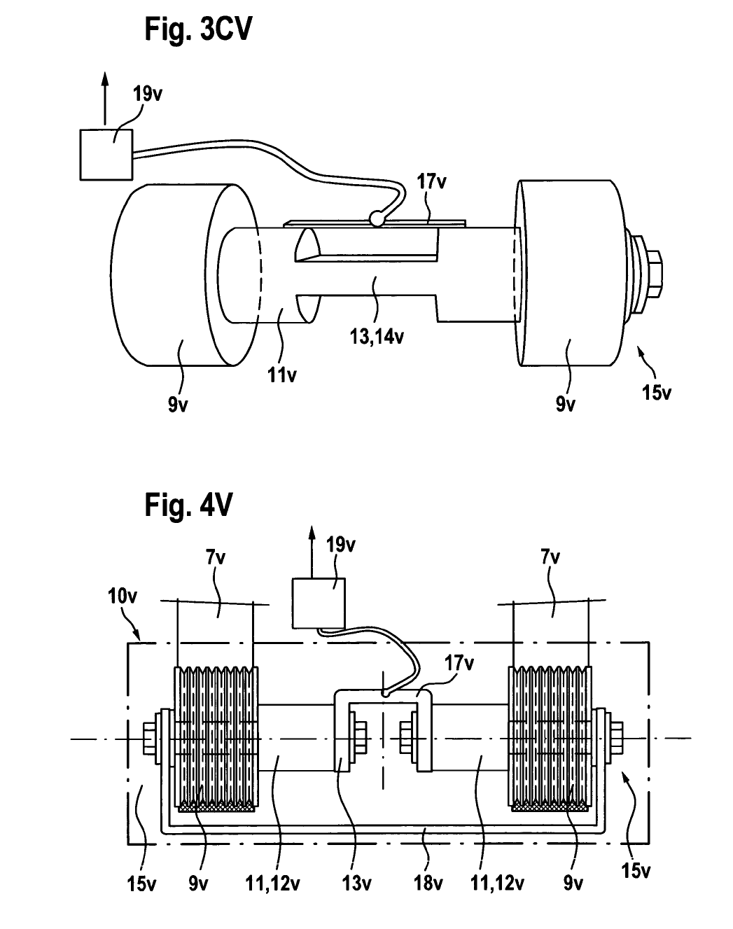

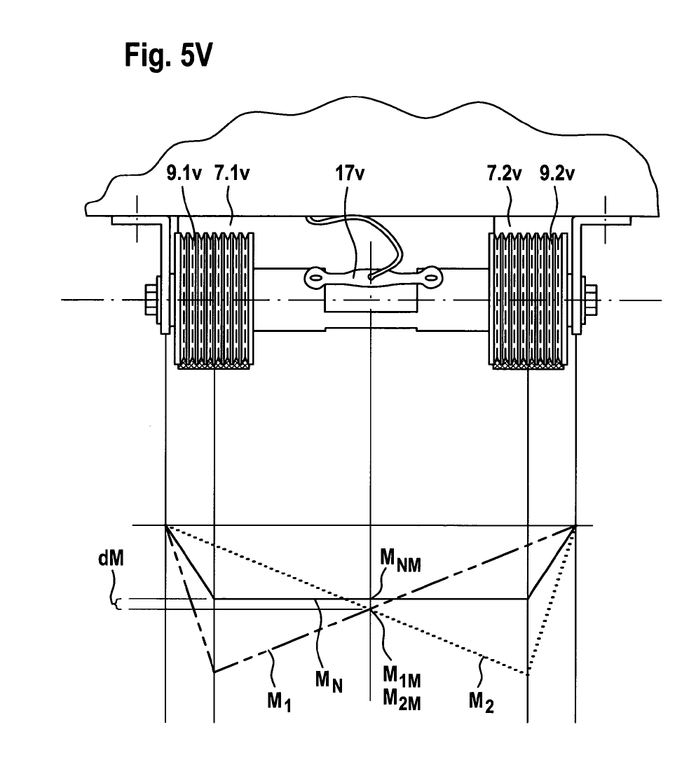

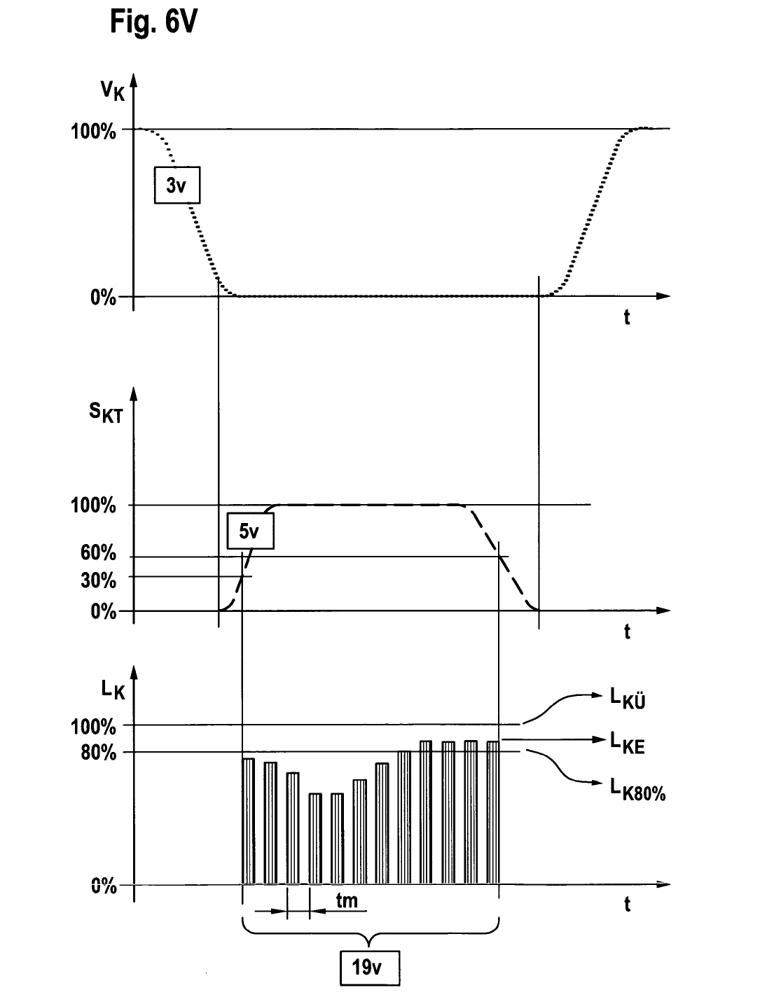

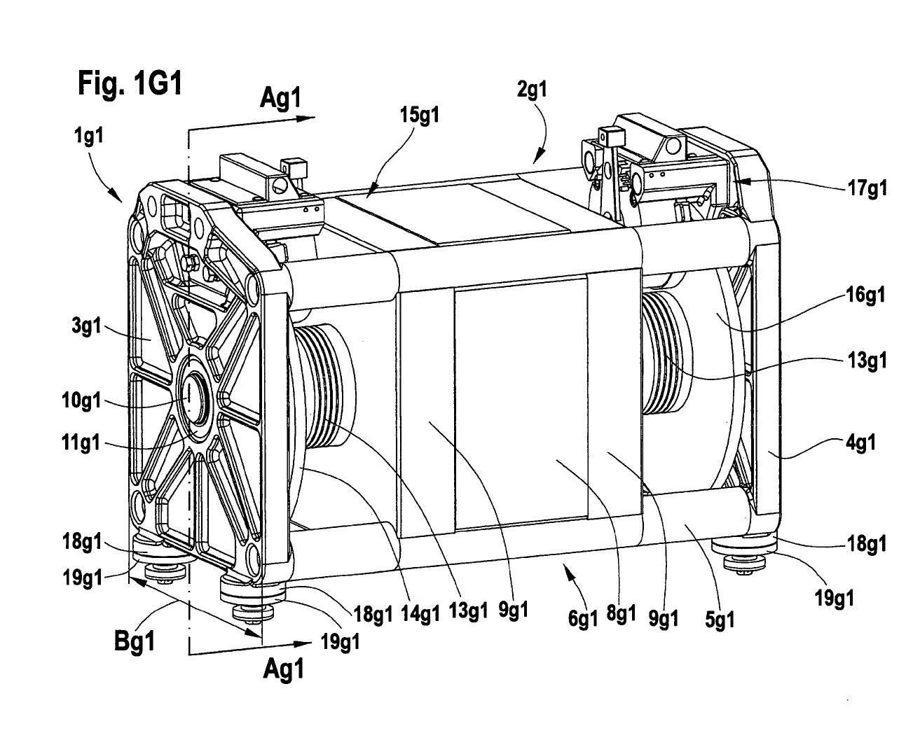

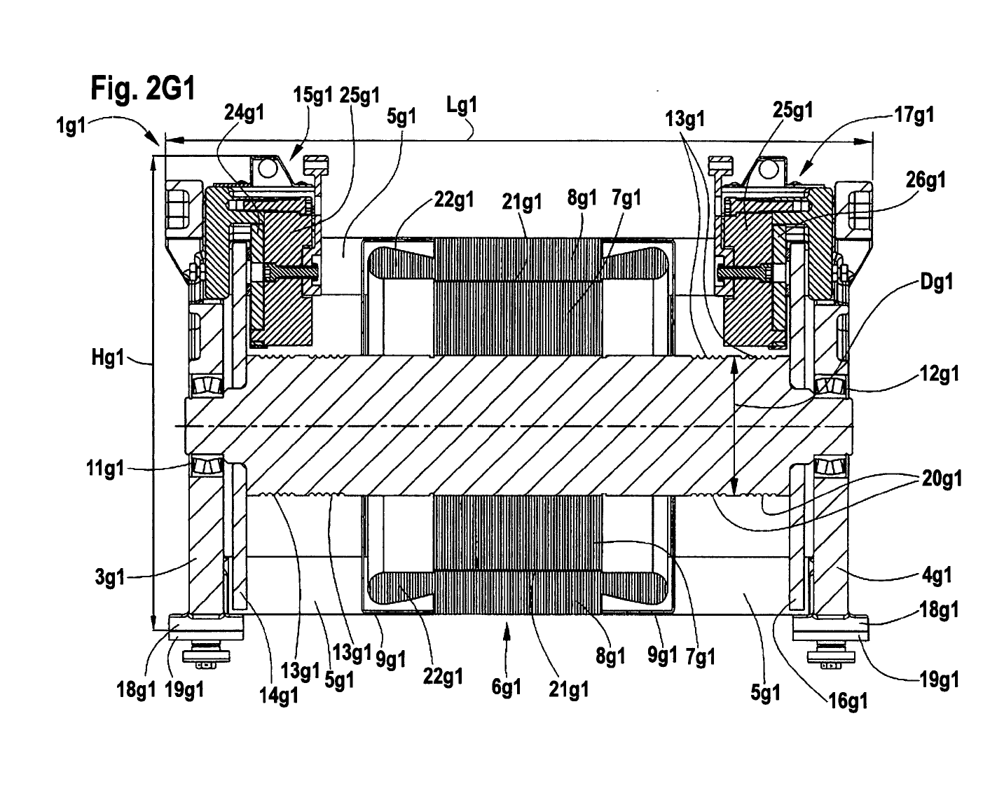

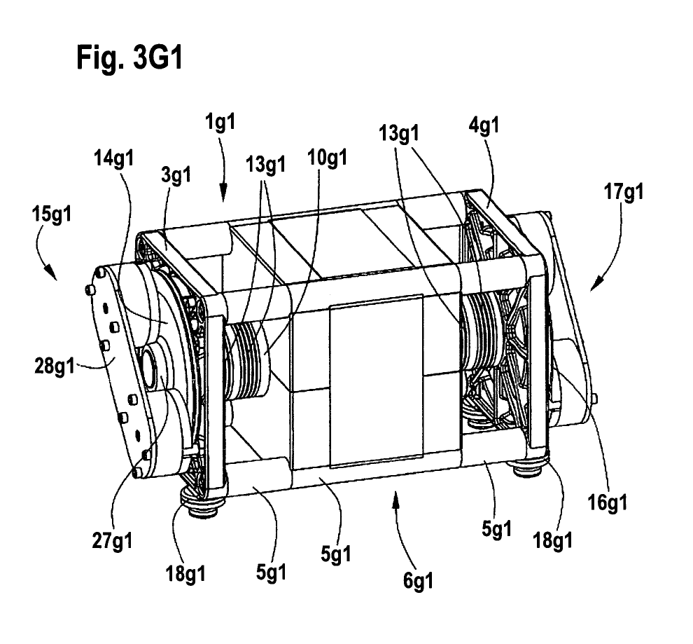

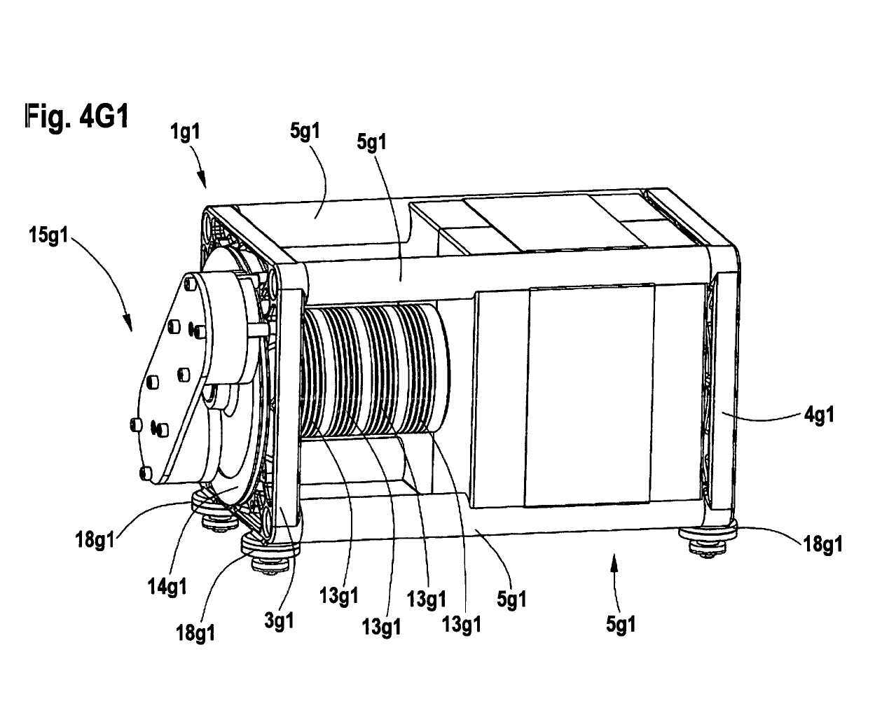

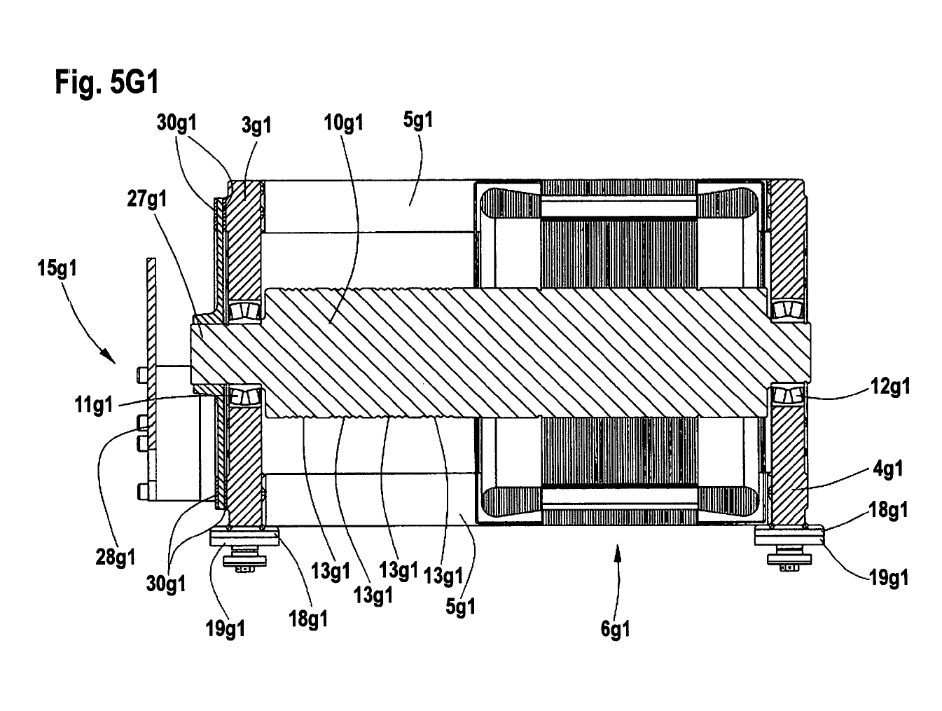

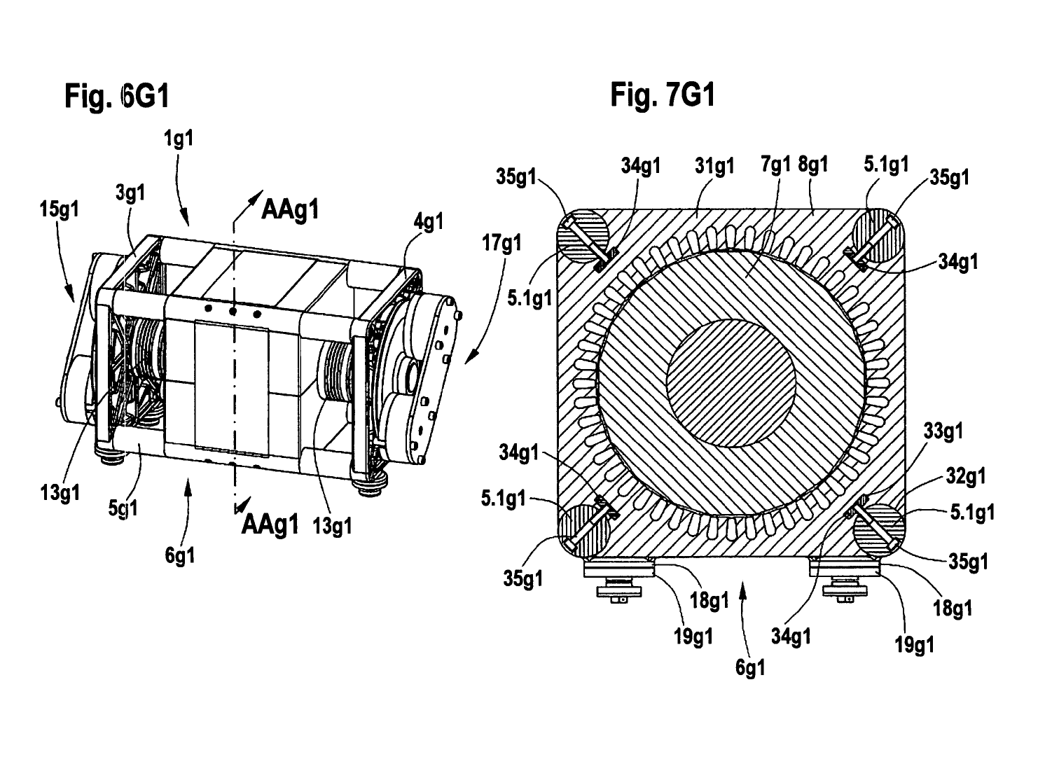

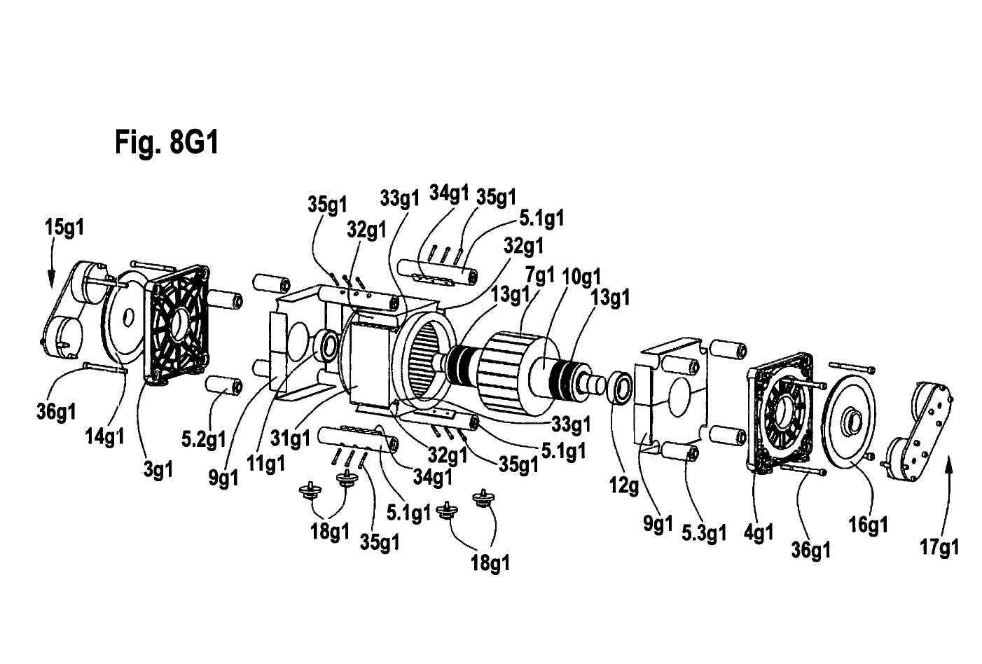

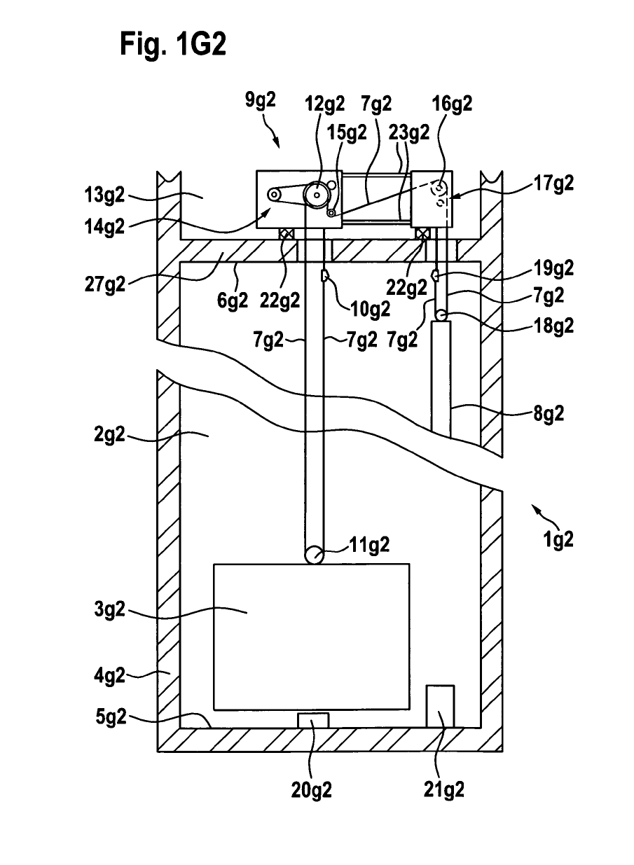

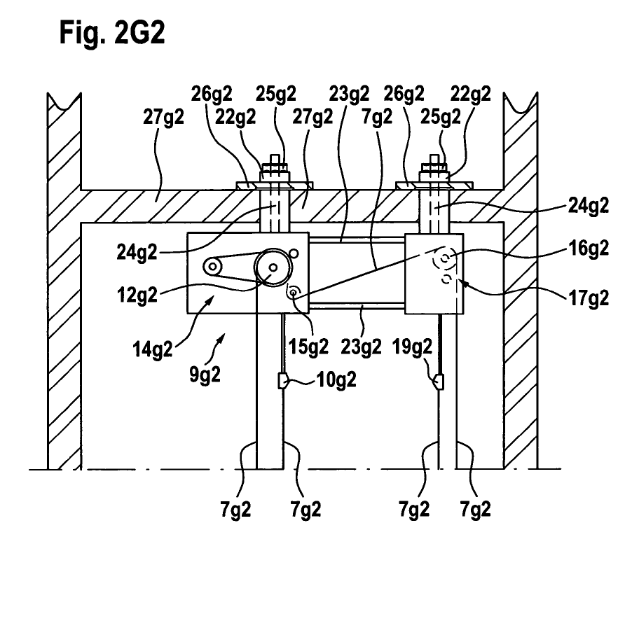

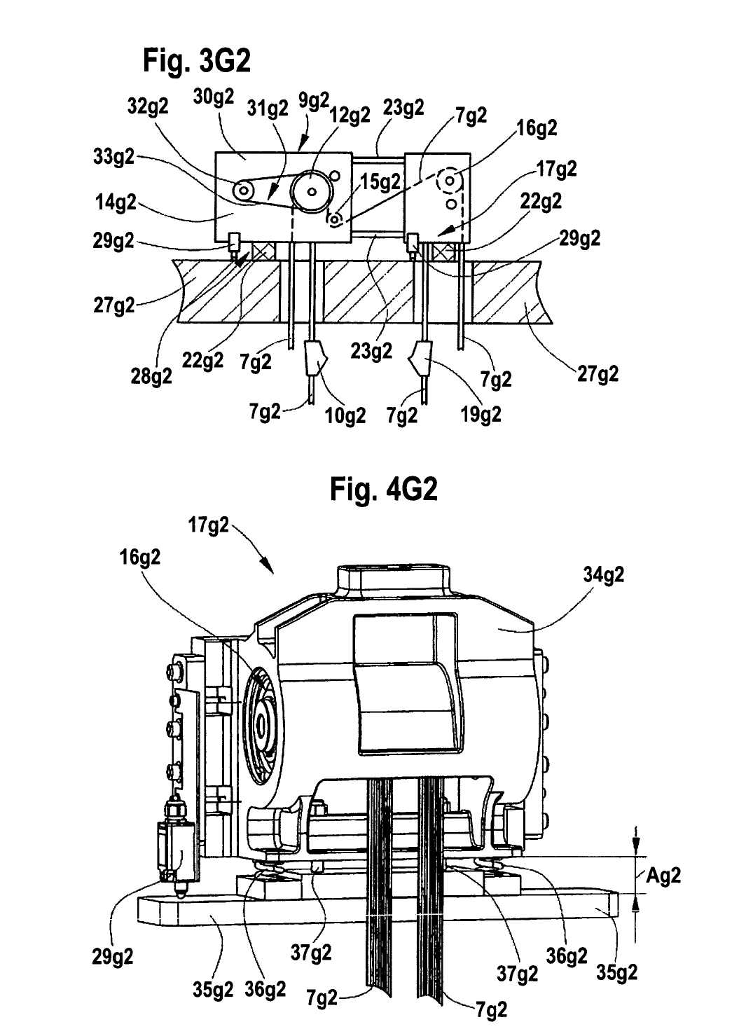

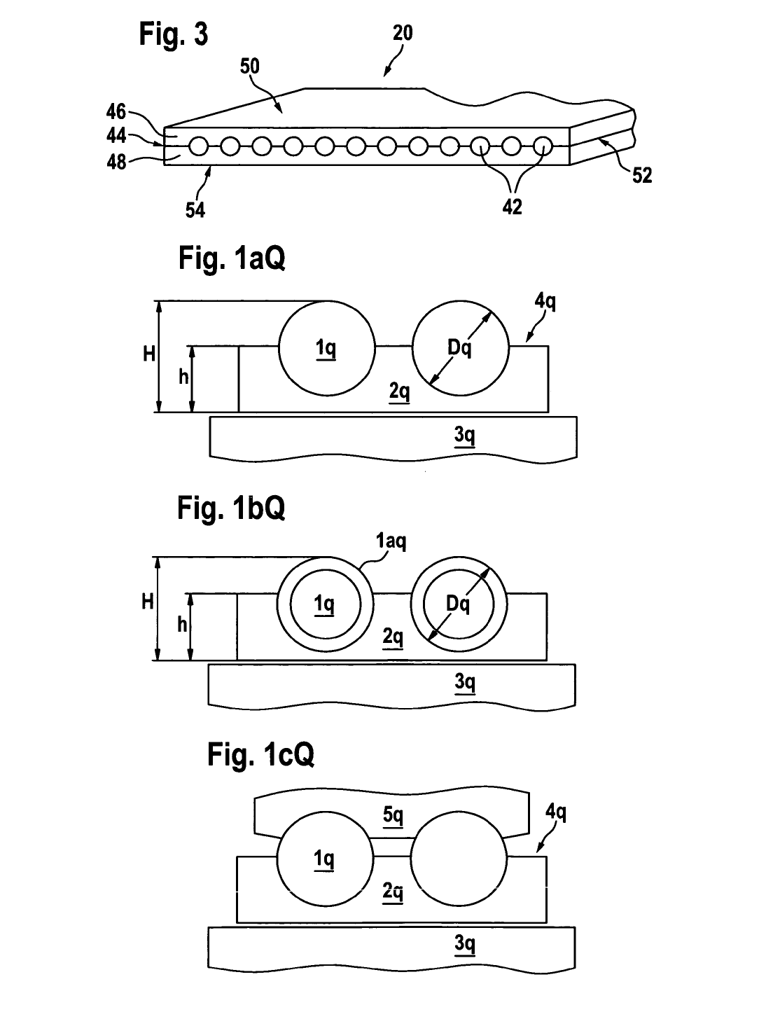

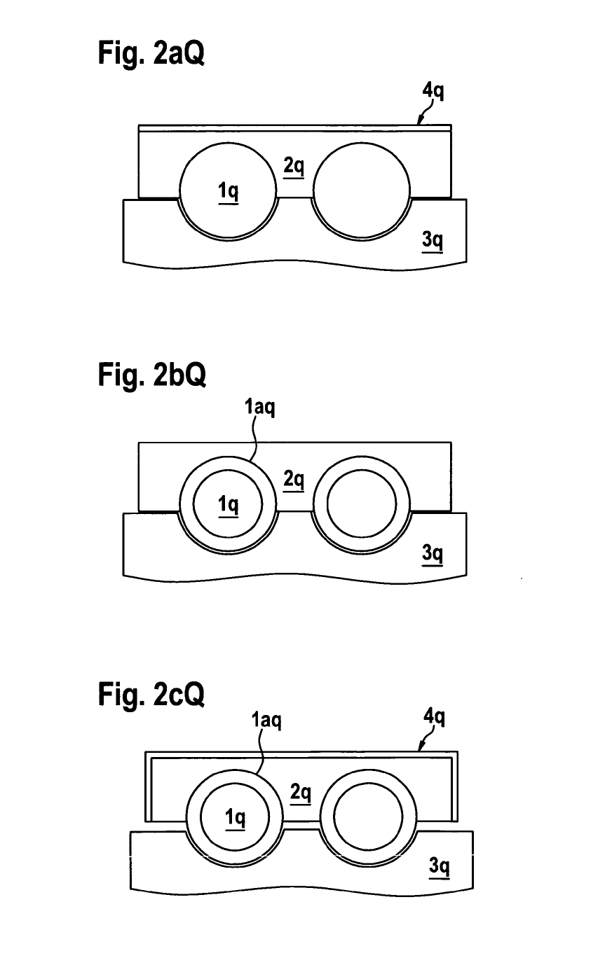

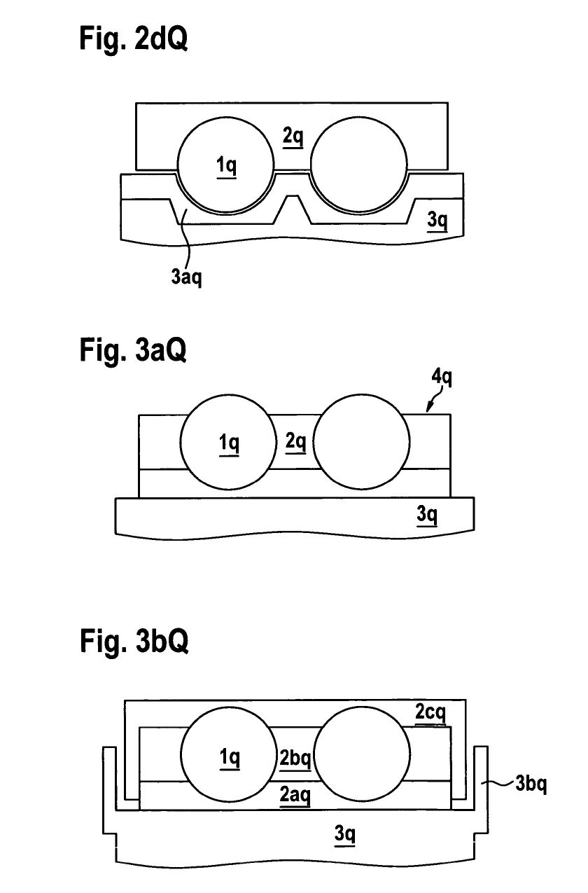

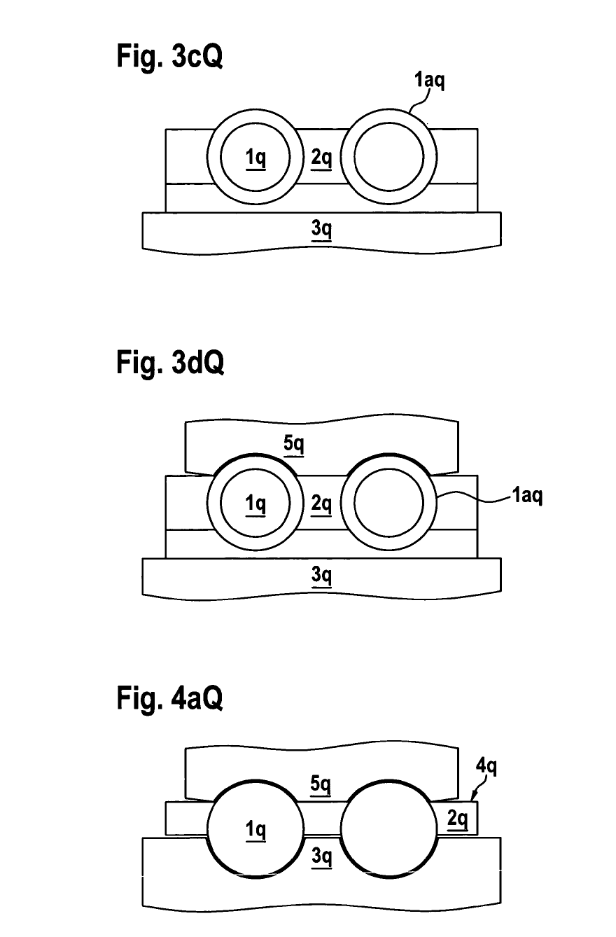

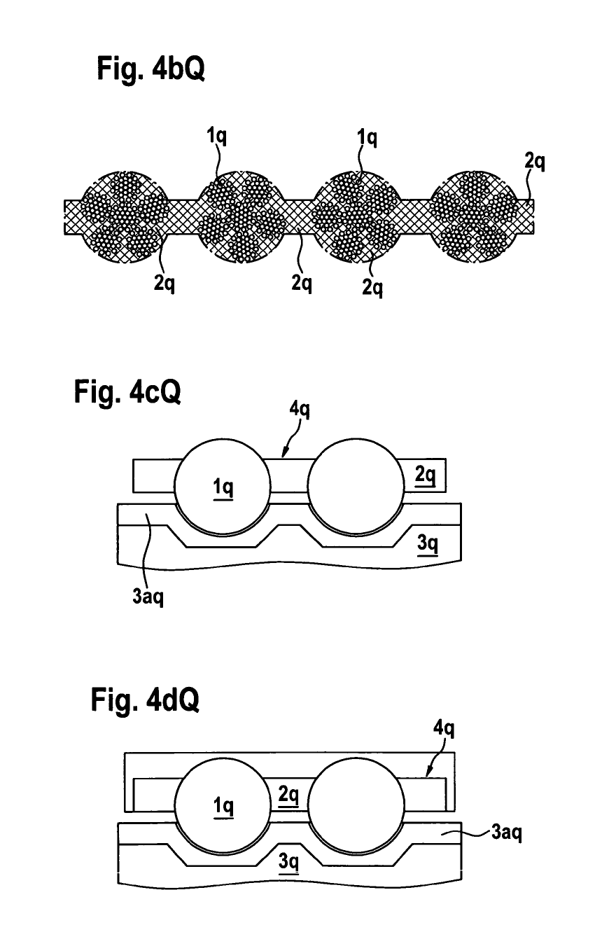

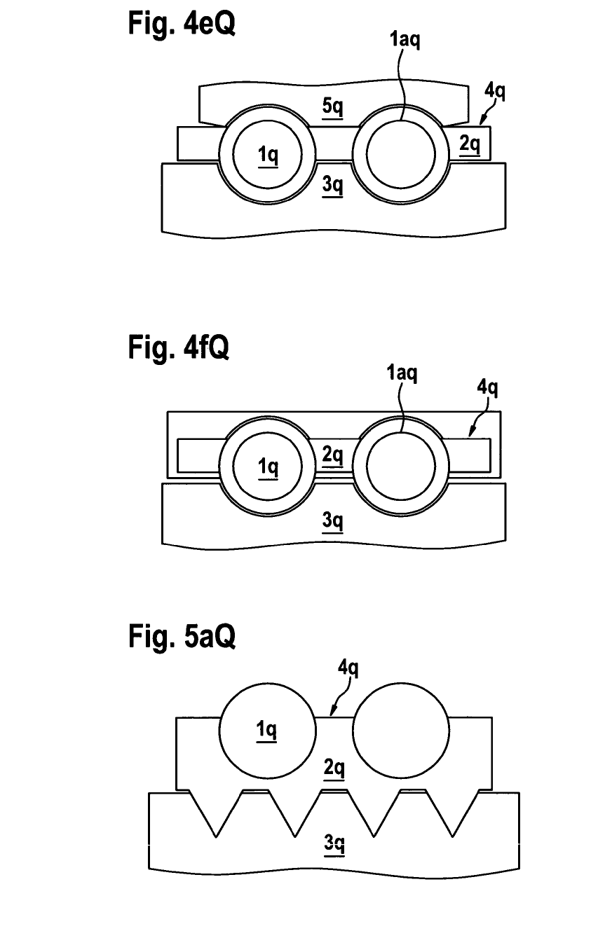

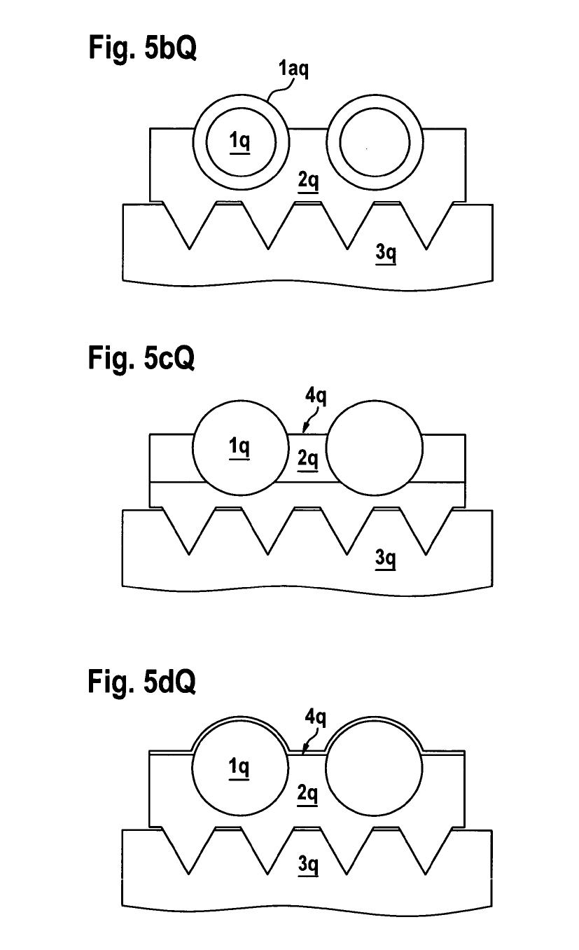

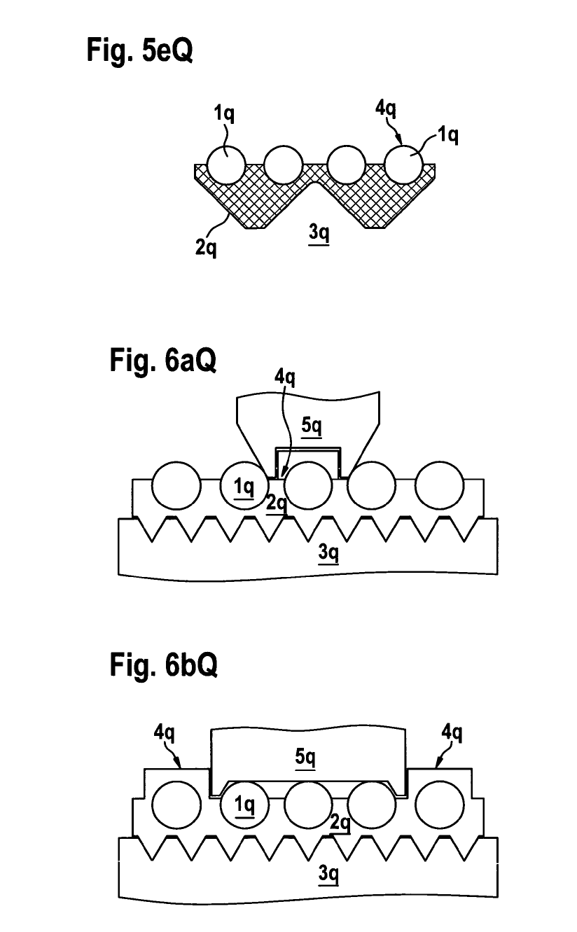

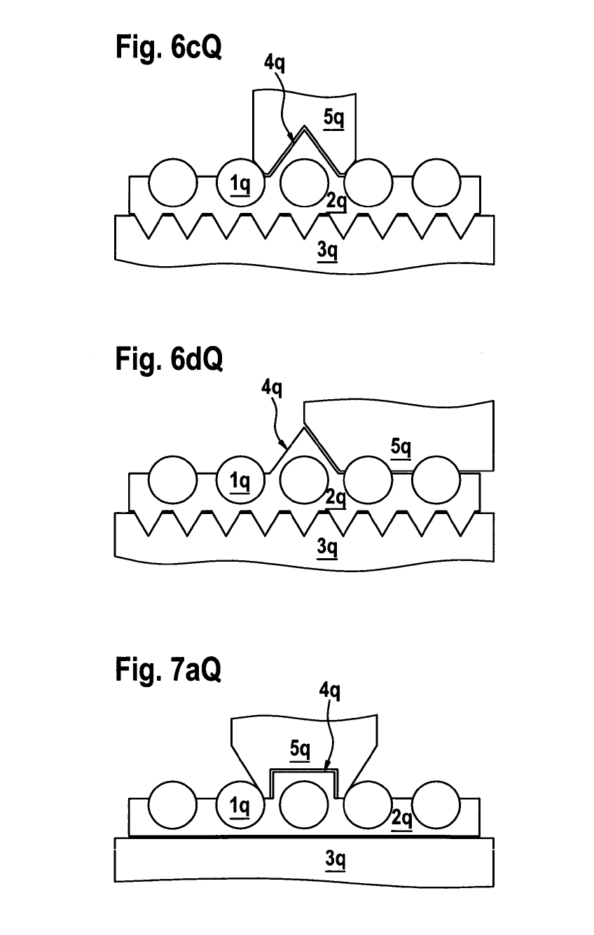

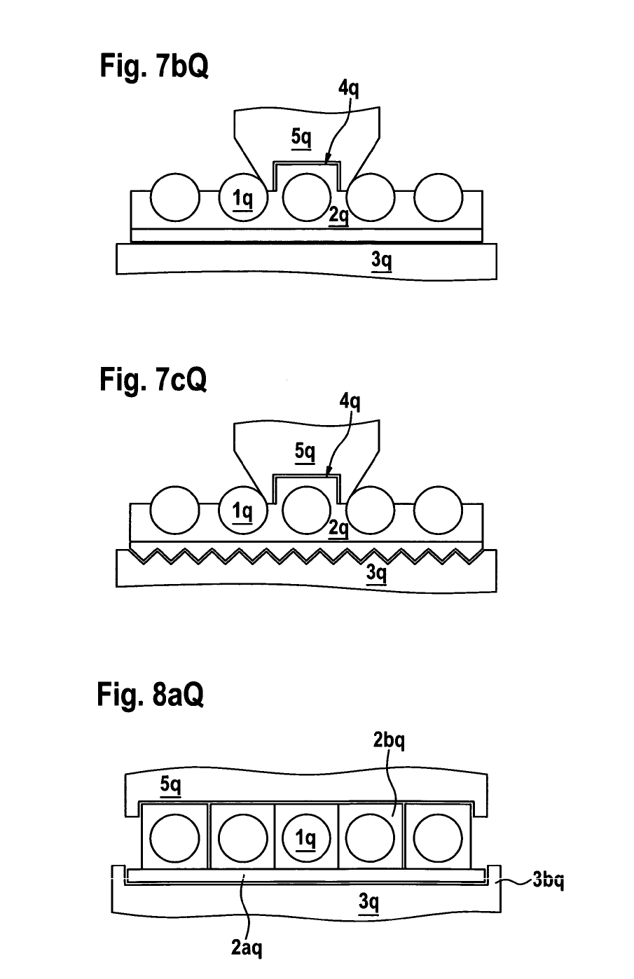

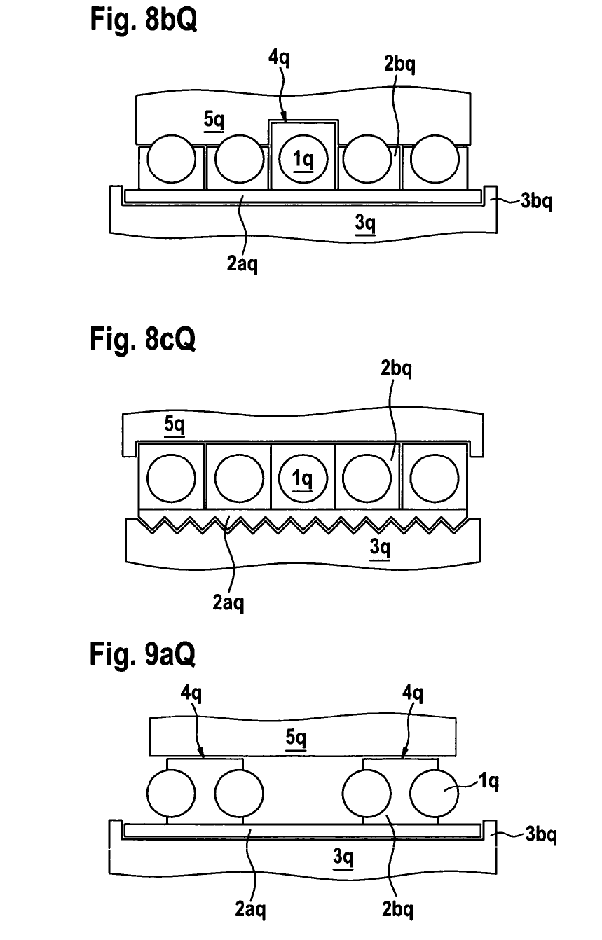

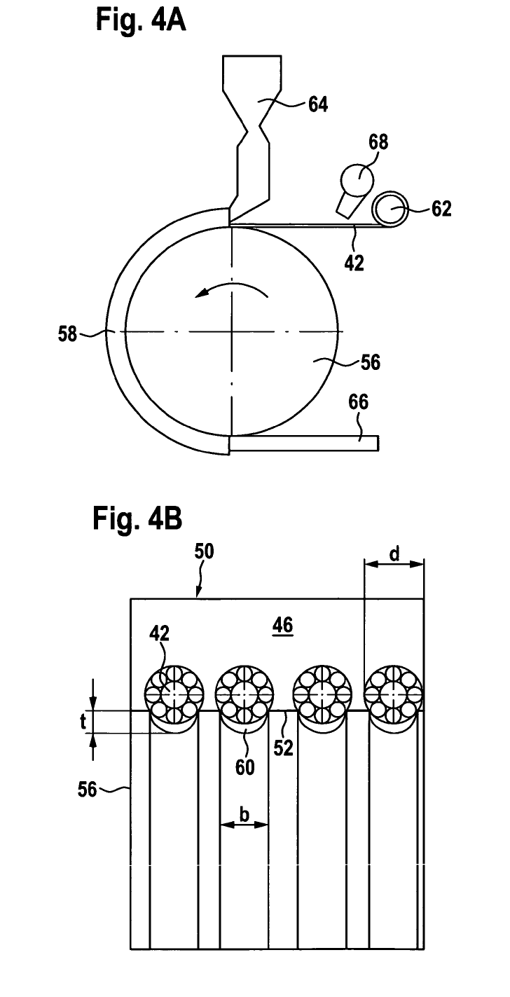

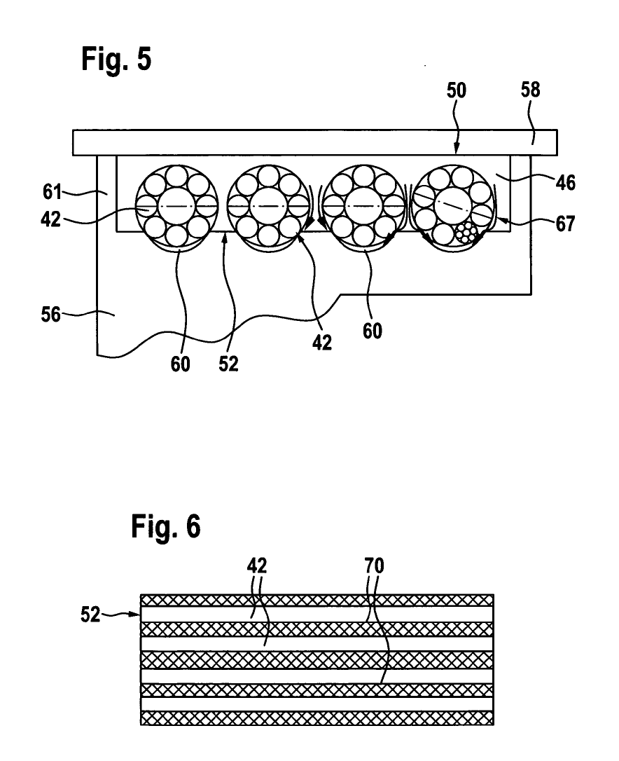

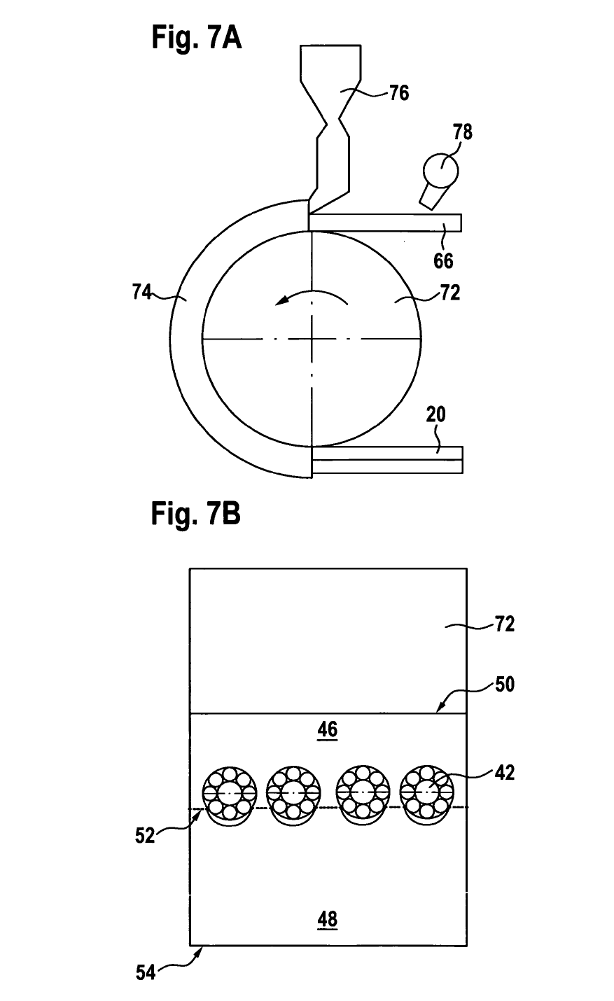

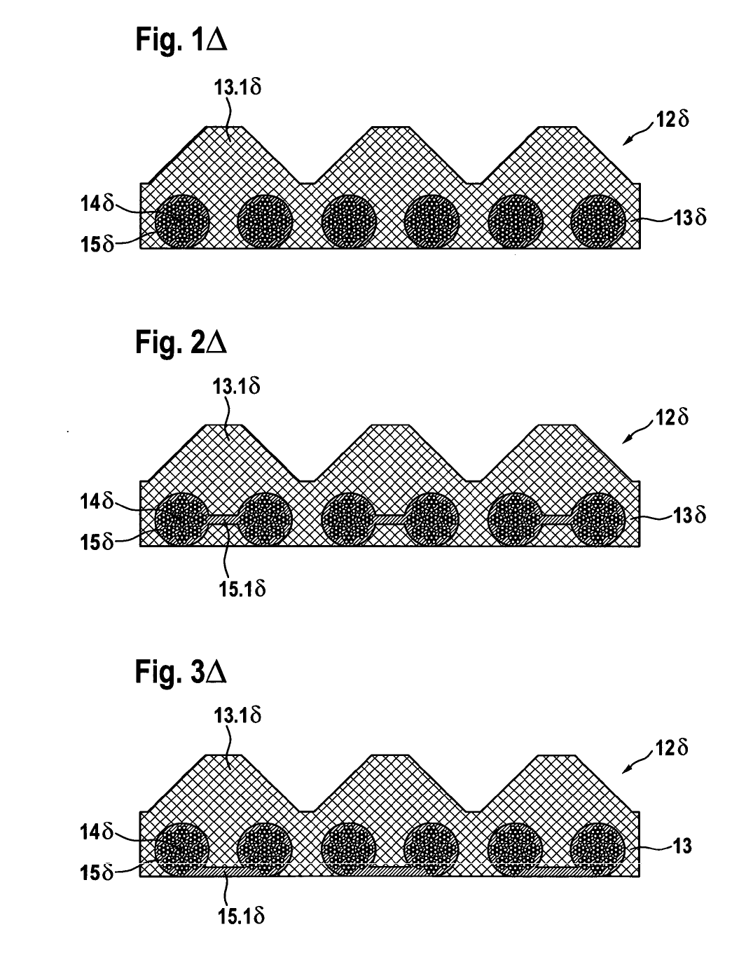

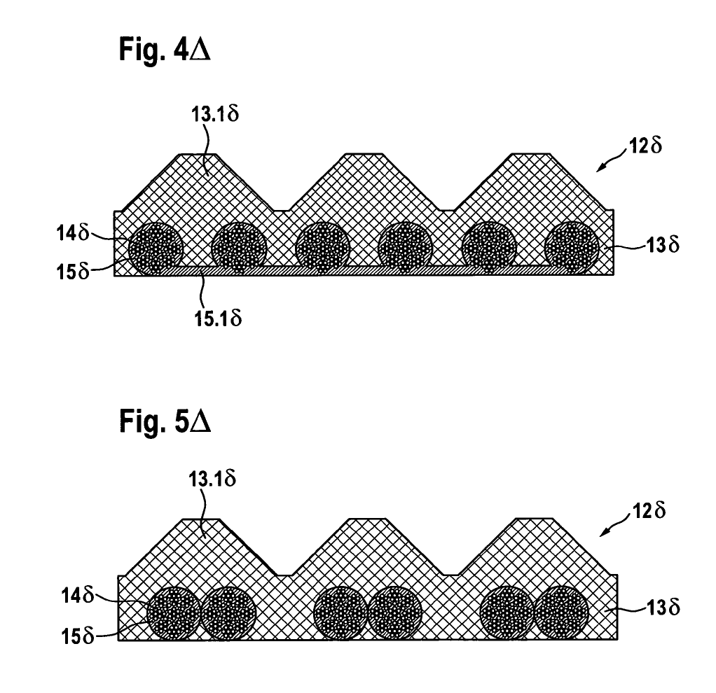

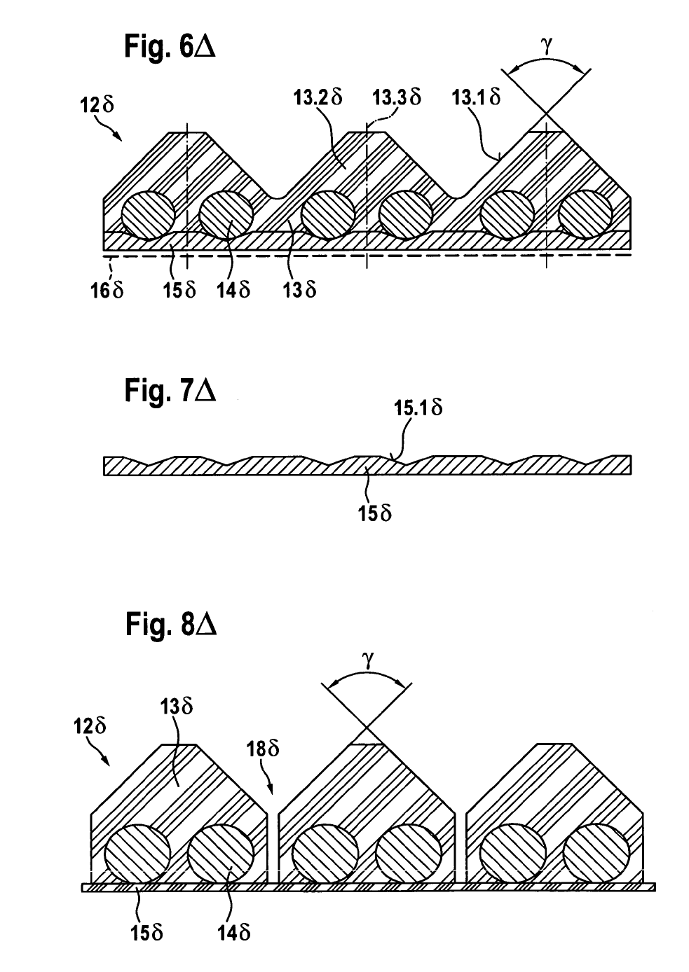

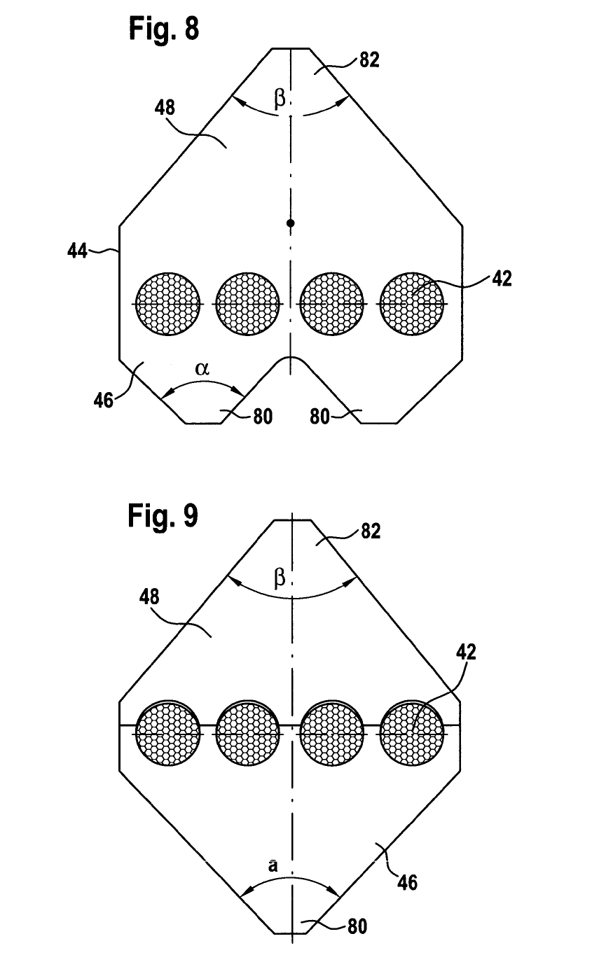

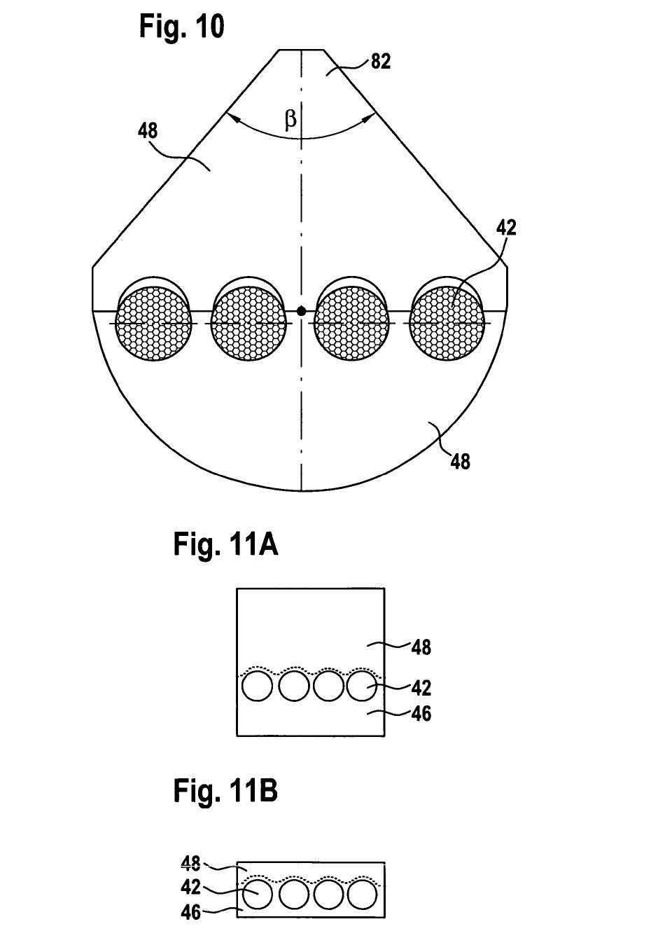

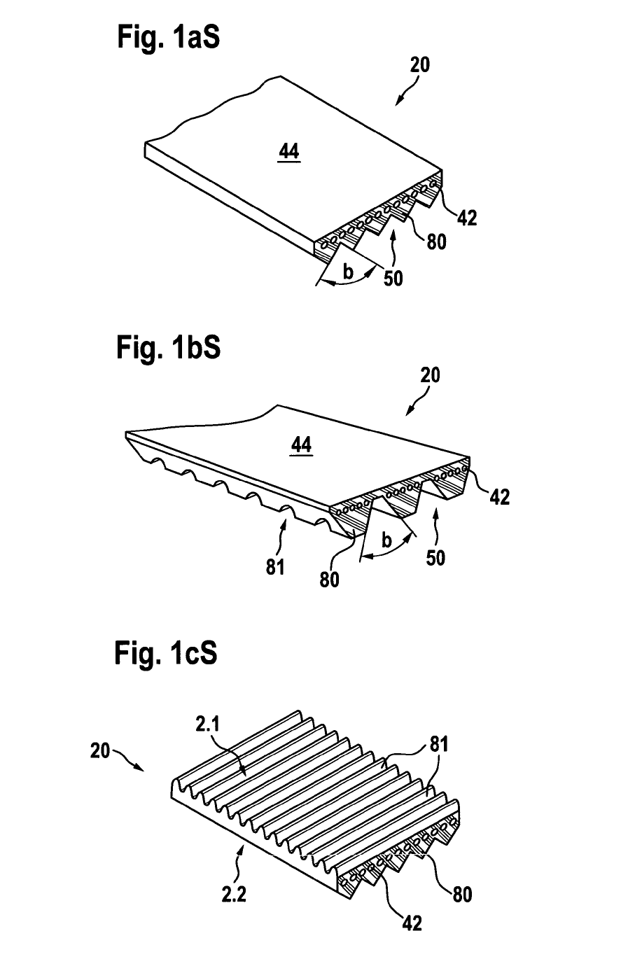

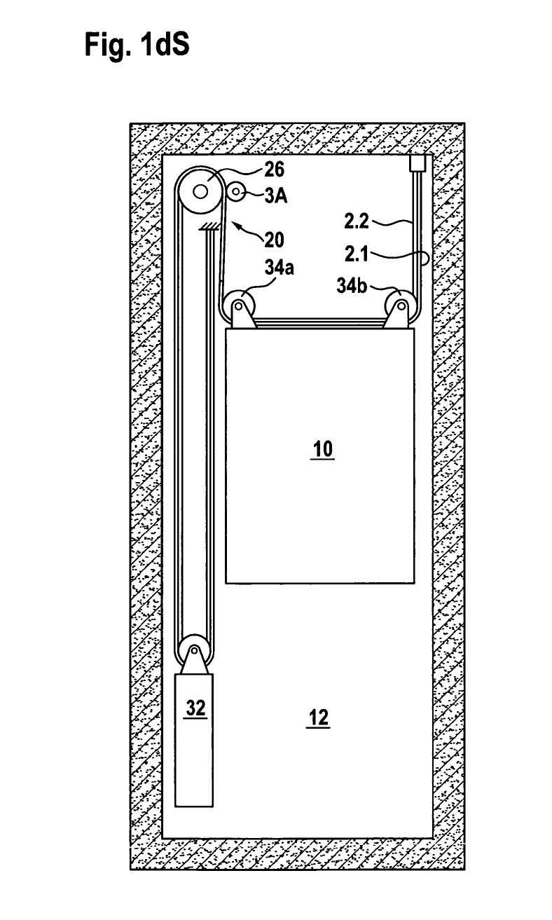

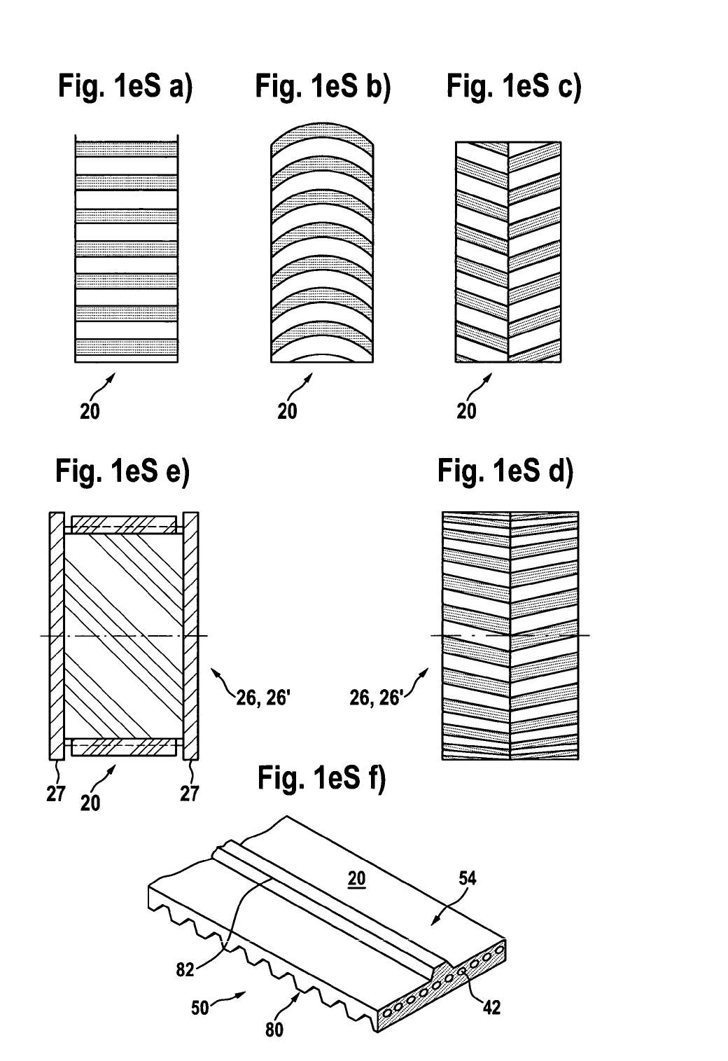

FIG. 1 a depiction of the structure of an elevator system according to invention

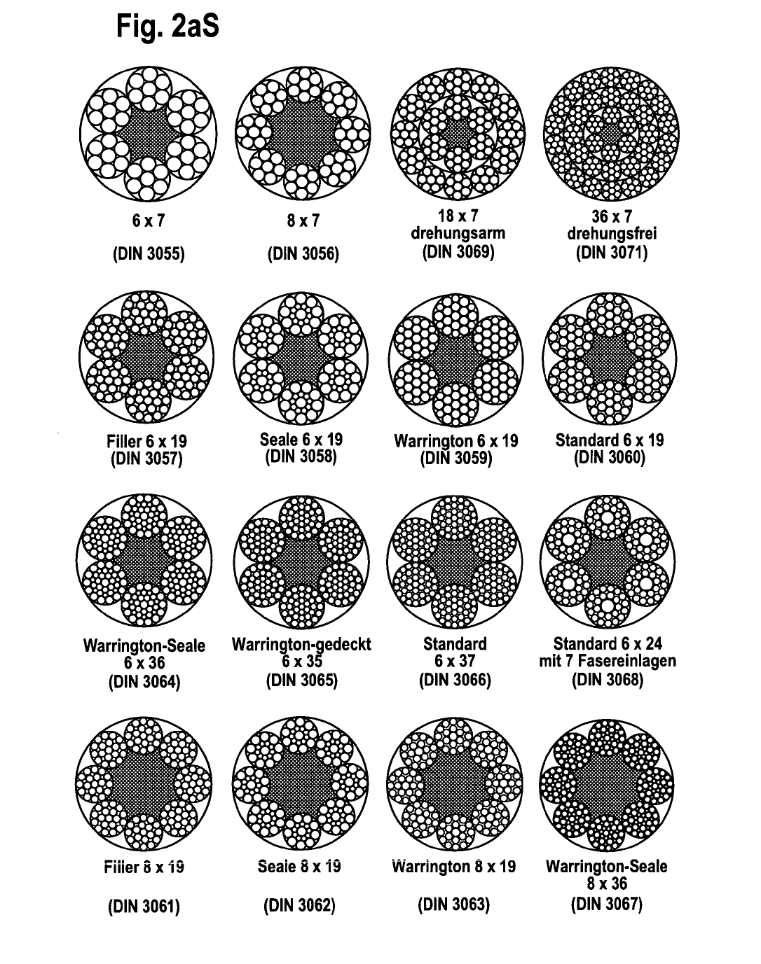

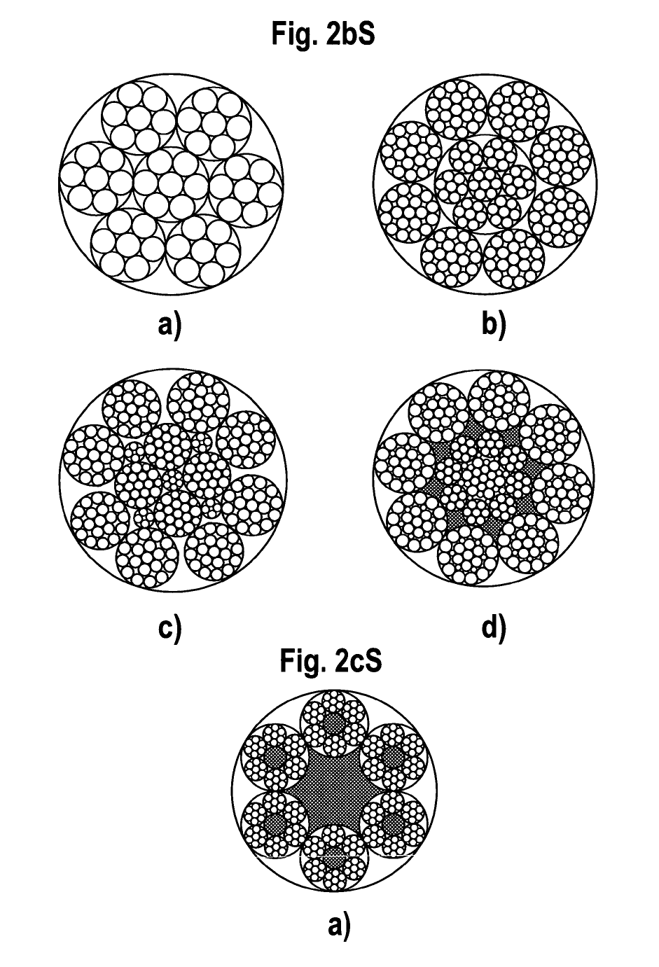

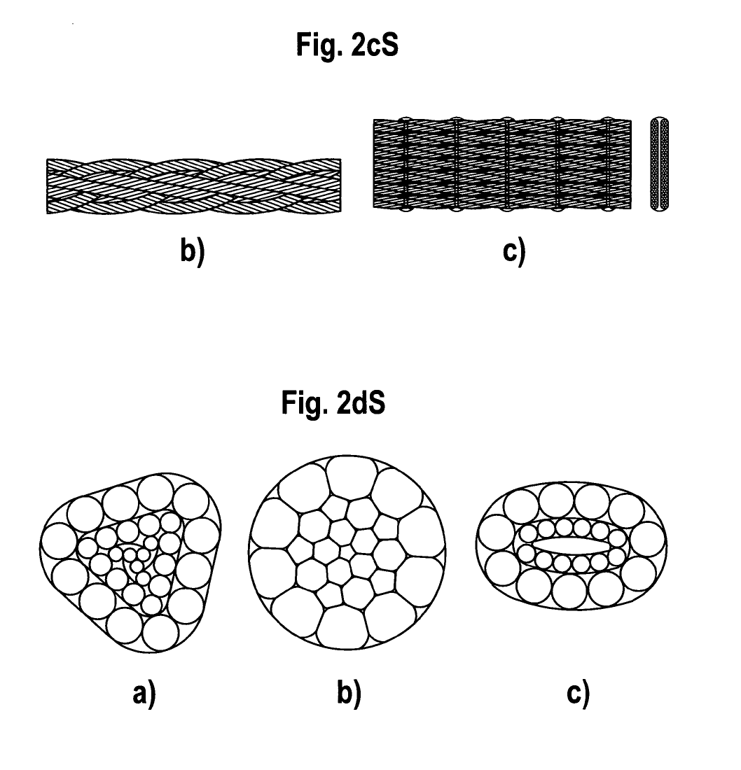

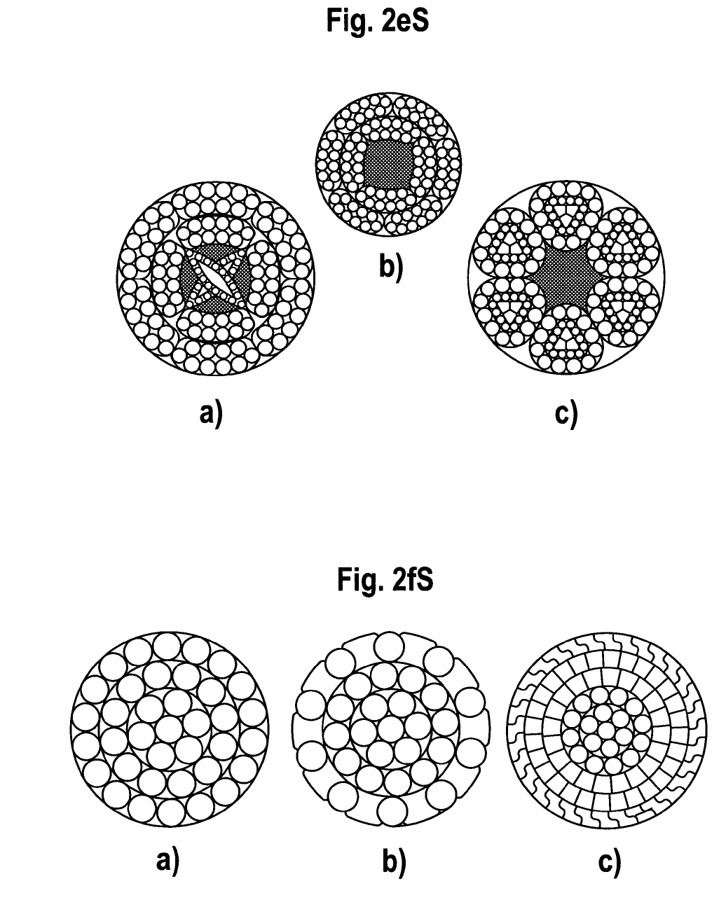

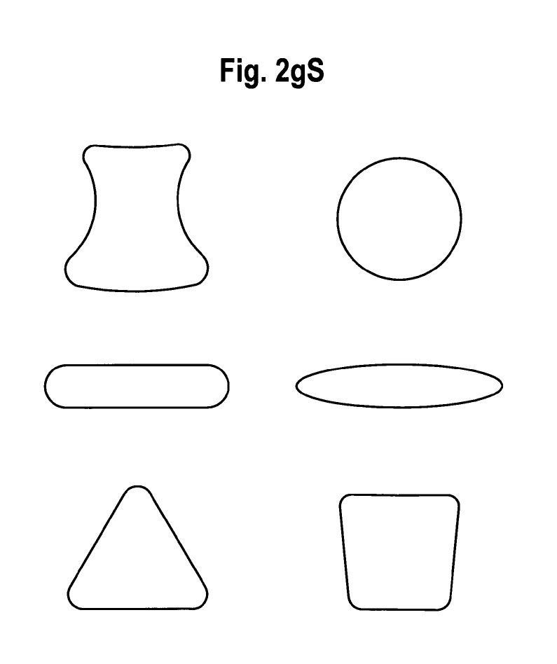

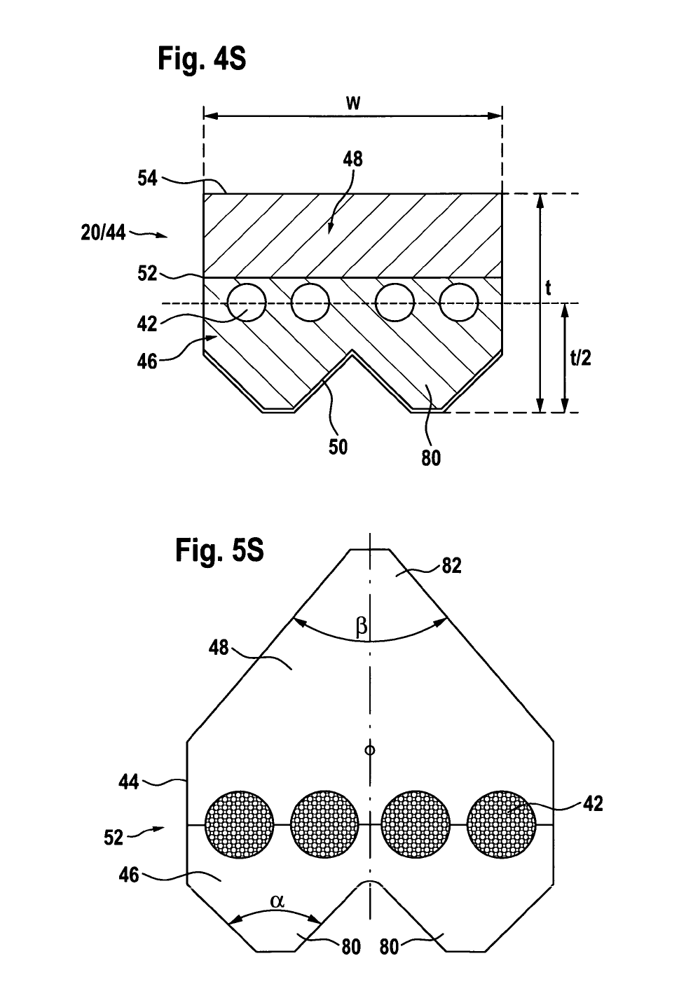

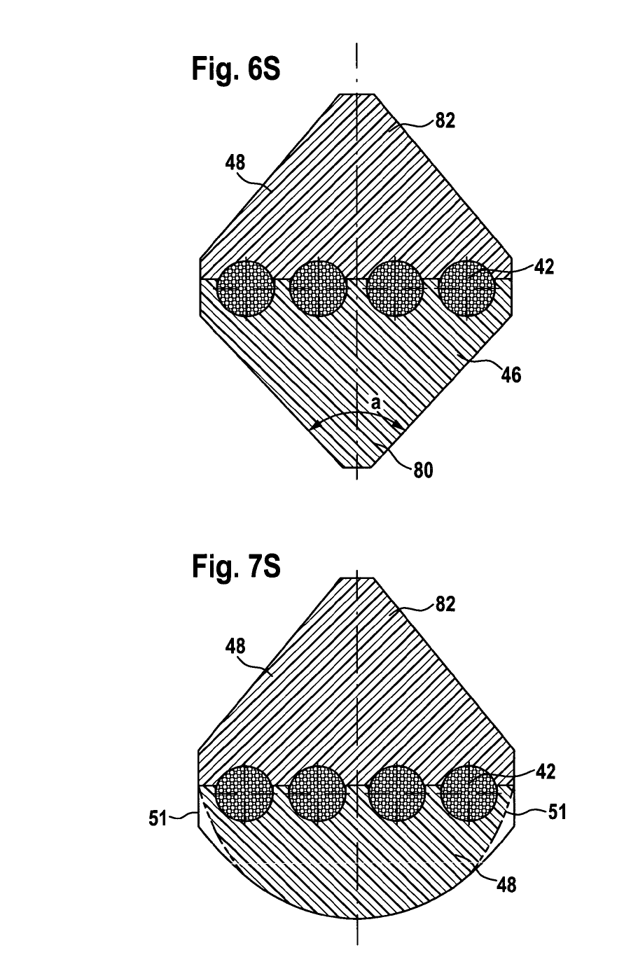

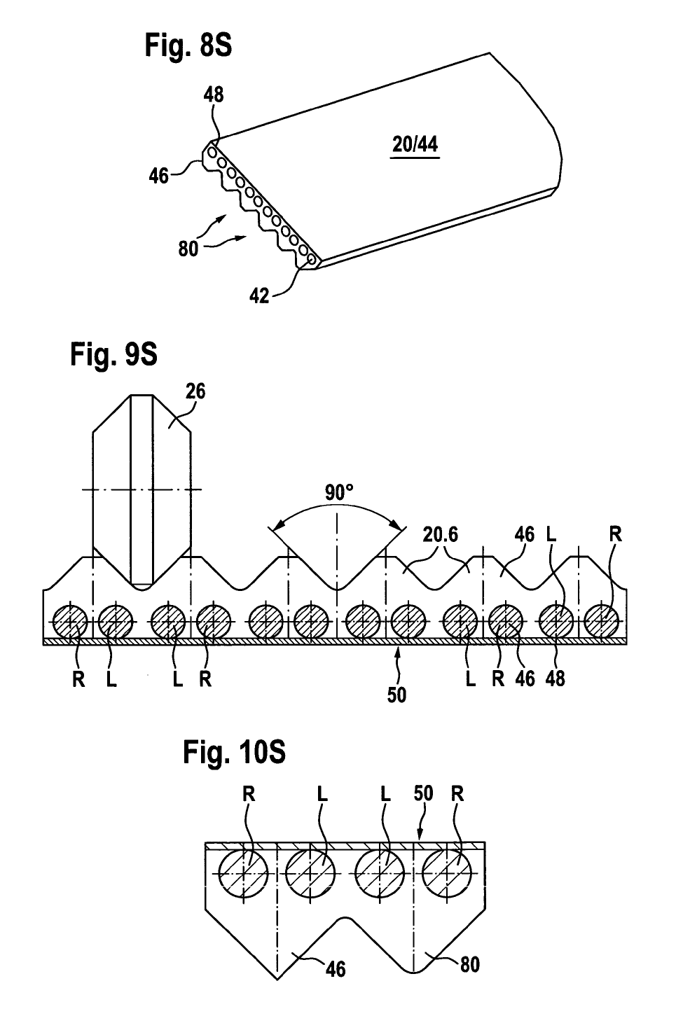

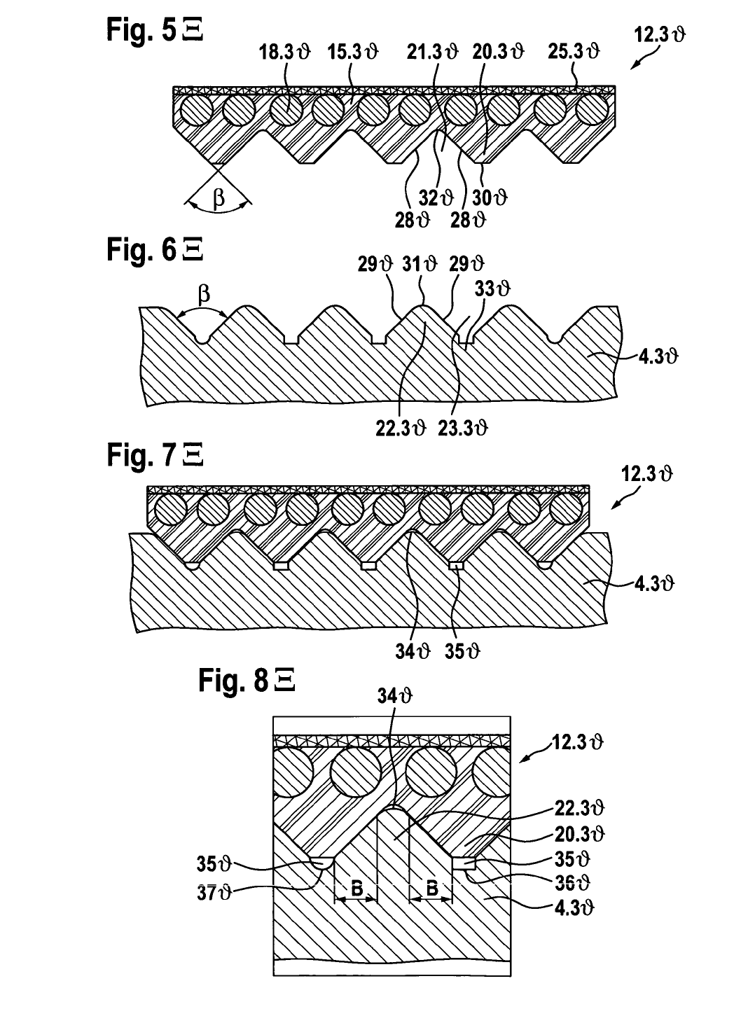

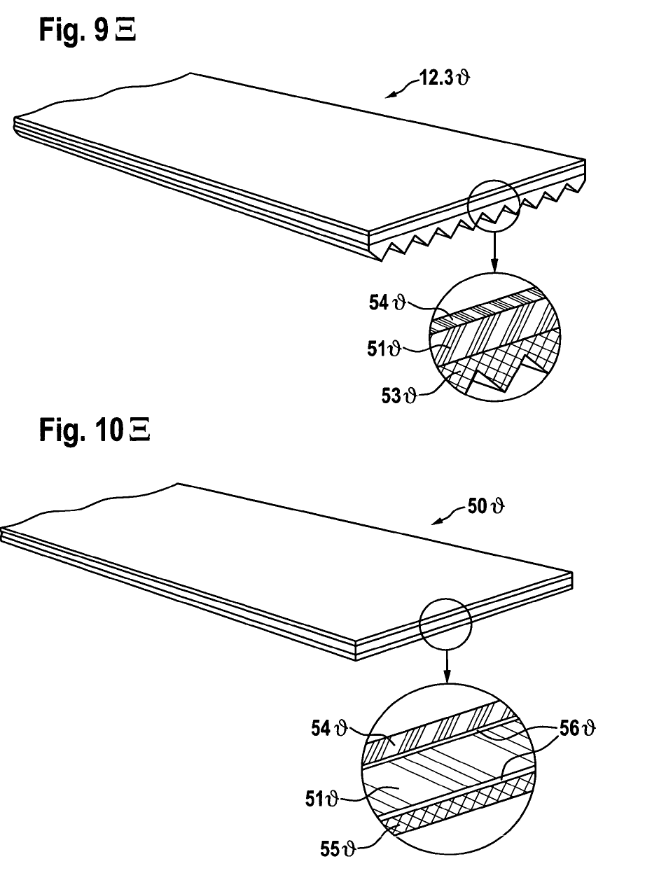

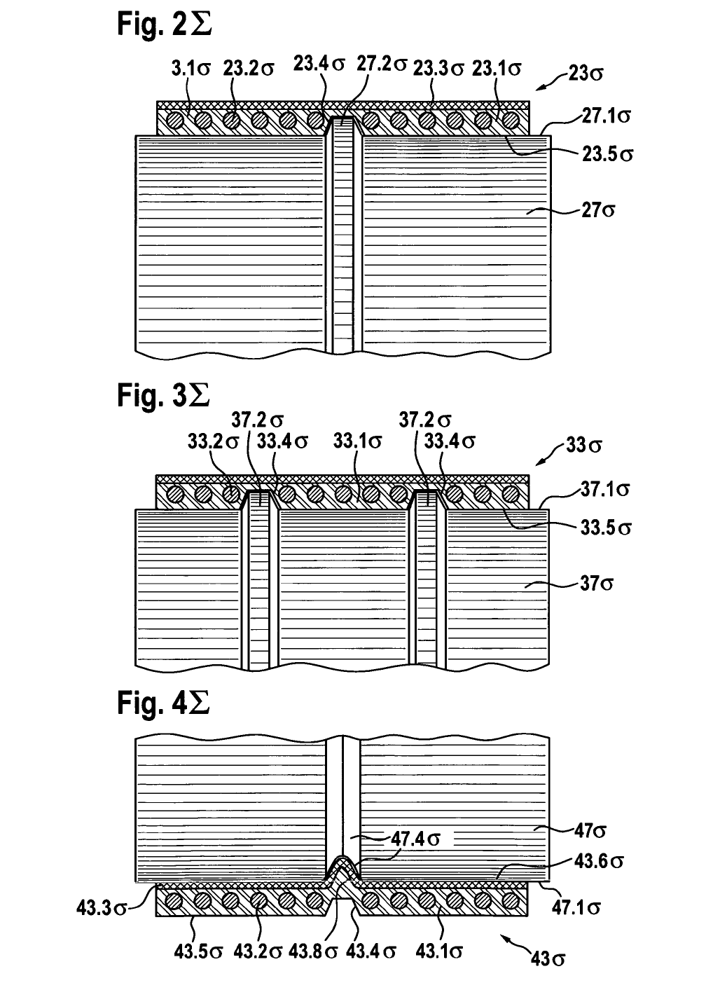

FIGS. 2A, 2B depictions of the structure of an elevator system according to invention with a traction drive, with an elevator car in a lower end position or in an upper end position in an elevator well

FIGS. 1AR, 1BR, 1CR different views of another embodiment of the elevator system according to invention

FIG. 1CR the force transfer through the suspension element strands for the elevator car

FIG. 1DR as alternative to that

FIGS. 1AR, 2R, 3R advantageous arrangements of the traction sheaves

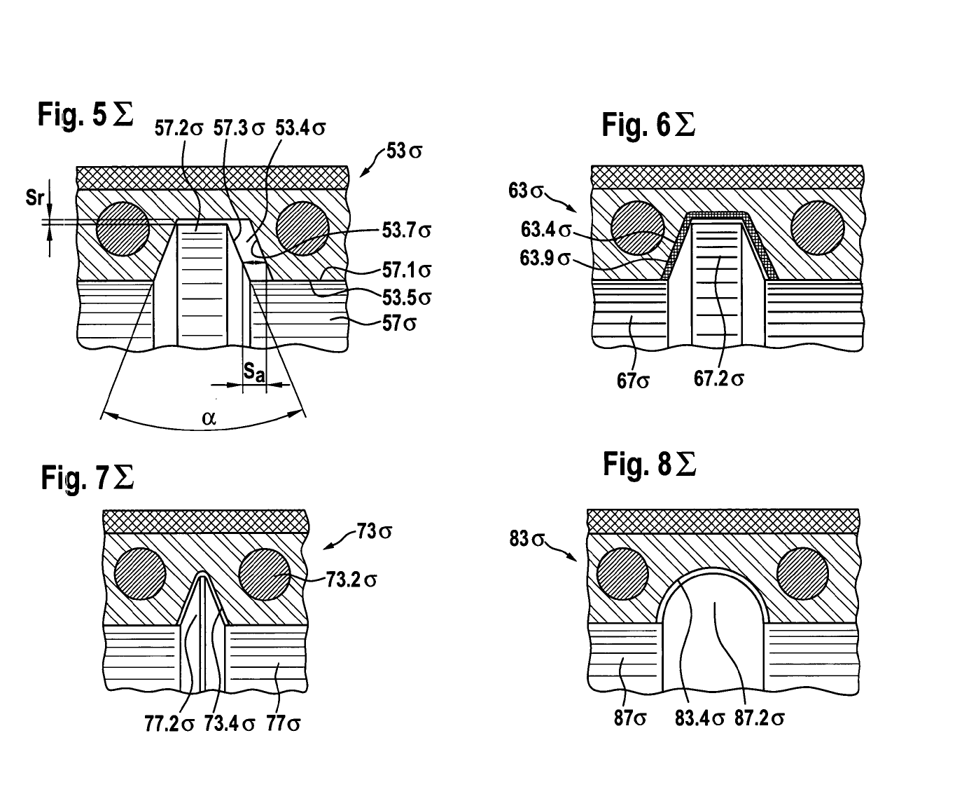

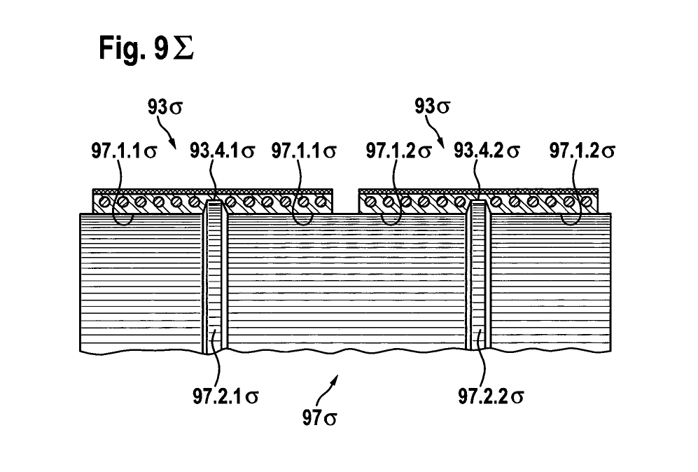

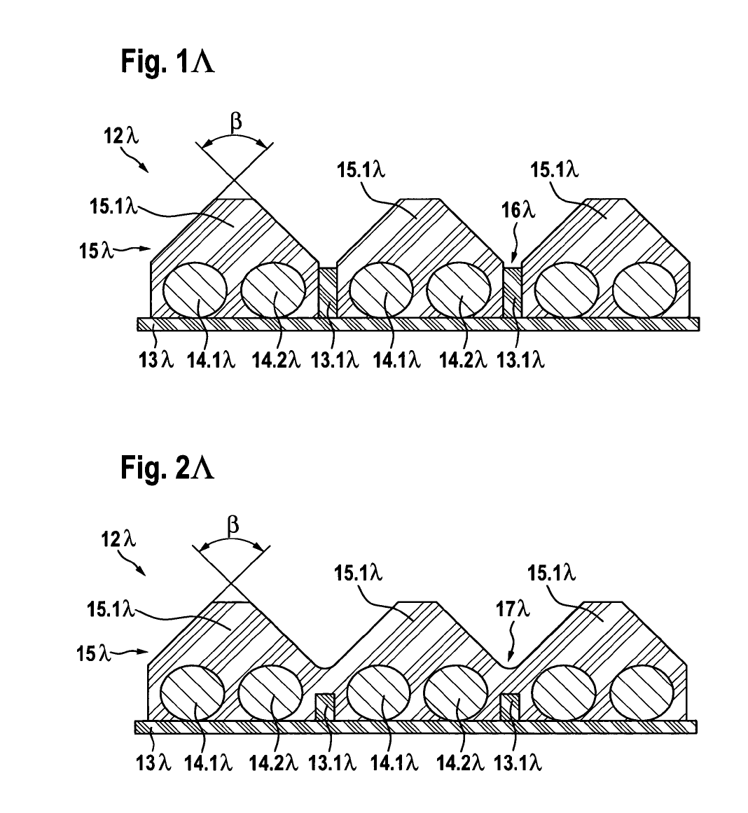

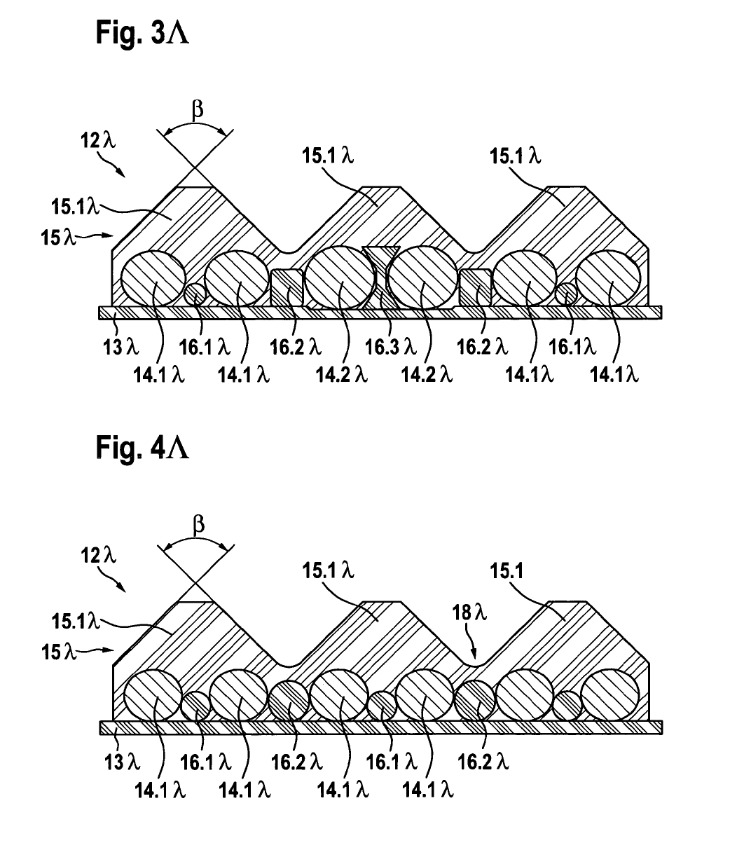

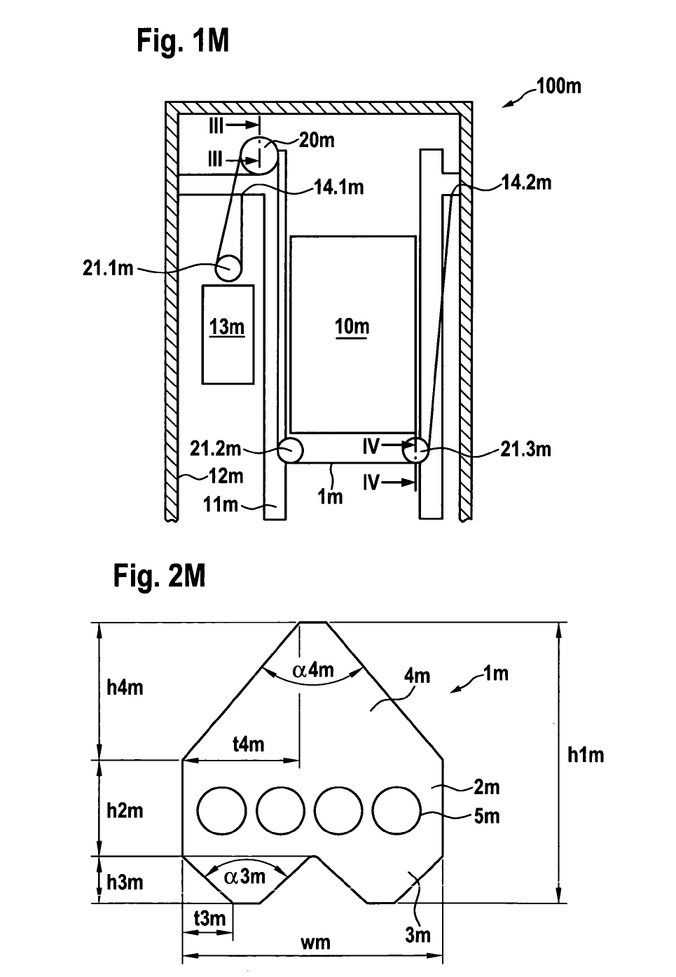

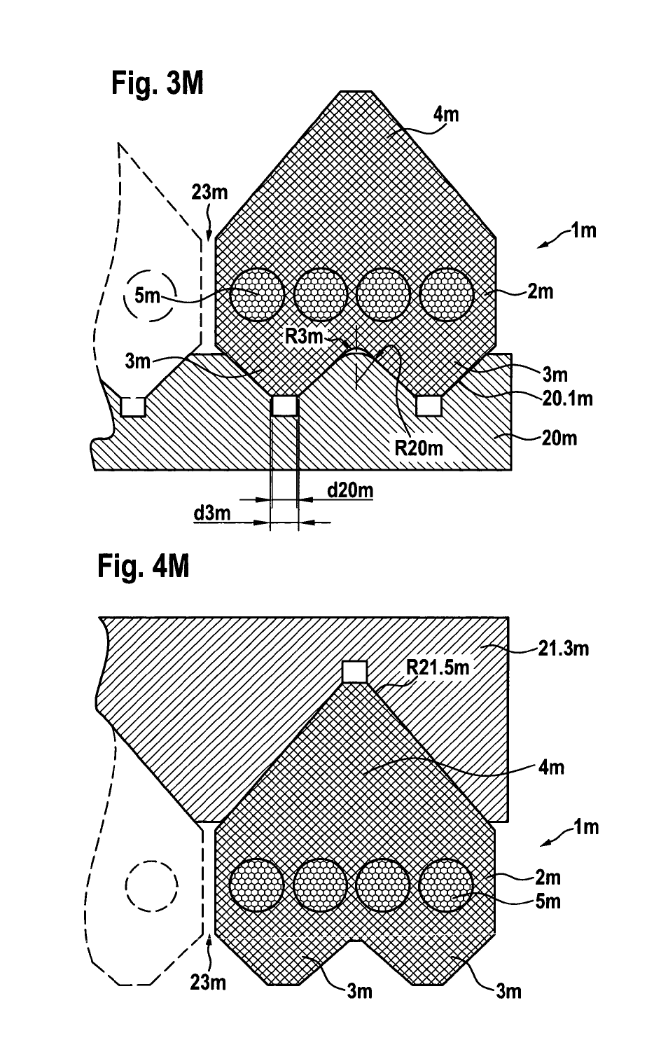

FIG. 3R a magnified depiction of FIG. 1BR in which further details are shown

FIGS. 1AX, 1BX, 1CX another embodiment example of an elevator system according to invention

FIGS. 1CX, 6X the approximately central-symmetric force transfer through the suspension element strands for each of the elevator cars

FIGS. 1AX, 2X, 3X, 4X, 5X advantageous arrangements of the traction sheaves in the uppermost area of the elevator well

FIG. 2X a second embodiment example analogue to the one of FIGS. 1AX, 1BX and 1CX, with a device known as compensating rope tension device

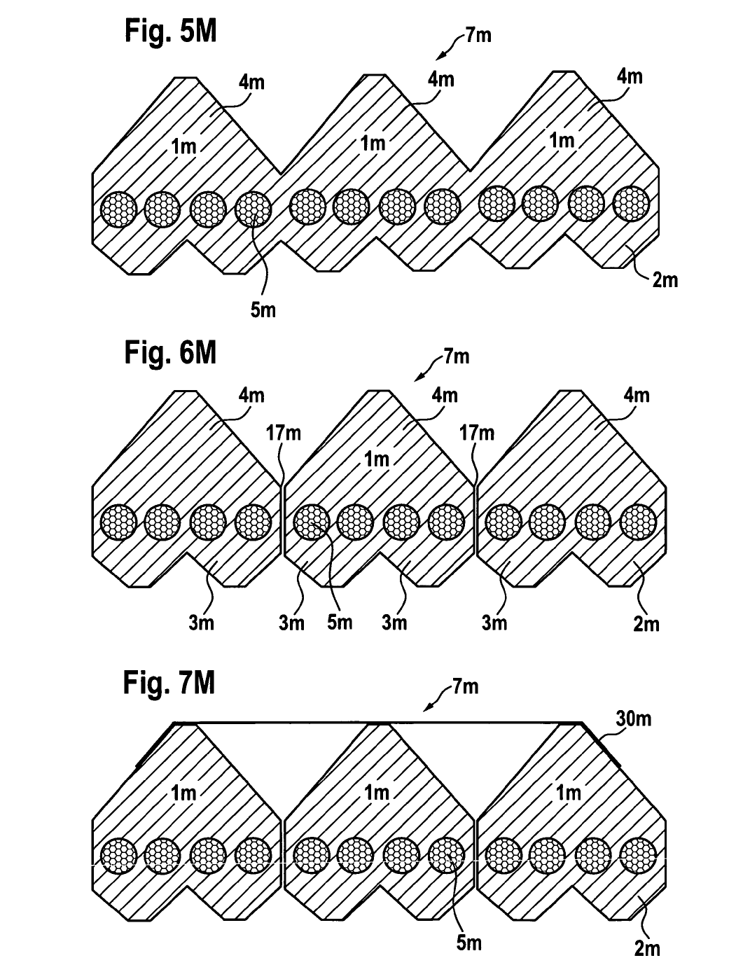

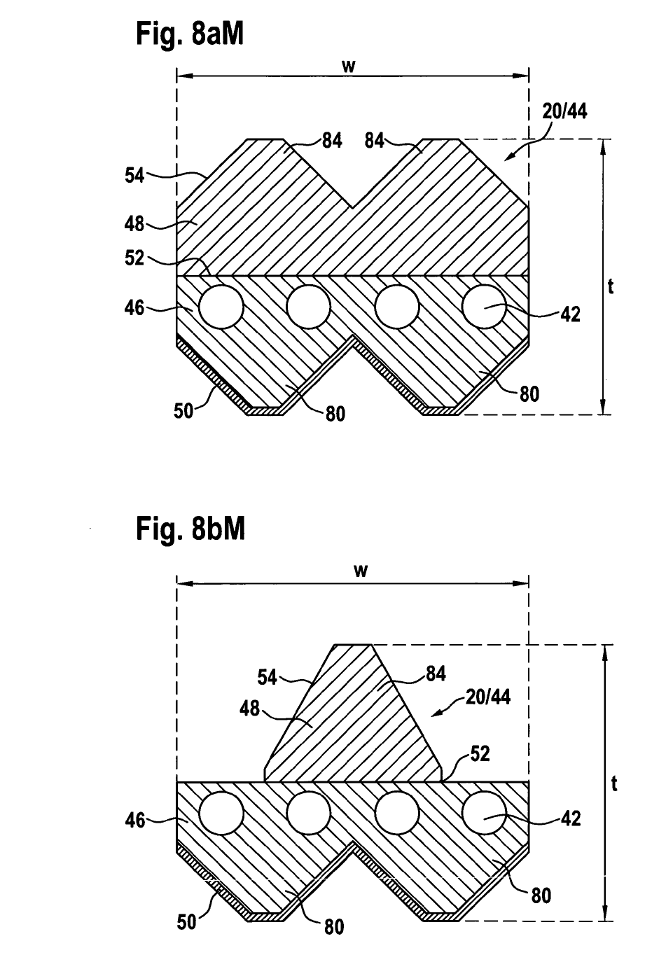

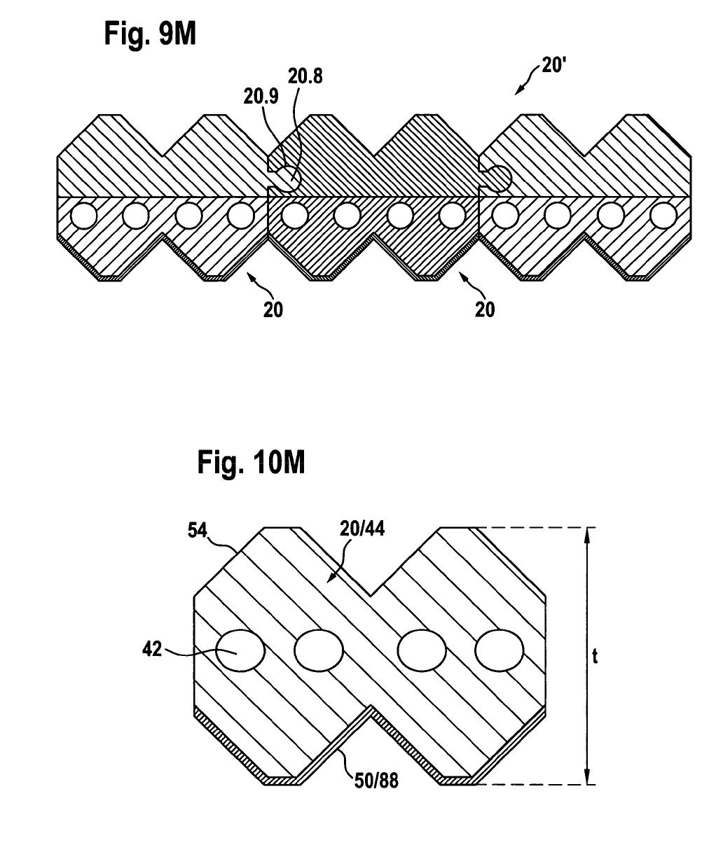

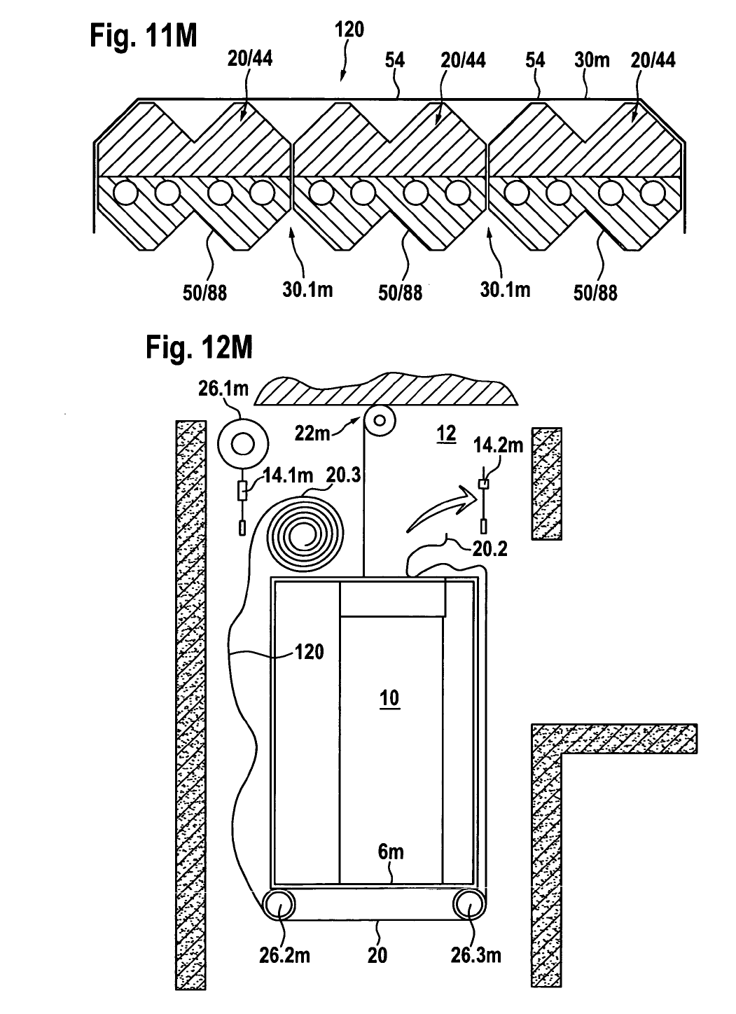

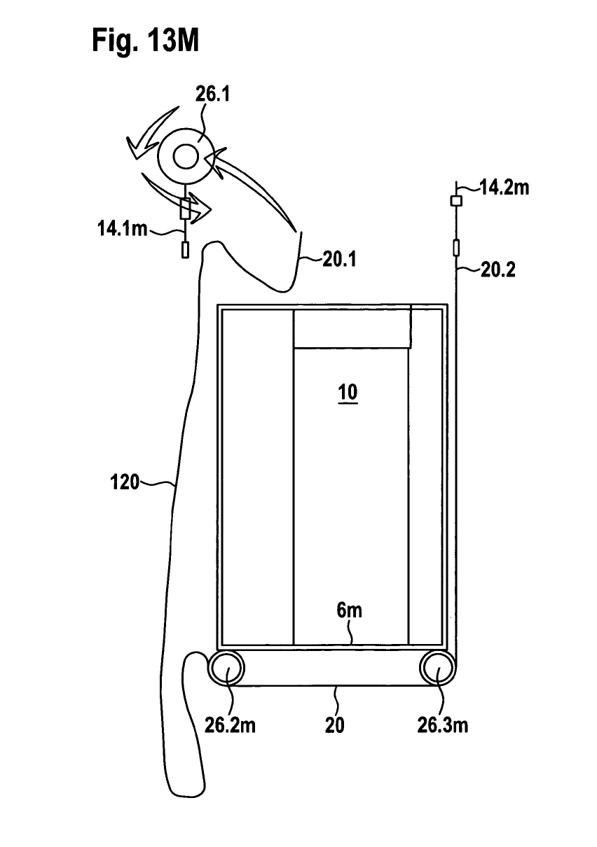

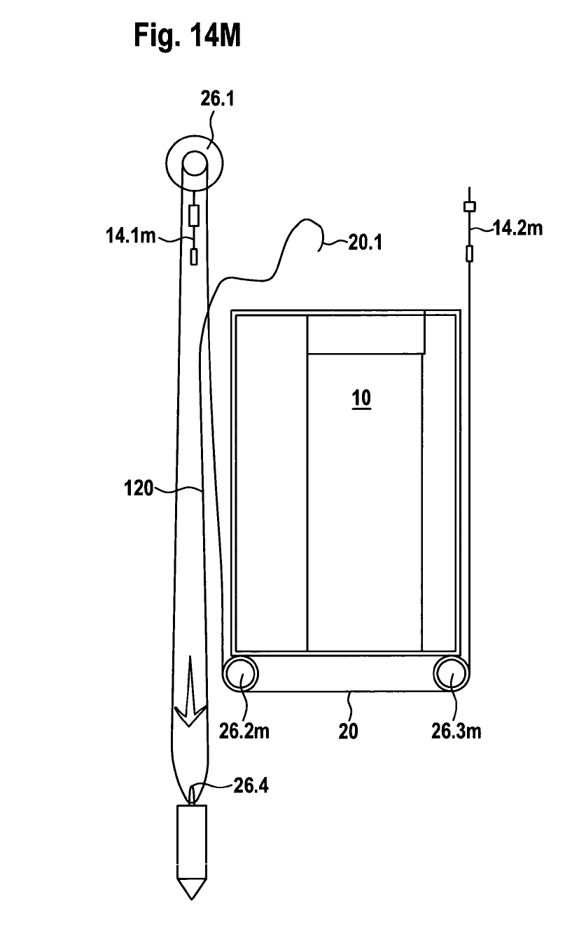

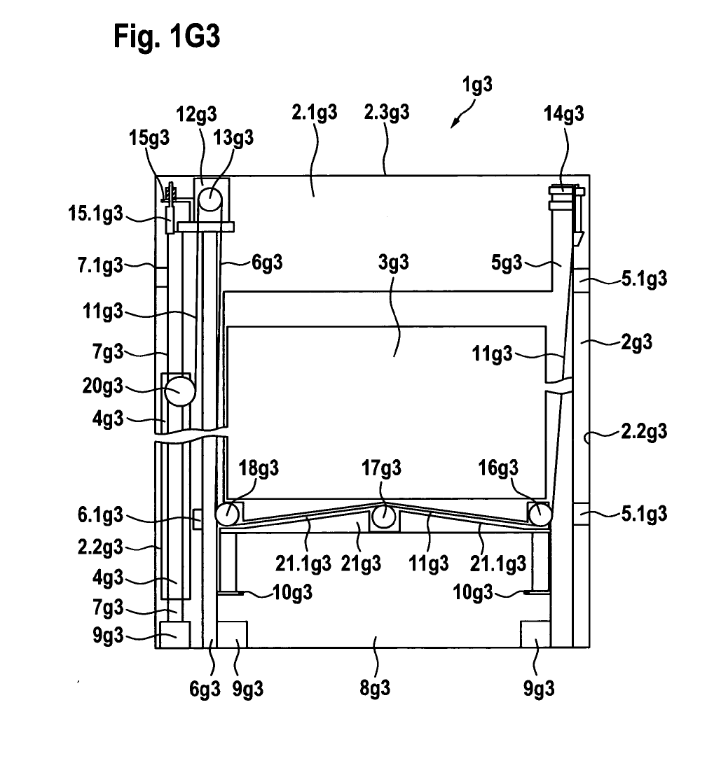

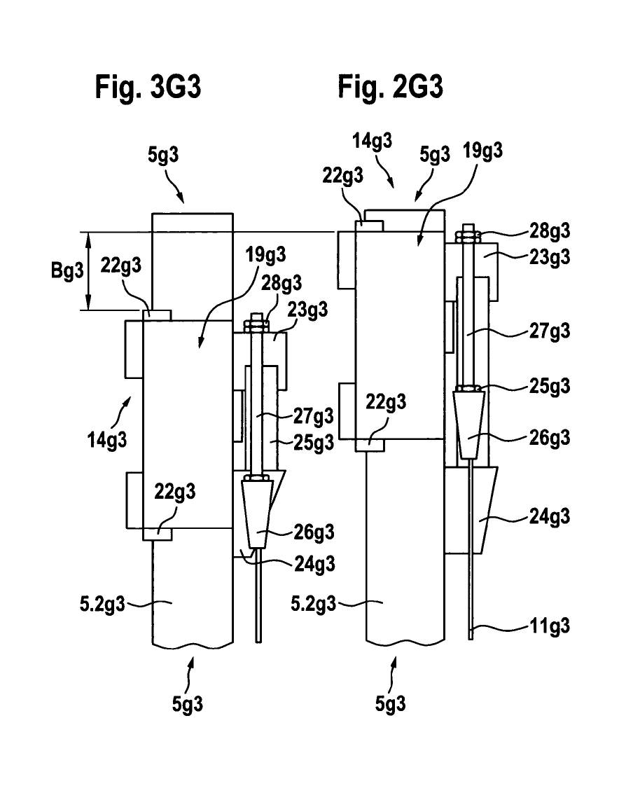

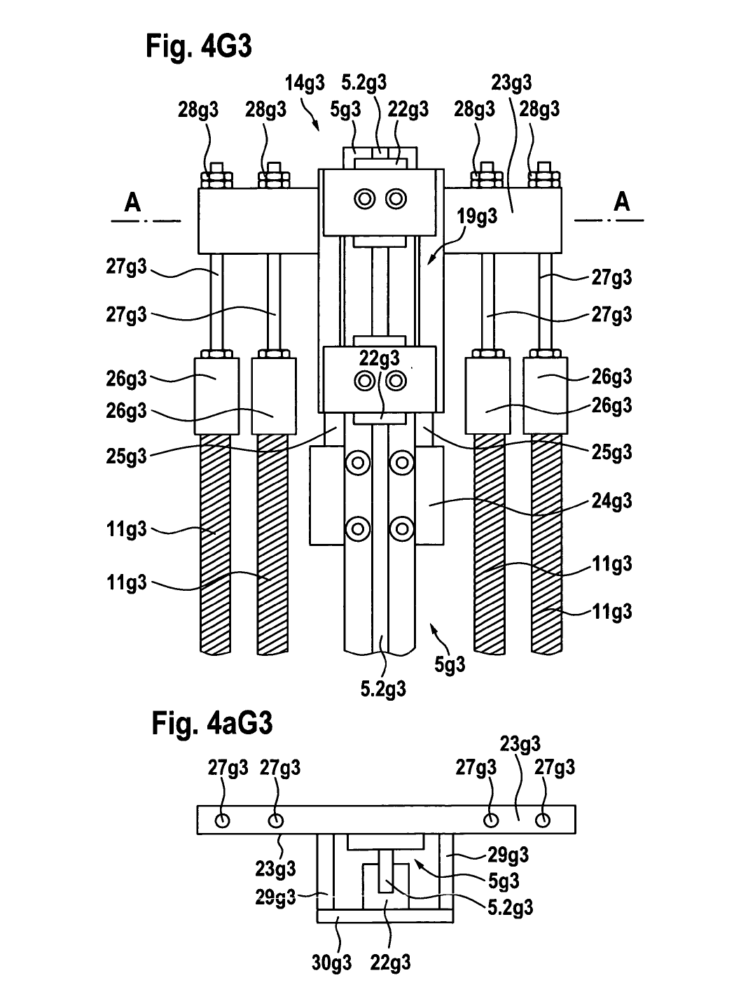

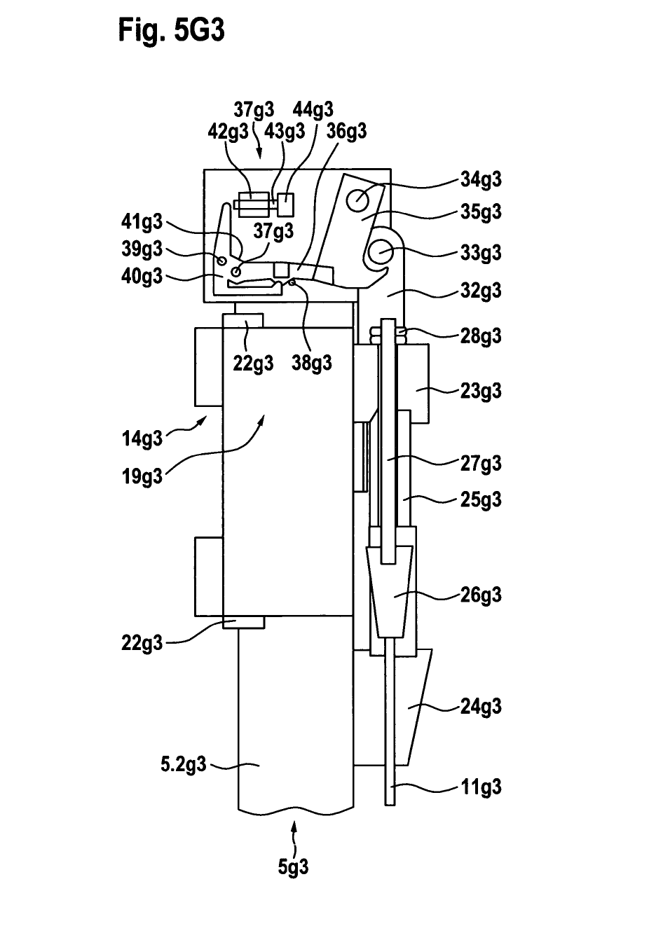

FIGS. 2X, 3AX, 3BX, 3CX types of positioning the fixing points, valid analogously also for the embodiments shown in FIGS. 4X and 5X

FIG. 4X a similar embodiment example as in FIG. 1X

FIG. 1G5 structures of a traction sheave and a deflecting pulley for a suspension element with longitudinal ribs according to invention

FIG. 1G5a an embodiment of a suspension element according to invention with longitudinal ribs removed at the end of the suspension element

FIGS. 2G5-7G5 further embodiments of suspension elements with flat riding surface and flat traction sheave groove

FIGS. 8G5-15G5 examples of suspension elements according to invention with two tension members

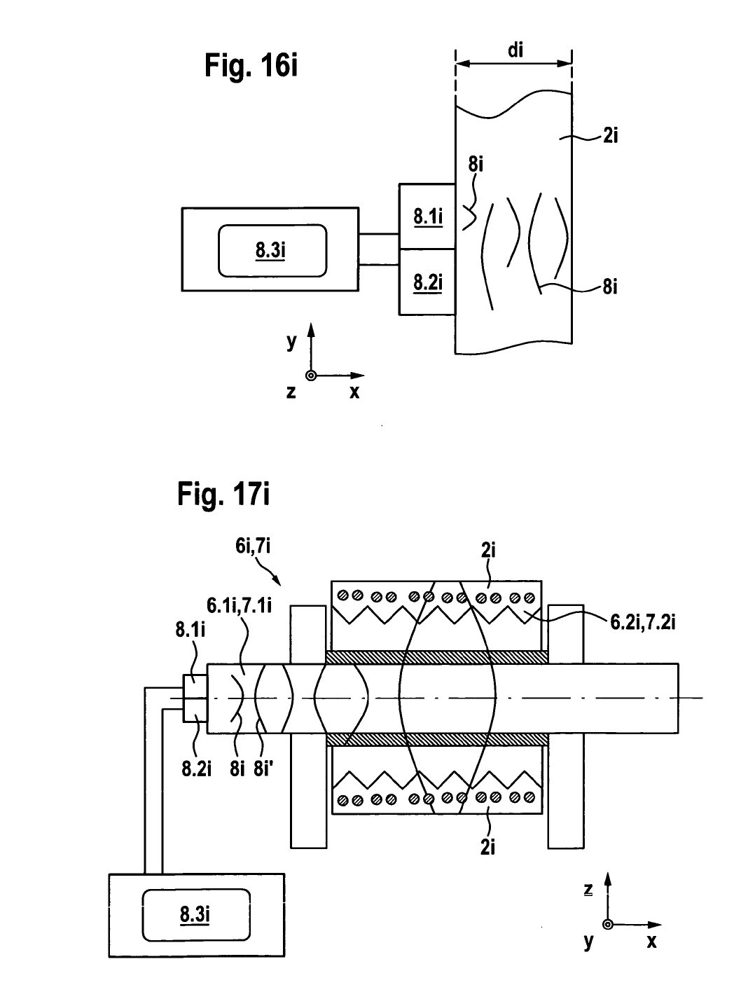

FIGS. 16G5-18G5 examples of suspension elements according to invention with one tension member

FIG. 1H a roller element in combination with suspension elements in the form of flat belts

FIG. 2H a roller element with suspension elements in the form of V-ribbed belts

FIG. 1P an elevator according to an embodiment of the present invention, in a lateral cross-sectional view

FIG. 2P cross-sectional view of a suspension element in a groove of a roller element, according to an embodiment of the present invention

FIG. 3P cross-sectional view of the suspension element of FIG. 2P in another embodiment of the groove of the roller element

FIG. 4P cross-sectional view of another embodiment of the suspension element in a respectively adapted groove of a roller element

FIG. 5P cross-sectional view of an alternative suspension element in a respective groove of a roller element

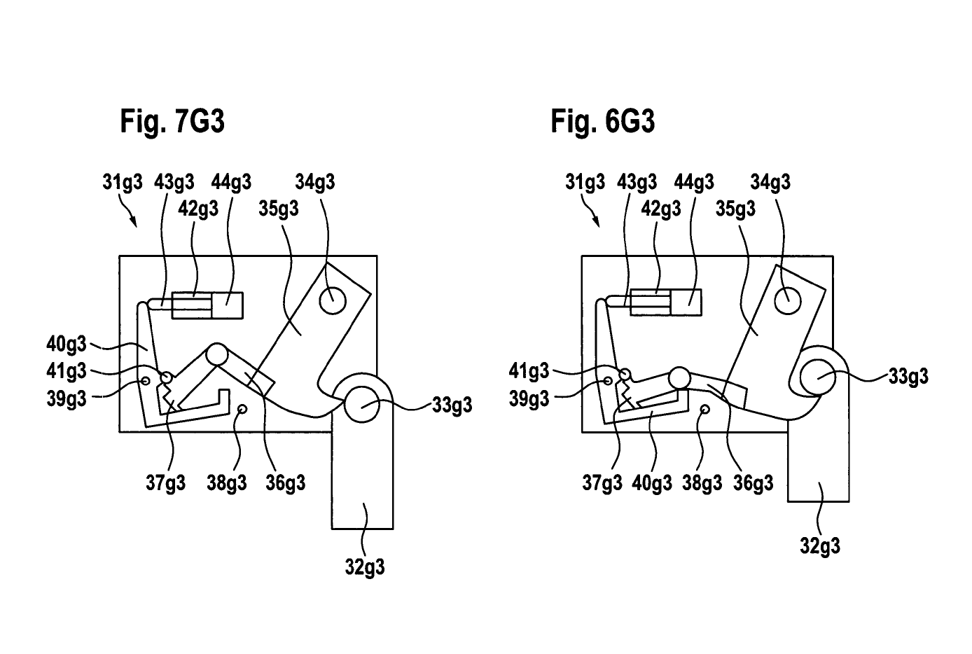

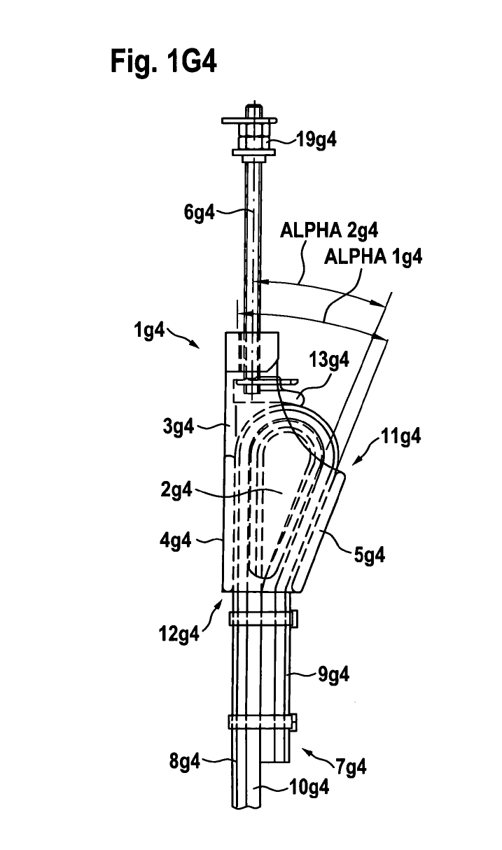

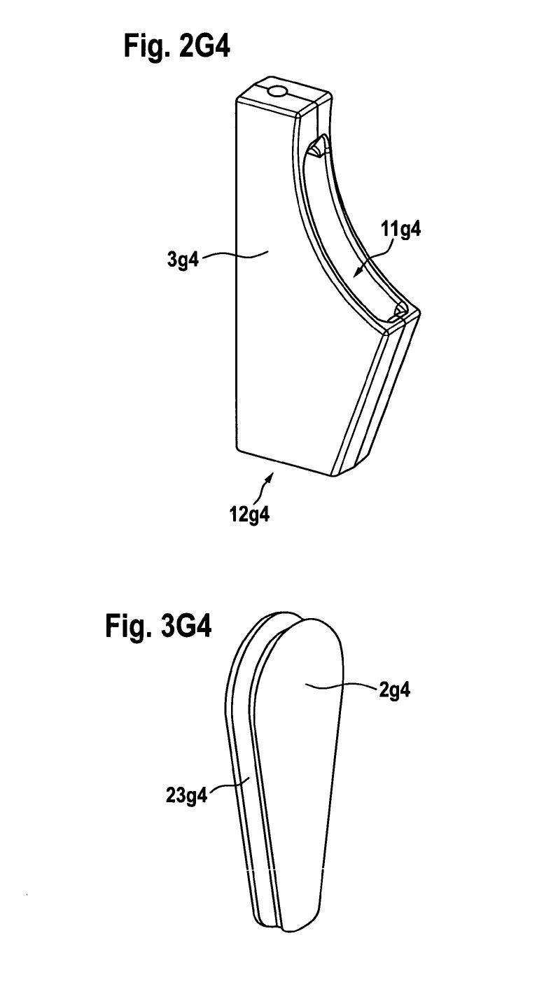

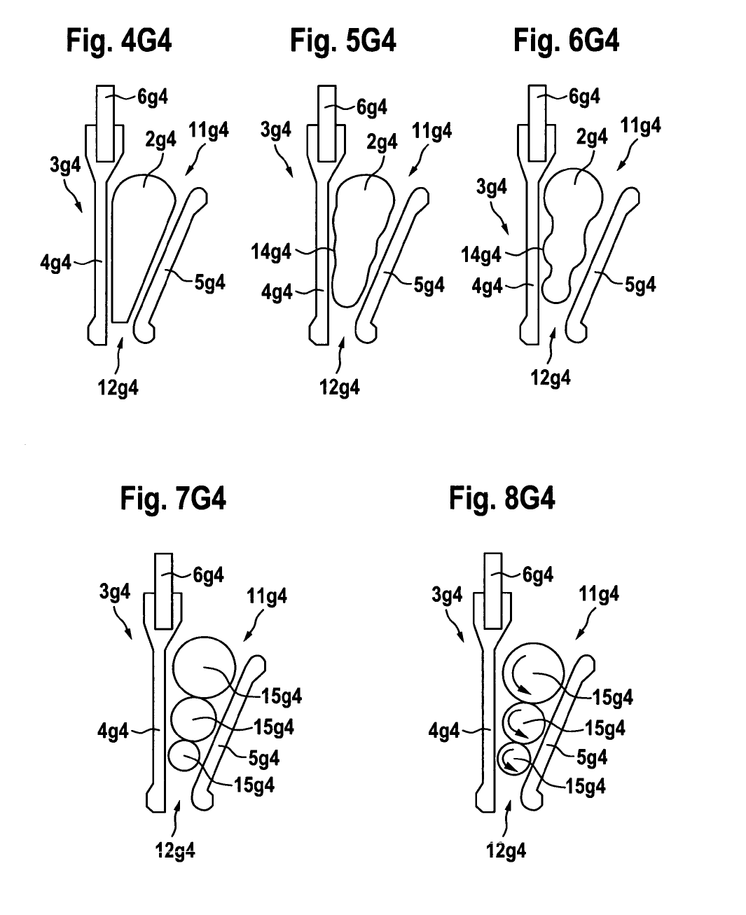

FIG. 6P cross-sectional view of another embodiment of the suspension element in a groove of a roller element

FIG. 7P again a cross-sectional view of another alternative suspension element in the groove of a roller element

FIG. 8P again a cross-sectional view of another alternative embodiment of a groove with suspension element

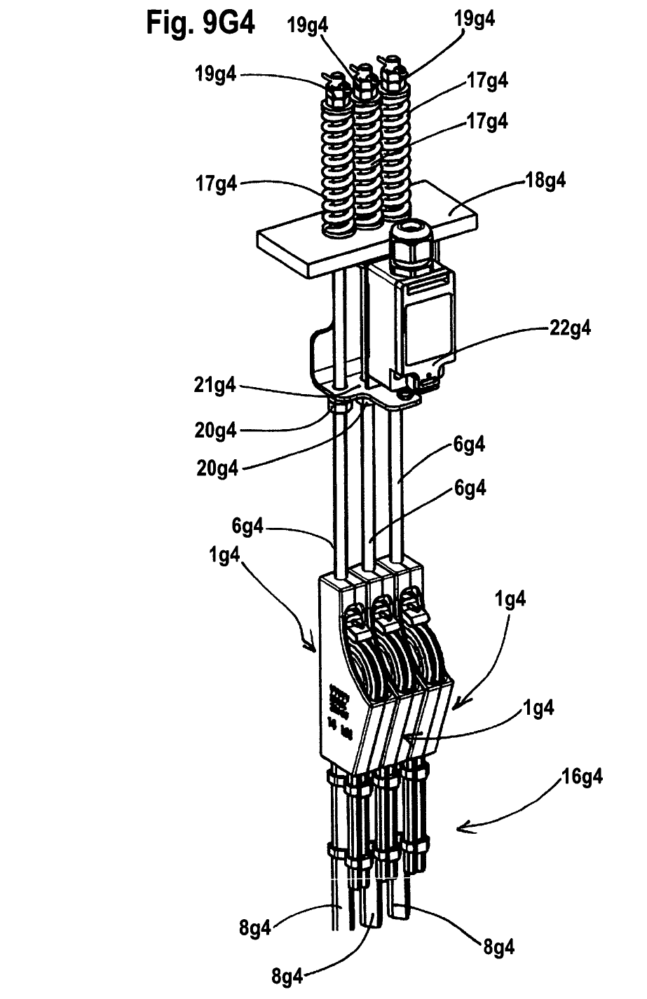

FIG. 9P an arrangement of a traction sheave with suspension elements positioned in its grooves

FIG. 1AV a schematic view of an elevator system with deflecting pulleys arranged underneath the car

FIG. 1GV a schematic view of an elevator system according to FIG. 1AV, seen from above

FIG. 2AV a schematic view of an elevator system with deflecting pulleys arranged above the car

FIG. 2GV a schematic view of an elevator system according to FIG. 2AV, seen from above

FIG. 3V a depiction of the principle of a first deflecting pulley unit

FIG. 3AV a sectional depiction of the deflecting pulley unit according to FIG. 3V with a load sensor

FIG. 3BV a sectional depiction of the deflecting pulley unit according to FIG. 3AV with locator

FIG. 3CV a perspective view of the deflecting pulley unit according to FIG. 3AV

FIG. 4V a depiction of the principle of another deflecting pulley unit

FIG. 5V a torque diagram of a deflecting pulley unit

FIG. 6V a time sequence chart of a load measuring process during a loading process

FIG. 1G1 a symmetric drive unit with drive frame according to invention

FIG. 2G1 a section through the symmetric drive unit according to invention

FIG. 3G1 an embodiment variant of the symmetric drive unit

FIG. 4G1 an asymmetric drive unit with drive frame according to invention

FIG. 5G1 a section through the asymmetric drive unit according to invention

FIG. 6G1 the drive unit according to invention with intersecting plane

FIG. 7G1 a section through the drive unit according to invention

FIG. 8G1 the drive unit according to invention in exploded representation

FIG. 1G2 an elevator with an elevator car, a counterweight, and a drive unit

FIG. 2G2 a suspended drive unit

FIG. 3G2 a drive unit with the monitoring device according to invention

FIG. 4G2 an embodiment variant of a deflection unit with the monitoring device according to invention

FIG. 3 a schematic perspective view of a basic structure of a belt-type suspension element according to the present invention

FIGS. 4A, 4B structure of a first station to manufacture the suspension element illustrated in FIG. 3

FIG. 5 a schematic depiction explaining the mode of operation of the first station illustrated in FIGS. 4A and 4B

FIG. 6 a schematic depiction of a partial belt manufactured according to a special embodiment in the first station of FIGS. 4A and 4B

FIGS. 7A, 7B schematic depictions of the structure of a second station to manufacture the suspension element illustrated in FIG. 3

FIG. 8 sectional view of another embodiment example of the suspension element according to invention, manufactured according to a procedure of the invention

FIG. 9 sectional view of a belt-type suspension element according to another embodiment example of the invention, manufactured according to a procedure of the invention

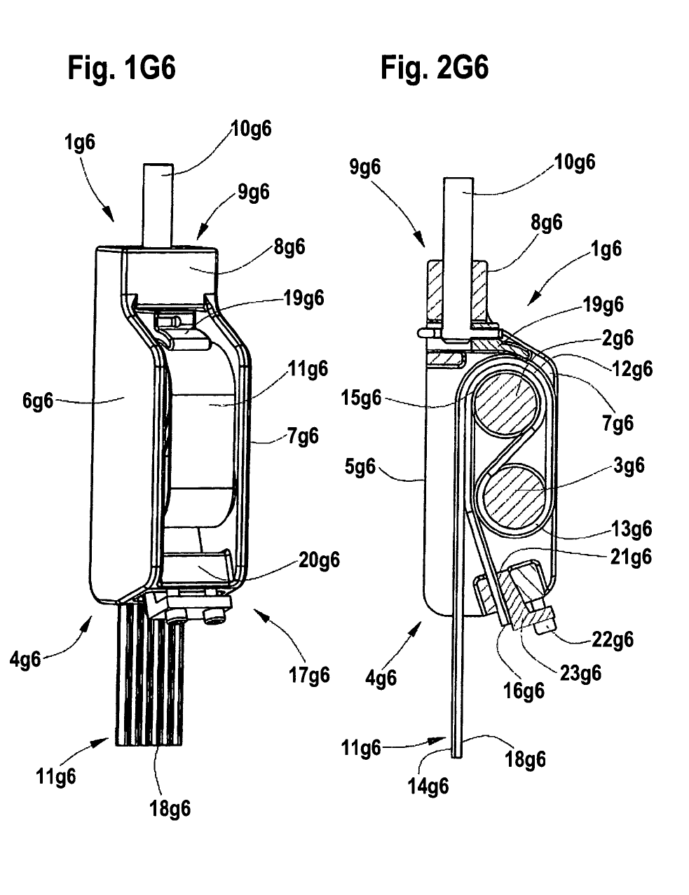

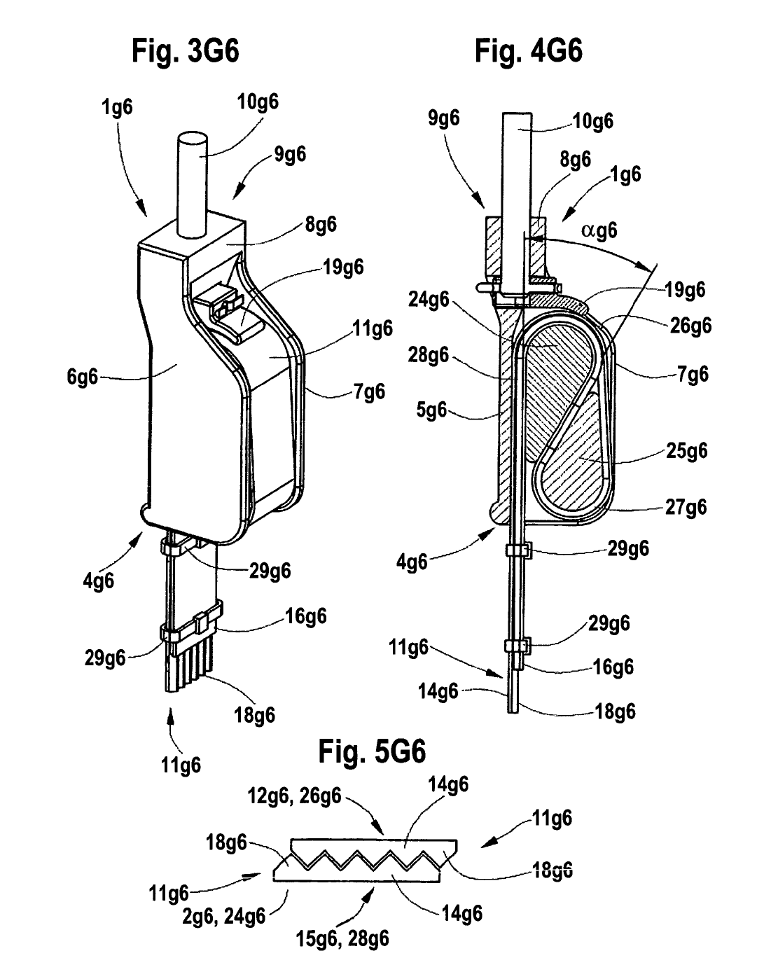

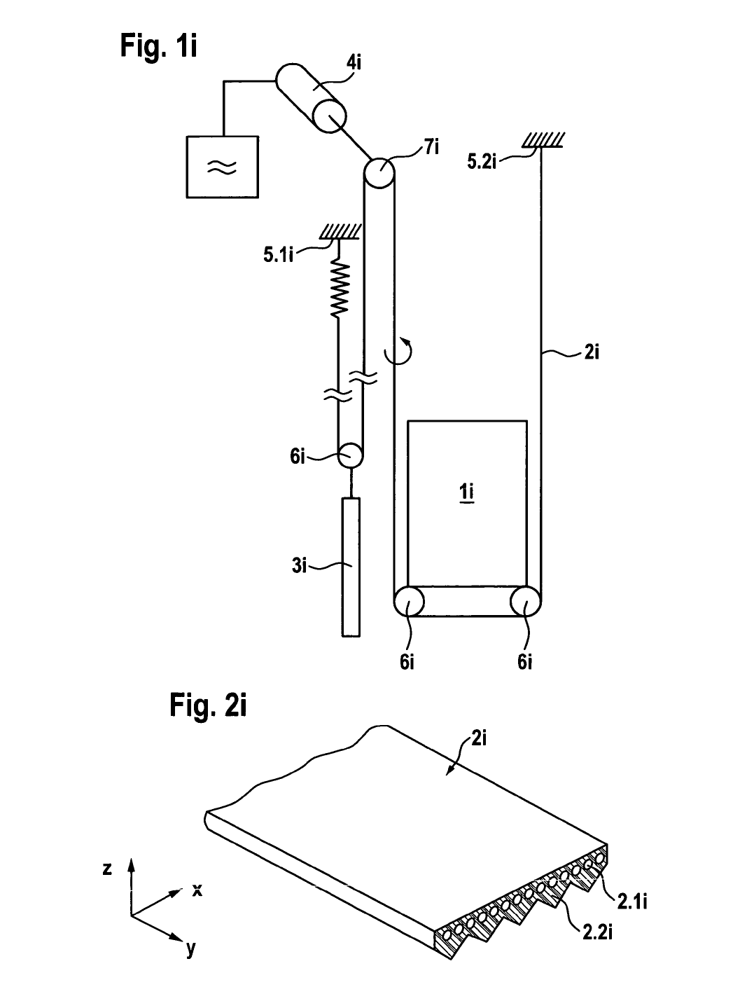

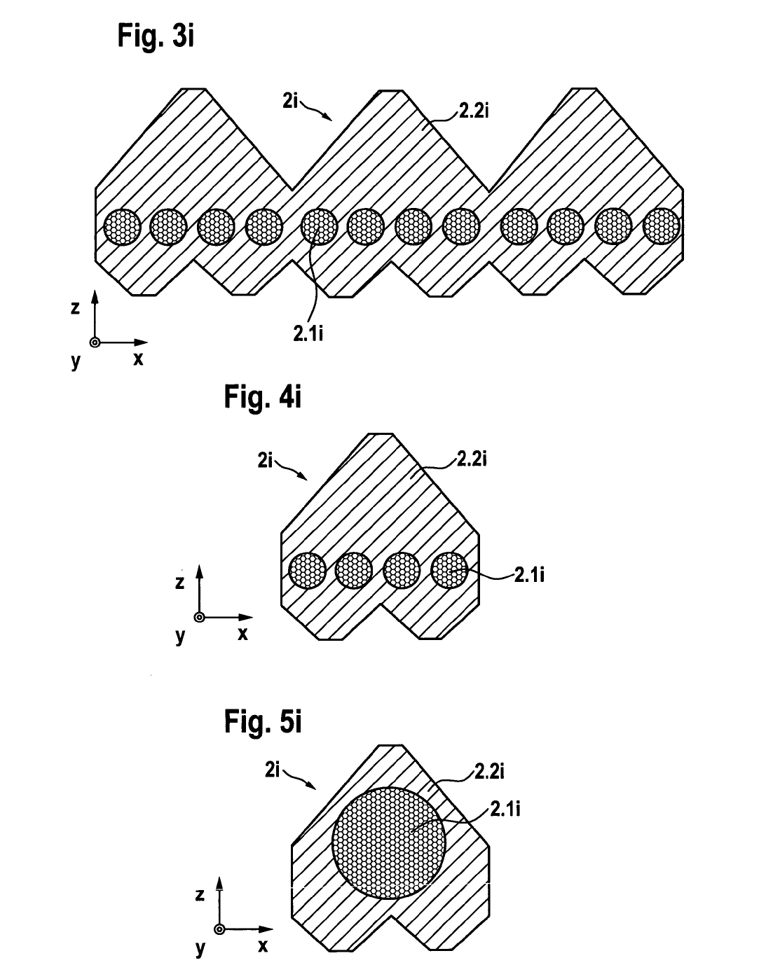

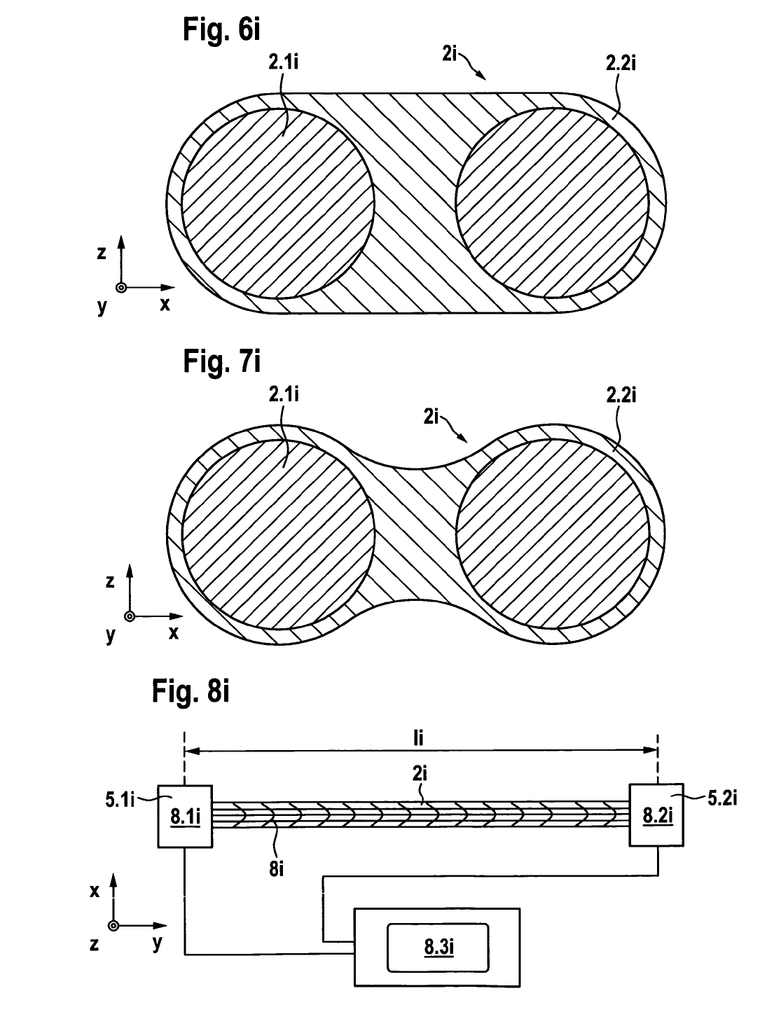

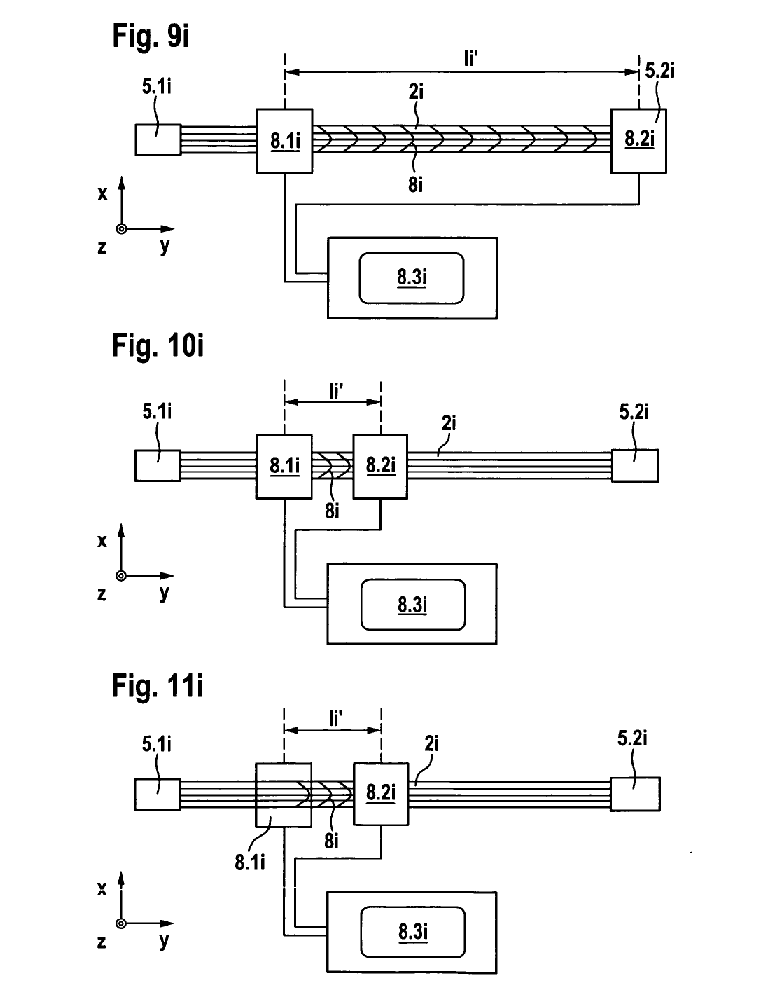

FIG. 10 sectional view of another belt-type suspension element according to another embodiment example of the invention, manufactured according to a procedure of the invention

FIG. 11A, 11B schematic sectional views of two variants of a belt-type suspension element manufactured in a procedure according to invention

FIG. 1G3 an elevator with a fixing point according to invention

FIG. 2G3 a side view of the fixing point

FIG. 3G3 the fixing point at the end of an emergency stop situation

FIG. 4G3 a view of the fixing point seen from the free leg of a guide rail

FIG. 4aG3 a horizontal section of the fixing point along line A-A

FIG. 5G3 a mechanism to release the fixing point

FIGS. 6G3, 7G3 the process of releasing the fixing point

FIG. 1G4 a suspension element end connection with a wedge arranged in a casing

FIGS. 2G4, 3G4 details of the casing and the wedge

FIGS. 4G4-8G4 different embodiment variants of the wedge

FIG. 9G4 a suspension element strand with several suspension element end connections

FIGS. 1G6, 2G6 a suspension element end connection with wrap elements firmly arranged in a casing

FIGS. 3G6, 4G6 a suspension element end connection with one wrap element firmly arranged in a casing and one movably arranged

FIG. 5G6 loops of a wrap element running in opposite senses

FIG. 1i an elevator system according to an embodiment of the present invention

FIG. 2i a first embodiment of a suspension element of the elevator system according to FIG. 1i, in perspective sectional detail view

FIG. 3i a second embodiment of a suspension element of the elevator system according to FIG. 1i, in cross-sectional view

FIG. 4i a third embodiment of a suspension element of the elevator system according to FIG. 1i, in cross-sectional view

FIG. 5i a fourth embodiment of a suspension element of the elevator system according to FIG. 1i, in cross-sectional view

FIG. 6i a fifth embodiment of a suspension element of the elevator system according to FIG. 1i, in cross-sectional view

FIG. 7i a sixth embodiment of a suspension element of the elevator system according to FIG. 1i, in cross-sectional view

FIG. 8i a first embodiment of a recording device for recording the status of a suspension element of the elevator system according to FIG. 1i, with ultrasonic waves being coupled in over the whole length of the suspension element

FIG. 9i a second embodiment of a recording device for recording the status of a suspension element of the elevator system according to FIG. 1i, with ultrasonic waves being coupled in along the longitudinal dimension of the suspension element

FIG. 10i a third embodiment of a recording device for recording the status of a suspension element of the elevator system according to FIG. 1i, with ultrasonic waves being coupled in along the longitudinal dimension of the suspension element

FIG. 11i a fourth embodiment of a recording device for recording the status of a suspension element of the elevator system according to FIG. 1i, with ultrasonic waves being coupled in along the longitudinal dimension of the suspension element

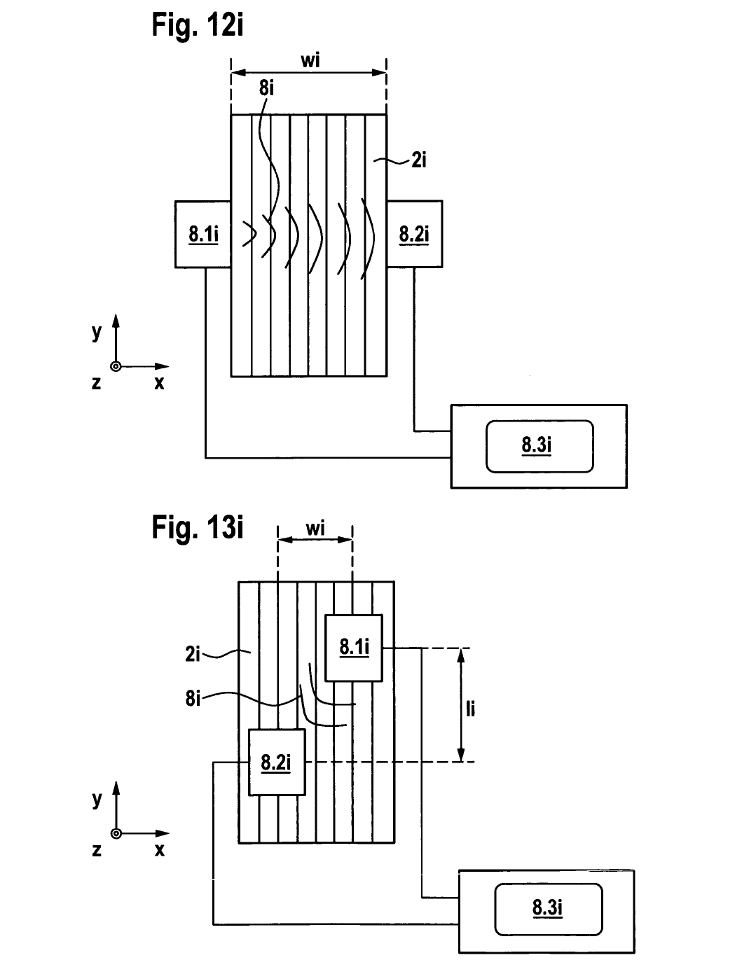

FIG. 12i a fifth embodiment of a recording device for recording the status of a suspension element of the elevator system according to FIG. 1i, with ultrasonic waves being coupled in over the whole width of the suspension element

FIG. 13i a sixth embodiment of a recording device for recording the status of a suspension element of the elevator system according to FIG. 1i, with ultrasonic waves being coupled in both in longitudinal and in transverse direction of the suspension element

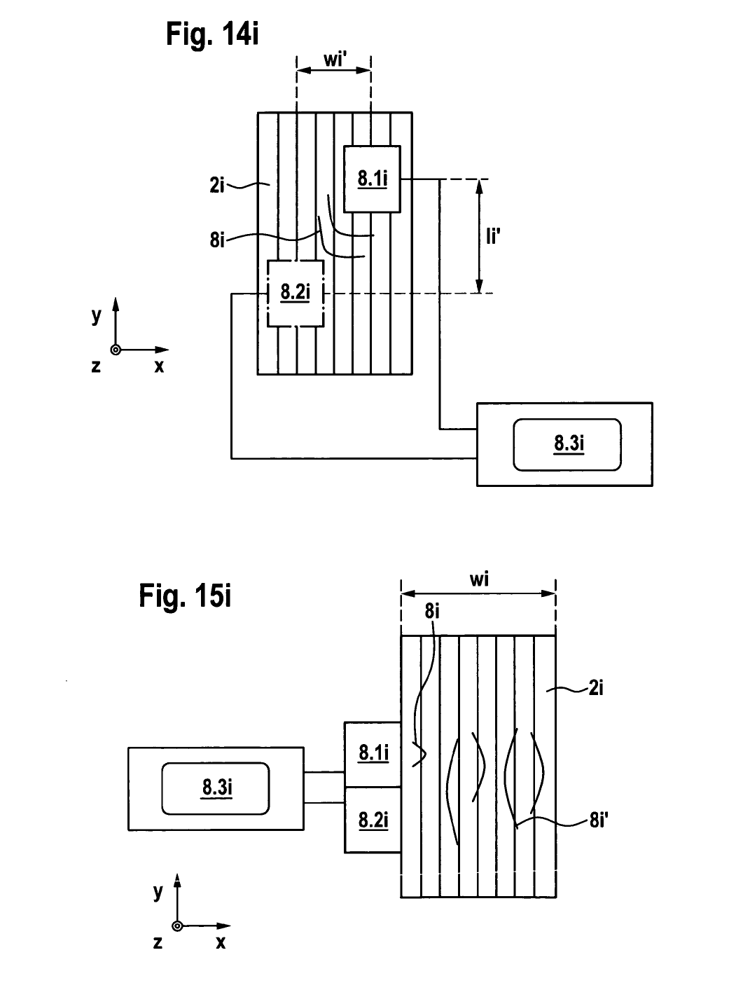

FIG. 14i a seventh embodiment of a recording device for recording the status of a suspension element of the elevator system according to FIG. 1i, with ultrasonic waves being coupled in both in longitudinal and in transverse direction of the suspension element

FIG. 15i an eighth embodiment of a recording device for recording the status of a suspension element of the elevator system according to FIG. 1i, with ultrasonic waves being coupled into the suspension element and reflected ultrasonic waves being recorded

FIG. 16i a ninth embodiment of a recording device for recording the status of a suspension element of the elevator system according to FIG. 1i, with ultrasonic waves being coupled into the suspension element and reflected ultra sound waves being recorded

FIG. 17i a tenth embodiment of a recording device for recording the status of a suspension element of the elevator system according to FIG. 1i, with ultrasonic waves being coupled into the suspension element via a traction sheave

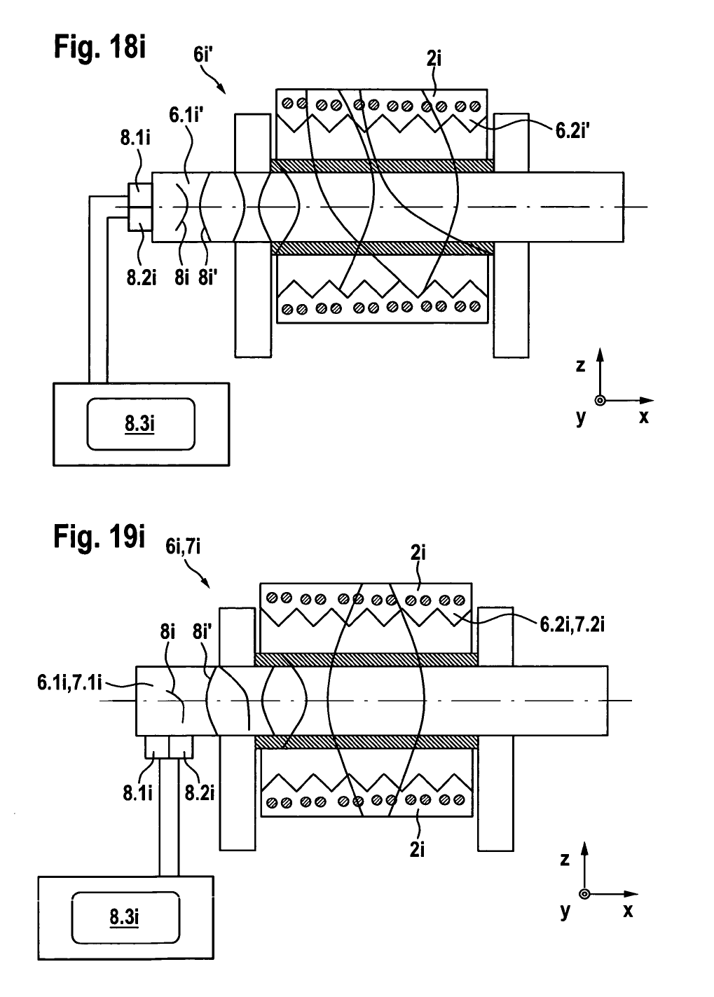

FIG. 18i an eleventh embodiment of a recording device for recording the status of a suspension element of the elevator system according to FIG. 1i, with ultrasonic waves being coupled into the suspension element via a deflecting pulley

FIG. 19i a twelfth embodiment of a recording device for recording the status of a suspension element of the elevator system according to FIG. 1i, with ultrasonic waves being coupled into the suspension element via a deflecting pulley

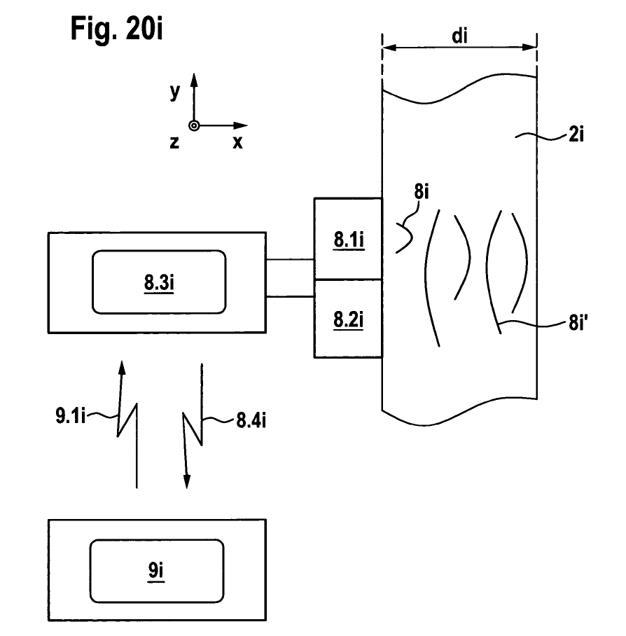

FIG. 20i a thirteenth embodiment of a recording device for recording the status of a suspension element of the elevator system according to FIG. 1i, with trigger signal and evaluation signal of the status recording

### DETAILED DESCRIPTION OF THE PRESENTLY PREFERRED EMBODIMENT

### Examples

1. Elevator Facility/Elevator System/Disposition

An elevator facility or elevator system according to the present invention can be designed as a passenger elevator to transport persons and, if necessary, also goods, or as a goods elevator for the exclusive transport of goods. The following description of the individual elevator components refers to an embodiment as a passenger elevator, but the teaching according to invention is basically applicable to goods elevators, too. Furthermore, an elevator system according to invention can be favourably used in various objects, like immobile aboveground and/or underground buildings, mines, or mine systems, in land vehicles, aircraft, and/or water vehicles. Besides, further information regarding the concrete embodiment is found in EN 81-1: 1998, including CORRIGENDUM 09.99.

The elevator system according to invention comprises at least one elevator car, or alternatively one or more mobile platforms, movable in vertical direction between fixed access points (in particular between the floors of a building) and guided along their tracks, at least sectionally. The elevator car is movable by means of a drive system, with the drive system comprising one or more hoisting machines, which can be operated independent of each other, if need be. Optionally, with the help of the drive system, the elevator car is also embodied as movable in horizontal direction or along a curved track.

Drive systems can be basically differentiated into mechanical drive systems using a traction sheave or a drum, hydraulic drive systems, and so-called rack-and-pinion drives. The present invention relates in particular to elevator systems with a traction drive or drum drive as a drive system.

The concrete structure of the drive system according to invention is described in detail below. Possible configurations and dispositions for elevator systems according to invention will be explained more precisely elsewhere in this document, with the components described in more detail below or elsewhere in this document—like elevator car, drive, suspension element, etc.—being applied in those described systems.

1.1 a) Elevator Car

The elevator car represents one of the main assembly groups of the elevator system according to invention and serves to receive passengers and goods. It comprises particularly a steel frame structure of 2.5 m or of up to 3.5 m height, composed of a floor frame and a supporting frame, as well as corresponding wall and ceiling components.

The elevator cars are generally produced with a rectangular or square floor area, but other car forms, e.g. with round floor area and the like, are possible as well. As to the solution of concrete design problems, also EN 81-1: 1998, including CORRIGENDUM 09.99 is referred to.

One or more entrances are conceived at the elevator car. In most cases, the entrances of the elevator car can be closed by a car door.

For carrying the elevator car, there is a suspension element or a force transfer arrangement with several (equal or different) suspension elements, which, in one embodiment example, are indirectly or directly fixed at the car ceiling. In modified embodiment examples, suspension elements are guided over respective deflecting pulleys below or above the elevator car and held in position by the elevator well or by various well installations. For regulations in detail, see EN 81-1: 1998, including CORRIGENDUM 09.99.

Elevator cars according to invention are favourably equipped with an evacuation device.

1.1 b) Evacuation

The elevator system according to invention is favourably equipped with an evacuation device which, if necessary, allows an automatic evacuation of persons being in the elevator car. If the elevator car deviates from the normal track (i.e. the track usual with normal operation), this is detected by a safety monitoring system, and the moved elevator car is transferred into a special operation mode. Alternatively, a version can be conceived where the elevator car changes into a special operation mode without control and that this is detected by a safety monitoring system. Such a special operation mode is also adopted, for instance, with a deviation of an actual travel movement from the normal track, with an interruption of the driving power, with a failure of service brake systems, or also with a failure of a suspension element.

In special operation mode, the elevator car can be decelerated up to a standstill by a brake system, by means of a braking force exerted by the brake system together with the braking track, and subsequently be kept standing still. In this example of a brake system, the braking force is created by pressing a brake lining with a certain force onto a braking track or a guide rail. Such a brake system can comprise a brake that is arranged at the hoisting machine and generates the braking force in interaction with a brake drum, brake disk, or brake shaft, etc. In a modified embodiment example, it is embodied as a brake system that is arranged in the area of the elevator car. In the first case, the brake system can evidently no longer provide security with a failure of suspension elements, but in the second case, the brake system also takes over the tasks of a safety gear according to chapter 1.5 (Safety gear).

The brake system used in the present example is preferably a regulated or controlled brake system which can at least adjust a deceleration according to a preset value. An example of an embodiment of such a brake system is described in EP 1671912 A1, which is referred to in full. Here, the brake system comprises at least two brake units, with each brake unit comprising a normal force control that adjusts a normal force (FN) according to a normal force value determined by a brake control unit. This normal force is the force with which the brake lining is pressed onto the guide rail, thus effecting a corresponding braking force and deceleration of the elevator car. In this respect, it has to be taken into account that the braking force to decelerate an elevator car in special operation mode or in case of malfunction may actually be very low. This is the case if, for instance, the elevator car is loaded such that it is counterbalanced by its counterweight. The holding force is the force needed to safely hold the elevator car—with potential loading or handling situations being taken into account—while the braking force is the force needed or existing to safely decelerate an elevator car in motion.

With the alternative evacuation device presented here, preferably the braking control unit and/or the brake system and/or a (special operation) computer assigned to the brake system or the braking control unit calculates intermittently or continuously the deceleration needed in special operation mode to bring the elevator car to a standstill within an exit zone. This is of advantage, since it allows a simple rescuing of passengers in the elevator car during special operation mode. Hence, a prolonged stay of passengers trapped in an elevator car standing still is avoided.

Alternatively or complementarily, the brake system further identifies an occurred standstill of the elevator car by detecting a precipitous change of a braking force and/or a measured actual acceleration, and, on detecting that the standstill has occurred, the brake system adjusts a preset braking force value or a normal force according to a holding force. This is of advantage since in that way the elevator car is safely fixed after braking has taken place. The elevator car can thus be cleared for being left, and a sliding away while passengers leave the elevator car or, for example, service staff enters is prevented.

Optionally, the brake system favourably comprises a braking force sensor, with the help of which a braking force can be sensed. In addition, the braking force sensor can be embodied as an integral part of the brake system itself. In that way, a simple functional structure and, furthermore, a cost-effective embodiment are achieved.

A precipitous change of the braking force can particularly simply be assumed if a change of the action direction of the braking force resulting from a change of the movement direction of the elevator car is detected. Furthermore, a precipitous change of the braking force can be assumed if, due to a standstill of the elevator car, there is no longer a deceleration component in the braking force. According to invention, the absence of the deceleration or acceleration component is preferably detected by measuring the actual acceleration. These are particularly simple and safe variants to reliably detect the standstill.

The nature of the variant used in a specific case evidently depends on a current operation, special operation, or failure situation. If, for instance, a not much loaded elevator car is going downwards and has to be stopped because of an unexpected event, only a very low braking force is necessary to decelerate the elevator car, since it is already decelerated because of the overweight of the counterweight. If the elevator car then comes to a standstill, due to the still existing overweight of the counterweight, the elevator car tends to move upwards or to accelerate in upward direction. This can be detected particularly simply, as the action direction of the braking force changes, and the preset braking force value can be increased in such a manner that a high and secure holding force results. The elevator car can thus be smoothly decelerated and nevertheless be held safely. On the other hand, if for instance the not much loaded elevator car goes upwards and has to be stopped because of an unexpected event or a malfunction, the overweight of the counterweight further accelerates the elevator car. Hence a braking force is necessary which, on the one hand, compensates a static overweight of the counterweight and, on the other hand, provides a dynamic braking component. Once the car then comes to a standstill, there is no longer a dynamic braking component, as only the overweight of the counterweight has still to be held. This can now also be detected in a simple way, since braking force or acceleration change precipitously. In that case, the preset braking force value or the normal force have to be increased in such a manner that a high and secure holding force results. The elevator car can thus again be smoothly decelerated and subsequently held safely.

A high holding force ensures that the elevator car does not suddenly slide away during the then following service activities. Here, it is self-evident that, depending on the construction type of the brake system, there are different possibilities to adjust the holding force required in a standstill. If, in a first example according to invention, a brake system is used where a normal force is regulated or controlled to achieve a desired braking or holding force, the preset braking force value results in a preset normal force value according to which the brake system will then adjust an acting normal force. If, in a second example according to invention, a direct regulation of the braking force or a simple deceleration regulation is used, the brake system will, due to the preset braking force value, inevitably effect a maximum infeed force or normal force, since in a standstill, with non-moving elevator car, only a braking force equalling the holding force can be measured and—as that value is lower than the preset braking force value in a stop—the brake system will accordingly try to increase that value. This makes it clear that the use of a normal force regulation means going easy on the brake system, since it is possible to preset a normal force value as it is required only for holding. In the following, in this context the notion of normal force will be used, including equivalently also an infeed force that results from a braking force control or deceleration control.

Favourably, after a maximally expected braking time has expired or a braking failure has been detected, the brake system adjusts the normal force to a value equalling the holding force. This provides a second security, since in case of a disorder of the brake system a safe holding force is adjusted after a predetermined time, even if the elevator car has already stopped safely. The system safety is thus increased.

In a preferred embodiment example, the elevator car is arranged in an elevator well or a housing, with landing doors and/or emergency doors being conceived through which the elevator car can be entered. An exit zone is determined by an approaching area of the elevator car with respect to the landing door or emergency door. This is of advantage, since this embodiment allows a leaving of the elevator car at a “normal” stop. A “normal” stop is defined as a stop which is approached in normal operation, too. There, the exit zone is, for instance, the area in which an elevator car door engages with a landing door and can thus be opened without risk manually or maybe by electric control.

Evidently, in special operation mode an exact alignment of elevator car door to landing door has not necessarily to take place. A step of 0.25 m or more can in fact be acceptable in special operation mode. Besides, in such an event a warning message or indication can be provided pointing to a possible step and thus warning passengers. A bigger distance of up to 0.5 m is equally possible. Here, the intervention of an instructed person can be conceived who can manually open the landing doors and elevator car doors. In further embodiment examples, emergency exit zones can be defined for particular buildings. This is reasonable if there are rather large travel distances without normal stops, as is the case, for instance, in elevator systems with so-called express zones. These emergency exit zones are equipped with emergency doors.

Favourably, the brake system according to invention is embodied in a way that during movement of the elevator car in normal operation mode it repeatedly calculates a hypothetically required deceleration which would be required to bring the elevator car to a standstill within the exit zone in special operation mode. This is of particular advantage since the brake system is thus able to react quickly. In another modified embodiment example, the repeated calculation of the hypothetically required deceleration is used for a plausibility control: favourably, the calculation of the hypothetically required deceleration takes place in short time intervals or continuously. To realize the plausibility control, several calculation results are compared with each other, and especially deviations of the calculation results from each other or from a standard deviation are determined. A possible time interval is chosen such that a sufficiently precise approaching of the exit zone is possible. The time interval can be chosen as a function of a travelling speed of the elevator car. Usually, a time interval of less than 1 second is preferred, especially an interval between 0.1 s and 0.6 s.

According to invention, in the transition to special operation mode an exit zone as close as possible to the position of the elevator car is approached. In a modified embodiment example, that zone is approached which can be reached with “comfortable deceleration”, even if it is not the closest exit zone. Here, for instance, a deceleration of less than 4 m/s² is seen as “comfortable deceleration”. Dependent on an operation situation or a type of special operation mode, of course higher deceleration values may also be used. This is in particular the case if an impending crashing into an obstacle is detected (i.e. a threatening collision with another elevator car or with a well end), or if an opened landing door in close proximity is detected at the point in time of transition to special operation mode.

Favourably, the deceleration hypothetically required in the transition to special operation mode (i.e. for instance if an unexpected event occurs) is directly defined and used as the deceleration required to perform the braking. In further modified embodiment examples, the brake system determines, on the basis of this required deceleration, further braking control variables like braking force or normal force, according to case. This solution provides a clear functional structure. From the moment on when the unexpected event occurs, braking can take place autonomously, since the brake system has only to meet the preset deceleration value.

Favourably, the brake system is able to determine a temporally delayed slow-down initiation or the deceleration in form of an optional reference acceleration curve, should this be required or favourable to reach the next exit zone. An optional form of the reference acceleration curve is, for instance, a curve that defines a high deceleration during a first time period and for a second time period (after the phase of heavy deceleration) defines a phase of lower deceleration (in particular when approaching the exit zone). Alternatively, a modified form of the reference acceleration curve can be determined according to which an acceleration during a first time period is admitted, followed by a transition to a deceleration phase in a second time period. In a third time period, a reduced deceleration during approaching the exit zone can be defined. This is advantageous, since the time for reaching the exit zone, as a function of the distance to the next possible exit zone, can be optimized according to needs. Favourably, for the calculation of the required deceleration a braking computer or a special operation computer is used which is at least functionally separated from other control functions.

In another preferred embodiment example of the invention, the brake system comprises an acceleration sensor and an acceleration control. During braking, these instruments use the required deceleration preset by the braking computer as reference value, and the normal force as control variable. Furthermore, the brake system favourably comprises at least two brake units acting on one braking track each, with the brake system determining braking control variables for each individual brake unit. This is of advantage, since failures of an individual brake unit can thus be compensated by the other brake units.

The brake system is favourably embodied as an electro-mechanical or a hydraulic one or as a purely mechanical friction brake system. A combination of different braking types can be used, too. This increases the functional security of the whole system, since different types usually complement each other in failure situations.

Favourably, the braking track is assembled with the guide track in one piece. This means a cost-effective overall solution.

In one further formation, the required deceleration and/or the temporally delayed slow-down initiation and/or a reference acceleration curve are determined, taking into account one or several of the following parameters:
speed of the elevator car
current position of the elevator car in relation to a well end
current position of the elevator car in relation to a landing door
current position of the elevator car in relation to an emergency door
current position of the elevator car in relation to another elevator car
operation mode of the elevator system and/or
status of the brake system

Taking the mentioned parameters selectively into account, a comfortable and yet safe stop of the elevator car in special operation mode can be achieved.

In another embodiment example of the elevator system according to invention, an evacuation is performed by means of an evacuation control, which, with a stop of the elevator car due to an error, is initialized either manually or automatically. This type of embodiment can be chosen if no controllable brake system is used.

If the elevator drive (described in detail elsewhere in this document) is intact, a standstill brake is opened by means of an emergency power supply after the evacuation control has been initialized. A travel direction detector then records a resulting movement direction of the elevator car. The resulting movement direction ensues from a momentary loading status of the elevator car. If the elevator car is not much loaded, it may perhaps start moving upwards due to a comparably heavier counterweight, while with a heavily loaded elevator car, a downward movement will occur. Thus, after the opening of the standstill brake, the travel direction detector, preferably a speed encoder integrated at the hoisting machine, will detect the load-dependent travel direction, and the evacuation control will then give a travel command to the driving unit into just that direction. The respective reference travel speed is set to a low value, for instance between 0.03 m/s and about 0.3 m/s. Evidently, the drive does not use much energy in this travel direction, since only braking is necessary. Accordingly, the emergency power source is optionally dimensioned in such a manner that a drive control—usually a frequency-controlled converter—is kept in operation. With this low reference travel speed, the next exit place is approached, and when it is reached, the standstill brake is engaged again so that the car is fixed. Trapped passengers can leave the elevator car.

Alternatively or complementarily, a device can be conceived which will be applied if there is a defect of the drive device or the appertaining drive control. Here, the standstill brake is opened, with a preferably manual operation of an evacuation device, for a short period of time and then closed again. In this time span, the elevator car moves in one of the two travel directions according to its loading status. The respective time span is defined such that, even with extreme loading and with lacking driving torque, not too high a speed will result. This process of opening the standstill brake is then repeated until the elevator car has reached the exit area of an exit site. Preferred time spans for keeping the standstill brake open range from about 120 to 500 milliseconds, preferably amount to about 180 milliseconds. This time span is preset as a function of the overall mass distribution of the moving parts—like elevator car, counterweight, suspension element, and rotating parts of the hoisting machine. Alternatively, instead of the time span, a distance range can be defined, too. So, the standstill brake can be kept open until the elevator car has moved by about 150 mm to 350 mm, preferably by about 250 mm. In that way, too, the elevator car can be moved safely to the neighbourhood of a next exit site for the purpose of evacuation.

Favourably, an evacuation control according to invention is equipped alternatively or additionally with a speed sensor, for instance the speed encoder of the hoisting machine is instrumentalized to that end. According to invention, the evacuation control keeps the standstill brake open only as long as a travel speed is below an admissible evacuation speed of, for instance, 0.5 m/s.

1.2 a) Counterweight

Especially in elevator systems with a traction drive, a counterweight is used to reduce the driving energy needed. There, the counterweight also influences the tractive capacity of the drive system.

The weight of the counterweight usually amounts to at most the sum of the weight of the elevator car and half the maximum rated load of the elevator system. The full balance, the state at which the driving energy is predominantly used to overcome the frictional resistance in the system, is hence given with a loading of the elevator car with half the rated load.

The form of the counterweight is preferably adapted to form and size of the counterweight movement zone, which is conceived within the elevator well for the elevator car or separate of the latter. Here, the counterweight is preferably guided in the well in suitable guide rails. As to the solution of concrete design problems, EN 81-1: 1998, including CORRIGENDUM 09.99 is also referred to.

1.2 b) Counterweight Embodiment

According to invention, the weight of the counterweight 32 is chosen such that it at least approximately equals the sum of the structural weight and half the admissible rated load of the elevator car 10. In that way, the maximum tractive force which the hoisting machine 14 has to apply to elevator, hold, or lower the elevator car 10 is minimized. With half the admissible rated load, the elevator system is balanced, i.e., the hoisting machine 14 does not have to apply any holding force, and even in elevatoring or lowering has only to overcome frictional forces. The maximum tractive force then occurs with an empty elevator car 10 (the counterweight 32 pulling downward) and with a full elevator car 10 (the elevator car 10 pulling downward). The hoisting machine 14 is then chosen such that it is able to, on the one hand, apply this maximum tractive force as a static holding force, and, on the other hand, additionally also counterbalance the inertia forces of the elevator car 10 including rated load and counterweight 32 occurring with a nominal speed profile in continuous or temporary elevatoring operation.

In a modified embodiment example of this invention, it is suggested according to U.S. Pat. No. 5,984,052, the contents of which are referred to in full with respect to the embodiment of the elevator system, to choose the counterweight such that it equals the sum of the structural weight and a statistic mean of the rated load distribution, which, in the embodiment example, is assumed as amounting to 30% of the admissible rated load. On average, such an elevator system is balanced, i.e. requires only low holding or elevatoring forces during a great portion of its daily operation. If, however, the elevator car in the embodiment example transports more than 40% of the admissible rated force, the tractive force to be applied by the hoisting machine increases as compared to the above-described elevator system balanced with 50% and, from 80% of the admissible rated force on, exceeds the maximum tractive force to be provided by the elevator system balanced with 50%. In combination with suspension elements, traction sheaves, and deflecting pulleys or guide pulleys proposed elsewhere in this document, the total weight of the elevator system can be optimized.

In an operation range of about 70% to 100% of the admissible rated load, the hoisting machine according to invention described elsewhere in this document can no longer counterbalance the same inertia forces as in the remaining operation range. Accordingly, referring to U.S. Pat. No. 5,984,052, it is suggested to change the nominal speed profile from a certain percentage of the rated load on—e.g. from 70%, 75%, or 80% on—and work only with lower accelerations. Preferably, it is also conceived according to invention, to successively lower the speed (or rotation speed of the motor and/or the gear) from a certain threshold value of the rated load on—e.g. from 50% on—in steps or continuously. Here, a linear or parabolic/hyperbolic functional correlation between the actual value of the rated load and the car speed or motor rotation speed can be defined in an elevator control.

The balancing suggested by U.S. Pat. No. 5,984,052 and adopted in the context of the present invention basically requires the complicated empirical determination of the rated load mean. If, in actual operation, the rated load distribution deviates from the distribution on which the design of the weight of the counterweight is based, the elevator system works sub-optimally. With a heavy deviation from the mean, i.e., if rated loads frequently deviate heavily from the mean, the efficiency of the elevator system becomes poorer, too.

The traditional 50%-balancing, on the other hand, requires relatively big counterweights. These are disadvantageous regarding production, mounting, and maintenance. One particular disadvantage is that big counterweights require additional installation space in the elevator well. The balancing with a statistical mean of the rated load considerably reduces the transport capacity in full load operation, since especially with this operation state the nominal speed is reduced.

In another embodiment example, the elevator system according to invention comprises an elevator car 10 according to invention (with the structural weight MK) designed for an admissible rated load MLmax (e.g. 1500 kg). A suspension element is fixed at the elevator car 10 onto which the hoisting machine 14 can apply a tractive force such that the elevator car 10 is elevatored, lowered, or held at a certain height. Here, a variant of the suspension element described elsewhere in this document is conceived. Furthermore, the hoisting machine 14 can apply a maximum tractive force MFmax as static holding force MFmaxA, as dynamic continuous elevatoring force MFmaxUD, and/or as temporary elevatoring force MFmaxUZ. Preferably, the hoisting machine is chosen according to a construction type revealed elsewhere in this document.

Usually, the dynamic elevatoring force, which, in addition to weight forces has also to balance inertia forces and frictional forces, is greater than the static holding force. Here, the temporary elevatoring force which the hoisting machine 14 can produce over a short period is, in general, greater than the continuous elevatoring force the hoisting machine 14 can apply over a longer period. Conversely, the static holding force MFmaxA maximally generated by the hoisting machine 14 can also exceed the dynamic elevatoring force MFmaxU, in particular if the hoisting machine 14 favourably comprises a brake, which is integrated in a motor or can be embodied as separate from the latter. So, especially safety brakes in elevator systems are to exceed the nominal performances of the drive motors so as to be able to safely brake and hold the elevator car 10 in case of failure of the motors. To safely balance the inertia forces occurring in such an emergency braking, which may exceed the dynamic loads in normal operation, the brakes can be dimensioned as correspondingly strong.

According to this advantageous embodiment of the invention, it is now proposed that the weight MG of the counterweight 32 should basically equal the sum of the structural weight MK and the difference between the maximum tractive force MFmax of the hoisting machine 14 and the admissible rated load MLmax of the elevator car 10, which is expressed in the following equation:

MG≈MK+(MLmax−MFmax) (1)

The weight of the counterweight 32 does not have to exactly equal the sum of the structural weight and the difference between the maximum tractive force and the admissible rated load. In particular, the counterweight 32 can be chosen somewhat bigger, as will be explained below, so as to take inertia forces and frictional forces as well as additional forces of the suspension elements into account, so that the following holds:

MG≧MK+(MLmax−MFmax) (2)

The hoisting machine 14 described elsewhere can provide, depending on its design, a maximum tractive force MFmax. This maximum force is always at least greater than half the admissible rated load MLmax, since otherwise the hoisting machine 14 could hold, elevator, or lower neither the full nor the empty elevator car 10.

MFmax>0.5×MLmax (3)

Now, according to a preferred embodiment variant of the invention, the mass of the counterweight 32 is chosen such that the hoisting machine 14 can, with its maximum tractive force, just hold the elevator car 10 with counterweight 32 coupled to it, or elevator or lower it with the nominal speed profile. The safety factors required for elevator systems can be taken into account here for instance by using the ratio of the design-dependent maximum tractive force of the hoisting machine 14 and a corresponding factor as value for the maximum tractive force MFmax in equation (1) or (2). Values for this safety range typically range from 1.1 to 2.0. In that way, usual acceleration and inertia influences, friction losses, shifts of suspension elements, or overload reserves can be taken into account. This safety factor is usually defined for certain elevator categories. Preferably, this safety factor amounts to about 1.3. This value has proved efficient in passenger elevators for up to 10 floors.

Of course, this safety factor can already be contained in the definition of the maximum tractive force MFmax of the hoisting machine 14. In that case, this safety factor needs no longer to be considered in the optimizing of the counterweight 32.

As diverging from the above-described embodiment of the weight of the counterweight 32, where on the one hand the required maximum tractive force of the hoisting machine 14 is minimized (50% balancing), and/or on the other hand the statistic mean of the required tractive force of the hoisting machine 14 is minimized, in another variant it is proposed to completely use the tractive force made available by a hoisting machine 14 and, in doing so, optimize or minimize the weight of the counterweight.

In that way, it becomes favourably possible to select a hoisting machine 14 from a construction series with predetermined graded tractive forces. In doing so, in a first step that hoisting machine 14 is selected that provides the lowest maximum tractive force sufficing to elevator, lower, or hold the elevator car 10 with 50% balancing, since with 50% balancing the required maximum tractive force is minimal—a hoisting machine 14 has hence in any case to be able to provide this balancing-dependent lowest possible maximum tractive force.

In graded construction series, usually the maximum tractive force of the individual types will not exactly match the lowest maximum tractive force for a concrete application, determined as a function of structural weight and rated-load weight of elevator car 10, friction coefficients, weights of the suspension elements, safety factors and the like. Accordingly, in a first step that hoisting machine 14 of the construction series is selected the maximum tractive force of which just exceeds this lowest required maximum tractive force.

The thus selected hoisting machine 14 therefore provides more (maximum) tractive force than would be required for the concrete application case. This excess is used according to invention to optimize the mass of the counterweight 32 as far as possible, that is, to minimize it. Since a counterweight which is not balanced with 50% will, in the borderline case of an empty or maximally loaded elevator car 10, require a higher tractive force to elevator, lower, or hold the elevator car 10. The hoisting machine 14, however, selected out of the construction series and insofar over-dimensioned, can just provide this higher tractive force.

On the other hand, it is not necessary—as it is with the embodiment variant according to U.S. Pat. No. 5,984,052—to change the nominal speed profile with higher rated loads, since according to invention, the mass of the counterweight 32 is minimized only so far that the elevator car 10 can travel over its entire rated-load distribution with the desired nominal speed profile, only so far that the hoisting machine 14 can elevator or lower elevator car 10 in all operation states with the desired speed profiles. In that way, the transport capacity during full-load operation is increased.

So, the selection of the mass of the counterweight 32 according to invention represents an optimal compromise between a 50% balancing with, in a borderline case, minimal tractive force, and a balancing with respect to the statistical mean of the rated load, where the statistical mean of the tractive force is minimal. It allows in particular to select the hoisting machine 14 from a construction series with predetermined graded tractive forces, hence to fall back upon cost-effective series-produced hoisting machines with utilizing them optimally, and to minimize costs.

A minimal counterweight means a number of advantages: On the one hand, already in production material costs are saved. On the other hand, a smaller counterweight 32 is clearly easier to be handled in production, transport to the site of use, mounting in the elevator well, maintenance, and dismantling. Finally, a smaller counterweight favourably needs less space in the elevator well (or a separate well).

In another embodiment example, the mass of the counterweight 32 could preferably be made that low that it equals the weight of the empty elevator car 10. As Stawinoga shows in the journal ‘Elevatorreport’ of September/October 1996, in that case further measures to protect against uncontrolled upward movements could be dispensed with. The considerations regarding the design of the mass of the counterweight described there are applied according to invention.

The suspension element can comprise one or more ropes and/or one or more belts and/or suspension elements of arbitrary form and arbitrary structure or of arbitrary material. According to invention, such suspension elements are preferred which at the same time perform the function of a traction element, i.e. rope(s) and or belt(s) that are fixed at the elevator car 10 and the counterweight, and/or are deflected via idle and/or fixed pulleys and/or one or more traction sheaves, and/or are fixed at the building installation. With particular preference, the suspension elements described in detail elsewhere in this document are used, which provide an additional adjusting possibility or an additional degree of freedom with respect to the distribution of the masses within the elevator system according to invention. With particular preference, one or more (single) suspension elements are conceived, the (tractive-force-transferring) tension members of which are embodied as ropes and/or tissue structures and coated with an elastomer, in particular with polyurethane. An elastomeric coating increases in particular the tractive capacity of the suspension element. An increase of the friction coefficient through the advantageous coating allows in particular a reduction of the weight of the counterweight 32, since with a deflection via a traction sheave the counterweight should, according to the Euler-Eytelwein equation, amount to at least e^{μα} of the elevator car weight (where μ is the friction coefficient between traction sheave and suspension element, and α the deflection angle).

The hoisting machine 14 preferably comprises a motor, in particular a frequency-controlled electric motor, and may comprise at least one traction sheave to translate an output torque of the motor into a tractive force onto the suspension element. A brake can be conceived as integrated into the motor or as separate of it, which can apply a static holding torque onto the at least one traction sheave. All known non-positive and/or positive brakes are eligible as brakes. Moreover, one of the drives described elsewhere in this document is preferably conceived.

As maximum tractive force MFmax of the hoisting machine 14, the lowest value of the following is preferred:
static holding force MFmaxA, with which the hoisting machine 14 holds the elevator car 10 at a certain level
dynamic continuous elevatoring force MFmaxUD, with which the hoisting machine 14 can elevator the elevator car 10 during a longer period, and
dynamic temporary elevatoring force MFmaxUZ, with which the hoisting machine 14 can elevator the elevator car 10 for a short period.

As described above, in particular with safety brakes the static holding force MFmaxA can exceed the dynamic elevatoring force MFmaxU. Conversely, for instance with pure motor brakes, the static continuous holding force can fall below the dynamic (temporary) elevatoring force. To ensure both a safe elevatoring and lowering of elevator car 10, i.e. a sufficient dynamic elevatoring force of hoisting machine 14, and a safe holding of elevator car 10 at some level, i.e. a sufficient static elevatoring force of hoisting machine 14, it is suggested to base the design of the mass of the counterweight 32 on the lowest of these values.

In the design of the mass of counterweight 32, the weight of the counterweight and/or the structural weight of elevator car 10 and the admissible rated load of elevator car 10 is reduced according to the number of the idle pulleys around which the suspension element is deflected, following the laws known for sets of pulleys. Thus, in equations (1) and (2), the weight MG of counterweight 32 or the structural weight MK and the admissible rated load MLmax can, for instance, be divided by a suspension factor 2 if the suspension element is deflected once (or side-of-car and side-of-counterweight) around an idle pulley (singly). With multiple roping (i.e. 4 times, 5 times, etc.), the divisor for the design of the weights changes accordingly. With a direct suspension, without idle pulleys, the divisor equals 1, hence is of no effect.

In ways generally known, the structural weight of the elevator car 10 and/or the maximum tractive force of the hoisting machine 14 and/or the admissible rated load of the elevator car 10 can be increased in equations (1) and (2) by the safety factor for consideration of inertia forces occurring during operation. Similarly, friction and/or the weight of the suspension element and/or traction element can be considered in equations (1) or (2).

In further embodiment variants of the elevator system according to invention, the counterweight can, for instance, be distributed to several individual partial counterweights, which, for instance, can be arranged at both sides of elevator car 10 or in corner areas of the elevator well.

For the production of a counterweight, plates or other structure elements of metal materials, like steel or lead are conceivable in all embodiment examples. Complementarily or alternatively, mixtures of pressed materials can be used, which are filled into bulk containers arranged side-of-counterweight or are press-moulded with supporting structures. Furthermore, counterweights can comprise iron/concrete constructions. Alternatively or in combination with other structure elements, stone plates can also be used, or containers filled with liquids (e.g. water) can be employed alternatively or in combination with the mentioned other structure elements. The latter embodiment has the advantage that, with changed load situations or for special transports (transport of heavy machines, furniture, or the like) a load balance can be quickly changed by means of filling in additional liquid.

1.3 Elevator Well

According to invention, the car is arranged in an elevator well, with a wall at least sectionally surrounding the well. Here, load-bearing and non-load-bearing walls of stone, bricks, metal, concrete, glass or the like are conceivable. The elevator well is preferably a room bordered on several sides by vertical walls, in which the track of the elevator car is enclosed. Preferably, apart from the track of the elevator car, also the track of the counterweight is found in the elevator well. In a modified embodiment example, the counterweight is located in another elevator well or in a counterweight well at least partly separated from the elevator well.

As appertaining to the elevator well, a well headroom of at least 50 cm height in the upper end area of the elevator well, and a well pit of at least 50 cm depth in the lower end area of the elevator well are conceivable, so as to provide potentially desired overtravels and shelters. The well pit is, for instance, embodied as part of the elevator well between the upper edge of the door sill of a lowest stop and the well bottom. Well headroom and well pit are located outside the operation end positions of the elevator car and the counterweight on their respective tracks. In the well pit, for instance, buffers for the elevator car and the counterweight can be arranged. Details are regulated in EN81-1: 1998, including CORRIGENDUM 09.99.

According to invention, basically rigid guide rails for the elevator car and the counterweight are arranged at the side walls of the elevator well, so as to safely and precisely guide the elevator car or the counterweight on their respective tracks in the elevator well.

1.4 Guide Rails

The guide rails in the elevator well have the task to guide the elevator car or the counterweight in their respective tracks and base area sections, in particular in vertical movements. At the same time, the guide rails serve for engaging the safety gear in the process of clamping the car.

Guide rails for elevator systems often comprise a T-profile, optionally also of an angle profile, fixed on one side wall of the elevator well.

The elevator car is, at its top and at its bottom, on both sides, equipped with a firm guide, e.g. in form of guide gliding shoes and/or rollers, by means of which it is guided along the guide rails in the elevator well. Details are regulated in particular in EN81-1: 1998, including CORRIGENDUM 09.99.

1.4.1 Special Variants of Guide Rails According to Invention

The belt-type suspension element according to invention is preferably used in an elevator system according to invention in which elevator guide rails with improved sound-absorbing and vibration-absorbing fixing elements are mounted in the elevator well.

These sound-absorbing and vibration-absorbing fixing elements for elevator guide rails, described below, can be produced cost-effectively, meet the safety requirements in case of fire, and can also absorb tractive forces.

With these sound-absorbing and/or vibration-absorbing fixing elements for elevator guide rails, an installation procedure for guide rails can be realized in which the isolation of the guide rail fixation can be adjusted precisely to the frequencies to be absorbed.

The fixing element according to invention is a sound-absorbing and/or vibration-absorbing fixing element for elevator guide rails, comprising of an anchor rail which, by means of an absorption medium, is connected to an assembly, rail in which the anchor rail, designed to carry the elevator guide rail, is arranged as embedded in the absorption medium, in parallel to the longitudinal extension of the assembly rail. The longitudinal extension is largely parallel to the travel direction of the car in the elevator well. Between anchor rail and assembly rail, there is a distance of at least a slot, and this slot is filled with the absorption medium.

The absorption medium is a material characterized by a significantly higher absorption coefficient regarding sound and/or vibrations than that of steel or aluminium.

A slot is the space enclosed between two opposite L-profiles.

The advantage of the invention comprises in the fact that the anchor rail, vibration-isolated against the assembly rail, is loadable in all directions. This is achieved by the slot between anchor rail and assembly rail which is filled with the absorption medium. With a buffer or safety bolt, a failure of construction elements can be completely excluded. Only definable maximum shearing forces can then occur, which thus cannot cause a peeling of the rubber or absorption medium located between assembly rail and anchor rail. Forces in the direction of x-axis, y-axis, and z-axis as well as torsional moments can be absorbed and damped correspondingly, i.e. in relation to the profile cross-section in longitudinal direction (z-axis), and transversely in the directions of x-axis and y-axis.

Another advantage of the invention is the fact that the whole unit can be integrated both on or at a component and in a component.

An advantageous feature is the fact that both vulcanizable and castable materials can be used as rubber or absorption medium.

Another advantageous feature is the fact that there is a great range of different fixation options, with threads of different sizes and even with pin holes being possible.

Furthermore, the fixing element is favourably produced by cutting it according to needs from a long bar produced by the metre.

Furthermore, the fixing element is favourably cut and mounted in such a manner that its length is adjusted to a frequency to be absorbed.

Below, the invention is described in detail on the basis of embodiment examples depicted in the drawings. The following is shown:

FIG. 1t an elevator guide fixation according to invention, in schematic depiction

FIG. 2t the fixing element for elevator guide rails according to invention

Equal or equally acting constructive elements are assigned equal reference signs in all figures, even if they are not embodied as identical in each detail.

FIG. 1t shows a complete system. The elevator guide rails 30t are fixed by the bracket 40t at a wall of the well 20t. A fixing element 10t is inserted between wall of the well and bracket so as to absorb sound and vibrations.

FIG. 2t shows a fixing element 10t according to invention.

An assembly rail 1t comprises a bed plate 1.1t and two L-profiles 1.2t. The assembly rail 1t is filled with an absorption medium 5t which preferably comprises a castable plastic of elastomer or caoutchouc. An anchor rail 2t running in parallel to the assembly rail 1t is embedded in the absorption medium 5t. The anchor rail 2t also comprises a bed plate 2.1t and two L-profiles 2.2t, with the L-profiles of the assembly rail 1t and the anchor rail 2t being located opposite of each other, and the assembly rail 1t being filled with the absorption medium 5t. The absorption medium may completely fill the assembly rail 1t, but may also have cavities. Through the L-profiles, a positive connection between assembly rail and anchor rail is created.

The space enclosed between the two opposite L-profiles 1.2t and 2.2t (see FIG. 2t) forms a slot 6t.

This slot is dimensioned such that the vibrations caused by the guide rails 30t can not propagate to the wall of the well 20t.

In case of destruction of the absorption medium 5t, e.g. in case of fire, the guide rail 30t, securely bolted with anchor rail 2t and bracket 40t, can only insignificantly change its position, due to the low clearance of the anchor rail 2t in the assembly rail 1t, so that its function is not impaired.

The assembly rail 1t is typically equipped with fixation holes 3t up to M16 adapted to anchor bolts. The anchor rail 2t is embodied with several threaded holes 4t up to M12, to receive the guide rail fixings that are to be isolated.

Between these two rails 1t and 2t, comprising of pressed or rolled steel profiles or edged sheet metal profiles, the absorption medium 5t is, e.g., vulcanized rubber. The form of the two profiles 1t and 2t is chosen such that there is basically a positive connection and the slot 6t is created. The distance between the two profiles it and 2t amounts to about 3 mm-5 mm in an unloaded state and changes due to the load that may be caused by the guide shoe pressures and the settling of the building (pushing forces). In case of overload, actually a sound web can be created, which thus basically causes a changed acoustic behaviour. This can be evaluated as an indicator for a change of the situation in general, e.g. building contraction, which may be utilizable. Over the whole length of the unit, an optimal isolation can be adjusted to the forces to be absorbed.

The fixing element 10t can favourably be produced by the, metre/as bar material and can then be cut to length according to needs, hence be adapted exactly to the needs: the shorter, the softer/more absorbing—the longer, the stiffer/harder. Thus production is cost-effective.

Via the length but also via the number of fixing elements, an exact adjustment to the frequencies to be absorbed can be induced. The isolation can be adapted simply and precisely to the frequencies to be absorbed.

The longitudinal extension is defined as parallel to the travel direction of the elevator car. The lateral extension is defined as perpendicular to the travel direction of the elevator car.

According to use, lengths of 250 mm-500 mm are conceived. The longitudinal extension is significantly larger than the lateral extension. As widths of the complete units, 45 mm-55 mm are conceived, to ensure that the surface pressure p does not exceed or fall below the ideal values of 0.25<p<0.40 N/mm. The hardness of the absorption elements is to range in the interval of 50-70 SH A, so that, for system reasons, their deflection cannot exceed the value of 3 mm.

On principle, the interfering frequencies to be absorbed are measured. The following components exert their influence on the system, and their excitation frequencies (at VKN=1.0 m/s) are partly known:

| | Excitation frequency |
|---|---|
| Component | fₑᵣᵣ [min⁻¹] |
| hoisting motor (1000, 1500 and 1950 rpm at | 990, 1290/1309, 1850 |
| VKN = 1.00 m/s) | |
| worm-shaft (tooth frequency gear ratio) | 2970, 2580/2618, 5550 |
| traction sheave Ø 320 mm | 60 |
| suspension belt Ø 8 mm | 26112 |
| overspeed governor (GBPD), rope roller Ø | 95 |
| 200 mm | |
| overspeed governor (GBPD), governor | 764 |
| reelevatoring table (8 dugs) | |
| governor rope | 14688 |

The geometry or the hardness of the absorption elements is determined by measuring vibration or force in the direction of the x-axis, y-axis, and z-axis. In addition, the unit can be simulated by an FEM-analysis.

As a rule of thumb, the following holds: isolation area=v2×excitation frequency (rough formula). The natural frequency of the absorption element is to amount to at least 40% of the interfering frequency.

The natural frequency fe of the absorption element can, for instance, be calculated by means of the following approximation formula:

fe=½p*v(C/m)

where m represents the mass of the guide rail section between two consecutive fixing points, and C represents the linear stiffness of the fixing elements.

The length l of a fixing element to damp a certain excitation frequency can thus be clearly determined.

The length of the fixing elements can, e.g., be realized in a single operation/cut. The interfaces at both sides (to structure=building substance) are always embodied as identical.

The fixing elements can be manufactured on the basis of drawn but also of edged base profiles. But it is also possible to operate with stamped or lasered and then edged small parts.

It is also possible to use standard profiles which could then be mechanically reworked.

The fixing element 10t can be procured and processed by quite simple means. No expensive preformed isolators are needed. Customary rectangular profiles are completely sufficient.

According to a cost-saving preferred embodiment, the absorption medium comprises a castable plastic.

The advantages achieved with the invention are, on the one hand, the safety of the fixation of the components if influenced by fire or heat, and, on the other hand, the cost-effective production. The proposed castable plastic of elastomer/caoutchouc, e.g. polyurethane, connects well with sandblasted steel, is oil-proof, ozone-proof, and more age-resisting than the known fixing elements equipped with vulcanized rubber dampers. Besides, it is possible to realize different degrees of hardness, according to needs.

Other appropriate materials can be used as absorption medium, too.

1.5 Safety Gear

One of the most important and oldest requirements for the operation of elevator systems (in particular of passenger elevators) is the securing of the elevator car against falling.

In general, two types of safety gears are used today: the instantaneous safety gear and the progressive safety gear. The instantaneous safety gear is certified only up to a certain operation speed, whereas the progressive safety gear is appropriate for elevator systems with higher operation speeds.

Both types of safety gear are firmly connected with the elevator car and are usually located underneath the elevator car, without, however, being restricted to this position. Most often, they comprise two safety gear blocks with the safety gear elements (i.e. one safety gear block for each oft the two opposite guide rails), the transfer elements and the connecting elements for triggering the safety gear. Both types of safety gears are triggered by an overspeed governor/controller when a predetermined trigger speed is exceeded. Among the overspeed governors, two construction types are distinguished: the average-position controllers and the centrifugal governors.

The basic function of both types is often the same: in the process of clamping the car, wedges, rollers, or the like are moved upwards in the wedge chambers of the safety gear blocks that taper in upward direction. Thereby, the elevator car is clamped between the guide rails of the elevator well or slowed down up to a standstill. At the same time, the safety gear switch to interrupt control and hence stop the drive system is opened.

Safety gears can not only be used for the elevator car but also for the counterweight. For further details and variants, see EN 81-1: 1998, including CORRIGENDUM 09.99.

1.6 Landing Doors and Their Safety Devices

The landing doors can be embodied according to type and purpose of an elevator system. The different embodiments of landing doors can be classified into hinged doors (or single-panel and double-panel swing doors), folding doors, horizontal sliding doors, vertical sliding doors, and special constructions.

Door interlocks as important safety devices of elevator systems can be classified, on the one hand, according to the type of the doors to be locked and, on the other hand, according to the locking device used. For swing doors, for instance, door interlocks with sliding latches or with overhead flap locks are known, for horizontal sliding doors and for vertical sliding doors, there are, for instance, door interlocks with sliding latches or with hook latches.

Landing doors and their interlocks are mostly coupled with the elevator car or its car doors. For instance, a starting of the elevator car must not to be possible before both doors are closed and the respective landing door is completely locked.

1.7 Buffers

Particularly in elevator systems with higher operation speeds, several buffers are conceived in the area of the well pit, to prevent for instance an all too hard touchdown of the elevator car or, respectively, of the counterweight on the bottom of the well pit in case of a malfunction of the brake of the drive system or of overtravelling the operation end positions of the elevator car.

The buffers can be embodied either as springs (energy accumulation type) or as acting hydraulically (energy dissipation type).

The present invention is basically applicable in elevator systems with arbitrary types, numbers, and arrangements of buffers, but evidently also with different rope configurations and car tracks. Details are regulated for instance in EN 81-1: 1998, including CORRIGENDUM 09.99.

2. Drive System

Now, the structure of the above-mentioned drive system will be explained in more detail.

2.1 Drum Drive

At first, the structure of an elevator system with drum drive will be described in more detail, referring to FIG. 1.

The elevator system comprises an elevator car 10, movable upwards and downwards in an elevator well 12. In this movement, the elevator car 10 is guided along vertical guide rails (not depicted), for instance located at the walls of the elevator well 12. For moving the elevator car 10, a hoisting machine 14 is conceived, which, in particular, comprises a drum 18 driven by a motor 16 (motor and drum are preferably constructed as an integral unit), and a control (not depicted).

There is at least one suspension element 20 to carry the elevator car 10 and to transfer the forces from the hoisting machine 14 to the elevator car 10. In general, there are several suspension elements 20, running in parallel, as is indicated in FIG. 1. The one end of the suspension element(s) 20 is fixed above the elevator car 10, and the other end of the suspension element(s) 20 is coiled on the drum 18 of the hoisting machine 14. The movement of the elevator car 10 is produced just by coiling/uncoiling the suspension element(s) 20 on or off the drum 18 of the hoisting machine 14, through turning that drum 18. Suspension elements are preferably conceived as round, rope-type, sheathed and non-sheathed suspension elements. In a modified embodiment example, however, also non-round sheathed and non-sheathed suspension elements are conceived, the width of which is about the size of their height. Details regarding the employable suspension elements are found in other sections of this document, which are referred to in full.

A possible structure of a drum drive according to invention has been exemplarily explained on the basis of FIG. 1. Numerous further variants are conceivable.

Other than with the traction drive still to be explained below on the basis of FIGS. 2A and 2B, no counterweight is conceived in the embodiment of FIG. 1. Yet a counterweight is conceivable with a drum drive. The counterweight is then coupled, via a second suspension element, with the drum 18 of the hoisting machine 14, so as to reduce the required driving forces provided by the motor 16.

In the well pit of elevator well 12, preferably buffers for elevator car 10 are arranged.

While in FIG. 1, the suspension elements 20 are fixed at the upper side of elevator car 10, an under-wrapping of elevator car 10 by the suspension elements 20 is conceivable, too.

In FIG. 1, the hoisting machine 14 is arranged in a machine room 22 above the elevator well 12, with the machine room 22 being separated from the elevator well 12 by a well ceiling 24, a transverse girder, a web, or the like. Yet also elevator systems without a machine room are possible, and the hoisting machine 14 can alternatively also be arranged beside elevator well 12. For instance, the hoisting machine 14 can also be attached on the guide rails for the elevator car 10 and/or the counterweight.

2.2 Traction Drive

A(nother) possible structure of an elevator system according to invention with a traction drive is explained in more detail below, with reference to FIGS. 2A and 2B. There, equal or corresponding components are assigned the same reference numbers as with respect to the drum drive depicted in FIG. 1.

The elevator system comprises an elevator car 10, movable upwards and downwards in an elevator well 12. In its movement, the elevator car 10 is guided along vertical guide rails (not depicted), for instance located at the walls of elevator well 12. For moving the elevator car 10, a hoisting machine 14 is conceived, which, in particular, comprises a traction sheave/drive shaft 26 driven by a motor 16, and a control (not depicted). For carrying elevator car 10 and for transferring the forces from hoisting machine 14 to elevator car 10, a force transfer arrangement is conceived with at least one suspension element 20, the two free ends of which are fixed in or at the elevator well 12, at fixing points 28a and 28b. According to invention, for instance the suspension element end connection devices described elsewhere in this document can be employed.

From the first fixing point 28a (on the left in FIGS. 2A and 2B), the suspension element 20 at first runs downward along elevator well 12, then wraps a counterweight idler pulley 30, on which a counterweight 32 is suspended, and then runs back upwards towards the traction sheave 26 of the hoisting machine 14. After wrapping traction sheave 26, the suspension element 20 extends downward again and wraps the elevator car 10 which, to this end, comprises two car idler pulleys 34a and 34b at its bottom side, which are wrapped by the suspension element 20 by about 90° each. Subsequently, the suspension element 20 runs along elevator well 12 upwards again, to the second fixing point 28b.

The traction sheave 26 transfers the forces generated by motor 16 to the suspension element 20, which is coupled both with the elevator car 10 and with the counterweight 32. With a rotation of the traction sheave 26, the elevator car 10 and the counterweight 32 move upwards and downwards in opposite directions in elevator well 12, by means of suspension element 20. FIG. 2A shows the elevator car 10 in its lower operation end position (i.e., the counterweight 32 in its upper position), and FIG. 2B shows the elevator car 10 in its upper operation end position (i.e., the counterweight 32 in its lower position).

A crucial advantage of the traction drive is the fact that, due to the counterweight 32 conceived, relatively low motor moments of the hoisting machine 14 are needed. Although not depicted, the counterweight 32, too, is usually guided along vertical guide rails, for instance at the walls of the elevator well 12.

In the well pit 36 of the elevator well 12, usually buffers 38 for the elevator car 10 and buffers 40 for the counterweight 32 are arranged.

The structure of the traction drive has been exemplarily explained above, on the basis of FIGS. 2A and 2B, but numerous variants are conceivable.

While in FIGS. 2A and 2B, the elevator car 10 and the counterweight 32 are both arranged in the elevator well 12, it is possible, too, to conceive an own counterweight well for counterweight 32, which is separated from the elevator well 12 by a separation wall or the like.

Furthermore, in FIGS. 2A and 2B, two car idler pulleys 34a and 34b are conceived underneath the car floor of elevator car 10, at both sides, so that the elevator car 10 is under-wrapped by the suspension element 20. Alternatively, it is also possible to position the two car idler pulleys 34a and 34b at the upper side of elevator car 10 (in analogy to the counterweight idler pulley 30 in FIGS. 2A and 2B).

Analogously, the counterweight idler pulley 30 can also be positioned underneath the counterweight 32 instead of at its upper side, so that the suspension element 20 under-wraps the counterweight 32. Besides, the numbers of the idler pulleys are, of course, not restricted to the one counterweight idler pulley 30 and the two car idler pulleys 34a and 34b.

While in FIGS. 2A and 2B, respectively, only one suspension element 20 is depicted, it is usual, in particular for safety reasons, to conceive several suspension elements 20 of the same kind which run in parallel along the above-described courses.

In FIGS. 2A and 2B, a 1:2-suspension of elevator car 10 by the suspension element 20 is illustrated. But other arrangements are possible as well, like, for instance, a 1:4-suspension, a 1:8-suspension, etc., in which the area of suspension element 20 that is driven by hoisting machine 14 moves four times, eight times, etc. faster than elevator car 10. An elevator system with a 1:4-suspension is, for instance, described in detail in WO 2006/005215 A2 of the applicant, which document is therefore referred to in full with respect to structure and functioning of a 1:4-suspension.

In FIGS. 2A and 2B, the hoisting machine 14 is arranged in a machine room 22 above the elevator well 12, with the machine room 22 being separated from the elevator well 12 by a well ceiling 24, a transverse girder, a web, or the like. But also elevator systems without a machine room are known, and the hoisting machine 14 can alternatively also be arranged underneath the elevator well 12 or beside it. For instance, the hoisting machine 14 can also be fixed on the guide rails for elevator car 10 and/or counterweight 32.

The fixing points 28a, 28b for the free ends of suspension element 20 are not necessarily positioned in the upper area of elevator well 12. They can equally be arranged in the lower area of elevator well 12 or at arbitrary intermediate levels, with a correspondingly adapted course of the suspension element 20. Nor do the two fixing points 28a, 28b have to be arranged at the same (vertical) level. They can equally be conceived at different vertical level positions. Optionally, the free ends of suspension element 20 can also be fixed directly at counterweight 32 and at elevator car 10, in particular to realize a 1:1-suspension.

In elevator systems with higher operation speeds, generally so-called sub-suspension elements are used, too, apart from the above-described suspension elements 20. They are tensioned via a deflecting pulley located in well pit 36, between car floor and lower side of the counterweight 32. In that way, they are to balance the weights of the upper suspension elements 20 and prevent a “rebound” of elevator car 10 or counterweight 32 when counterweight 32 or elevator car 10 touch down or are clamped.

2.3 Further Dispositions

In a traction-sheave driven elevator system, at least one elevator car and its corresponding elevator components—like a hoisting machine or a counterweight—can be differently positioned in an elevator well or an appropriate elevator structure, like an open wall structure, an iron girder lattice work structure, or a box structure. The guide of the suspension elements and possibly the sub-suspension elements largely depends on the positioning of the said elevator components and the suspension ratio of the at least one elevator car. Accordingly, at least one traction sheave as well as further deflecting pulleys, car idler pulleys and counterweight idler pulleys can be positioned in the elevator well or the like to guide the suspension elements or sub-suspension elements between the fixing points of the suspension element ends and sub-suspension element ends. The arrangement of these and of further elevator components is also known by the notion of ‘disposition’. The individual components according to invention are described in detail elsewhere in this document.

A first group of dispositions relates to elevator systems with an elevator car that preferably is vertically traversable, in a well. In FIGS. 2A and 2B, a first embodiment example of an elevator system according to invention is depicted, with one elevator car that is suspended on a suspension element 20 at a suspension ratio of 2:1.

In patent specification EP 1 446 348 B1, further embodiment examples of elevator systems according to invention with belt-type suspension elements and one elevator car are represented in FIGS. 1-12 and the corresponding descriptions. There, different ways to suspend the elevator car, and different arrangements of elevator components—like hoisting machines, counterweights, elevator car guide rails, traction sheaves, deflecting pulleys, car idler pulleys and counterweight idler pulleys—as well as the guiding of the suspension elements and positioning of the suspension element ends are revealed. EP 1 446 348 B1 is referred to in full with respect to the embodiment of possible variants of the present invention.

Patent specification EP 1 400 477 B1 shows, in FIG. 6, another embodiment example of an elevator system according to invention, with alternative positioning of the hoisting machine and the traction sheaves above the elevator car. The corresponding revelation of EP 1 400 477 B1 is referred to in full with respect to the embodiment of possible variants of the present invention.

Patent specification EP 1 550 629 B1 discusses another special case of a suspension element guide. As is shown in FIG. 3 of EP 1 550 629 B1 and the corresponding description, a belt between two deflecting pulleys is arranged as twisted along its longitudinal axis so that a contoured suspension element surface, like, e.g., the V-ribs 80, can engage with complementarily contoured circumferential surfaces of both deflecting pulleys. The suspension elements according to invention described in detail elsewhere are particularly suited for such an application, as they are designed as twistable around their respective longitudinal axes. Accordingly, the mentioned revelation of EP 1 550 629 B1 is referred to in full with respect to the embodiment of possible variants of the present invention.

A second group of dispositions presents elevator systems with at least two elevator cars. These elevator cars are arranged vertically above one another and preferably are traversable independent of each other. To this end, preferably several separate hoisting machines are conceived, which are described in detail elsewhere in this document.

Patent specification EP 1 489 033 A1 describes, in FIGS. 1-4, two embodiment examples of an elevator system with two elevator cars arranged vertically above one another. FIGS. 1-4 refer in particular to the positioning of the hoisting machines, which can be overtravelled by the elevator cars. Furthermore, counterweights and different suspension ratios of the elevator cars and the assigned counterweights are described, which are particularly suitable for a practical embodiment of the present invention. Accordingly, the mentioned revelation of EP 1 489 033 A1 is referred to in full with respect to the embodiment of possible variants of the present invention.

In patent specification WO 2006/065241 A1, numerous further embodiment examples of belt-driven multi-car elevator systems with two elevator cars vertically arranged above each other are described. FIGS. 1-12 of this patent specification refer to different arrangements of hoisting machines, traction sheaves, deflecting pulleys, counterweight idler pulleys, and car idler pulleys, as well as to suspension variants for elevator cars and counterweights and corresponding suspension element guides. The said arrangements can all be favourably realized in conjunction with the suspension elements according to invention revealed elsewhere this document. Furthermore, the present revelation describes concrete embodiments of the individual elevator elements and components. Accordingly, the said revelation of WO 2006/065241 A1 is referred to in full with respect to the embodiment of possible variants of the present invention.

In FIGS. 1-9 of patent specification WO 2006/011634 A1, further embodiment examples of multi-car elevator systems are represented. Elevator systems with two and three elevator cars, with several arrangement variants of the above-mentioned elevator components are shown. FIG. 2, in particular, shows an arrangement of elevator car idler pulleys and counterweight idler pulleys which allows a non-conflicting vertical guiding of the suspension elements. The said arrangements can all be favourably realized in conjunction with the suspension elements according to invention revealed elsewhere in this document. Furthermore, the present revelation describes concrete embodiments of the individual elevator components and constituent parts. Accordingly, the mentioned revelation of WO 2006/011634 A1 is referred to in full with respect to the embodiment of possible variants of the present invention.

FIGS. 1-7 of patent specification WO 02/03801 A1 show another embodiment example of an elevator system with two elevator cars. In this embodiment example, in particular a hoisting machine arrangement above the upper elevator car is represented which, because of the narrow arrangement of the traction sheaves and deflecting pulleys, is not suited for traditional belt construction types. The said arrangements can all be favourably realized in conjunction with the suspension elements according to invention revealed elsewhere in this document. Furthermore, the present revelation describes concrete embodiments and further formations of the individual elevator components and constituent parts (drive, traction sheave/shaft, deflecting pulleys, etc.) mentioned in WO 02/03801 A1. Accordingly, the said revelation of WO 02/03801 A1 is referred to in full with respect to the embodiment of possible variants of the present invention.

Elevator System with Two Elevator Cars

FIGS. 1K and 2K show an embodiment example of an elevator system according to invention for at least two elevator cars, which have their own hoisting machines A1K, A2K, respectively, and are traversable in vertical direction independent of each other. The hoisting machines A1K, A2K are positioned in the well headroom above the elevator cars, close to first and second walls of the well. The first and second walls of the well are those opposite walls of the well which preferably do not comprise landing doors. The hoisting machines A1K, A2K are located at two different levels, so that the two suspension elements Z1K, Z2K, on which the elevator cars are suspended, are guidable in a non-conflicting way and without touching each other. In a preferred embodiment, the two suspension elements Z1K, Z2K are embodied as flat and belt-type suspension elements. In further preferred embodiments, the further suspension elements described in detail elsewhere in this document are conceived for suspending cars and counterweights.

The present invention provides the expert with numerous options to fix the hoisting machines A1K, A2K in the well. In particular, the expert can arrange the two hoisting machines A1K, A2K at the same level (besides, all hoisting machines or motors described in detail elsewhere in this document can be applied here). This variant is not shown, for mere reasons of space, since a side view of the hoisting machines A1K, A2K, then lying behind one another, is only of limited informative content. The top view of FIG. 4K, however, shows an arrangement of the hoisting machines A1K, A2K which does not only enable the already mentioned attachment of the hoisting machines A1K, A2K at different levels but also an attachment of the hoisting machines at the same level. Such an arrangement is of advantage above all if the spatial situation in the well headroom is rather narrow. In addition, in this variant, too, a non-conflicting guiding of the suspension elements Z1K, Z2K is ensured.

Favourably, the hoisting machines A1K, A2K are positioned on separate supporting steels each, which provides considerable freedom to align the hoisting machines A1K, A2K. In another favourable variant, the hoisting machines A1K, A2K are positioned at, on, or underneath a common supporting steel. Preferably, an upper hoisting machine A1K is placed on the upper side of the supporting steel and a lower hoisting machine A2K at the lower side of the supporting steel. This arrangement of the hoisting machines A1K, A2K is very compact and has the advantage to block as little space in the well headroom as possible.

Together with the traction sheave 1aK, 1bk for driving the suspension element Z1K, Z2K, the hoisting machine A1K, A2K forms a drive module. The traction sheave 1aK, 1bK is designed in such a manner that it is suited to receive single or several suspension elements Z1K, Z2K. The suspension elements Z1K, Z2K are preferably elastomer-sheathed belts according to invention, with unilaterally or bilaterally arranged ribs engaging into corresponding indentations on traction sheaves, and/or deflecting pulleys, or guide pulleys. Belt variants like smooth belts, traditional V-ribbed belts, and unilaterally or bilaterally toothed belts, with respective traction sheaves 2aK, 2bK can be used as well. In addition, also different types of ropes—like single ropes, double ropes, or multiple ropes—can be employed. The suspension elements comprise rope-type tension members made of steel wire or aramid fibres. Further variants and embodiment examples of suspension elements according to invention, the details of which are described elsewhere in this document, can be used as well.

The suspension element Z1K, Z2K in FIG. 1K is configured as sets of pulleys, where both at least one elevator car and at least one counterweight are suspended as a so-called “block”, in particular in a suspension element loop. The suspension element Z1K, Z2K is guided from a first fixing point 13aK, 13bK to a second fixing point 14aK, 14bK, being guided by several deflecting pulleys or car idler pulleys and counterweight idler pulleys 2aK, 2bK, 3aK, 3bK, 4aK, 4bK, 5aK, 5bK as well as by the traction sheave 1aK, 1bK in a basically torsion-free way.

In this configuration, the suspension element Z1K, Z2K is guided from a first fixing point 13aK, 13bK to the first deflecting pulley 2aK, 2bK such that the respective counterweight assigned to an elevator car is suspended on the counterweight idler pulleys 3aK, 3bK as block. The suspension element Z1K, Z2K hence runs from the first fixing point 13aK, 13bK along a first or second wall of the well downwards to the counterweight idler pulley 3aK, 3bK, wraps it from inside to outside by about 180°, and runs upwards again along a first or second wall of the well to the first deflecting pulley 2aK, 2bK. This first deflecting pulley 2aK, 2bK is located opposite the assigned traction sheave 1aK,1bK, close to second or first walls of the well. In the present embodiment, the first deflecting pulley 2aK, 2bK is a constituent part of a deflection module, which is connected to the drive module via rigid girder-type bars, forming an assembly group with it. The advantage of this embodiment lies in the reduction of the number of constituent parts and the respective simple assembly. In addition, drive modules and deflection modules can be shifted along the connection bars, so that a flexible longitudinal adaptation of the assembly group to the real dimensions of the well is possible. Another advantage is the modular design of the assembly group, which enables rather easy maintenance or replacement of the latter.

From the first deflecting pulley 2aK, 2bK, the suspension element Z1K, Z2K is then guided along the well ceiling to the traction sheave 1aK, 1bK and wraps this traction sheave 1aK, 1bK from inside to outside, with an angle of wrap of 90° to 180°. In its further course, the suspension element Z1K, Z2K, with first car idler pulleys 4aK, 4bK and second car idler pulleys 5aK, 5bK, creates a block suspension of the elevator car below the traction sheave 1aK, 1bK by being guided by the traction sheave 1aK, 1bK along first or second walls of the well downwards to first car idler pulleys 4aK, 4bK. The suspension element Z1K, Z2K wraps the car idler pulley 4aK, 4bK from outside to inside, with an angle of wrap of about 90°, and then runs horizontally to the second car idler pulley 5aK, 5bK. Finally, the suspension element Z1K, Z2K runs upwards along first or second walls of the well to the second fixing point 14aK, 14bK, after wrapping the second car idler pulley 5aK, 5bK from inside to outside, with an angle of wrap of about 90°.

An adjusting pulley 6aK, 6bK may optionally be part of the drive module. With this adjusting pulley 6aK, 6bK, the angle of wrap of the suspension element can be adjusted at the traction sheave 1aK, 1bK, i.e. be increased or reduced so as to transfer the desired tractive forces from the traction sheave 1aK, 1bK to the suspension element Z1K, Z2K.

From FIGS. 2K-4K it can be seen that the two axes formed by the hoisting machines A1K, A2K and the deflecting pulleys 2aK, 2bK are positioned at an acute angle to third and fourth walls of the well. The third and fourth walls of the well are those opposite walls in the well that have at least one landing door 8K. In that way, it is achieved that the assigned counterweights 12aK, 12bK, which are suspended as a block at the first fixing point 13aK, 13bK and on the first deflecting pulley 2aK, 2bK, are positioned between the elevator car guide rails 10K of the elevator car 7aK, 7bK and third and fourth walls of the well. The advantage of such an arrangement of the hoisting machine A1K, A2K and the deflecting pulley 2aK, 2bK lies in the space-saving and simple positioning of the counterweights 12aK, 12bK. Here, the counterweights 12aK, 12bK are guided by counterweight guide rails 11aK, 11bK.

In addition, the axis, formed by the two car idler pulleys 5aK, 5bK and 4aK, 4bK on which the elevator car 7aK, 7bK is suspended, has only a small distance to the elevator car guide rails 10K. In that way, the moments which are transferred by the suspension forces from the suspension element Z1K, Z2K via the elevator car 7aK, 7bK to the elevator car guide rails 10K are kept low.

FIGS. 3K and 4K show two variants of the above-described embodiment of the invention. In them, the suspension axes, formed by the car idler pulleys 4aK, 4bK and 5aK, 5bK on which the elevator car 7aK, 7bK is suspended, are located either both in front of the elevator car guide rails 10K, or one is located in front, one behind the elevator car guide rails 10K. While the expert may prefer one or the other solution, depending on the spatial situation in the well, the symmetric suspension mentioned first is of advantage with respect to the moment exerted by the elevator car 7aK, 7bK on the elevator car guide rail 10K. The distance from the suspension axis of the elevator car 7aK, 7bK to the elevator car guide rails 10K is kept minimal, thus reducing the moment, and in addition, the two antagonistically acting moments partly or completely offset each other. Experts knowing the above teaching will have further variants at their disposal, which are not shown here, like, e.g., an arrangement in which the position of the two suspension axes is chosen behind the elevator car guide rails.

The space-saving positioning of at least one counterweight 12aK, 12bK between the elevator car guide rails 10K and a third or fourth wall of the well can be realized thanks to a special arrangement of the elevator car door 9K. In normal operation of the elevator system, the elevator cars 7aK, 7bK are placed flush with the landing in a floor stop, and the elevator car doors 9K are opened together with the landing door 8K, so as to allow the transfer of passengers from the landing to the elevator car 7aK, 7bK. In the opening of the elevator car doors 9K, its sliding elements protrude into the well space and require a certain space of the well not to be used for other purposes. If the elevator car door 9K does not comprise—as usual—of two sliding elements but of at least four sliding elements that can be telescopically drawn in and out, less well space is required in the opening of the elevator car door 9K. Thanks to the shorter sliding elements, these sliding elements protrude less into the well space with open elevator car door 9K, thus leaving more space for the counterweights 12aK, 12bK or other objects in the well, like electric installations, sensors, safety device, or electric current box.

According to invention, the expert has several options to suspend the elevator cars 7aK, 7bK. According to available space in well headroom, well pit, or between the floors, one or the other suspension variant will be optimal.

FIGS. 5K and 6K show an arrangement with two elevator cars 7aK, 7bK in block suspension. In FIG. 5K, the upper elevator car 7aK is suspended as an over-slung car and elevator car 7bK as an under-slung car. This suspension variant is of advantage above all if a minimal approach between the elevator cars is desired—for instance if distances between floors are small. According to FIG. 6K, both elevator cars 7aK, 7bK are suspended as over-slung cars. This variant is of advantage if the spatial situation in the well pit is narrow. Besides, in both examples, the over-slung upper elevator car 7aK cannot be pushed into the well headroom by the suspension elements Z1K, Z2K.

FIGS. 7K and 8K show a suspension with a 1:1-suspension of the upper elevator car 7aK. The lower elevator car 7bK is suspended in block suspension according to invention. Depending on the spatial situation in the elevator well, the lower elevator car 7bK can be suspended as over-slung car or under-slung car.

FIG. 1KK shows another embodiment example of an elevator system according to invention, with at least two elevator cars 7aKK, 7bKK, which have their own hoisting machine A1KK, A2KK each and which are traversable in vertical direction independent of each other. The hoisting machines A1KK, A2KK are positioned laterally, at first and second walls of the well. The first and second walls of the well are those opposite walls of the well that have no landing doors. Here, the hoisting machines A1KK, A2KK are positioned alternately at opposite walls of the well, at two different well levels, with the distance in vertical direction usually amounting to at least the height of an elevator car. With their positions, the hoisting machines A1KK, A2KK define at the same time the highest reachable point of an assigned elevator car 7aKK, 7bKK, since in the shown embodiment the suspension element according to invention, preferably embodied as a belt-type one, can not elevator a suspension point of an elevator car 7aKK, 7bKK above the level of a traction sheave 1aKK, 1bKK. It is also conceivable, though, that two hoisting machines A1KK, A2KK of neighbouring elevator cars 7aKK, 7bKK are fixed at the same well level.

The hoisting machine A1KK, A2KK comprises a motor M1KK, M2KK, as is shown in FIG. 4KK—preferably an electric motor—, a traction sheave 1aKK, 1bKK, and optionally an adjusting pulley 13aKK, 13bKK allowing to adjust the angle of wrap of the suspension element Z1KK, Z2KK around the traction sheave 1aKK, 1bKK, and the horizontal distances of the suspension element Z1KK, Z2KK to the hoisting machine A1KK, A2KK, to the elevator car 7aKK, 7bKK, or to the counterweight 12aKK, 12bKK.

The motor M1KK, M2KK is positioned vertically above the traction sheave 1aKK, 1bKK. Thanks to this arrangement, the hoisting machine A1KK, A2KK can be positioned in the light projection of the counterweights 12aKK, 12bKK between the elevator cars 7aKK, 7bKK and first and second walls of the well. In that way, the hoisting machines A1KK, A2KK can be overtraveled by the elevator cars 7aKK, 7bKK and can thus be placed in a space of the well that is not used otherwise. Thereby, the space in the well headroom and/or the well pit is gained as compared to traditional elevators without machine rooms.

The motor M1KK, M2KK of the hoisting machine A1KK, A2KK drives the suspension element Z1KK, Z2KK, via traction sheave 1aKK, 1bKK. The traction sheave 1aKK, 1bKK is designed such that it is suited to receive one or more suspension elements Z1KK, Z2KK. The suspension elements Z1KK, Z2KK are preferably embodied as elastomer-sheathed belts or ropes with longitudinally oriented ribs on one or more sides of the suspension element, which engage in one or more indentations side-of-traction-sheave. Belt variants, like even, flat belts, traditional V-ribbed belts, and unilaterally or bilaterally toothed belts with respective traction sheaves 1aKK, 1bKK can be used as well. In addition, different types of ropes are utilizable, like single ropes, double ropes, or multiple ropes. The suspension elements particularly comprise rope-type tension members made of steel wire or aramid or vectran, which are completely sheathed by an elastomeric sheathing. Further variants of suspension elements that can be used according to invention are described in detail elsewhere in this document, and are favourably usable in the context of the dispositions described here.

The at least two elevator cars 7aKK, 7bKK and two counterweights 12aKK, 12bKK are suspended on suspension elements Z1KK, Z2KK as a “block”. There, the elevator cars have at least one first and one second car idler pulley 2aKK, 2bKK, 3aKK, 3bKK, which are fixed in a lower area of the elevator cars 7aKK, 7bKK. These car idler pulleys 2aKK, 2bKK, 3aKK, 3bKK have one or more grooves at their outer circumference, able to sectionally receive one or more suspension elements Z1KK, Z2KK and to this end shaped complementarily to the chosen suspension element. The car idler pulleys 2aKK, 2bKK, 3aKK, 3bKK are hence suited to guide suspension elements Z1KK, Z2KK and are brought into contact with the latter. The elevator cars 7aKK, 7bKK are hence preferably suspended as under-slung cars.

In an optional embodiment, the car idler pulleys 2aKK, 2bKK, 3aKK, 3bKK are located in the upper area of the elevator car 7aKK, 7bKK. According to the above-given description, the elevator car 7aKK, 7bKK is suspended as over-slung car.

In the upper area of the counterweights 12aKK, 12bKK, there is a counterweight idler pulley 4aKK, 4bKK which, in analogy to the car idler pulleys 2aKK, 2bKK, 3aKK, 3bKK, is also suited to receive one or more suspension elements Z1KK, Z2KK. Accordingly, the counterweight 12aKK, 12bKK is preferably suspended on the third counterweight idler pulley 4aKK, 4bKK, as over-slung counterweight, underneath the assigned hoisting machine A1KK, A2KK. The afore-mentioned counterweight idler pulleys, car idler pulleys, traction sheaves or drive shafts—are, like other deflecting pulleys and guide pulleys of the suspension element—to be understood in analogy to the deflecting pulleys, guide pulleys, and traction sheaves described in detail elsewhere in this document. So, the features described in another section of the document can be used for a specification or modification of the present embodiment examples. The same also holds, on principle, for all other elevator components, like drive unit, fixing points, monitoring sensors, etc.

The suspension element Z1KK, Z2KK is guided from a first fixing point 5aKK, 5bKK to a second fixing point 6aKK, 6bKK, via several car idler pulleys or counterweight idler pulleys 2aKK, 2bKK, 3aKK, 3bKK, 4aKK, 4bKK and the traction sheave 1aKK, 1bKK, from the first wall of the well to the second wall of the well. Here, the first fixing point 5aKK, 5bKK is located opposite the assigned hoisting machine A1KK, A2KK, at about the same well level, near a first or second wall of the well. The second fixing point 6aKK, 6bKK is located near the assigned hoisting machine A1KK, A2KK, at an opposite second or first wall of the well.

From the first fixing point 5aKK, 5bKK, the suspension element Z1KK, Z2KK runs along a first or second wall of the well downwards to the second car idler pulley 3aKK, 3bKK, wraps it from outside to inside by about 90°, and then runs to the first car idler pulley 2aKK, 2bKK. The suspension element Z1KK, Z2KK wraps this first car idler pulley 2aKK, 2bKK from inside to outside, again by about 90°, and is then guided upwards along the elevator car 7aKK, 7bKK to the traction sheave 1aKK, 1bKK, and wraps the latter from inside to outside by about 150°. According to adjustment of the optional adjusting pulley 13aKK, 13bKK, the angle of wrap may range from 90° to 180°. Subsequently, the suspension element Z1KK, Z2KK is guided along a second or first wall of the well downwards to the counterweight idler pulley 4aKK, 4bKK, wraps the latter from outside to inside, by about 180°, and is guided upwards again along a second or first wall of the well, to the second fixing point 6aKK, 6bKK.

An adjusting pulley 13aKK, 13bKK is an optional part of the hoisting machine A1KK, A2KK. With this adjusting pulley 13aKK, 13bKK, the angle of wrap of the suspension element at the traction sheave 1aKK, 1bKK can be adjusted, i.e. be increased or reduced so as to transfer the desired tractive forces from the traction sheave 1aKK, 1bKK to the suspension element Z1KK, Z2KK. Moreover, according to the distance of the adjusting pulley 13aKK, 13bKK to the traction sheave 1aKK, 1bKK, the distances of the suspension element Z1KK, Z2KK to the hoisting machine A1KK, A2KK, to the counterweight 12aKK, 12bKK, or to the elevator car 7aKK, 7bKK can be adjusted. In that way, a non-conflicting guide of the suspension elements Z1KK, Z2KK in the well between the traction sheave 1aKK, 1bKK and the first car idler pulley 2aKK, 2bKK is ensured.

According to FIG. 2KK, the elevator cars 7aKK, 7bKK are guided by two elevator car guide rails 10.1KK, 10.2KK. The two elevator car guide rails 10.1KK, 10.2KK form a connection plane VKK, which approximately runs through the respective barycentres SKK of the two elevator cars 7aKK, 7bKK. In the embodiment represented, the elevator cars 7aKK, 7bKK are suspended eccentrically. In this suspension arrangement, the suspension elements Z1KK, Z2KK and the assigned guide elements—like car idler pulleys or counterweight idler pulleys 2aKK, 2bKK, 3aKK, 3bKK, 4aKK, 4bKK, and traction sheaves 1aKK, 1bKK—are positioned at one side of the connection plane VKK, with the counterweight idler pulleys 4aKK, 4bKK not being represented in FIG. 2KK, for reasons of clarity. The above-mentioned components which are assigned to an elevator car 7aKK, 7bKK thus lie either between third walls of the well and the connection plane VKK or between fourth walls of the well and the connection plane VKK. Third or fourth walls of the well denote walls of the well that comprise at least one landing door 9KK, as well as the respective opposite walls of the well. Favourably, the distance yKK of the suspension elements Z1KK, Z2KK and the connection plane VKK is approximately equal. The suspension elements Z1KK, Z2KK of an elevator car 7aKK, 7bKK lie alternately on the one side or the other side of the connection plane VKK. So, the moments generated by the eccentric suspension of the elevator cars 7aKK, 7bKK act antagonistically. With equal rated loads of the elevator cars 7aKK, 7bKK, and with an even number of elevator cars 7aKK, 7bKK, the moments acting on the guide rails 10.1KK, 10.2KK basically offset each other.

The counterweights 12aKK, 12bKK are each guided by two counterweight guide rails 11a.1KK, 11a.2KK, 11b.1KK, 11b.2KK. The counterweights 12aKK, 12bKK are positioned at opposite walls of the well, between the elevator car guide rails 10.1KK, 10.2KK and first or second walls of the well. Favourably, the counterweights are suspended in their barycentres SKK on the suspension elements Z1KK, Z2KK. Since the elevator cars 7aKK, 7bKK are suspended eccentrically, the counterweights 12aKK, 12bKK are located in a laterally shifted position near third and fourth walls of the well.

The rotation axes of the traction sheaves 1aKK, 1bKK and the car idler pulleys and counterweight idler pulleys 2aKK, 2bKK, 3aKK, 3bKK, 4aKK, 4bKK are located in parallel to first or second walls of the well. In the represented embodiment, the above-mentioned components are embodied such that they can receive four suspension elements Z1KK, Z2KK arranged in parallel to each other, guide them, and—as regards the traction sheave 1aKK, 1bKK—also drive them. To be able to receive the suspension elements Z1KK, Z2KK, the car idler pulleys and counterweight idler pulleys 2aKK, 2bKK, 3aKK, 3bKK, 4aKK, 4bKK and traction sheaves 1aKK, 1bKK have four especially designed contact surfaces, which in the case of V-ribbed belts or ropes are for instance embodied as grooves, or in the case of belts e.g. as shaped surfaces or toothing, or in the case of a contact surface designed as flat are equipped with guide shoulders. These four contact surfaces can either be applied on a joint roll-type base body or respectively on four individual rollers with a joint rotation axis.

In modified embodiment examples, one to four or more individual idler pulleys or guide pulleys or deflecting pulleys are arranged, with or without distance to each other, on a joint rotation axis. Here, according to embodiment, each pulley can receive one to four suspension elements Z1KK, Z2KK, and even more if need be.

In normal operation of the elevator, the elevator cars 7aKK, 7bKK, in a floor stop, are placed flush with the landing, and the elevator car doors 8KK are opened together with the landing doors 9KK to allow the transfer of passengers from landing to elevator car 7aKK, 7bKK and vice versa. FIG. 3KK shows an alternative suspension arrangement with centrically suspended elevator cars 7aKK, 7bKK. Here, the suspension elements Z1KK, Z2KK are guided by the car idler pulleys and counterweight idler pulleys 2aKK, 2bKK, 3aKK, 3bKK, 4aKK, 4bKK and traction sheaves 1aKK, 1bKK, on both sides of the connection plane VKK. Favourably, the suspension is here arranged symmetrically with respect to the connection plane VKK. Since in this case the suspension barycentre is basically identical with the barycentre of the elevator car 7aKK, 7bKK, no additional moments act on the elevator car guide rails 10.1KK, 10.2KK.

With this centric suspension of the elevator car 7aKK, 7bKK, the assigned car idler pulleys 2a.1KK, 2a.2KK, 2b.1KK, 2b.2KK, 3a.1KK, 3a.2KK, 3b.1KK, 3b.2KK and 1b.1KK, 1b.2KK preferably comprise at least two pulleys, arranged on the left and on the right of the connection plane VKK. The counterweight idler pulleys 4aKK, 4bKK of the counterweights 12aKK, 12bKK, too, preferably comprise at least two pulleys, preferably arranged symmetrically on the left and on the right of the connection plane VKK, but not depicted in FIG. 3KK, for reasons of clarity. In the present example, the car idler pulleys and counterweight idler pulleys 2aKK, 3aKK, 4aKK and the traction sheave 1aKK assigned to the upper elevator car 7aKK are arranged at a first distance xKK to the connection plane VKK. The car idler pulleys and counterweight idler pulleys 2bKK, 3bKK, 4bKK and the traction sheave 1bKK assigned to the lower elevator car 7bKK are arranged at a second distance XKK to the connection plane VKK, with the first distance xKK being smaller than the second distance XKK. In that way, a non-conflicting guide of the suspension elements Z1KK, Z2KK is ensured with centric suspension of the elevator cars 7aKK, 7bKK.

Here, too, the counterweights 12aKK, 12bKK are favourably suspended in their barycentres on the suspension elements Z1KK, Z2KK, between the elevator car guide rails 10.1KK, 10.2KK and first or second walls of the well. Since the elevator cars 7aKK, 7bKK are now suspended centrically, the counterweights 12aKK, 12bKK, too, are preferably positioned in a central area of the first and second walls of the well. Thanks to this central position of the counterweights 12aKK, 12bKK, the clear space between the lateral ends of the counterweights 12aKK, 12bKK and third and fourth walls of the well is increased. In that way, leeway for designing the counterweights 12aKK, 12bKK is gained. So, for instance, a narrower and broader counterweight 12aKK, 12bKK can be employed to make better use of the space. With given well cross-section, the elevator car 7aKK, 7bKK gains in width, or with given size of the elevator car, the well cross-section can be reduced.

FIG. 4KK shows a hoisting machine A1KK, fixed on a transverse girder 19KK, which is fixed at an elevator car guide rail 10.1KK and/or at the counterweight guide rails 11a.1KK, 11a.2KK and/or at a wall of the well. Furthermore, the following can be seen in FIG. 4KK:
the motor M1KK, with traction sheave 1aKK preferably arranged vertically below it, and the optional adjusting pulley 13aKK
the counterweight idler pulley 4aKK, on which the counterweight 12aKK is suspended, and
in the background the elevator car 7aKK

The example shown here is mirror-inverted with respect to the connection plane VKK in comparison to the arrangement of FIG. 2KK.

Optionally, the hoisting machines A1KK, A2KK can also be fixed directly at the walls of the well. In this embodiment example, one or more transverse girders 19KK can be dispensed with if need be.

Another embodiment example according to invention shows an elevator system comprising two elevator cars arranged vertically above one another, with a joint counterweight.

As to FIGS. 1AR, 1BR, 1CR, 2R, 3R and the related descriptions, generally the following holds:

The depictions are not to be understood as true to scale. Equal or similar or equally or similarly acting constructive elements are assigned equal reference signs in all figures. Information like ‘right’, ‘left’, ‘above’, ‘below’ refers to the respective arrangement in the figures. Deflecting pulleys, deflecting auxiliary pulleys, and counterweight idler pulleys are generally given in sections vertically to their rotation axes and represented as black circle areas. Traction sheaves, in sections vertically to their rotation axes, are generally represented as circle perimeters. Those parts of suspension elements or suspension element strands or sub-suspension elements or sub-suspension element strands that are located between one of the elevator cars and an upper counterweight idler pulley are represented with other lines than those parts of the suspension element strands or sub-suspension element strands that are located between the other elevator car K2R and the upper counterweight idler pulley. Besides, with each suspension element or sub-suspension element, it is indicated by a usual diameter sign and by one of the FIG. 1 or 2 whether the depiction refers to one or two suspension elements or sub-suspension elements in that respective case. Moreover, it is indicated what type of suspension element strands or sub-suspension element strands is referred to.

FIGS. 1AR, 1BR, and 1CR show a first embodiment example of an elevator system 10R according to invention. They represent schematic side views or sections, on the basis of which the basic elements of the invention are explained.

A lower elevator car K1R and an upper elevator car K2R of the new elevator system 10R are positioned one above the other in a joint elevator well 11R. In elevator well 11R, there is furthermore a joint counterweight 12R. The counterweight 12R is suspended on an upper counterweight idler pulley 12.1R, in a so-called 2:1-suspension. The notion of ‘counterweight idler pulley’ is also to refer to a pulley arrangement with more than one pulley. By v1R, a speed of the lower elevator car K1R is indicated, by v2R a speed of the upper elevator car K2R, and by v3R a speed of the counterweight 12R.

In an upper area of the elevator well 11R, or above the track of the elevator cars, there are drive elements to drive the elevator cars. The drive elements include a first hoisting machine for the lower elevator car K1R and a second hoisting machine for the upper elevator car K2R. In modified embodiment examples, further—i.e. more than two—elevator cars in the elevator well are conceived.

The first hoisting machine, which is assigned to the lower elevator car K1R, comprises a first motor M.A1R and a second motor M.B1R. The motors M.A1R and M.B1R are preferably operated in a synchronized way (e.g. electrically or electronically). The first motor M.A1R is coupled with a first traction sheave 13.A1R. The second motor M.B1R is coupled with a second traction sheave 13.B1R. In modified embodiment examples, the motors are embodied as mechanically couplable or de-couplable via gears and/or freewheels.

The second hoisting machine, which is assigned to the upper elevator car K2R, comprises a third motor M.AB2R. The third motor M.AB2R is coupled via a joint shaft with a third traction sheave 13.A2R and a fourth traction sheave 13.B2R. That is, in this embodiment a joint motor M.AB2R is conceived to drive two traction sheaves 13.A2R and 13.B2R. But two separate motors can be used here as well.

Furthermore, the elevator system 10R according to invention described here comprises a flexible suspension element TAR, TBR, which basically comprises a first suspension element strand TAR and a second suspension element strand TBR. The suspension element strands TAR and TBR have a first end and a second end each, at which they are fixed.

Favourably, each of the suspension element strands TAR and TBR is formed by two or more suspension element components arranged in parallel, for instance by several identical components described elsewhere in this document, in particular four to eight elastomer-sheathed belts, or four to eight ropes. But each suspension element strand TAR and TBR may also comprise only one or two belts or one or two ropes. The (interior plastic-sheathed or rubber-sheathed) tension members of these suspension element strands TAR and TBR are favourably produced of stranded steel wires, aramid fibres, or vectran fibres and/or embodied according to further alternative embodiment examples described elsewhere this document.

In the present embodiment example, the first traction sheave 13.A1R and the second traction sheave 13.A2R are assigned to the first suspension element strand TAR, while the third traction sheave 13.B1R and the fourth traction sheave 13.B2R are assigned to the second suspension element strand TBR. The traction sheaves are preferably embodied according to the traction sheaves or drive shafts described elsewhere in this document, and experts may choose the suitable variant according to their needs and according to the technical requirements.

The motor M.A1R and the traction sheave 13.A1R for the lower elevator car K1R are arranged at a first level. The motor M.B1R and the traction sheave 13.B1R, equally for the lower elevator car K1R, are arranged at a second level. The motor M.AB2R and the traction sheaves 13.A2R and 13.B2R for the upper elevator car K2R are equally arranged at the second level. The second level is below the first level. This arrangement is of advantage, but, of course, not compulsory. Details regarding the traction sheave/motor configuration according to invention are described elsewhere in this document, so that experts may be referred to these descriptions.

The elevator car 10R may also comprise four motors, in which case an own motor can be assigned to each traction sheave or to each end of the suspension element strands, respectively. It is of advantage for a desired even traction to assign an own traction sheave to each end of the suspension element strands, so as to be able to transfer the driving forces in a particularly even way to the suspension element strands TAR, TBR.

Furthermore, the elevator system 10R according to invention comprises several deflecting pulleys—in the present example a first deflecting pulley 14.A1R, a second deflecting pulley 14.A2R for the first suspension element strand TAR, a third deflecting pulley 14.B1R for the second suspension element strand TBR, as well as a fourth deflecting pulley 14.A3R, 14.B2R for both suspension element strands TAR and TBR. The deflecting pulleys are described in detail elsewhere in this document.

The lower elevator car K1R, in its lower elevator car area B1R, comprises a first fixing point 15.1R and a second fixing point 15.11R, which are arranged laterally at opposite sides of the elevator car K1R.

The upper elevator car K2R, in its upper elevator car area, comprises a third fixing point 15.2R and a fourth fixing point 15.22R, which preferably are at least approximately arranged centrically. In the present embodiment example, the fixing points may actually coincide at 15.2R/15.22R. In FIG. 1AR, they are represented without horizontal distance, for reasons of clarity of the drawing.

The suspension element strands TAR, TBR are fixed at the lateral fixing points 15.1R, 15.11R of the lower elevator car K1R as well as at the central fixing point 15.2R/15.22R of the upper elevator car K2R. Each of the elevator cars K1R and K2R is thus suspended on both suspension element strands TAR and TBR. The elevator cars K1R and K2R are suspended on the suspension element strands TAR and TBR in a so-called 1:1-suspension, as will be described in detail below.

The first suspension element strand TAR extends upwards from the first fixing point 15.1R at the lower elevator car K1R, where it is fixed with its first end, and then immediately to the first traction sheave 13.A1R. From the traction sheave 13.A1R, the first suspension element strand TAR extends downwards, for instance via a first deflecting pulley 14.A1R and via a second deflecting pulley 14.A2R, to the upper counterweight idler pulley 12.1R. From the upper counterweight idler pulley 12.1R, the first suspension element strand TAR is guided further upwards and then, via a deflecting pulley 14.A3R, to the third traction sheave 13.A2R. From the third traction sheave 13.A2R, the first suspension element strand TAR is guided immediately to the central fixing point 15.2R/15.22R at the upper elevator car K2R, where it is fixed with its second end. Fixing points and suspension element end connections according to invention and utilizable here are described in other sections of this document, which are hence referred to.

The second suspension element strand TBR extends upwards from the second fixing point 15.11R at the lower elevator car K1R and then immediately to the second traction sheave 13.B1R. From the latter, the second suspension element strand TBR extends downwards, via the fourth deflecting pulley 14.B1R, to the upper counterweight idler pulley 12.1R. From the latter, the second suspension element strand TBR runs upwards, via the deflecting pulley 14.B2R, farther to the fourth traction sheave 13.B2R, and from there immediately to the central fixing point 15.2R/15.22R at the upper elevator car K2R. On their way immediately to or from the upper counterweight idler pulley 12.1R, the two suspension element strands TAR and TBR run in parallel.

FIG. 1CR shows how the force transfer for elevator car K1R takes place through the suspension element strands TAR and TBR. FIG. 1DR shows an alternative to that.

FIGS. 1AR, 2R, and 3R show a favourable arrangement of the traction sheaves 13.A1R, 13.B1R, 13.A2R, 13.B2R in the uppermost area of elevator well 11R. The traction sheaves 13.A1R, 13.B1R, 13.A2R, 13.B2R are arranged vertically, i.e. with horizontal axes, as can be seen in FIG. 3R. Further embodiment examples and modifications of traction sheaves or drive shafts are described elsewhere in this document and can be used here.

A guide device to vertically guide the elevator cars K1R and K2R in elevator well 11R comprises two stationary guide rails 19.1R and 19.11R which extend vertically along opposite sides of the elevator well 11R and are fixed at the latter in a manner not depicted. The guide device, moreover, comprises guide bodies that are not depicted. At each elevator car K1R and K2R, bilaterally, preferably two guide bodies in vertically aligned arrangement are attached, which act jointly with the respective guide rails 19.1R or 19.11R. The guide bodies at one side of the elevator cars K1R, K2R are preferably positioned at a height distance as large as possible. The guide rails 19.1R and 19.11R are arranged as adjacent, at a right angle, to counterweight 12R.

Another guide device with two guide rails 19.2R, 19.22R is arranged in the area of the narrow sides of counterweight 12R and serves to guide the counterweight 12R.

The first suspension element strand TAR runs along the same side of elevator well 11R as the guide rail 19.1R, starting from the first fixing point 15.1R at the lower elevator car K1R. The second suspension element strand TBR runs along the same side of elevator well 11R as the guide rail 19.11R, starting from the second fixing point 15.11R at the lower elevator car K1R.

FIG. 1CR shows the same lower elevator car 1KR, but with the fixing points 15.1R and 15.11R in the upper area of the elevator car. Here, too, the fixing point configurations according to invention are applicable, as they are described elsewhere in this document.

FIG. 2R shows another embodiment example of the invention. This comprises all constructive components described with reference to FIGS. 1AR, 1BR, and 1CR, as well as an additional device to better tension the suspension element strands TAR and TBR and to better guide the elevator cars K1R and K2R as well as the counterweight 12R.

To this end, the elevator system 10R according to FIG. 2R comprises a lower counterweight idler pulley 12.2R, which is suspended on counterweight 12R. At the lower area B1R of the lower elevator car K1R there are, centrically positioned, a fifth fixing point 15.3R and a sixth fixing point 15.33R, which actually coincide at 15.3R/15.33R.

At the lower area B2R of the upper elevator car K2R there are, laterally positioned at opposite sides of the elevator car K2R, a seventh fixing point 15.4R and an eighth fixing point 15.44R. In the present embodiment example, the seventh fixing point 15.4R and the eighth fixing point 15.44R are positioned near those sides of the elevator well 11R on which the guide rails 19.1R, 19.11R run.

Alternatively, the seventh and eighth fixing points 15.4R, 15.44R are positioned in the upper area of the elevator car K2R.

A flexible sub-suspension element essentially comprises a first sub-suspension element strand SAR and a second sub-suspension element strand SBR. Each of the sub-suspension element strands SAR and SBR has a first end and a second end. Favourably, each one of the sub-suspension element strands SAR, SBR is formed by two or more parallel sub-suspension element components, for instance by several, in particular four to eight, suspension element components according to invention described elsewhere in this document. But each sub-suspension element strand SAR, SBR can also comprise only one belt or rope, or combinations of the suspension elements according to invention. The tension members of these sub-suspension element strands SAR, SBR are favourably made of steel, aramid, or vectran and/or manufactured as described in detail elsewhere in this document.

The first and second fixing points 15.1R, 15.11R, as well as the fifth and sixth fixing points 15.3R, 15.33R are jointly located in the lower area B1R of elevator car K1R, or respectively in a lower area B1R or an upper area of elevator car K1R. If the first and second fixing points 15.1R, 15.11R are located in the upper area of the elevator car K1R, this has the advantage of shorter suspension element strands TAR, TBR being needed. If the first and second fixing points 15.1R, 15.11R are located jointly with the fifth and sixth fixing points 15.3R, 15.33R in the lower area B1R of the elevator car K1R, this has the advantage of a simple construction of the elevator car K1R. The force-transferring structure can then comprise a simple common girder element at which several fixing points are arranged.

An analogue argumentation also holds for the third, fourth, seventh, and eighth fixing points 15.2R, 15.22R, 15.4R, 15.44R, which are located either jointly in the upper area of the elevator car K2R, or in an upper area or lower area B2R of elevator car K2R each. If the seventh and eighth fixing points 15.4R, 15.44R are located in the lower area B2R of elevator car K2R, this has the advantage of shorter sub-suspension element strands SAR, SBR being needed. If the seventh and eighth fixing points 15.4R, 15.44R are located jointly with the third and fourth fixing points 15.2R, 15.22R in the upper area of the elevator car K2R, this has the advantage of a simple construction of elevator car K2R. The force-transferring structure can then comprise a simple common girder element at which several or all fixing points can be fixed.

Furthermore, in the lower area of elevator well 11R, several deflecting pulleys are arranged, the geometry and production of which is described elsewhere in this document, in particular in analogy to other deflecting pulleys and/or guide pulleys. Two tension pulleys 16.A1R, 16.A2R are conceived for the first sub-suspension element strand SAR, and two tension pulleys 16.B1R, 16.B2R for the second sub-suspension element strand SBR. In addition, two auxiliary pulleys 17.A1R and 17.A2R are conceived for the first sub-suspension element strand SAR, and two auxiliary pulleys 17.B1R and 17.B2R for the second sub-suspension element strand SBR, the geometry and production of which is described elsewhere in this document, in particular in analogy to deflecting pulleys and/or guide pulleys. Besides, a pre-tension arrangement 16R is conceived.

The first sub-suspension element strand SAR is fixed with its first end at the central fixing point 15.3R/15.33R of the lower elevator car K1R and from there runs around the tension pulleys 16.A1R and 16.A2R to the lower counterweight idler pulley 12.2R. From the lower counterweight idler pulley 12.2R, the first sub-suspension element strand SAR runs, via deflecting pulleys 17.A1R and 17.A2R, to the seventh fixing point 15.4R at the upper elevator car K2R, where it is fixed with its second end.

The second sub-suspension element strand SBR is fixed with its first end at the central fixing point 15.3R/15.33R of the lower elevator car K1R and from there runs around the tension pulleys 16.B1R and 16.B2R to the lower counterweight idler pulley 12.2R. From the lower counterweight idler pulley 12.2R, the second sub-suspension element strand SBR runs, via deflecting pulleys 17.B1R and 17.B2R, to the eighth fixing point 15.44R at the upper elevator car K2R, where it is fixed with its second end.

FIG. 3R is a magnified representation of FIG. 1BR, in which details are shown which in FIG. 1CR do not or not clearly appear. In particular, a first vertical central plane E1R is depicted, a second vertical central plane E2R, a first vertical diagonal plane D1R, and a second vertical diagonal plane D2R.

The first fixing point 15.1R and the second fixing point 15.11R are located in the lower area of the elevator car, at opposite sides of the lower elevator car K1R, at opposite sides of the first vertical central plane E1R, and at opposite sides of the second vertical central plane E2R, so as to ensure a basically central-symmetric, i.e. balanced, force transfer to elevator car K1R (not recognizable in FIG. 3R). This balanced force transfer has the advantage that there is less friction and wear at the guide rails. Besides, the appearance of audible and perceptible shocks during travel is significantly reduced.

The fixing point 15.2R/15.22R is located centrally at the upper elevator car area of the upper elevator car K2R, so that here, too, a centric force transfer takes place (not recognizable in FIG. 3R).

Since both elevator cars K1R, K2R are connected via joint suspension elements TAR, TBR to only one counterweight 12R, and due to the special type of the 1:1-suspension of the elevator cars K1R, K2R and the 2:1-suspension of the counterweight 12R, different speeds v1R, v2R, and v3R result according to travel situation. If elevator car K1R moves upwards at speed v1R while elevator car K2R is resting, the counterweight 12R moves downwards at speed v3R=v1R/2. If elevator car K2R moves downwards at speed v2R while elevator car K1R is resting, the counterweight 12R moves upwards at speed v3R=v2R/2. If the elevator cars K1R, K2R move towards each other at equal speed v1R=v2R, then v3R=0. If the elevator cars K1R, K2R move downwards at equal speed v1R=v2R, the counterweight 12R moves upwards at speed v3R=v1R=v2R.

FIGS. 1AX, 1BX, and 1CX show another embodiment example of an elevator system 10X according to invention. They present schematic side views or sections on the basis of which the basic elements of the invention are explained.

A lower elevator car K1X and an upper elevator car K2X of the new elevator system 10X are located above one another in a common elevator well 11X, where they can move independent of each other.

In addition, a common counterweight 12X is located in the elevator well 11X. The counterweight 12X is suspended on an upper counterweight idler pulley 12.1X, in a so-called 2:1-suspension. The notion of counterweight idler pulley shall also denote a pulley arrangement with more than one pulley. A speed of the lower elevator car K1X is indicated by the variable v1X, a speed of the upper elevator car K2X by the variable v2X, and a speed of the counterweight 12X by the variable v3X.

In the upper area of the elevator well 11X, a first hoisting machine M1X for the lower elevator car K1X is located, and a second hoisting machine M2X for the upper elevator car K2X. A first traction sheave 13.1X is coupled with the first hoisting machine M1X, and a second traction sheave 13.2X is coupled with the second hoisting machine M2X. Details regarding hoisting machines according to invention that may also be used here are described in other sections of this document, which are hence referred to.

Furthermore, a first deflecting pulley 14.1X is assigned to the lower elevator car K1X, and a second deflecting pulley 14.2X to the upper elevator car K2X, which are both located in the upper area of elevator well 11X. Details regarding deflecting pulleys and/or guide pulleys according to invention that may favourably be used here, too, are described in other sections of this document, which are hence referred to.

The cars have so-called fixing points at which whole suspension element units or suspension element strands are fixed side-of-car. The lower elevator car K1X has, in its upper area, a first fixing point 15.1X on the left and a second fixing point 15.11X on the right. The upper elevator car K2X has, also in its upper area, a third fixing point 15.2X on the right and a fourth fixing point 15.22X on the left. The elevator cars K1X and K2X are suspended in a so-called 1:1-suspension on limp suspension element units TAX, TBX, as is described in detail below.

The suspension element units essentially comprise a first suspension element strand TAX and a second suspension element strand TBX, each of which has a first and a second end. At the fixing points 15.1X, 15.11X, 15.2X, 15.22X, the suspension element strands TAX, TBX are fixed at the elevator cars K1X or K2X in such a manner that each of the elevator cars K1X and K2X is suspended on each of the suspension element strands TAX and TBX. Favourably, each of the suspension element strands TAX and TBX is formed by two or more parallel suspension element components, for instance by two, three, four, five, six, or more basically identical elastomer-sheathed belts or ropes, described in greater detail elsewhere in this document. But each suspension element strand TAX and TBX can also comprise only one sheathed belt or one rope. The tension members of these suspension element strands TAX and TBX are favourably produced of steel wires stranded with each other, aramid fibres, or vectran fibres, or are embodied as is shown elsewhere in this document.

The first suspension element strand TAX is fixed with its first end at the first fixing point 15.1X at the lower elevator car K1X. From there, it runs upwards to the first deflecting pulley 14.1X, and farther to the right, to the first traction sheave 13.1X, around which it is guided with an angle of wrap of at least 90°.

The second suspension element strand TBX is fixed with its first end at the second fixing point 15.11X at the lower elevator car K1X. From there, it runs upwards to the first traction sheave 13.1X, around which it is guided with an angle of wrap of at least 180°.

The two suspension element strands TAX and TBX run jointly downwards in parallel from traction sheave 13.1X to the upper counterweight idler pulley 12.1X, where they are deflected by 180°.

From the upper counterweight idler pulley 12.1X, the two suspension element strands TAX and TBX run jointly upwards to the second traction sheave 13.2X. The first suspension element strand TAX is guided around the second traction sheave 13.2X with an angle of wrap of at least 180°. The second suspension element strand TBX is guided around the second traction sheave 13.2X with an angle of wrap of at least 90°. From the second traction sheave 13.2X, the first suspension element strand TAX runs downwards to the third fixing point 15.2X at the upper elevator car K2X, at which its second end is fixed. Equally from the second traction sheave 13.2X, the second suspension element strand TBX runs to the left, to the deflecting pulley 14.2X and then to the fourth fixing point 15.22X at the upper elevator car K2X, at which its second end is fixed.

FIGS. 1CX and 6X show how the force transfer by means of the suspension element strands TAX and TBX occurs for each of the elevator cars K1X and K2X in an at least approximately central-symmetric way, so that a tendency of the elevator cars to tilt around a horizontal tilting axis lying in the central plane E1X is counteracted. This type of suspension is also called ‘balanced suspension’ here. It ensures that, even with an asymmetric loading of the elevator cars K1X or K2X, a tilting of the latter is prevented or that the extent of tilting is kept within reasonable limits.

FIGS. 1AX, 2X, 3AX, 4X, and 5X show an advantageous arrangement of the traction sheaves 13.1X and 13.2X in the upper area of the elevator well. The traction sheaves 13.1X and 13.2X are arranged vertically, i.e. with horizontal axes A1X and A2X, as can be seen in FIG. 6X.

A particularly favourable arrangement with a non-conflicting guiding of the suspension element strands TAX and TBX is achieved by arranging the hoisting machines M1X and M2X at different levels one above the other, with the stagger favourably amounting to at least the radius of the traction sheaves 13.1X or 13.2X.

In the above described arrangement, referring to FIGS. 1AX, 1BX, and 1CX, the suspension element strands TAX, TBX so-to-speak change their places. That is, the suspension element strand TAX is fixed at the lower elevator car K1X on the left side and at the upper elevator car K2X on the right side, and the suspension element strand TBX is fixed at the lower elevator car K1X on the right side and at the upper elevator car K2X on the left side. In that way, it is achieved that the overall lengths of the two suspension element strands TAX, TBX do not differ substantially, which is of advantage with respect to their behaviour (in particular as regards thermal expansion and elastic strain). In a modified embodiment example, the suspension element strands TAX, TBX can also be arranged in a non-crossed way.

A guide device for vertically guiding the elevator cars K1X and K2X in elevator well 11X comprises two stationary guide rails 19X which extend vertically along opposite sides of elevator well 11X and are fixed at the latter in a manner not depicted. The guide device, moreover, comprises guide bodies that are not depicted. At each elevator car K1R and K2R, bilaterally, preferably two guide bodies in vertically aligned arrangement are attached, which act jointly with the respective guide rails 19X. The guide bodies at each side of the elevator cars K1R and K2R are favourably positioned at a vertical distance as large as possible, i.e., are especially positioned on the one hand in the area of the car ceiling and on the other hand in the area of the car floor.

The configuration according to invention is such that the counterweight 12X is arranged close to one of the guide rails 19X and also moves along this guide rail 19X, vertically guided by counterweight guide rails not represented, where the guide rail 19X is arranged between the elevator cars K1X and K2X and the counterweight 12X.

FIG. 2X shows a second embodiment example of the invention. It comprises all constructive components described with reference to FIGS. 1AX, 1BX, and 1CX, as well as an additional device (also known as compensating rope tension device), to better tension the suspension element strands TAX and TBX and to better guide the elevator cars K1X and K2X as well as the counterweight 12X.

To this end, the elevator system 10X according to FIG. 2X comprises a lower counterweight idler pulley 12.2X, which is suspended at the bottom of counterweight 12X. In the lower area of the lower elevator car K1X, there is down on the left a fifth fixing point 15.3X and down on the right a sixth fixing point 15.33X. In the lower area of the upper elevator car K2X, there is down on the right a seventh fixing point 15.4X and down on the left an eighth fixing point 15.44X.

Furthermore, two deflecting pulleys are located in the lower area of well 11X, which are denoted as first auxiliary pulley 16.1X and second auxiliary pulley 16.2X. In addition, two further deflecting pulleys are conceived, which are denoted as third auxiliary pulley 17.1X and fourth auxiliary pulley 17.2X. Besides, the elevator system 10X according to FIG. 2X comprises sub-suspension elements, which basically comprise a first sub-suspension element strand SAX and a second sub-suspension element strand SBX.

The first sub-suspension element strand SAX is fixed with its first end at the fifth fixing point 15.3X of the lower elevator car K1X and from there runs around the auxiliary pulleys 16.1X and 17.1X. The second sub-suspension element strand SBX is fixed with its first end at the sixth fixing point 15.33X of the lower elevator car K1X and from there runs around the auxiliary pulley 17.1X. The two sub-suspension element strands SAX and SBX then run jointly from the deflecting pulley 17.1X to the lower counterweight idler pulley 12.2X, where they are deflected and subsequently guided jointly to the auxiliary pulley 17.2X. Starting from the auxiliary pulley 17.2X, the first sub-suspension element strand SAX runs upwards to the seventh fixing point 15.4X of the upper elevator car K2X. Also starting from the auxiliary pulley 17.2X, the second sub-suspension element strand SBX runs to the auxiliary pulley 16.2X and from there upwards to the eighth fixing point 15.44X of the upper elevator car K2X. What has been said about the changing of places of the sub-suspension element strands TAX and TBX with reference to FIG. 1X also holds for a crossing of the sub-suspension element strands SAX and SBX.

Favourably, each of the sub-suspension element strands SAX, SBX is formed by two, three, four, five, six, seven, eight or more parallel sub-suspension element components, the detailed structure or design of which is described in another section of this document, which is therefore referred to. But each sub-suspension element strand SAX and SBX can also comprise only one belt or one rope. The tension members of these sub-suspension element strands SAX, SBX are favourably produced of steel, aramid, or vectran, with detailed embodiment variants being described in other sections of this document, which are hence referred to in full.

In the area of the sub-suspension element strands SAX, SBX, preferably tensioning aids in or at well 11X are conceived so that the sub-suspension element strands SAX, SBX can be mechanically tensioned. These tensioning aids are not shown in the figures. The tensioning aids preferably instrumentalize deflecting pulleys/guide pulleys as are described elsewhere in this document.

The first and second fixing points 15.1X, 15.11X, as well as the fifth and sixth fixing points 15.3X, 15.33X are respectively either located in a lower area of elevator car K1X or in an upper area, as is shown in FIG. 2X, or jointly in the lower or upper area of the elevator car K1X, as is shown in FIGS. 3AX and 3BX. If the first and second fixing points 15.1X, 15.11X are located in the upper area of elevator car K1X and the fifth and sixth fixing points 15.3X, 15.33X in the lower area of elevator car K1X, this has the advantage of shorter suspension element strands TAX, TBX being needed. Basically, a reverse arrangement of the first and second fixing points 15.1X and 15.11X in the lower and of the fifth and sixth fixing points 15.3X, 15.33X in the upper area of elevator car K1X is possible, too. If the first and second fixing points 15.1X, 15.11X are located jointly with the fifth and sixth fixing points 15.3X, 15.33X in the lower or upper area of the elevator car K1X, this has the advantage of a simple construction of the elevator car K1X. The force-transferring structure can then comprise a simple, rigid common girder element at which several or all fixing points can be arranged. Such a girder element can be embodied as a component of the car structure, in particular of the car ceiling construction or the car floor construction.

An analogue argumentation also holds for the third, fourth, seventh, and eighth fixing points 15.2X, 15.22X, 15.4X, 15.44X, which either are located jointly in the upper or lower area of elevator car K2X, as is shown in FIGS. 3AX and 3CX, or respectively in an upper area or lower area of elevator car K2X, as is shown in FIG. 2X. If the seventh and eighth fixing points 15.4X, 15.44X are located in the lower area of elevator car K2X and the third and fourth fixing points 15.2X, 15.22X in the upper area of elevator car K2X, this has the advantage of shorter sub-suspension element strands SAX, SBX being needed. Basically, a reverse arrangement of the third and fourth fixing points 15.2X and 15.22X in the lower and of the seventh and eighth fixing points 15.4X, 15.44X in the upper area of elevator car K2X is possible here, too. If the seventh and eighth fixing points 15.4X, 15.44X are located jointly with the third and fourth fixing points 15.2X, 15.22X in the upper or lower area of elevator car K2X, this has the advantage of a simple construction of elevator car K2X. The force-transferring structure can then comprise a simple common girder element, which, again, can be embodied as a component of the car structure.

The ways of positioning the fixing points 15X shown in FIGS. 2X, 3AX, 3BX and 3CX can be applied analogously also in the following embodiment examples, shown in FIGS. 4X and 5X. Moreover, experts know that the embodiment examples of FIGS. 4X and 5X can also be equipped with a compensating rope tension device system according to FIGS. 2X, 3AX, 3BX, 3CX.

FIG. 4X shows a similar embodiment example as FIG. 1X, without the well 11X but with another guiding of the suspension element strands TAX, TBX, so as to improve or ensure their traction by means of an angle of wrap of the suspension element strands TAX, TBX around the traction sheaves of more than 90°, and preferably ranging from 180° to 270°.

To this end, according to FIG. 4X, the first suspension element strand TAX runs upwards from the first fixing point 15.1X at the lower elevator car K1X and around deflecting pulley 14.1X, and from there to the right, to the first traction sheave 13.1X. The first suspension element strand TAX is then guided, in a first wrap phase as in the arrangement according to FIG. 1X, around the first traction sheave 13.1X, wrapping it by 90° and subsequently by another 90°. From there, it comes to the left, hence back to deflecting pulley 14.1X, and from the latter again to the right, to the first traction sheave 13.1X, around which it is now guided, in a second wrap phase, wrapping it by at least 90°. So, the total angle of wrap of the first suspension element strand TAX around the first traction sheave 13.1X (amounting to 90° in FIG. 1X) now, according to FIG. 4X amounts to 270°. Of these 270°, 180° are due to the first wrap phase and 90° to the second wrap phase. From the first traction sheave 13.1X, the first suspension element strand TAX runs downwards to the counterweight idler pulley 12.1X and subsequently upwards to the second traction sheave 13.2X. The first suspension element strand TAX is then guided by 180° around traction sheave 13.2X and finally reaches the third fixing point 15.2X at the upper elevator car K2X.

The second suspension element strand TBX runs from the second fixing point 15.11X at the lower elevator car K1X around the first traction sheave 13.1X, with its angle of wrap around the first traction sheave 13.1X amounting to 180°. Starting from the first traction sheave 13.1X, the second suspension element strand TBX runs jointly with the first suspension element strand TAX to the upper counterweight idler pulley 12.1X, and from there upwards to the second traction sheave 13.2X. There, the second suspension element strand TBX is guided in a first wrap phase around the second traction sheave 13.2X, with an angle of wrap of 90°. From the second traction sheave 13.2X, the second suspension element strand TBX then runs to the left, to deflecting pulley 14.2X, where it is deflected by 180° and hence guided back to the right, to the second traction sheave 13.2X. Here, it is again guided around traction sheave 13.2X in a second wrap phase, and this time with an angle of wrap of 180°. Then it is guided again to the left, to the deflecting pulley 14.2X, from where it finally runs downwards to the fourth fixing point 15.22X of the upper elevator car K2X. So, the total angle of wrap of the second suspension element strand TBX around the second traction sheave 13.2X (amounting to 90° in FIG. 1X) now, according to FIG. 4X, amounts to 270°. Of these 270°, 90° are due to the wrap phase and 180° to the second wrap phase.

FIG. 5X shows another embodiment of the elevator system 10X according to invention, in which, like in FIG. 4X, angles of wrap around the traction sheaves 13.1X, 13.2X of more than 90° are achieved. FIG. 5X depicts this only with respect to the upper elevator car K2X and the second traction sheave 13.2X, though. It represents the upper elevator car K2X, the counterweight 12X with the upper counterweight idler pulley 12.1X, the deflecting pulley 14.2X, the traction sheave 13.2X, and those suspension element strands TAX and TBX that are located between the fixing points 15.2X and 15.22X and the upper counterweight idler pulley 12.1X. The embodiment shown in FIG. 5X additionally comprises deflecting pulleys 14.3X and 14.4X.

The first suspension element strand TAX, starting from the third fixing point 15.2X, runs upwards to deflecting pulley 14.4X and from there to traction sheave 13.2X, along which it is guided in a first wrap phase with an angle of about 90°. From there, the first suspension element strand TAX runs downwards, around deflecting pulley 14.3X, and back to traction sheave 13.2X, along which it is now guided in a second wrap phase with an angle of about 180°. The suspension element strand TAX hence runs around the traction sheave with a total angle of wrap of 270°. From the traction sheave 13.2X, the suspension element strand TAX runs downwards to the counterweight idler pulley 12.1X.

The second suspension element strand TBX, starting from the fourth fixing point 15.22X at the upper elevator car K2X, runs upwards to deflecting pulley 14.2X and from there to traction sheave 13.2X, around which it is guided in a first wrap phase with an angle of about 90°. From there, the second suspension element strand TBX runs downwards, around deflecting pulley 14.3X, and back to traction sheave 13.2X, along which it is now guided in a second wrap phase with an angle of about 180°. The suspension element strand TBX hence runs around traction sheave 13.2X with a total angle of wrap of 270°. Subsequently, the second suspension element strand TBX, together with the first suspension element strand TAX, runs downwards to the counterweight idler pulley 12.1X. The further course of the suspension element strands TAX and TBX is not depicted but will be clear for any expert from the above-given description.

FIG. 6X is a magnified depiction of FIG. 1BX, in which details are shown that do not or not clearly appear in FIG. 1BX. In particular, the vertical central plane E1X is depicted, which is defined by the two longitudinal axes of the guide rails 19X, and the vertical central plane E2X positioned vertically to the latter. The two central planes E1X and E2X intersect in a vertical central axis, which is visible in FIG. 6X only as an uppermost point XX.

Both the first fixing point 15.1X and the second fixing point 15.11X at the lower elevator car K1X are positioned at distances S1X from the first central plane E1X that are equal or at least approximately equal. The two fixing points 15.1X, 15.11X are located at opposite sides of the first central plane E1X and the second central plane E2X, to achieve the balanced suspension of the lower elevator car K1X. Preferably, they are arranged in a rotation-symmetric or at least approximately rotation-symmetric way in relation to a point on the vertical central axis. Dependent on the application, however, equal distances S1X to the plane E1X will suffice, too.

Equally, the third fixing point 15.2X and the fourth fixing point 15.22X at the upper elevator car K2X are positioned at distances S2X from the first central plane E1X that are equal or at least approximately equal. The two fixing points 15.2X, 15.22X are located at opposite sides of the first central plane E1X and the second central plane E2X, and respectively also at other sides of the two central planes than the fixing points 15.1X and 15.11X. This arrangement, too, achieves a balanced suspension. Preferably, they are arranged in a rotation-symmetric or at least approximately rotation-symmetric way in relation to the point XX on the vertical central axis. Dependent on the application, however, equal distances S2X to the plane E1X will suffice, too.

With this special arrangement of the fixing points 15.1X, 15.11X or 15.2X, 15.22X, a balanced suspension of the elevator cars K1X or K2X is achieved, in such a manner that tilting movements of the elevator cars around horizontal tilting axes lying in the vertical central plane E1X are largely avoided.

The first traction sheave 13.1X has a first axis A1X, the second traction sheave 13.2X has a second axis A2X. The deflecting pulley 14.1X has a third axis A3X, the deflecting pulley 14.2X has a fourth axis A4X.

The projections of the first axis A1X and the second axis A2X intersect in a point PX in the first central plane E1X, forming an angle WX. This angle WX preferably ranges from 180° to 90°.

Since both elevator cars K1X, K2X are connected, via joint suspension elements TAX, TBX, to only one counterweight 12X, and due to the special type of the 1:1-suspension of the elevator cars K1X, K2X and the 2:1-suspension of the counterweight 12X, different speeds v1X, v2X, and v3X result according to travel situation. If elevator car K1X moves upwards at speed v1X while elevator car K2X is resting, the counterweight 12X moves downwards at speed v3X=v1X/2. If elevator car K2X moves downwards at speed v2X while elevator car K1X is resting, the counterweight 12X moves upwards at speed v3X=v2X/2. If the elevator cars K1X, K2X move towards each other at equal speed v1X=v2X, then v3X=0. If the elevator cars K1X, K2X move downwards at equal speed v1X=v2X, the counterweight 12X moves upwards at speed v3X=v1X=v2X.

Since the preferably used suspension elements, described elsewhere in this document, allow significant transverse bending, and since preferably several of these belts are arranged in parallel, at a small distance, the transverse guiding of the belts has to be paid special attention to. In preferred embodiment examples, roller-type guide elements (cylindrical guide pulleys) are conceived, which are arranged in the well headroom, in the well pit, and at the elevator cars or at the counterweights, and which at least on one side press against the individual suspension element or roll on it. Preferably, the guide pulleys are arranged at a vertical distance of less than 10m of each other.

In this context, it is proposed to equip the suspension elements (as described elsewhere in this document) with at least one guide section in the form of a longitudinally oriented guide rib, on a side of the suspension element looking away from the traction surface (i.e. the backside). At such a guide section, for instance a basically cylindrical guide pulley engages, which is rotatably positioned next to the reference position of the suspension element in the well. The rotation axis of the guide pulley is basically oriented vertically to the longitudinal extension of the suspension element. The guide pulley is preferably embodied as it is described in detail elsewhere in this document for arbitrary types of guide pulleys or deflecting pulleys in general. In particular, however, at least one all-around groove or indentation is conceived in the area of the contact surface of the pulley in circumferential direction, the form of which corresponds with the cross-sectional contour of the guide section.

In a modified embodiment example, the pulley comprises at least one disk-type flange, with which it encloses the suspension element at least sectionally. In particular, a flange may have a radius exceeding the radius of a cylindrical basis surface of the pulley by approximately the thickness of the suspension element.

In another preferred embodiment, additional and/or alternative guide elements as compared to the previously presented embodiment examples are arranged in the elevator well. These additional guide elements comprise, for instance, mobile guide pulleys, guide rails, or guide combs, which are preferably arranged at a distance of less than 10 m, in particular at a distance of less than 5 m from each other, along the track of the elevator car and the counterweight in the well. The said guide elements are basically arranged in the elevator well in such a manner that the free vibration length of a belt and/or the vibration amplitudes of the suspension elements are limited to a predetermined threshold value (e.g. 1 mm, 2 mm, or nmm).

By a ‘guide comb’, a comb-type guide element is understood that, like a fork or a comb, has prongs or teeth as well as recesses or interspaces between the prongs to receive individual belts. The prongs or teeth to separate the suspension elements preferably engage between a multitude of individual, neighbouring suspension elements, where the neighbouring suspension elements may, in turn, form a suspension element strand. In a preferred embodiment, the prongs of the guide element are embodied as elastic (synthetic) fibre bundle, so that the guide element as a whole has a brush structure. As materials for such a comb-type guide element, in particular plastics with low friction coefficient are conceived, like polyamide, nylon, or Teflon®, where the stiffness of the prongs of the guide element is in particular also adjusted by their shaping: The stiffness of the guide element is adjusted in such a manner that the frictional forces between suspension element and guide element do not exceed a certain value to be preset, which can be chosen according to the abrasion resistance of suspension element and guide element.

In a preferred embodiment, the guide elements are positioned at lateral walls of the well and/or at floor ceilings. In this embodiment, the fact is of advantage that an arbitrary number of additional guide elements can be mounted along the track of an elevator car to optimize the free vibration length of a belt between two neighbouring guide elements.

In another preferred embodiment, additional guide elements are conceived in the upper area of an elevator car which is suspended in its lower area on suspension elements. The guide elements reduce the free vibration length by about at least the height of the car. By means of construction elements and/or girders, which, e.g., can be mounted on the elevator car roof, guide elements can be positioned above the actual car level. Accordingly, the free vibration length of a belt can be further reduced. In this embodiment, the advantage lies in the simple way of positioning additional guide elements on the elevator car, in a space otherwise not used by elevator components. In addition, the belts can be guided at their guide elements that already engage with the car idler pulleys. Analogously, guide elements can be arranged underneath the car, by means of girders protruding from the car floor.

In another preferred embodiment, a multiple-car elevator system is conceived, with a lower and an upper elevator car. If, for instance, the lower elevator car is suspended in a 2:1-suspension, its suspension elements laterally pass the upper elevator car on their way towards traction sheaves, deflecting pulleys, or fixing points in the upper area of the elevator well. According to invention, in such a configuration additional guide elements are positioned at the upper elevator car, which enclose or guide the suspension elements of the lower elevator car. Analogously, the free vibration length of sub-suspension elements of the upper elevator car is reduced by positioning additional guide elements at the lower elevator car, with the said guide elements enclosing or guiding the sub-suspension elements of the upper car. In that way, however, the free vibration length of a suspension element can at most be halved, depending on the position of the two elevator cars in the elevator well.

On principle, the proposed guide elements are suitable for all suspension elements described in this document and are in particular conceived for narrow suspension elements with low transverse stability (width/height<1), where a low-wear material pairing, with low frictional forces between suspension element and guide element is preferred. Furthermore, the guide elements can be supported in a flexible bearing so as to achieve an increased yieldingness of the guide element.

3. Hoisting Machine

With respect to hoisting machines 14 of mechanical drives, the expert distinguishes gearless hoisting machines and geared hoisting machines. The essential constituent parts of hoisting machines are a motor 16, a brake, a traction sheave 26 or a drum 18, and, possibly, a gear. For reasons of exact alignment and low-noise operation, the motor, the brake, and possibly the gear are preferably structured as an integral construction unit, for instance mounted on a common bedplate. Basically, gearless hoisting machines do not differ functionally from geared hoisting machines, and the gear can be more or less considered and, if need be, embodied as an integral part of the hoisting machine.

3.1 Motor

The motor 16 of the hoisting machine 14 for the elevator system is usually an electric motor, adapted to the desired parameters—like acceleration values, travel speeds, size of rated loads, noise conditions, switching frequencies, and operating time. Besides, motors have to be very robust and overloadable in their electric and mechanical parts.

Mostly, the motors used in elevator systems are three-phase a.c. motors with one or several rotation speeds, sometimes also direct current motors. According to invention, preferably asynchronous motors and/or permanent magnet motors are employed. With higher travel speeds or special requirements regarding levelling accuracy, pole-changing three-phase a.c. motors with two travel speeds may be used. For electric control of motor rotation speed or motor performance, voltage transformers, current transformers and/or frequency converters are assigned to the motors in the elevator systems. Preferably, the said transformers are arranged in a separate unit, at a distance to the motor.

3.2 Brake

The brake of a hoisting machine 14 for an elevator system works as a holding brake and as a pedal brake. As a holding brake, it locks a stationary drive shaft of the machine, thus enabling a holding of elevator car 10 at the desired stop position. As a pedal brake, it has the function of braking the rotating drive shaft and bringing the elevator car (both in loaded and in unloaded state) safely and precisely to a stop at the desired stop position.

Braking decelerations to be effected by the hoisting machine can be reached with respective three-phase a.c. motors by pole-changing, or else through mechanical brakes (e.g. shoe brake, double-shoe brake).

In gearless hoisting machines, the brake disk is preferably arranged on a drive shaft or on the drum shaft, in geared hoisting machines, braking occurs at the gear shaft. A common material for the brake disk is grey cast iron, with the brake disk being detachably connected with the drive shaft and/or the gear shaft.

3.3 Traction Sheave

A traction sheave 26 (or a functionally equivalently operating section) is an essential constituent part of a hoisting machine 14 in the elevator system with traction drive. The traction sheave 26 has to be optimally adapted to the respective type of the suspension element 20 used in the elevator system. So, for instance with a rope-type or belt-type suspension element 20, the forces generated by motor 16 of the hoisting machine 14 are transferred by means of traction from traction sheave 26 to the suspension element 20. With a chain-type suspension element 20, on the other hand, the traction sheave 26 is embodied with a toothed rim.

The achieved traction effect depends heavily on the specific construction of the rope-type or belt-type suspension element 20 and the corresponding traction sheave 26. A crucial factor here is, for instance, the groove form of traction sheave 26. Especially the following three types of grooves are used here: semicircular groove, seat groove, and V-groove.

Besides, the hoisting machine 14 generally contains several parallel traction sheaves 26, or one traction sheave 26 with several parallel force transfer sections, the number of which equals the number of suspension elements 20 of the elevator system running in parallel.

Structure and functioning of traction sheaves 26 according to invention are described in detail in the context of the suspension element 20 according to invention.

3.3 a) Traction Sheave Surface Treatment

The belt-type suspension element according to invention is preferably driven by a traction sheave the circumferential surface of which, interacting with the suspension element, is hardened according to a procedure in which no hardening cracks occur. In particular, the traction sheave comprises at least two sectors, with at least one sector being hardened and at least one sector not being hardened.

Preferably, the traction sheave is cast or manufactured in one piece. Due to the sectorial hardening of the traction sheave, tensions generated during hardening are more easily released, and the probability of cracking is hence reduced.

By hardening, any mechanical, thermal, or chemical process is understood here that modifies the structure of a material, thereby increasing its hardness. By the surface of the traction sheave, here the exterior, cylindrical surface of the traction sheave is understood, which carries the ropes and which is worn in elevator operation. By the sectors of the traction sheave, here the circle sectors of the cylindrical traction sheave are understood, which are defined and determined by a centre angle of the traction sheave. The arms of the centre angle define the two sector sides. Hardening of a sector is to be understood as both the formation of a thin, hardened layer at the surface of the traction sheave, in the angle area of that sector, and the hardening of the material of that sector below the surface of the traction sheave.

The invention will be explained in more detail on the basis of FIG. 1n below.

FIG. 1n shows a hardened traction sheave 1n for elevators, according to a preferred embodiment of the present invention.

For normal use, i.e. in an elevator for a residential building of mean height, a six-groove traction sheave of 638 mm nominal diameter is manufactured. As usual, haematite basic raw iron is taken as basic material, which contains 4.3%-4.6% of coal, 0.0015%-0.05% of manganese, 2.26%-2.75% of silicon, and 0.035%-0.11% of phosphorus. In the present case, ferrosilicon is added to the melted basic raw iron as an alloy material containing 73% of silicon, 0.7% of manganese, 0.1% of phosphorus, and 0.08% of sulphur.

As a next step of the procedure, the sulphur content of the melting bath is reduced or adjusted to a value below 0.01%—in the present case to 0.008%. To this end, magnesium coke is used, which is introduced into the melting bath at a temperature of 1480°. The introduction of the magnesium coke into the melting bath is done such that this addition is introduced below the surface of the melting bath. Immediately before casting, the secondary modification with ferrosilicon is performed, to improve the homogeneity of the basic structure. Then, the casting into the casting mould is done, at a temperature of 1320° C. The complete cooling occurs in the sand mould, in about 9 hours.

Then, the cooled casting is normalized for the purpose of de-tensioning. To this end, the casting is at first preheated in an oven to 920° C., as usual, and then—after 4 hours of being kept warm at that temperature in the oven—cooled down to 900° C. Then, the cooled casting is finished to the nominal dimensions, in known ways. According to results of tests done with traction sheaves manufactured in the above-described way, hardness values HB=210-260 kp/mm² are measured at the rope guide sheathing (with a ball of 10 mm diameter, at a load of 30 kN). The material testing proves that the material of the casting has a ferrite-pearlite basis (with about 30% ferrite, material quality: F30, degree of fineness of the pearlite: Pf=1.4), hence is a spheroidal graphite cast iron with invariable graphite form and graphite distribution (the characteristic values for the graphite form are: Ga 9-10; graphite size: Gm 45), the strength properties of which exceed the standard regulations referring to GÖV 500, (i.e., R_{p 0,2}=406 Mpa-459 MPa; Rₘ=602 Mpa-658 MPa; A₅=2.3%-3.6%). The spheriodal graphite iron contains: 2.8%-3.15% coal, 2.8-3.1 silicon, max. 0.3% manganese, max. 0.2% phosphate, as well as 0.008% sulphur.

Such a casting can more easily be cut than the traditional cast iron of lamellar graphite, which for the finish-machining tools results, e.g., in a prolongation of their service life by 30%. This, in turn, means a further cost reduction due to a longer service life of the tools. After finishing, the work piece will be subjected to a subsequent heat treatment, with subsequent hardening. This heat treatment aims at further increasing the hardness of the surface of the traction sheave, and in particular the hardness of the surface of the grooves, while at the same time preventing the formation of cracks.

This heat treatment of the groove surface is performed by hardening, namely by flame hardening exerted at 850° C. In this process, the traction sheave rotating at a controllable rotation speed, or its grooves are heated at one go, simultaneously, with a special gas burner head. The heat-treated groove area is then cooled down immediately, for instance by twisting the traction sheave. By the rotation speed of the traction sheave, the thickness of the hardened layer of the groove surface can be regulated, and in a preferred embodiment amounts to 1 mm-1.5 mm. The desired degree of annealing heat can be identified in practice on the basis of the colour (sour cherry red). The hardening is done sectorially. FIG. 1n shows, for instance, the hardened layer of a sector with an angle area α. The angle area α is bordered by the sector sides.

A sector of the traction sheave defined by a centre angle α of 25° is hardened first. Then, the adjacent sector of the traction sheave, corresponding to a centre angle of 5°, is not hardened. The sectorial hardening of the angle areas is done over the whole circle of the traction sheave, resulting in 12 hardened sectors of 25° each, separated by 12 non-hardened sectors of 5° each. The traction sheave hence finally comprises a regular sequence of hardened and non-hardened sectors. According to the preferred present embodiment of the invention, the sectors of the traction sheave are sequentially hardened and not hardened around the whole circumference of the traction sheave surface. On principle, a simultaneous hardening of all sectors is conceivable, too. Also, irregular sequences of hardened and non-hardened sectors are possible.

The measured groove hardness values amount to HB=480-500 kp/mm² for the hardened sectors. With the stresses occurring in practice, for the operators such values mean a satisfying, long service life and ensure an economic operation. In addition to the already mentioned advantages, one further important advantage of this invention is the fact that traction sheaves for different load situations can be produced with the same, universally applicable technology, and can then, after finishing, be subjected to the above-described surface hardening procedures, if need be. Thereby, the respective optimal surface hardness and wear resistance can be adjusted, since the spheroidal graphite material structure produced by the procedure according to invention provides the respective possibility. As a consequence of the use of a traction sheave with longer service life and improved wear resistance according to invention, weight savings are achieved.

According to operation results, the elevator traction sheaves produced according to the above-described procedure have—with normal loading, i.e. in a residential building of medium height with 8 floors—a significantly increased wear resistance as compared to traditional elevator traction sheaves and therefore can be used significantly longer. This means, on the other hand, that the sum of enforced downtimes can be significantly shortened.

Instead of flame hardening, also induction hardening of the traction sheave surface can be applied, which will lead to similar results. The depth of the hardened material can be varied at will. In the minimal case, only a thin layer of a few micrometres thickness of the traction sheave surface is hardened. In the extreme case, a whole sector of the traction sheave is hardened, with the hardened zone reaching up to the centre of the traction sheave.

The sectorially hardened traction sheaves of elevator drives are used irrespective of the drive type, i.e. geared, gearless, or V-belt drive. All geometric variants of sectorial hardening, number of segments, angle distribution etc. are conceivable and will lead to positive results, independent of the procedures of producing and hardening the traction sheave or their respective conditions and means.

For all possible shapes of grooves of the traction sheave, crack formation is reduced.

Irrespective of the material selected for the traction sheave—which also can be a non-castable material—both the sectorial hardening over the circumferential surface of the traction sheave and a segment-wise through-hardening of the traction sheave have positive effects. Moreover, the hardened segments can be located perpendicular to the rope groove, or they can be located at an angle, hence diagonal to the traction sheave surface. The same hardening is also possible with bipartite rope rollers, in which case a reworking, i.e. a regrinding of the grooves, becomes necessary to ensure quiet running in quickly running elevators.

3.3 b) Traction Sheave

In the following, the traction sheave 26 adapted to the suspension element 20 will be explained in more detail.

By means of the traction sheave, the forces generated by the drive motor are transferred to the suspension element. In the suspension elements according to invention, which, besides, are also described elsewhere in this document, the sheathing of the suspension element forms a frictional grip with the surface of the traction sheave, where shape and surface texture are of crucial importance. The friction coefficient of the traction sheave can, for instance, be influenced by insertion of insert parts, or by roughening the surface, e.g. by sandblasting or etching.

On the basis of FIGS. 1G5, 1G5a, 2G5, 3G5, 4G5, 5G5, 6G5, 7G5, 8G5, 9G5, 10G5, 11G5, 12G5, 13G5, 14G5, 15G5, 16G5, 17G5, and 18G5, several configurations of traction sheave and suspension element according to invention are explained in more detail.

Regarding the design of the traction sheave for flat suspension elements, among other things DIN 111 is referred to, where the traction sheave according to the present invention is preferably embodied as one-piece with the drive shaft and/or as one-piece with one or more neighbouring traction sheaves, and the explanations of DIN 111 have to be modified respectively. Alternatively or complementarily, DIN 4000 part 43, as well as DIN 7867 are to be drawn upon regarding the geometric design of the traction sheave/drive shaft, in particular if non-round and non-flat suspension elements are to be applied. The said standards provide essential hints as to dimensioning, design of details, and manufacturing of a traction sheave or drive shaft according to invention (also regarding those described elsewhere in this document).

FIG. 1G5 shows a traction sheave 1g5 and a guide pulley and/or deflecting pulley 2g5, for a suspension element 3g5 with longitudinal ribs 4g5 at its riding surface 5g5, and with a comb 6g5 at its backside 7g5. For each longitudinal rib 4g5, two tension members 37g5 are conceived, which, for instance, comprise a multitude of steel strands stranded with each other, and/or synthetic fibre strands stranded with each other. All further tension members described elsewhere in this document can also be applied in the context of the embodiment examples described here. The tension members 37g5 in the present embodiment example are embedded in a sheathing made of an elastomeric plastic that essentially surrounds the tension members completely.

Furthermore, the proposed configurations of traction sheave, guide pulley(s) and/or deflecting pulley(s) and suspension element can be used in all other elevator configurations described elsewhere in this document.

The height Hg5 of the suspension element 3g5 or of its sheathing is chosen here as by 5%-50% larger than the width Bg5 of the suspension element or the sheathing, respectively. The traction sheave 1g5 is equipped with a ribbed groove 8g5, into which the longitudinal ribs 4g5 engage correspondingly. The comb 6g5 of suspension element 3g5, in turn, engages preferably with a groove 9g5 of the guide pulley and/or deflecting pulley 2g5, such that even with a counter-bending of the suspension element, there will be a (backside) guide of the suspension element 3g5.

FIG. 1 G5a shows a suspension element 3g5 with longitudinal ribs 4g5 of the riding surface 5g5 and comb 6g5 of the backside 7g5 removed at the suspension element end. The longitudinal ribs 4g5 have been removed up to a line denoted by L1g5, and the comb 6g5 has been removed up to a line denoted by L2g5, for instance by means of cutting with a plane, over a length of 10 cm-70 cm. Without longitudinal ribs 4g5 and comb 6g5, the suspension element 3g5 has, at its end, a flat-belt-type shape. The flat-belt-type suspension element end fits into suspension element end connections, as is depicted in FIGS. 1G6-4G6 regarding the use of belt-type suspension elements that are flat over their whole length.

FIGS. 2G5-7G5 show a suspension element 3g5 with flat riding surface 5g5 and flat traction sheave groove 12g5. In FIG. 2G5, the suspension element 3g5 is embodied as a flat belt 10g5 with four tension members 11g5. FIG. 3G5 shows how a flat belt 10g5, embodied as not particularly rigid in transverse direction, rises at the edge of the traction sheave groove 12g5 if there is a deflecting pull. The rising does not occur with a transversely rigid flat belt according to invention, which is shown in FIGS. 4G5 and 5G5.

FIG. 4G5 shows at first a flat belt 13g5, with V-shaped transverse ribs 14g5 that are embodied in one piece with the elastomer of the remaining sheathing. FIGS. 5G5 and 6G5 show another flat belt 15g5 with rounded transverse ribs 16g5. As is shown in FIG. 7G5, a continuous reinforcement 17g5 extending along the whole length of the suspension element can be conceived instead of several individual transverse ribs 16g5. The comb 6g5 of the suspension element 3g5 of FIG. 1G5 can also act as a reinforcement and contribute, via a better transverse reinforcement of this suspension element 3g5, to quieter running.

The reinforcement can either be made of the same material as the sheathing of the tension members, or it can be produced of a material different from the latter, whereby the requirements regarding the transverse stiffness to be achieved can additionally be taken into account. So, this material can, for instance, have a texture that effects a stiffening in transverse direction. A composite material can be thought of, too, containing fibres that act as reinforcing in transverse direction, correspondingly aligned in parallel. Dependent on the material, the reinforcement can the be either embodied as in one piece with the elastomer of the remaining sheathing or it can be conceived as a separate element that is firmly connected to a prefabricated flat-belt primary product. This connection can be produced, dependent on the materials of reinforcement and sheathing, by welding, in particular by pressure welding, by adhesive bonding, by extrusion of the reinforcement on the prefabricated flat-belt primary product, or conversely by co-extrusion, etc.

FIGS. 8G5-15G5 show a suspension element 3g5 with two tension members 18g5. FIG. 8G5 shows two separately sheathed tension members 18g5, with the individual sheathings 19g5 being connected via a web 20g5. The web material can, in favour of the transverse stiffness of the suspension element, differ from the sheathing material, with preferably an adhesive-bond connection between the individual elements being produced. Furthermore, alternatively or complementarily to the adhesive-bond connection, a form-locking connection can be conceived between the respective sheathings 19g5 and the web, by conceiving a groove-tongue connection, an undercut, or the like.

In FIG. 9G5, the suspension element 3g5 of FIG. 8G5 is embodied with two tension members 18g5 as flat belt 21g5. To this end, the two separately sheathed tension members 18g5 can either be completely sheathed by a common sheathing that fills the interspace between them accordingly and holds the two sheathed tension members in their positions at a defined distance, or again a web can be conceived, which in its thickness is not or not significantly reduced as compared to the other sheathing. In the variants of both FIG. 8G5 and FIG. 9G5, the traction sheave groove 12g5 is embodied as flat or without contour.

FIG. 10G5 shows a suspension element in which the tension members 18g5 are interlinked and held in position by a common sheathing, with a neck between the two tension members. Alternatively or complementarily, a sort of groove, longitudinal notch, or indentation between the two tension members is conceived to be arranged at least at one side. The tension members in this embodiment are preferably enclosed by a common sheathing, but, for instance for a better fixation in the common sheathing, can be equipped with an adhesion-promoting impregnation and/or an individual, additional internally located sheathing.

The traction sheave 1g5 interacting with such a suspension element 3g5 is preferably flat, as in the previously described examples, or the traction sheave groove 22g5 is equipped with a ring-shaped nose 23g5 projecting into the neck between the tension members 18g5. The nose 23g5 guides and supports the suspension element by engaging with the correspondingly shaped groove or neck at the side of the suspension element. Optionally, the ring-shaped nose 23g5 can be firmly mounted on the traction sheave or be produced in one piece with the traction sheave, or it can be arranged as independent of the traction sheave, freely rotatable on the latter. Accordingly, the ring-shaped nose 23g5 can be produced of a material different from that of the traction sheave, in particular of a plastic or a metal alloy. As is shown in FIG. 11G5, a traction sheave or a drive shaft embodied in one piece with the motor shaft can also be embodied for two or more suspension elements according to FIG. 10G5. In particular, it is of advantage to conceive a multitude of 9-18 basically identical suspension elements, which each comprise a small number of tension members (preferably one, two, four, or six) as well as an elastomer sheathing to embed the tension members. Their details are described elsewhere in this document.

FIG. 12G5 shows two tension members 25g5 interlinked via a web 24g5, with asymmetric sheathing 26g5. The material of the eccentric sheathing part can be the same as or different from the material of the remaining sheathing. Preferably, the eccentric sheathing part is embodied as sacrificial layer, with the material of the eccentric sheathing part showing a reduced wear resistance in relation to the material of at least one object contacting with the sheathing part during operation. The traction properties, too, can be adjusted to the traction sheave by the selection of a material for the eccentric sheathing part that differs from the overall sheathing material.

FIG. 13G5 shows a suspension element with longitudinal ribs 27g5 on the riding surface as well as on the backside. The traction sheave groove 28g5 is contoured as complementary to the longitudinal ribs 27g5. This embodiment with longitudinal ribs 27g5 symmetrically arranged on both sides of the flat belt favours a bilateral engagement of the suspension element with several deflecting pulleys and/or guide pulleys, and, due to the homogeneous material distribution, stabilizes the reverse bending strength of the sheathing, in particular in the area of the base body of the suspension element 3g5 surrounding the tension members 3g5.

FIG. 14GA shows a suspension element with two jointly sheathed tension members 30g5. At its backside, the suspension element comprises a comb 29g5 at least sectionally spanning both tension members 30g5, as well as a recess between the two tension members 30g5. In interaction with a correspondingly embodied traction sheave, as it is outlined exemplarily in FIG. 14G5, the recess between the tension members can serve to guide the suspension element on the traction sheave, by a ring of the traction sheave or the guide/deflecting pulley engaging with the recess. The comb, in interaction with a respective guide element side-of-traction-sheave can hence achieve an exact positioning of the suspension element on the traction sheave.

In a modified embodiment example, the suspension element is assigned at least one guide pulley, which is, in particular in the area of its contact surface with the suspension element, embodied as contoured in a direction transverse to its circumferential direction, where the contour of the contact surface of the guide pulley corresponds with the contour of the suspension element (in particular with the contour of the comb 29g5). Besides, in this embodiment example, a traction sheave or drive shaft is conceived which, in the area of its traction surface, is embodied as basically cylindrical and non-contoured. In that way, the guiding task is transferred to the guide pulley, to improve the traction qualities of the traction sheave described in more detail elsewhere in this document. An interaction of the comb 29g5 with correspondingly shaped deflecting pulleys can also be conceived. There, both first deflecting pulleys can be conceived for engaging with the traction surface of the suspension element, and second deflecting pulleys for engaging with the comb 29g5 (arranged on the backside).

In the embodiment example according to FIG. 15G5, an external tension member 31g5 runs coaxially to an internal tension member 32g5. Each tension member here has its own sheathing. The traction sheave groove is preferably embodied as a half-round groove 33g5. Besides, the features of the above-described suspension elements can be conceived alternatively or cumulatively.

FIGS. 16G5-18G5 show a suspension element with a tension member and a sheathing of an elastomeric plastic, which is self-centering on the traction sheave groove. The sheathing has a non-round, preferably polygonal cross-section geometry. As particularly suited according to invention, one-angled, biangular, triangular, tetragonal, pentagonal, or hexagonal cross-section geometries are used. These embodiments have the advantage that the tensile load is transferred very homogeneously or symmetrically into the one tension member, and preferably also the contact pressure acts on the traction sheave in a homogeneously or symmetrically distributed way. FIG. 16G5 shows a suspension element with a tension member 34g5 with a sheathing with square cross-section. In engaging with the traction sheave and/or a guide/deflecting pulley, the sheathing 35g5 is positioned on its angle so that the height Hg5 of the sheathing 35g5 is the same as its width Bg5 (both equalling the square diagonal).

FIGS. 17G5 and 18G5 show a structure comparable to that of FIG. 16G5, differing from the latter in that in FIG. 17G5 the suspension element is wider than high, and in FIG. 18G5 the suspension element is higher than wide. The traction sheave groove 36g5 is preferably contoured as complementary to the respective sheathing geometry, and, in its bottom, has an additional recess, so as to avoid notching effects.

3.3 c) Traction Sheave/Deflecting Pulleys—Traction

The traction sheave 26 is an essential constituent part of the hoisting machine 14 with traction drive. It has the function to transfer a longitudinal force onto suspension element 20 so that the latter can hold or move the elevator car. In this respect, the traction sheave 26 has to be optimally adapted to the respective type of the suspension element 20 used for the elevator system. Thus, the forces generated by the motor 16 of the hoisting machine 14, for instance in a rope-type or belt-type suspension element 20, are transferred from the traction sheave 26 onto the suspension element 20 through a traction effect, i.e. through a friction effect.

The achieved traction effect heavily depends on the construction of the rope-type or belt-type suspension element 20 and the corresponding traction sheave 26. Rope-type suspension elements are guided in circumferential grooves existing in the traction area of the traction sheave. The traction effect between traction sheave and suspension element is essentially influenced by the groove form of traction sheave 26 and the friction coefficient between traction sheave and suspension element: The circumferential grooves preferably have one of the following three groove forms: half-round groove, seat groove with undercut, and V-groove. Rope-type suspension elements can have an external sheathing of the load-bearing elements, on which the said friction coefficient and hence the traction effect heavily depends. Besides, the circumferential grooves of the traction sheave may have coatings or linings which, in interaction with the rope-type suspension element 20, lead to a desired friction coefficient or a certain wear behaviour.

With belt-type suspension elements, the traction effect depends on the one hand on the friction coefficient occurring between the traction surface of the suspension element and the traction surface of the traction sheave. This friction coefficient can, for instance, be influenced by the choice of materials forming the traction surfaces and/or by the design of their surface structures. On the other hand, the traction effect can be influenced by designing the traction surfaces with suitable profiles, in analogy to achieving a traction increase in V-belts.

The hoisting machine 14 generally comprises several parallel traction sheaves 26 or a traction sheave 26 with several parallel force transfer sections, the number of which equals that of the suspension elements 20 of the elevator system running in parallel.

Deflecting pulleys have the function of deflecting and guiding the suspension elements in the area of the elevator system. They are also denoted as idler pulleys 30, 34 if, via them, the suspension element transfers a carrying force, for instance onto the elevator car 10 depicted in FIGS. 2A, 2B, or onto the depicted counterweight 32. Deflecting pulleys denoted as idler pulleys normally exist in elevator systems in which, during travel, the suspension element moves relatively to elevator car or counterweight in the area of its coupling to elevator car/counterweight.

In the following, traction sheaves and deflecting pulleys used in different embodiments of the elevator system according to invention as well as their arrangement are described in more detail. In this context, the notion of ‘idler pulley’ will only be used again if this seems to be expedient in a specific context.

Traction sheaves as well as deflecting pulleys are essentially characterized by their mechanical structure and the material of their roller body, by the type of their rotational bearing, by the design of their areas interacting with the suspension elements, and possibly by type and material of their coatings or inserts in those areas. Another essential feature of traction sheaves/deflecting pulleys is their effective diameter, i.e., the diameter of its areas getting in contact with the suspension element.

Modern suspension elements, for instance flat-belt-type suspension elements with reinforced elastomer bodies, or ropes made of high-strength synthetic fibres allow the reduction of the traction sheave diameters or the deflecting pulley diameters to less than 200 mm, preferably to less than 100 mm. This has the advantage that less well space is needed for an elevator system, and that the torque required at the traction sheave and hence the size of the drive motor of a gearless drive unit can be significantly reduced. Traction sheave diameters that low allow a cost-effective production of drive shaft and traction sheave of the drive unit in one piece, in the following simply called drive shaft. The design features of traction sheaves/deflecting pulleys described below also hold for such drive shafts, where applicable.

A traction sheave/deflecting pulley used in an elevator system according to invention can comprise a roller body, preferably made of cast and/or finish-machined steel, grey cast iron, spheroidal-graphite cast iron, or of cast, pressed, or injected plastic, in particular of polyamide (PA), polyurethane (PU), polyethylene (PE), polycarbonate (PC), or polyvinyl chloride (PVC).

A deflecting pulley conceived for several suspension element strands arranged in parallel can comprise a single roller body with a number of suspension element tracks (grooves for rope-type suspension elements, flat tracks for flat-belt-type suspension elements) at its circumferential surface. But it can also comprise several suspension element rollers made of one of the listed materials, pivoted on an axis body, with the number of suspension element rollers normally, yet not compulsorily, equalling the number of suspension element strands arranged in parallel. Deflecting pulleys with suspension element rollers supported in separate bearings have the advantage of not causing inhomogeneous tensile loads in the suspension element strands arranged in parallel, and of promoting the reduction of inhomogeneous tensile loads generated, for instance, by the traction sheave.

The areas of the traction sheave/deflecting pulley getting in contact with the suspension element can be made of the unchanged material of the roller body. Preferably, however, these areas have a surface with specific properties. They can, for instance, be surface-hardened, or be equipped with a surface coating, or they can have a special surface structure. By such measures, for instance the traction relation between traction sheave and suspension element and/or the wear behaviour in a contact between traction sheave/deflecting pulley and suspension element can be optimized. Besides, with suitable coatings, surface treatments, or surface structures in the said contact area of traction sheave/deflecting pulley, it is possible to counteract noise emission or the twisting of round suspension elements.

An elevator system according to invention can comprise a traction sheave or deflecting pulley the circumferential surfaces of which (interacting with the suspension element) can have one of the surface coatings described below:
corrosion-proof metal coatings produced by electroplating, in particular chromium or hard chrome coatings
chromium layers with structured surfaces, like Topochrom®, where preferably two-layer nickel-chromium coatings are applied
hard-metal coatings spray-applied by means of arc spraying or plasma spraying, e.g. tungsten carbide coatings or ceramic coatings
spray-applied or cast-on or pasted-on plastic coatings, e.g. of polyurethane PU, polyamide PA, polytetrafluoroethylene PTFE (Teflon®), polyethylene PE.

To achieve certain qualities, like for instance optimized guide and traction properties, good noise absorption, or the capacity to have rope-type suspension elements embedded, the coatings can comprise two or more different materials, arranged on top of one another and/or beside one another in the area of interaction of traction sheave/deflecting pulley and suspension element.

Coating of the surfaces interacting with the suspension element with nano-particles, and/or insertion of nano-particles into these surfaces, produced by means of PVD (physical vapour deposition/sputtering). Here, nano-particles, e.g. of metal oxides, SiO₂, TiC, TiN, CrN, AlTiN, AlCrN, MoS₂, or mixtures of these components, are deposited on the said surfaces, where they form wear-resistant layers with different friction coefficients in relation to the suspension element. So-called nACo-layers and nACRo-layers (firm Blösch, Grenchen, CH) have proved to be particularly effective as regards high wear resistance combined with high friction coefficient, preferably for the coating of traction sheaves. In these coatings, crystals of AlTiN or AlCrN of only a few nanometres size are embedded into a matrix of amorphous Si₃N₄. Particularly low-friction coatings can be produced by sputtering of MoS₂, Ti—MoS₂, or graphite onto the surfaces interacting with the suspension element, in particular onto surfaces of deflecting pulleys.

An elevator system according to invention can comprise a traction sheave or a deflecting pulley which, in the areas of contact with the suspension element, have specially structured surfaces, to reach certain properties, e.g.:
surfaces with a defined treatment-produced roughness ensuring a desired friction relation between traction sheave and suspension element
surfaces with transverse grooves or ribs extending transversely to the circumferential direction, which in elevator systems according to invention in standstill situations prevent a slow gliding (creeping) of the suspension element on the traction sheave
surfaces with the above-mentioned Topochrom® hard chrome layer produced by electroplating, which are formed of calotte-shaped (ball-cap-shaped) micro structures. This coating mainly serves for achieving a defined, relatively low friction relation between traction sheave and suspension element combined with a high wear resistance.

An elevator system according to invention can be equipped with a traction sheave the surfaces of which, interacting with the suspension element, can comprise a friction-reducing coating or be treated so as to reduce friction. A friction-reducing coating or surface treatment has, in particular, one or several of the following advantages:
By reduction of the traction relation between traction sheave and suspension element, it is prevented that the elevator car can be elevatored further by the drive and the suspension element once the counterweight has impacted on its lower buffer due to a control error.
By reduction of the friction between traction sheave or deflecting pulley and several parallel suspension elements running over them, an excessively uneven load of the suspension elements is prevented.
Twistings imposed on a rope-type suspension element can be removed more easily, so that damages at the suspension element resulting from twistings are avoided.

Such traction sheaves or deflecting pulleys with friction-reducing coatings of the traction surfaces interacting with the suspension element are revealed in EP1764335 as well as in WO2004/113219. EP1764335 reveals coatings of hard chrome with calotte-shaped micro-structured surface (Topochrom®), of amorphous carbon, of PTFE (Teflon®), and of ceramics, and mentions carbonitride oxidation as friction-reducing surface treatment. Features and embodiment details of traction sheaves according to EP1764335 are represented in particular in FIGS. 5, 6 and the respective descriptions, in particular in sections [0016], [0017], [0018], and are herewith incorporated into the present application.

WO2004/113219 reveals traction sheaves and deflecting pulleys equipped in the areas of contact with the suspension elements with friction-reducing coatings, preferably made of polytetrafluoroethylene PTFE (Teflon®), polyethylene PE, or ETFE (copolymer of tetrafluoroethylene and ethylene), where these materials, to the end of increasing their wear resistance, are preferably reinforced by glass fibres. The features of the traction sheaves according to WO2004/113219 are represented in particular in FIGS. 2, 3 and the respective descriptions, in particular from page 7, line 4, to page 9, line 2, and are herewith incorporated into the present application.

In another embodiment example, the elevator system according to invention comprises a traction sheave the traction surfaces of which, interacting with the suspension element, have a roughness measured in circumferential direction of about 0.5 μm-5 μm, preferably one of 1 μm-3 μm. In that way, especially, a defined and sufficient traction relation between traction sheave and suspension element is ensured. This roughness can be generated by finish-machining, e.g. by circular grinding, but preferably by shot-blasting or sandblasting. According to a preferred embodiment variant of such a traction sheave, its traction surfaces are equipped with a wear-resistant and corrosion-proof surface coating, which preferably can be produced in an electrochemical process, e.g. as a hard-chrome layer, or in an immersion process. This coating has a thickness of less than 20 μm, in a version that is optimized with respect to costs and service life a thickness of 10 μm-20 μm, and in a particularly cost-effective variant a thickness of less than 10 μm. The hardness of the surface coating amounts to more than 40 HRC, preferably to 40-55 HRC, so as to, on the one hand, provide sufficient wear resistance and, on the other hand, lend itself without problems to being roughened by means of shot-blasting or sandblasting. Such a traction sheave is revealed in EP1169256. Embodiment details and procedural features are described especially in sections [0013] and [0014] of the respective description, and are herewith incorporated into the present application.

For reasons of simplicity and for better readability, both deflecting pulleys or idler pulleys and traction sheaves will be subsumed under the notion of roller element(s) below. So, if the notion of roller element(s) is used, it will denote both deflecting pulleys (idler pulleys) and traction sheaves.

In another embodiment example, an elevator system according to invention comprises a roller element, in particular a traction sheave and/or a deflecting pulley for driving or deflecting, respectively, a suspension element, produced in such a manner that the mean roughness value of its at least one contact surface measured in circumferential direction, and the mean roughness value of its contact surface measured in axis direction are different. The advantage of such a roller element lies in the fact that—with low roughness in circumferential direction required for reasons of wear minimization—the costs for producing the roller element can be reduced as compared to those for producing a roller element with equal roughness in both directions. Besides—in particular with the use of flat belts as suspension elements—an increased roughness of the contact surfaces in axis direction of the roller element can positively influence the lateral guiding of the suspension element on the roller element.

A preferred embodiment of the roller element or the traction sheave/deflecting pulley is characterized by the mean roughness value of the contact surface measured in circumferential direction amounting to less than 1 μm, preferably to 0.1 μm-0.8 μm, with special preference to 0.2 μm-0.6 μm. One of the advantages of contact surfaces with a roughness according to these preset values is the low wear of both the suspension element and the contact surfaces of the roller element itself. Another advantage is the fact that the maximum tractive relation between roller element and suspension element is rather precisely limited, which is of importance in particular in operation situations where the suspension element is to slide in relation to the roller element during a limited time. Such an operation situation can, for instance, occur if, due to a control failure, the elevator car or the counterweight impact on their lower track limits or if elevator car or counterweight are blocked along their tracks for other reasons.

According to an advantageous embodiment of the invention, a difference of more than 0.2 μm exists between the mean roughness value of the contact surface measured in circumferential direction of the roller element and the mean roughness value of the contact surface measured in axis direction of the roller elements. In that way, on the one hand, lower production cost can be achieved and, on the other hand, the lateral guiding of the suspension element on the roller element is improved.

According to another embodiment of the invention, the mean roughness value of the contact surface measured in axis direction of the roller element amounts to more than 0.4 μm, preferably to 0.4 μm-0.95 μm. This embodiment, too, serves to reduce the costs of producing the roller element and to improve the lateral guiding of the suspension element on the roller element.

According to another embodiment of the invention, the at least one contact surface of the roller element is finished by lathing, fine-lathing, or circular profile grinding. In that way, the desired contact surface roughness can be achieved at production costs as low as possible.

According to another embodiment of the invention, at least one contact surface of the roller element is coated, preferably with a chromium-containing coating. In that way, on the one hand, wear resistance can be improved. On the other hand, the maximum tractive relation between roller element and suspension element can be influenced.

According to another embodiment of the invention, the roller element is made of a heat-treatment steel and has a hardness of 15-30 HRC, at least in the areas of its at least one contact surface. In that way, a sufficient wear resistance of the roller element is ensured.

According to another embodiment of the invention, one or more roller elements form a one-piece unit with a drive shaft of a drive unit of the elevator system, with the roller element(s) and the drive shaft preferably having approximately the same diameter. This has the advantage that, on the one hand, at least one of these roller elements can, without problems, take over the function of a traction sheave to drive the suspension element, since it is combined with the drive shaft of the drive unit. On the other hand, production costs as well as time and work needed for assembly can be reduced by integration of the roller element(s) into the drive shaft.

According to another embodiment of the invention, the roller element is designed for interaction with at least one suspension element, which has the form of a flat belt, or a V-ribbed belt, or a V-belt, or has a round cross-section. The interaction of the roller element with the sheathing of such suspension elements, usually made of an elastomeric plastic, results in a defined maximum tractive force as well as in low wear, both at the suspension element and at the roller element.

Embodiment examples of a preferred roller element are explained below, on the basis of FIGS. 1H, 2H.

FIG. 1H shows a roller element 1h to drive and/or deflect a suspension element 2h in an elevator system, with the roller element 1h existing in the form of a traction sheave fixed on a drive shaft 3h of a driving unit. This roller element comprises three contact surfaces 4h, interacting in elevator operation with three suspension elements 2h in the form of flat belts, with a connection existing between these suspension elements 2h and an elevator car as well as a counterweight of the elevator system (described elsewhere), for carrying and driving the latter in an elevator well. The contact surfaces 4h are embodied as spherical, which serves to guide the suspension elements 2h (flat belts) during elevator operation in the centre of the respective assigned contact surface 4h.

In FIG. 2H, a second embodiment example of a roller element 11h for driving and/or deflecting a suspension element 12h in an elevator system is shown. The roller element depicted in FIG. 2H is integrated into the drive shaft 13h of a drive unit and constitutes a one-piece unit with the latter. The roller element 11h interacts with two suspension elements 12h, which are connected to an elevator car (not depicted) and a counterweight of an elevator system, to carry and drive them in an elevator well. The represented suspension elements 12h are of the shape of wire-rope-reinforced V-ribbed belts, the V-ribbed profile of which engages with corresponding V-grooves 15h of the roller element 11h. The flanks of these V-grooves 15h form contact surfaces 14h, via which the second roller element 11h interacts with the second suspension elements 12h. The suspension elements 12h each comprise a belt body 12.1h made of an abrasion-resistant elastomer, into which tension members 12.2h made of steel wire strands or synthetic fibre strands are embedded to ensure sufficient tensile strength. The integration of the roller element 11h shown in FIG. 2H into a drive shaft or deflection shaft 13h allows the use of roller elements 11h with very low diameters in combination with assigned shaft diameters as large as possible.

Roller elements 1h, 11h, as they are shown, for instance, in FIGS. 1H and 2H, are preferably made of steel, in particular of heat-treatment steel, which—at least in the area of the contact surfaces 4h, 14h—has a tensile strength of 600N/mm²-1000N/mm² and/or a Rockwell C hardness of at least 15 HRC.

The production of such roller elements 1h, 11h—in particular the treatment of their contact surfaces 4h, 14h—is preferably done by lathing and/or fine-lathing and/or circular profile grinding with machine tools suited to produce surfaces of low roughness.

Further options for treating the contact surfaces are sandblasting and/or shot-blasting and/or heat-treating, particularly surface heat-treating, and/or plasma hardening, and/or coating by means of electroplating procedures, and/or immersion procedures, and/or plastic engineering procedures. These treatment procedures can be applied in addition to or instead of lathing and/or fine-lathing and/or circular profile grinding and/or milling.

According to another embodiment of the invention, the contact surfaces 4h, 14h of the roller elements 1h, 11h are equipped with coatings that have a surface structure with the above-described roughness properties and are sufficiently wear-resistant. Chromium-containing coatings, in particular hard-chrome layers have proved useful, as they are described with respect to protection against wear, e.g. in ‘Schatt: Werkstoffe des Maschinen-, Anlagen- und Apparatebaues, 2nd edition, VEB Deutscher Verlag, Leipzig 1982’, p. 144. Further possibilities to protect the contact surfaces against wear can also be found in ‘Schatt: Werkstoffe des Maschinen-, Anlagen- und Apparatebaues, 2nd edition, VEB Deutscher Verlag, Leipzig 1982’, in section 8.3.4, pp. 352-361.

In another embodiment, the same had-chrome layer does not only serve as protection against wear but also as protection against corrosion. The use of this layer as corrosion protection is also described in ‘Schatt: Werkstoffe des Maschinen-, Anlagen- und Apparatebaues, 2nd edition, VEB Deutscher Verlag, Leipzig 1982’, in section 7.9.2, p. 312.

The contact surfaces 4h, 14h of the roller elements 1h, 11h are treated or coated in such a manner that the mean roughness value ^{U}Rₐ of the contact surfaces measured in circumferential direction of the roller elements differs from the mean roughness value ^{A}Rₐ of the contact surfaces measured in axis direction of the roller elements. Since the quality of treating the contact surfaces does not have to meet the defined top requirements for both directions, production costs can be saved. Besides, the lateral guiding of the suspension element on the roller element can be improved by means of an increase in the roughness of the contact surfaces in axis direction of the roller element. This is of a positive effect particularly with flat belts or V-ribbed belts as suspension elements. In FIGS. 1H and 2H, the directions for roughness measurement in circumferential direction are denoted by A, and the directions for roughness measurement in axial direction are denoted by B.

To reduce wear at the suspension elements—in particular with a relatively long-lasting slip between roller elements 1h, 11h and suspension elements 2h, 12h—the contact surfaces 4h, 14h are treated or coated in such a manner that the mean roughness value ^{U}Rₐ of the contact surfaces 4h, 14h measured in circumferential direction A of roller element 1h, 11h amounts to less than 1 μm. A still further prevention of wear can be achieved if the said mean roughness value ^{U}Rₐ ranges between 0.1 μm and 0.8 μm, with particular preference between 0.2 μm and 0.6 μm. A relatively long-lasting slip of up to 60 seconds duration may occur in an elevator system for instance if, due to a control defect, the elevator car or the counterweight impact on their lower track limits or are blocked otherwise.

The mean roughness value ^{U}Rₐ or ^{A}Rₐ is to be understood as the mean roughness value Rₐ defined in standard DIN EN ISO 4287.

An advantageous compromise between the demand for wear reduction and the demand for low production costs or for advantageous lateral guide properties can be reached with an embodiment of the roller elements 1h, 11h in which a difference of more than 0.2 μm exists between the mean roughness value ^{U}Rₐ of the contact surfaces 4h, 14h measured in circumferential direction of the roller elements, and the mean roughness value ^{A}Rₐ of the contact surfaces measured in axis direction of the roller elements.

As to the interaction with suspension elements in the form of flat belts or V-ribbed belts, advantageous results with respect to production costs and lateral guide properties can be achieved if the mean roughness value ^{A}Rₐ of the contact surfaces 4h, 14h measured in axis direction of the roller element amounts to more than 0.4 μm, preferably ranges from 0.4 μm to 0.95 μm.

Of course, further embodiments of the roller elements can be realized, for instance as interacting with at least one V-belt, round belt, or round steel wire rope, respectively.

The belt-type suspension elements preferably comprise belt bodies made of an abrasion-resistant elastomer, preferably of a thermoplastic elastomer. Examples of elastomers usable for belt bodies are polyurethane (PU), in particular ether-based polyurethane, or an ethylene propylene (diene) copolymer (EPM, EPDM), and these belt bodies are reinforced in longitudinal direction by tension members of steel wire strands or synthetic fibre strands. With the use of such suspension elements, the contact surfaces of the roller elements interact with the elastomeric material of the belt body of the suspension elements. That means that the contact surfaces are adjusted in their surface properties and structures especially to the requirements concerning interaction with these elastomeric materials, to achieve an optimal adjustment of traction, wear, slip behaviour, and service life of suspension element, roller element, and potential coatings.

If steel wire ropes are used as suspension elements, these steel wire ropes can interact with or without sheathing with the roller elements. Sheathings, here, are preferably also made of an elastomeric material, as described above.

An elevator system according to invention can comprise a traction sheave and/or a deflecting pulley the area of which interacting with the suspension element is equipped with inserts of a material different from the material of the roller body. Preferably, these inserts comprise a plastic the properties of which lead to desired effects in interaction with the suspension element, for instance to increased or reduced tractive capacity, reduced abrasion at the suspension element or at the traction sheave or the deflecting pulleys, or to lower noise emission. Materials suited for such inserts are, e.g., natural rubber or synthetic rubber, like polyurethane PU, to increase the tractive capacity, polyamide PA to reduce wear at roller elements and suspension elements, and polyethylene PE or PTFE (Teflon®) to reduce friction and noise emission in the area of traction sheaves and deflecting pulleys. Such inserts can be fixed to the base body of a traction sheave or deflecting pulley as one-piece parts or ring-shaped turned parts subdivided in sectors—for instance be pasted to it or attached by mechanical means—or they can be applied by means of a coating procedure and subsequently be finished, if necessary.

The inserts can be contoured, for instance to ensure lateral guiding of a belt-type suspension element by interacting with corresponding contours of the latter. Favourably, such contours comprise at least one rib or groove extending in the circumferential direction of the traction sheave or deflecting pulley, interacting with at least one corresponding groove or rib extending in longitudinal direction of the belt-type suspension element. By suitable shaping of the interacting ribs and grooves, as with the V-belt principle, improved tractive capacity can be achieved. The inserts can also comprise integrated flanged wheels, which guide the belt-type suspension elements at their side surfaces. Such traction sheaves or deflecting pulleys with inserts in the area of their interaction with a belt-type suspension element are revealed in WO99/43885. Features and embodiment details are represented in FIGS. 2 and 3, and especially are described in p. 12, line 6-p. 14, line 8, and herewith are incorporated into the present application.

Traction sheaves and deflecting pulleys with inserts in the area of their contact with the suspension elements are also applicable in elevator systems the suspension elements of which have the form of steel wire ropes, sheathed steel wire ropes, and sheathed synthetic fibre ropes. Materials suitable for such inserts include especially those materials listed in the previous paragraph to be used for inserts in traction sheaves/deflecting pulleys for belt-type suspension elements. Such traction sheaves or deflecting pulleys with inserts in the area of their interaction with suspension elements are revealed, e.g., in EP1511683. Features and embodiment details are depicted in FIG. 4 and especially described in description sections [0021] and [0022], and are herewith incorporated into the present application.

According to another embodiment example, the elevator system according to invention comprises a traction sheave the surface of which, interacting with the suspension element, is hardened only partially, i.e. in the area of certain sectors of the circumferential surface, so as to reduce wear of the said surface. The advantages of such sectorial hardening are lower hardening costs and a lower risk of cracks occurring in the traction sheave during operation due to hardening strain in the material.

Such a traction sheave is revealed in EP1471030. Embodiment details and procedural features are described especially in FIG. 1 and in the description paragraphs [0019] to [0031], and are herewith incorporated into the present application.

An elevator system according to invention can comprise a traction sheave or a deflecting pulley in which provisions have been made to laterally guide a belt-type suspension element running over them. The following paragraphs relate to embodiments of such traction sheaves or deflecting pulleys.

The traction sheave or deflecting pulley can be equipped with flanged wheels provided for the suspension element on both sides of the riding surface so as to prevent too large a lateral deviation of the suspension element. A traction sheave or deflecting pulley can comprise riding surfaces for more than one suspension element, and in that case flanged wheels are arranged at both sides of each riding surface. Preferably, the radial lateral surfaces of the flanged wheels facing a respective suspension element are embodied such that the angle between them and the riding surface amounts to more than 90°.

In one embodiment example, an elevator system according to invention comprises a traction sheave or a deflecting pulley to drive or guide several flat-belt-type suspension elements arranged in parallel. The deflecting pulley or traction sheave comprises a central hollow axis and several ring bodies and distance washers centred on it, which are alternately aligned in axial direction and are interlinked, preferably by means of screws. Here, the circumferential areas of the ring bodies form the riding surfaces for the suspension elements, and the distance washers arranged between them form guide elements protruding above the ring bodies, which guide the flat-belt-type suspension elements laterally on the deflecting pulley or traction sheave. The said circumferential surfaces of the ring bodies can be equipped with vaults that facilitate the guiding of the suspension elements in the middle of the ring bodies. According to a preferred embodiment, the distance washers have a lower friction coefficient in relation to the suspension elements than the riding surfaces of the ring bodies. U.S. Pat. No. 6,405,833 reveals such a traction sheave or deflecting pulley. Features and embodiment details are represented in FIGS. 1, 2, 3 of this US document and in the respective description, in particular in column 2, line 44-column 3, line 47. Herewith, they are incorporated into the present application.

An elevator system according to invention can comprise a traction sheave or deflecting pulley which has at least one guide groove or guide rib on the circumferential surface interacting with the belt-type suspension element to laterally guide a belt-type suspension element running over them. This guide groove or guide rib extends in circumferential direction of the roller and interacts with at least one corresponding rib or groove of the suspension element extending in longitudinal direction of the latter, such that the suspension element is guided on the traction sheave or the deflecting pulley. Favourably, several guide grooves and/or guide ribs are distributed over the width of the roller or the belt-type suspension element, respectively. By a wedge-shaped or trapezoidal design of the guide ribs and/or guide grooves, the traction effect can be increased, as is the case with the V-belt principle.

In a modified embodiment variant, the flat-belt-type suspension element has a guide groove, and the deflecting pulley/traction sheave has a guide rib. In a second embodiment variant, the assignment is vice versa. An elevator system with such suspension elements or deflecting pulleys/traction sheave is revealed in WO2006/042427. Features and embodiment details, in particular the details regarding the suspension elements as well as the embodiment of the deflecting pulleys or the traction sheave, are described in FIGS. 2-9 and in the respective description, p. 10, line 10-p. 15, line 32. Herewith, they are incorporated into the present application.

In another embodiment example, an elevator system according to invention comprises a suspension element system with a belt-type suspension element 12.3 having several ribs 20.3 or grooves with wedge-shaped cross-section that extend in longitudinal direction of the suspension element. In this suspension element system, the suspension element 12.3 interacts with a traction sheave or with deflecting pulleys 4.3 that have corresponding grooves or ribs 22.3 with V-shaped cross-section extending in circumferential direction. The flank angle β between the flanks of the V-shaped ribs and grooves ranges from 60° to 120°, preferably from 80° to 100°, with special preference it amounts 90°. Favourably, the traction sheave or the deflecting pulleys are embodied such that a cavity 34, 35 exists between a rib ridge of the V-ribs 20.3, 22.3 and a corresponding groove bottom, when the suspension element bears on the suspension element roller 4.3. Thereby it is achieved that the suspension element and the traction sheave or the deflecting pulleys have contact with each other exclusively in the area of the inclined flanks of their ribs and grooves, but not at the groove bottom. In that way, dirt and rubbings can gather in the said cavity, thus reducing wear and increasing the service life of the traction sheave or deflecting pulley and/or the suspension element. A suspension element system of the mentioned type is revealed in EP1777189. Features and details regarding the embodiment of the deflecting pulleys or the traction sheave are described, in particular, in FIGS. 5-8 as well as in the respective description, column 8, line 32-column 11, line 25. Herewith, they are incorporated into the present application.

In another embodiment of a traction sheave or deflecting pulley interacting with at least one suspension element in form of a flat belt, the at least one riding surface for the flat belt is not embodied as completely cylindrical but, transversely to the circumferential direction, has a vault which causes a centring of the flat belt in the middle of the riding surface. In cross-sectional view along the rotation axis, this vault can have throughout the form of a circular arc, with the circle radius for instance amounting to about 1000 mm. Preferably, the vault can also be designed such that, with an increasing distance x of a curve point from the middle of the riding surface (measured in the direction of the sheave axis), the sheave radius is reduced by an increasing value y=xⁿ. In that formula, the distance x has to be entered in metres, and the exponent n has to be set to a value of about 2. The calculated value y of the radius reduction hence also has the dimension of metres. The vault height of the thus defined vault of the riding surface can be reduced in the area of the middle of the riding surface in such a manner that in this area the riding surface assumes a cylindrical form. A traction sheave or deflecting pulley with a riding surface with one of the described vault forms is revealed in WO2006/022686. Features and embodiment details are represented in FIGS. 2-4 and are described in particular in p. 3, line 9-p. 4, line 32 of the respective description. Herewith, they are incorporated into the present application.

For guiding belt-type suspension elements on a traction sheave or a deflecting pulley, suspension element guide pulleys can be installed. In a special embodiment, such suspension element guide pulleys are arranged at both sides of each suspension element and at both sides of a traction sheave/deflecting pulley, that is, in their respective run-in areas. The distance of the suspension element guide pulleys to the contact point between suspension element and traction sheave/deflecting pulley is here at least 5 times the width of the belt-type suspension element. The central rotation planes of the suspension element guide pulleys align here approximately with the central plane of the belt-type suspension element, parallel to the axes of the traction sheave/deflecting pulley. Each circumferential surface of the suspension element guide pulleys is located, at some distance, opposite a side surface of an assigned suspension element, respectively. As soon as the suspension element deviates by a certain distance from its central position on the riding surface, one of its side surfaces gets into contact with the circumferential surface of a guide pulley, whereby further lateral deviation is prevented in a frictionless way by the guide pulley. Favourably, the suspension element guide pulleys have a roundabout circumferential groove in the area of their circumferential surfaces, which in such a case is able to receive a margin area of the belt-type suspension element and guide this margin area such that it cannot dodge, due to the directing force of the suspension element guide pulleys transverse to the said central plane of the suspension element.

In elevator systems where the distance between belt-type suspension elements arranged in parallel side by side is too low to install suspension element guide pulleys between them, the suspension element guide pulleys can be replaced by suspension element guide plates preventing a lateral drifting of the belt-type suspension element by guiding it slidingly at its side surfaces. Such suspension element guide plates are favourably also mounted at a distance to the contact point of suspension element and traction sheave/deflecting pulley that amounts to at least to 5 times the width of the belt-type suspension elements. Materials suitable for such suspension element guide plates are, in particular, steel plates coated with nano-particles, for instance plates produced by sputtering MoS2, Ti—MoS2, or graphite onto the base metal, or plates of abrasion-resistant, low-friction plastic, e.g. of polyamide (PA), or polyethylene terephthalat (PETP), which preferably contain a solid lubricant like MoS2 or graphite.

An elevator system according to invention can comprise a traction sheave or deflecting pulleys in many different arrangements. Examples of such arrangements are revealed in EP1446348 and are specified in short below: FIGS. 1A, 1B, 2, 3, and 4 of EP1446348 show elevator systems with an elevator car, a counterweight, and a drive unit arranged in the well headroom with at least one traction sheave. Belt-type suspension elements wrap the traction sheave, and its strands side-of-car under-sling the elevator car and carry it via deflecting pulleys arranged at the car bottom side. With its strands side-of-counterweight, the suspension elements carry the counterweight via deflecting pulleys arranged at its upper side. As represented in FIG. 4, the guide rails of the elevator car can protrude into interspaces existing between two of the above-mentioned deflecting pulleys of the elevator car, which allows to install an elevator car as big as possible in a given well space. Embodiment details, in particular details regarding the arrangement of the deflecting pulleys, are described in p. 12, line 1-p. 16, line 4, and are herewith incorporated into the present application.

FIGS. 5A, 5B of EP1446348 show an elevator system comprising an elevator car, a counterweight, and a drive unit with a traction sheave arranged in the well headroom. The elevator car and the counterweight are directly coupled to the ends of suspension elements, with one of the suspension elements being guided from the counterweight via the traction sheave to the side of the elevator car facing the drive unit, and another suspension element being guided from the counterweight via the traction sheave and a deflecting pulley arranged in the well headroom to the side of the elevator car looking away from the drive unit. Embodiment details, in particular the details of the arrangement of the said deflecting pulley, are described in p. 16, line 6-p. 17, line 2, and are herewith incorporated into the present application.

FIGS. 6A, 6B of EP1446348 show an elevator system comprising an elevator car, two counterweights arranged laterally of the elevator car, and a drive unit with two traction sheaves arranged in the well headroom. The elevator car and the counterweights are carried by belt-type suspension elements arranged at both sides of the elevator car and driven by the said traction sheaves. To guide the suspension element and to carry the elevator car and the counterweight, four deflecting pulleys are arranged in the well headroom, one deflecting pulley at each counterweight, and one deflecting pulley at each side of the elevator car. Embodiment details, in particular details regarding the arrangement of the deflecting pulleys, are described in p. 17, line 14-p. 18, line 21, and are herewith incorporated into the present application.

FIGS. 7A, 7B of EP1446348 show an elevator system very similar to the elevator system revealed in FIGS. 6A, 6B but with the advantage that the suspension elements is deflected or bent always in the same bending direction. Embodiment details, in particular details regarding the arrangement of the deflecting pulleys, are described in p. 19, lines 9-16, and are herewith incorporated into the present application.

FIGS. 8, 9 of EP1446348 show elevator systems with an elevator car and a counterweight each, where the elevator car and the counterweight are suspended on a suspension element suited for the carrying function, which is guided over a deflecting pulley arranged in the well headroom. The driving of the elevator car and the counterweight is effected through a traction sheave of a drive unit arranged below, via a belt-type drive element suited for the drive function, the one end of which is fixed at the elevator car and the other end of which is fixed at the counterweight. Embodiment details, in particular details regarding the arrangement of the deflecting pulleys, are described in p. 19, line 29-p. 20, line 15, and are herewith incorporated into the present application.

FIGS. 10A, 10B of EP1446348 show an elevator system with an elevator car and a counterweight. The elevator car is coupled to the counterweight by means of two suspension elements suited for the carrying function. These suspension elements are guided over two deflecting pulleys installed in the well headroom, with the latter being arranged in such a manner that one of the suspension elements is guided to one of two opposing sides of the elevator car, where it is fixed at the elevator car. The drive of the elevator car and the counterweight is effected through a drive unit located laterally above, via a belt-type drive element suited for the drive function. This belt-type drive element wraps a traction sheave of the drive unit and a deflecting pulley arranged below, with both ends of the drive element being coupled to the counterweight and driving the latter. The driving of the elevator car is effected via the above-described suspension elements. An embodiment of this elevator system as well as embodiment details, in particular details regarding the arrangement of the deflecting pulleys, are described in p. 20, line 17-p. 21, line 12, and are herewith incorporated into the present application.

According to another embodiment example, the elevator system according to invention can comprise deflecting pulleys the arrangement of which is revealed in EP1555236 and is specified in short below: FIG. 1 of EP1555236 shows an elevator system with an elevator car and a counterweight and a drive 7 fixed at a well ceiling, which comprises a drive module 11 and a deflection module 19. Elevator car and counterweight are suspended on several suspension elements arranged in parallel, which are driven by the drive module 11 arranged over the centre of the elevator car, and deflected over the counterweight centre by deflecting pulleys existing in the deflection module 19. As can be seen in particular from FIGS. 5, 6, 7, 9, 10 of EP1555236, the distance between drive module 11 and deflection module 19 or the deflecting pulleys is adjustable. In that way, the different suspension element distances existing in different elevator systems between strands of the suspension elements leading to the elevator car and those leading to the counterweight can be adapted to the respective requirements. Features and embodiment details, in particular details regarding the arrangement of the deflecting pulleys, are especially described in column 4, line 53-column 6, line 18, and are herewith incorporated into the present application.

In a modified embodiment example, both elevator car and counterweight in the above-described elevator system according to invention are equipped with deflecting pulleys, by means of which they are each suspended on two strands of several suspension elements. In that way, both for the elevator car and for the counterweight a so-called 2:1-suspension is given. For each suspension element there are separate deflecting pulleys, supported in separate roller casings. Each deflecting pulley together with its roller casing forms a deflecting pulley unit 10 separate of the other deflecting pulley units 10. These deflecting pulley units 10 are connected with the elevator car or the counterweight, with the distance between each of the deflecting pulley units 10 and the elevator car or the counterweight being individually adjustable. This arrangement of the deflecting pulleys allows to compensate different elongations of the suspension elements, leading to the adjustment of equal tensile loads for all suspension elements. Such an embodiment example is revealed in EP1621508. Features and embodiment details, in particular details regarding arrangement and support in bearings of the deflecting pulleys, are especially described in FIGS. 2-5, and in column 3, line 19-column 5, line 48, and are herewith incorporated into the present application.

According to another embodiment example of an elevator system according to invention, the latter can comprise an arrangement of a belt-type suspension element in which the suspension element is twisted around its longitudinal axis between two consecutive deflecting pulleys or between a traction sheave and a following deflecting pulley. Preferably, the twisting angle amounts to 180° or 90°. A reason for such twisting of suspension elements may lie in the fact that the belt-type suspension element is equipped with guide profiles only at one side, and only by such twisting can it be achieved that with certain arrangements of consecutive rollers the suspension element will always bear on the rollers with its profiled side. Another reason may be a favourable course of the suspension element, in which the axes of consecutive rollers are not arranged in parallel but as twisted by 90° against each other, for instance to allow the positioning of a drive unit in a space-saving way. Examples of such suspension element arrangements are revealed in EP1550629. Features and embodiment details, in particular details regarding arrangement and embodiment of the deflecting pulleys or traction sheaves, are especially described in FIGS. 1, 3A, 3B, 5A, 5B, and 6, as well as in the respective description, in column 4, line 21-column 7, line 49, and are herewith incorporated into the present application.

In another embodiment example, an elevator system according to invention comprises a suspension element interacting with an elevator car and a counterweight, and at least one roller element wrapped by this suspension element, for instance a traction sheave or a deflecting pulley. The suspension element has an arrangement of tension members and a sheathing around these tension members, with the sheathing being equipped, in an area of its surface designed for the wrapping of a roller element, with a longitudinal structure, e.g. a longitudinal rib. The roller element has a groove along its circumference, in which the suspension element is received. The groove has a groove bottom of basically even form, i.e. appearing as a straight line in cross-sectional view.

According to a preferred embodiment, the tension member arrangement comprises only two tension members. This allows to embody the suspension element with a width/height ratio>1 and at the same time≦3. The lower limit 1 ensures that the suspension element as a whole is flat, and allows smaller deflection radiuses and hence smaller roller elements as compared to known ropes with circular cross-section, e.g. with a width/height ratio=1. At the same time, the upper limit 3 ensures that the transverse forces appearing in the suspension element do not grow too large, thus preventing excessive wear. Besides, a suspension element the width/height ratio of which, due to the two tension members, ranges in the proposed interval according to invention has a sufficient flexibility in width direction, which facilitates mounting.

The tension members can be made of carbon, aramid, or other plastics with sufficiently high tensile strength. Preferably, however, they are made of metal wires, in particular of steel wires, which are especially favourable as to manufacturability, deformability, strength, and service life. The wires can be singly or multiply stranded to ropes, where a rope can be stranded of several strands. A strand, in turn, comprises stranded wires. In the strands and/or the rope, a core can be arranged, in particular a textile or plastic core. The interspaces between the wires or strands are preferably filled partly or completely by material of the sheathing around the tension members. This prevents contact among the strands and/or wires moving against each other when the suspension element bends, thus reducing wear of the latter.

In another preferred embodiment, the two tension members are laid in opposite sense, i.e., the rope forming the one tension member of the tension member arrangement has a right-hand lay, and the rope forming the other tension member has a left-hand lay. In that way, twisting tendencies of the two tension members offset each other, thus favourably counteracting a twisting of the suspension element.

In a modification of the suspension element embodiment, the tension members, or the steel wires forming the latter, or the wires stranded to the latter have a maximum extension vertical to their longitudinal axes ranging from 1.25 mm to 10 mm, preferably from 1.25 mm to 2.5 mm, and in particular basically equaling 1.5 mm. This has proved to be a good compromise regarding weight, strength, and manufacturability. In particular, with such tension members favourably small deflection radiuses can be realized. With the use of such suspension elements in elevators with heavy weights, preferably steel ropes with a diameter of up to 8 mm are employed.

If the tension members have, for instance, a basically round cross-section, the said maximum extension equals the diameter of the tension member. Such a suspension element can be produced particularly easily, since in the arrangement of the tension members in the sheathing no attention has to be paid to the orientation in relation to the longitudinal axis. Equally, the tension members can also have oval or rectangular cross-sections, which are particularly suitable for realizing the width/height ratio between 1 and 3 according to invention.

An alternative embodiment according to invention conceives an at least punctual contact of the two tension members. This allows the production of particularly space-saving suspension elements.

In a modified embodiment, the longitudinal structure of the exterior surface of the suspension element has at least one groove running in the longitudinal direction of the suspension element. This favourably increases the flexibility of the suspension element without significantly reducing its tensile strength. A groove is here conceived preferably in the area of the exterior surface with which the suspension element wraps a roller element of the elevator.

Such a groove can, for instance, be generated by making the exterior surface of the suspension element basically follow an external contour of the two tension members arranged side by side, at least at one of its broadsides.

In another embodiment, the exterior surface on both broadsides basically follows the external contour of the tension members arranged aside one another. In that way, both tension members are favourably sheathed with basically the same wall thickness everywhere, so that tensions within the suspension element will distribute homogeneously. At the same time, a favourable groove as explained above results in a simple way between the two tension members, on the respective opposite broadsides of the suspension element. Furthermore, such an exterior surface or sheathing can be produced with little sheathing material, which means cost-effectiveness.

Evidently, this embodiment with a groove on one or both broadsides of the suspension element can also be realized in embodiments with several tension members arranged aside one another in a plane, with the number of grooves per broadside increasing respectively. The plane in which the tension members are arranged aside one another is arranged preferably in parallel with the longitudinal axis of the suspension element, both for two and for more tension members in the suspension element.

The groove or canal can also be arranged closely below the exterior surface of a suspension element. This enables transverse contraction, in particular with distanced tension members, and yet the pressing of the suspension element is concentrated in the area of the tension member, and a central area of the suspension element remains relieved of pressing. The central area equivalent to the pressing-relieved area of suspension element and groove favourably amounts to about 20%-50% of the suspension element width.

The sheathing can enclose each of the two tension members trapezoidally. In that way, favourably inclined exterior flanks of the suspension element are created which, due to the wedge effect, with equal pre-tension favourably increase the contact force and hence the tractive capacity of a traction sheave.

Preferably, the suspension element is embodied as symmetric relative to a thought transverse axis in its width direction, which, in the wrapping of a roller element, runs in parallel to the axis of the roller element. This facilitates mounting, since the suspension element can also be put on as twisted by 180°, and favourably enables the opposite-sense wrapping of consecutive roller elements with approximately identical exterior surface contours.

An elastomer has proved to be particularly suitable as sheathing material, e.g. polyurethane (PU), or ethylene propylene diene rubber (EPDM), which is of advantage with regard to damping and friction properties as well as wear behaviour.

The exterior surface can selectively be influenced. To this end, different areas of the suspension element can be (even differently) coated. So, one area may have a coating to reach good sliding properties. This area can, for instance, be an area of the suspension element looking away from the traction area, or a lateral area. One area, in particular the traction area of the suspension element, favourably has a coating to reach good traction or force transfer. One area of the suspension element may also have a colour coating or differ in colour due to a differently coloured material. This is of advantage in mounting, since a potential unintended twisting of the suspension element can be easily recognized and corrected on the basis of the differently coloured areas. If the sheathing has a multi-layered structure using differently coloured layers, also a wear or abrasion status can be easily recognized, on the basis of colour differences.

Such coating or layer structure can be achieved for instance by spray-applying, pasting, extruding, or flocking on a respective layer or coating. A layer in the layer structure can preferably comprise a plastic, and/or a composite plastic, and/or a tissue. By selection of a composite plastic, in particular wear resistance, roughness, compressive and tensile strength of the layer can be influenced, which is important above all if this layer acts as the exterior layer of the suspension element. Particles of metal, metal alloys, metal oxides, and/or carbon particles, and/or natural or synthetic fibres, and/or two-dimensional tissue layers may serve as composite materials in connection with the plastic. To optimize the properties of the layer in a direction-dependent way, above all linear particles or fibres with a texture—i.e., with a preferred alignment of the linear particles or fibres—can be processed with the plastic to form a composite material.

An elevator system according to the present invention comprises a car and a counterweight coupled to the latter via a suspension element. The suspension element interacts with the car and the counterweight so as to hold or elevator them, and, to this end, can be fixed directly at the car and/or the counterweight, respectively, e.g. by a wedge lock, or wrap one or more roller elements connected with car or counterweight.

The suspension element has a tension member arrangement and a sheathing around the tension member arrangement which, in an area of an exterior surface that wraps a roller element of the elevator, has a longitudinal structure. The roller element has a groove for lateral guiding of the suspension element, in which the suspension element is at least partly received. The suspension element wraps the roller element at least partly, e.g. by basically 180°.

According to invention, the groove bottom of the groove on which the suspension element bears with one of its broadsides in wrapping the roller element is embodied as basically constantly even or flat. In that way, the production of such a roller element is easy and relatively cost-effective. Mounting-friendliness of the elevator is also increased, since the longitudinal structure of the suspension element does no longer have to be oriented to a complementary structure of the groove bottom. In particular, the even groove bottom allows deformations within the suspension element and a more homogeneous distribution of tension over the cross-section of the suspension element. The groove as lateral limit stop ensures sufficient lateral guiding of the suspension element without impeding such deformations. Favourably, the groove follows at both edges of the suspension element approximately the form of the latter. To say it the other way round, the groove comprises a run-in area and a guide area. The run-in area is usually not in contact with the suspension element in the area of wrap, and changes into the guide area, which in the area of wrap contacts with the suspension element. The groove thus follows, with its lateral borders corresponding with the narrow side of the belt, the structure of the suspension element, while the groove bottom extending between these lateral limits is even, i.e., does not show any intermediate elevations or depressions.

The roller element wrapped by the suspension element and receiving the latter in its groove with flat groove bottom can be a deflecting pulley or a traction sheave. Also, several—preferably all—roller elements of the elevator wrapped by the suspension element can be equipped with grooves, in each of which the suspension element is at least partly received and which have an even or flat groove bottom.

In a favourable embodiment, the roller element is embodied such that several grooves with flat groove bottom are arranged side by side. In that way, several suspension elements of the same type can be guided, deflected, and/or driven beside one another.

One or more traction sheaves can here be coupled with a drive of the elevator, the torques of which applied to the roller element are fed in a non-positive way as longitudinal forces into the suspension element. Such a drive can comprise one or more asynchronous motor(s) and/or permanent magnet motor(s). This embodiment enables drives with small dimensions, so that the total space required for the elevator in a building can be reduced. To this end, the elevator can particularly be embodied as without a machine room.

With particular advantage, a suspension element according to invention as described before is used in an elevator according to invention. The respective advantages explained, in particular regarding lower wear and higher mounting-friendliness, will result accordingly.

The roller element, in particular the traction sheave, is favourably made of steel or cast material (grey iron, spheroidal graphite cast iron). The grooves of the traction sheave are preferably directly (i.e. especially in a one-piece way) worked into a shaft which is drivably connected to a motor. In a preferred embodiment, the groove bottom has a mean roughness in circumferential direction ranging from 0.1 μm to 0.7 μm, especially from 0.2 μm to 0.6 μm, and with particular preference from 0.3 μm to 0.5 μm. In axial direction, the groove bottom preferably has a mean roughness ranging from 0.3 μm to 1.3 μm, especially from 0.4 μm to 1.2 μm, and with particular preference from 0.5 μm to 1.1 μm. By means of these roughness grades, a friction coefficient in circumferential direction can be adjusted so that a sufficient tractive force is transferred while the suspension element is guided non-positively in axial direction, and excessive wear at the groove flanks is prevented.

To reach a desired surface property, the roller element can be coated. Alternatively, the roller element, in particular a deflecting pulley without traction function, can be made of plastic into which the required grooves are worked in or moulded directly.

In FIG. 1P, an elevator according to an embodiment of the present invention is schematically represented. It comprises a car 3p traversable along rails 5p in a well 1p, and a counterweight 8p coupled to it, moving in the opposite sense, guided by a rail 7p. A suspension element 12p according to invention described in more detail below is fixed with its one end, as inertia-resistant, at a first suspension point 10p in well 1p. Starting from there, it wraps a deflecting pulley 4.3p connected to counterweight 8p, by 180°, and then a traction sheave 4.1p, also by 180°. Then, after a twisting of 180° around its longitudinal axis, it wraps two deflecting pulleys 4.2p integrated in the bottom 6p of car 3p, in the same sense, by 90° each, and is fixed with its other end at a second suspension point 11p in well 1p. Between the two deflecting pulleys 4.2p connected with car 3p, two further deflecting pulleys 4.4p, which are wrapped by suspension element 12p by about 12° each, tension the suspension element with respect to the car bottom 6p, thus improving its guide in the deflecting pulleys 4.2p. The traction sheave 4.1p of the elevator without machine room is driven here by an asynchronous motor 2p arranged in well 1p, so as to hold or elevator car 3p and counterweight 8p.

FIG. 2P shows the upper half of traction sheave 4.1p of the elevator of FIG. 1P and the suspension element 12p wrapping it, according to an embodiment of the present invention, in cross-sectional view. The suspension element 12p comprises two tension members 14p arranged axially in relation to the traction sheave beside one another, which each comprise 9 strands stranded with one another. The core strand here is three-layered, made of 19 steel wires stranded with each other, and surrounded by 8 two-layered exterior strands, each comprising 7 stranded steel wires. The two tension members 14p have opposite directions of lay. To this end, the exterior strands of the one tension member are laid around the respective core strand with right-hand lay, the strands of the other one with left-hand lay. This counteracts a twisting of the suspension element 12p.

The tension members 14p have a diameter d of about 2.5 mm. Thereby, favourably, significantly lower deflection radiuses and hence smaller traction sheaves and/or deflecting pulleys can be realized, while a favourable diameter ratio D/d of, e.g., ≧40 is maintained, with D denoting the diameter of the traction sheave. In that way, the required installation space of the elevator can be favourably reduced. Of course, smaller diameter ratios D/d<40 can also be realized if high-strength tension members are used.

The two tension members 14p are embedded in a sheathing 13p of EPDM. This sheathing has an exterior surface 13.1p, which essentially follows the external contour 14.1p of the two tension members 14p indicated by a dashed line in FIG. 2P. As these tension members arranged side by side have a basically circular external contour 14.1p, the exterior surface 13.1p of the suspension element 12p, in cross-sectional view, has basically the shape of a lying sandglass, with a groove 13.2p in longitudinal direction of the suspension element 12p being embodied on each of the two broadsides (above, below in FIGS. 2P, 3P). Thereby, favourably, the wall thickness of the sheathing 13p surrounding the tension members 14p is basically the same everywhere, which leads to an improved tension distribution in suspension element 12p. At the same time, the grooves 13.2p facilitate a minor internal movement of the tension members 14p in the sheathing 13p relative to each other, so that transverse forces in the suspension element 12p can be reduced. A fixed embedding of the tension members 14p in sheathing 13p, however, may also be desired. Accordingly, a sheathing material or a production method is chosen which enables a good bonding of the sheathing material into the tension member.

Due to its structure, the suspension element 12p has a ratio B/H=2 of its width B in axial direction of the traction sheave 4.1p to its height H in radial direction of the traction sheave 4.1p. Thereby, at the same time small deflection radiuses and yet sufficient flexibility of the suspension element are ensured, particularly in the direction of its width. This increases the mounting-friendliness of the more flexible suspension element 12p, which can more easily be put on the roller elements 4.1p to 4.4p.

To still further increase the mounting-friendliness, the suspension element is shaped symmetrically relative to its transverse or upward axis (running in width or height direction and perpendicular to its longitudinal direction), so that it can be also put on as twisted by 180°. Consecutive roller elements with the same exterior surface contours can, without problems, be wrapped in opposite senses by respectively designed suspension elements, with the suspension elements, due to their exterior surfaces embodied as counter-equal to the grooves of the roller elements, being guided by the latter.

The suspension element 12p is received in a groove 15p of the traction sheave 4.1p in such a manner that, in the shown cross-section, it lies completely within the groove 15p. In the shown wrapping position, the suspension element touches the two flanks of groove 15p laterally (left, right in FIG. 2P), bordering the groove bottom 15.1p in an approximately line-shaped guiding area, and bears on the groove bottom 15.1p, while not touching the run-in areas 15.2p of the flanks. The groove bottom 15.1p thus wrapped by suspension element 12p is embodied as even or flat according to invention. This facilitates the above-explained internal movement in suspension element 12p, so that transverse forces in suspension element 12p are reduced, which counteracts wear of suspension element 12p and traction sheave 4.1p.

The deflecting pulleys 4.2p to 4.4p have similar grooves with even groove bottom (not depicted), in which the suspension element wrapping the deflecting pulleys 4.2p to 4.4p is received in the same manner as was described with respect to FIG. 2P for traction sheave 4.1p.

FIG. 3P shows a suspension element 12p as it is known from FIG. 2P. In this example, the suspension element 12p is again received in a groove 15p of the traction sheave 4.1p. The groove 15p comprises the groove bottom 15.1p, a lateral guiding area 15.3p, and a lateral run-in area 15.2p. The groove bottom, according to invention, is embodied as flat or even. The flanks of groove 15p or its guiding areas 15.3p follow approximately the outer shape of the suspension element 12p, up to approximately its broadest point. The run-in areas 15.2p are not in contact with suspension element 12p over the wrapping area. Towards groove bottom 15.1p, each run-in area 15.2p changes into the guiding area 15.3p, which is in contact with suspension element 12p over the wrapping area.

If the groove 15p of a traction sheave is equipped with a surface influencing the friction coefficient, the run-in area 15.2p is favourably embodied as reducing the friction coefficient, and the groove bottom 15.1p as increasing the friction coefficient. If the guiding area is not just equivalent to a narrow line, as in FIG. 2P, the guiding area 15.3p is favourably embodied as transition area with respect to the friction coefficient. The part neighbouring the run-in area 15.2p is preferably embodied with a reduced friction coefficient, and the part neighbouring the groove bottom 15.1p with an increased friction coefficient. Thereby, a safe traction transfer from the groove to the suspension element is achieved, and at the same time, the lateral guiding is done with as little friction as possible.

FIG. 4P shows a modification according to invention of the traction sheave 4.1p of the elevator shown in FIG. 1P, which is wrapped by a suspension element 12p according to another embodiment of the present invention. Below, only the differences to the embodiments according to FIGS. 1P-3P will be discussed.

According to the further embodiment of the present invention according to FIG. 4P, the sheathing 13p of suspension element 12p is embodied as trapezoidal or polygonal. In particular, the sheathing areas enclosing a respective tension member 14p have a trapezoidal cross-section on opposite broadsides of suspension element 12p (above, below in FIG. 4P). Thereby, also the two grooves 13.2p formed between the tension members 14p have a trapezoidal cross-section. The opposite narrow sides of suspension element 12p (left, right in FIG. 4P) are hence also shaped trapezoidally and have a defined angle with respect to the radial direction of traction sheave 4.1p.

The flanks 15.2p of groove 15p in traction sheave 4.1p opposing each other in axial direction are inclined relative to the radial direction by the same angle, so that the suspension element 12p received in groove 15p with trapezoidal cross-section bears on these flanks 15.2p with its outer inclined surfaces facing traction sheave 4.1p. By the thus produced wedge effect, with the same pre-tension in suspension element 12p the tractive capacity is favourably increased.

As indicated in FIGS. 3P and 4P, the suspension element does not have to be received completely in groove 15p in radial direction but can protrude radially from it. If, however, the suspension element 12p is completely received in groove 15p, like in the modification depicted in FIG. 2P, this can have a protective effect against damages of suspension element 12p.

FIG. 5P shows an alternative embodiment of suspension element 12p, based on the embodiment according to FIG. 3P. According to this embodiment, the two tension members 14p have contact at least at certain points. An external contour of the individual tension members 14p is given by the structure of the individual wires stranded in the outer strands. The two tension members 14p are pushed that close towards each other that a part of their respective outermost wires contact with each other. The sheathing of this embodiment of the suspension element is embodied in such a manner that in the area between the two tension members, a groove 13.2p or indentation results on both broadsides of the suspension element. The groove 15p of traction sheave 4.1p has an even or flat groove bottom 15.1p. Accordingly, a pressing between groove bottom 15.1p and suspension element 12p is low over an area R of the groove bottom corresponding with groove 13.2p of the suspension element. The represented suspension element 12p has a defined width B, and in the represented example, the portion (R/B) of the area R free of pressing amounts to about 30%.

FIG. 6P shows a combination of the embodiments according to FIG. 4P and the tension member arrangement according to FIG. 5P. In this embodiment, the special design of groove 13.2p allows the sheathing material 13 of suspension element 12p to deform slightly according to the effective groove width and shape and adapt to the actual shape of the groove.

Such adaptations are necessary since due to manufacturing tolerances there are always more or less significant deviations in the external shape of the suspension element and the groove shape of a roller element. This does not only hold for the embodiment according to FIG. 6P, it is valid for all embodiments according to invention.

FIG. 7P shows another embodiment of suspension element 12p, which is received in a groove 15p with even groove bottom 15.1p. In this embodiment of suspension element 12p, the groove 13.2p or a canal is arranged closely below the external surface 13.1p of suspension element 12p. In that way, a transverse contraction of the suspension element becomes possible. Nevertheless, the suspension element pressing is concentrated in the area of the tension members 14p, and a central area R of suspension element 12p remains relieved of pressing.

FIG. 8P shows another embodiment of groove 15p with even groove bottom 15.1p to receive suspension element 12p. The guiding area 15.3p is widened in the direction of the run-in area 15.2p in such a way that an air gap 19p exists between guiding area 15.3p and the unloaded suspension element 12p. This is favourably realized by a guiding area radius RR of guiding area 15.3p exceeding a suspension element radius RT of the unloaded suspension element 12p. With such a groove shape, the sheathing material of suspension element 12p can also be chosen as a bit softer or more flexible, so that it slightly deforms under load. The tendency of the sheathing material to deform under operation conditions heavily depends on its composition and the resulting properties. The change of shape under load results from a tensile stress, which for instance is caused by the load of a car hanging on the suspension element, and from a bending stress, which is caused by the deflection of the suspension element around traction sheave 4.1p. The widening of guiding area 15.3p has the effect that under load the suspension element 12p can freely—without constraining transverse limits—adopt a shape corresponding to its properties.

Favourably, the guiding area radius RR or the widened guiding area 15.3p are designed in such a manner that the suspension element 12p, in a deflection over traction sheave 4.1p, with an active force normally to be expected, can ovalize in such a manner that it essentially assimilates to the guiding area radius RR or the widened guiding area 15.3p. The active force normally to be expected usually correlates with a normal operation state of the elevator system or an operation state under maximum load. For such an operation state, the suspension element according to invention is favourably configured such that it ovalizes in its running around traction sheave 4.1p or deforms in a natural way, as it is depicted in FIG. 8P by the dashed line 12.1p. The suspension element 12p is thereby not impeded in the transverse contraction, which reduces lateral wear. Nevertheless, a centring of the suspension element in groove 15p is ensured by the shape of the guiding area.

FIG. 9P schematically shows a drive as it is usable in an elevator according to FIG. 1P. A motor 2p drives a traction sheave 4.1p, which in the represented example is directly integrated into a shaft of the drive or the motor 2p. The traction sheave 4.1p comprises several grooves 15p, in each of which a suspension element 12p is put on. The groove bottom 15.1p is even and, by radius, changes into the lateral run-in areas 15.2p. In the area of the radius, the external limit of groove 15p is approximately equal to the external shape of the suspension element in this area, and serves as guiding area 15.3p. The number of required grooves or suspension elements depends on the load-carrying capacity of the individual suspension elements and the weight of the car or the counterweight.

The previous explanations are given above all with respect to a traction sheave 4.1p. In their general meaning, however, they also hold for the deflecting pulleys 4.2p, 4.3p, 4.4p. Of course, the shown embodiments and the individual elements of the different embodiments are combinable with each other. So, for instance, also the suspension elements 12p of the embodiment examples of FIGS. 2P-6P can be equipped with grooves 13.2p or canals lying closely below the exterior surface 13.1p of suspension element 12p, and experts may change the external contours of the suspension element 12p. In particular, these contours may be oval, ribbed, or undulated, or it is possible to use symmetric as well as asymmetric external surfaces 13.1p or sheathings. Furthermore, the ovalized groove form according to FIG. 8P can also be applied for other external contours.

In another embodiment example, an elevator system according to invention comprises an elevator car with at least two deflecting pulleys arranged on a common axis, wrapped by at least one suspension element which carries the elevator car. Between the two deflecting pulleys, a load sensor is arranged on the common axis which can simply and cost-effectively sense a force acting on the common axis. The force acting on the common axis very well represents changes in a car payload. Such an arrangement of the load sensor can be simply integrated into an elevator system.

Here, a single load sensor is favourably arranged in the middle between the two deflecting pulleys, on their common axis, and the load sensor senses a bending deformation of this common axis. The central arrangement allows a very exact measurement, where different load distributions on the two deflecting pulleys do practically not affect the measurement result. That means that even with an asymmetric load distribution, an exact measurement is possible with only one load sensor. The bending deformation of the common axis can be measured easily, since the load case is a simply determinable one—a bending bar on two supports.

In one favourable embodiment, the common axis is cut out in its central area, so that a rectangular cross-section remains that is basically aligned symmetrically to the longitudinal axis of the common axis, and this cross-section is aligned such that a resulting deflecting pulley force effected by the wrapping of the deflecting pulleys by the at least one suspension element effects a suitable bending deformation. A suitable bending deformation here is a deformation which is well adjusted to a measuring range of the load sensor and takes the material properties—like admissible tension etc.—of the common axis into account.

Alternatively, the common axis comprises two outer axis sections firmly connected by a connection part, and this connection part is, in turn, shaped and aligned such that a deflecting pulley force resulting from the wrapping of the deflecting pulleys by the at least one suspension element effects a suitable bending deformation. By means of this solution, for instance, different dispositions or different deflecting pulley distances can be simply realized, since only the connection part has to be changed.

In both embodiments, it is of advantage that the ideal measuring preconditions for the load sensor can be realized.

In another favourable embodiment, the common axis is fixed on both its ends at the car, in a basically bending-flexible way, where at least one of the ends has a positioning aid that allows an aligning of the common axis to the resulting deflecting pulley force. With this embodiment, a precise measurement is possible and erroneous mounting is prevented.

Favourably, the two deflecting pulleys and the common axis are mounted to a deflecting pulley unit already in the manufacturing firm, possibly together with carrier structures for the fixation of the car. In that way, expensive mounting time in the elevator system is reduced and erroneous mounting is avoided, since the complete deflecting pulley unit can be subjected to a test in the factory.

Of course, the deflecting pulley units can also be mounted to a car structure or integrated in it already in the manufacturing firm.

In certain cases, the elevator system comprises two deflecting pulley units, which for instance are wrapped by the at least one suspension element by 90° each, with at least one of the deflecting pulley units here comprising a load sensor. This is cost-effective.

For an integration into a control of the elevator system, the load sensor favourably has a load measuring computer or is linked as signal-transmitting to a load measuring computer. The load measuring computer is programmed in such a manner that it can determine an effective payload by using a load characteristic of the load sensor. This is of advantage, since the characteristics of a load sensor are known or are easily determinable and the load measuring computers can therefore easily be equipped with the characteristics of even several load sensors. In that way, also several load sensors can be easily interlinked, and the interesting data can be determined by a central load measuring computer. The load measuring computer can also simply perform a check of the load sensor, for instance by using a structural weight of the elevator car as test variable.

In a practical embodiment, the load measuring computer determines the effective payload in defined short time intervals, during the time when access to the elevator car is possible, i.e., when a car door is open, and an elevator control transmits the respective last measurement signal to the elevator drive to determine a starting torque. This allows the determination of a precise starting torque, thus largely avoiding a start jerk.

Complementarily, the elevator control can block a start-of-travel command if an overload is detected. In this solution, it is of particular advantage that the effective payload is continuously measured, e.g. every 500 ms, from the time when the elevator car can be left and entered—for instance when the car door has opened by 0.4 m—to the time when the elevator car can no longer be entered or left—the car door is practically closed. Thereby, the drive is permanently kept informed about the driving torque it would have to use to start at a respective moment, and on the other hand, an overload can be detected early. In that way, it is, for instance, possible to activate a warning signal already before an overload is reached, and even to close the car door if need be.

In a modified embodiment, the load measuring computer determines, at defined time intervals, the effective payload during the time period when access to the elevator car is possible—i.e. with open car door. If the determined variable does no longer change, the load measuring computer, which is signal-technologically linked to an elevator control, transmits to the elevator control the effective payload and favourably a signal for closing the car door. The elevator control transmits the signal to close the car door to the respective drive motor for the car door, and a signal to the elevator drive that corresponds to the starting torque determined on the basis of the last measuring signal of the load sensor. Since the starting torque is adjusted exactly to car load including payload, a start of the elevator car without start jerk is possible here, too.

In another embodiment, the load sensor is a digital sensor, as it is, for instance, described in EP1044356. This is of advantage, as the measuring signals provided by such a sensor can be evaluated rather easily. In a respectively realized example, the digital sensor, due to its load—which, for instance results from an expansion of an outer tension fibre of the common axis—changes a vibration frequency. This vibration frequency is counted by a computer during a respective fixed measuring interval, e.g. of 250 ms. The vibration frequency of the digital sensor is hence a measure for the load, or the payload in the elevator car. The characteristic of the digital sensor is learned at an initialization of the elevator system, for instance with determining the vibration frequency of the digital sensor with an empty car and with a known test payload. Afterwards, on the basis of each further vibration frequency a related payload can be calculated.

In the following, the principle of the elevator system according to invention will be explained by several embodiment examples in combination with several figures.

A first possible overall arrangement of an elevator system is represented in FIGS. 1AV and 1GV. In the shown example, the elevator system 1v is installed in a well 2v. Basically, it comprises a car 3v, which is linked to a drive 8v via suspension element 7v, and furthermore to a counterweight 6v. By means of drive 8v, car 3v is traversed along a car track. Car 3v and counterweight 6v move in opposite directions here. The suspension elements 7v are linked to car 3v and counterweight 6v via deflecting pulleys 9v, by means of a multiple suspension. Two suspension elements 7v are positioned at a distance of each other and guided in the well 2v axial-symmetrically to a central axis 4v of car 3v represented by a dashed line, and over two deflecting pulley units 10v that comprise two deflecting pulleys 9v each are guided to pass underneath the car. The deflecting pulleys 9v of car 3v are wrapped by 90° each.

Belt-type suspension elements can be used in elevator systems according to invention with largely varying car size, car weight, counterweight dimensions, counterweight mass, and well dimensions.

For example, an elevator system according to invention may have the following characteristic properties:

| | |
|---|---|
| car weight: | 300 kg-10′000 kg |
| car width: | 900 mm-3′600 mm |
| car depth: | 800 mm-5′000 mm |
| car height | 2′100 mm-3000 mm |
| mass of the counterweight: | 200 kg-20′000 kg |
| well width: | 1′100 mm-4′000 mm |
| well depth: | 900 mm-5′200 mm |
| well height | up to 200 m |
| well pit depth: | 200 mm-4′000 mm |
| well headroom height: | 2′400 mm-4′000 mm |

Due to the multiple suspension, the carrying force acting in suspension element 7v is reduced according to a reeving factor, in the represented example a reeving factor of 2. The represented car 3v is located in a loading zone, i.e., a car door 5v is open, and the access to car 3v is free. One of the deflecting pulley units 10v of car 3v is equipped with a digital load sensor 17v, which, at defined time intervals or continuously, measures a variable that changes with loading, and the signal of which, resulting from the measurements, is constantly transmitted to a load measuring computer 19v during the loading process. The load measuring computer 19v performs the required evaluation and passes the calculated signals or a calculated effective payload to elevator control 20v. The elevator control 20v passes the effectively measured payload to drive 8v, which is able to provide a corresponding starting torque, or else the elevator control 20v initiates required measures if an overload is detected.

The transmission of signals from the load measuring computer 19v to elevator control 20v is done via known transmission pathways, like travelling cable, bus system, or wireless. In the represented example, load measuring computer 19v and elevator control 20v are separate units. Of course, these assembly groups can be combined arbitrarily—thus, the load measuring computer 19v can be integrated in the deflecting pulley unit 10v, or it can be integrated in the elevator control 20v, and the elevator control 20v, in turn, can be arranged at car 3v or in a machine room, or it can also be integrated in the drive 8v.

Another overall arrangement of the elevator system, also embodied with a reeving factor 2, is represented in FIGS. 2AV and 2GV. In contrast to the previous embodiment, only one deflecting pulley unit 10v is conceived, which is arranged centrally above car 3v. The deflecting pulleys 9v of car 3v are wrapped by suspension element 7v by 180°, i.e., the suspension element 7v runs from above to the deflecting pulley unit 10v, is deflected by 180°, and runs upwards again. The load sensor 17v is mounted to or into the deflecting pulley unit 10v side-of-car.

The following descriptions refer to the explanations of FIGS. 1AV and 1GV. In contrast to FIG. 1V, the car door 5v is depicted as closed in FIG. 2V. In that state, the load measuring computer 19v is inactive, as no exchange of payload is possible. Of course, the load measuring computer 19v could be kept permanently active if need be, for instance if data are to be gathered to draw conclusions from acceleration processes or failures in the travel process.

In FIG. 3V, a possible deflecting pulley unit 10v is represented as it is usable in an elevator system 1v according to FIGS. 1AV, 1GV, 2AV, 2GV. The deflecting pulley unit 10v comprises a common axis 11v with two deflecting pulleys 9v pivoted in the area of the outer ends 15v of axis 11v. In the shown example, the common axis 11v is connected with car 3v by means of carriers 18v. The axis 11v is fixed at the carriers 18v in a rotationally stable way. The carriers 18v are made of moulded steel plates in this example, and, for the ends 15v of the common axis 11v, define respective bearing places at which axis 11v is held, approximately bending-free, or bending-flexible. Besides, this fixation is designed in a way that free rotation of the deflecting pulleys 9v is ensured.

The two deflecting pulleys 9v are positioned at a distance to each other, which, for instance, allows to arrange car guides 4v in the area between the two deflecting pulleys, as can be seen in FIG. 1GV. In the centre, between the two deflecting pulleys 9v, the load sensor 17v is arranged, so that the deflecting pulleys 9v and the fixation with the help of the carriers 18v are located essentially symmetrically to this centre. The common axis 11v is reduced or cut out in cross-section in its central area, as depicted in FIG. 3AV. A rectangular cross-section 14v remains, which is basically aligned symmetrically to the longitudinal axis of the common axis 11v (cf. FIGS. 3V and 2AV). This cross-section 14v is embodied such that a bending deformation of the common axis is effected through the wrapping of the deflecting pulleys 9v by the suspension element 7v and the resulting deflecting pulley forces 23v. In the arrangement chosen according to FIG. 1V, the suspension elements 7v are guided to pass underneath the car 3v. Thus, the individual deflecting pulley unit 10v is wrapped by 90°, as can be seen in FIGS. 3AV and 3BV. The resulting deflecting pulley force 23v is calculated by vector-adding the suspension element forces 22v at an angle of about 45° to these and is represented by arrow 23v. The rectangular cross section 14v is aligned vertically to the direction of the resulting deflecting pulley force 23v to achieve an optimal bending deformation.

In the embodied example, the rectangular cross-section 14v or section is chosen such that the load sensor 17v experiences a length change of about 0.2 mm over the expected load range or payload range. The load range, here, results from the difference between empty and full car 3v. As can be furthermore seen in FIG. 3BV, an end 15v of the common axis 11v can be equipped with a positioning aid 16v that enables a doubt-free alignment of the common axis 11v in relation to the carriers 18v and furthermore to car 3v. In the example, the end 15v of the common axis 11v is embodied such that it is able only in the desired position to interact in a form-locking way with a respective recess 16v of the carrier and be fixed. FIG. 3CV shows, in a perspective view, the arrangement of the load sensor 17v as described in FIG. 3V. The load sensor 17v is linked to the load measuring computer 19v, usually by a cable. In the example, the load measuring computer 19v is arranged at the car 3v. In many cases, it is possible to arrange the load measuring computer 19v together with the load sensor 17v on the axis 11v, or even integrate it into the load sensor.

FIG. 4V shows an alternative embodiment of the deflecting pulley unit 10v. In this example, the common axis 11v has two outer axis sections 12v that receive the deflecting pulleys 9v and at the same time enable the connection to the carrier 18v. The two outer axis sections 12v are mounted by means of a connection part 13v to form the complete common axis 11v. The connection part 13v comprises the load sensor 17v and is, in turn, shaped in a way that optimal load and bending conditions for the load sensor 17v result. Of course, also in this embodiment the connection sites of the axis sections 12v to the connection part 13v and to the carrier 18v are designed such that an alignment of the common axis 11v according to a load direction results necessarily.

The shown embodiments are meant as examples and can be changed by using the teachings revealed here. So, for instance, instead of two distanced deflecting pulleys 9v, of course, also several deflecting pulleys can be used, for example, 4 deflecting pulleys can be arranged in pairs, at a distance of each other.

The symmetric arrangement of the load sensor 17v in the centre between the two deflecting pulleys 9v has the advantage—as depicted in FIG. 5V—that an asymmetric distribution of suspension element forces on the two suspension elements 7v does not result in significantly deviating values measured by the load sensor 17v. With a normal load distribution between two suspension elements 7.1v, 7.2v, a bending moment behaviour M_{N} in the common axis 11v results which is basically represented by a constant value between the two deflecting pulleys 9.1v, 9.2v. The load sensor 17v, which is arranged centrally between the two deflecting pulleys 9.1v, 9.2v, detects a bending deformation value corresponding to a bending stress M_{NM}. With a differing load distribution between the two suspension elements 7.1v, 7.2v depicted in FIG. 5V for the assumed case of a total failure of one of the suspension elements 7.1v, 7.2v, respectively, a bending moment behaviour M₁ results in case of failure of suspension element 7.2v, or a bending moment behaviour M₂ in case of failure of suspension element 7.1v. As can be seen from a comparison of the bending moment behaviours M_{N}, M₁, M₂, the bending deformation value M_{1M}, M_{2M} detected by the load sensor 17v arranged centrally between the two deflecting pulleys 9v remains essentially unchanged as compared to bending deformation value M_{NM}. A maximum measurement deviation dM in the bending deformation value results.

FIG. 6V shows a measuring process in the course of operation of the elevator system. The elevator car 3v approaches a stop at an operation speed V_{K} of 100% and decelerates to a standstill. Shortly before reaching the standstill, the elevator control initializes an opening of the car door 5v. The car door 5v begins to open and passes a respective opening way S_{KT}, while clearing the access to car 3v. As soon as car door 5v has passed a minimal opening way of, e.g., 30%, or has cleared a minimal access opening of, e.g., 0.4 m, load measurement is started or the load measuring computer 19v is activated. At time intervals t_{M}, the load measurement provides the elevator control 20v with a signal L_{K} equivalent to the effective payload. The elevator control can now recognize an 80% payload, as depicted in the example, and can, by means of a warning buzzer or the displayed information “car full” (not depicted) stop further loading and initialize the closing of car door 5v. As soon as car door 5v is then closed so far that access is no longer possible—in the depicted example after covering about 60% of the door opening way—the load measuring computer 19v will stop the evaluation of the load measurement signal, and the elevator control 20v will use the last measured value L_{KE} to determine the starting torque of the elevator drive. As soon as the opening way of car door 5v reaches 0% (door closed), accordingly a start of car 3v is initialized.

If, due to a load measurement signal L_{K}, the elevator control detects an overload L_{KÜ}, a demand to reduce the payload will be put out and the closing of the car door will be prevented as long as there is an overload. Of course, the control can be designed such that other criteria are defined for special operation situations. So, for instance, in emergency operation—e.g. with fire alarm—a higher overload limit could be admitted. Moreover, the shown elevator control can for instance further evaluate the signal of the load measuring computer, e.g. by the point in time of a warning signal being defined dependent on a loading speed. Furthermore, a respective deflecting pulley unit with load sensor can also be arranged in the well or at the drive.

Knowing the here revealed teachings, elevator experts may change the set forms and arrangements at will and combine the elements of the embodiments of elevator systems according to invention revealed in this document.

3.4 Drum

With a traction drive, the suspension element 20 runs over the traction sheave 26 and is driven according to the type of the suspension element, for instance by traction, whereas with a drum drive, the suspension elements 20 are coiled in a form-locking manner onto a drive drum 18, the length of which should be adapted to the elevatoring height of the elevator system. If rope-type suspension elements are used, the latter can be coiled helically onto a rope drum, the length of which is dependent on the elevatoring height of the elevator system. With belt-type suspension elements, it is in most cases more favourable to coil the latter onto a rope drum in the form of a spiral, with each suspension element turn bearing on the previously coiled suspension element turns. There, it is favourable to compensate the continuous change of the coil diameter by continuously adapted drum rotation speed, which, e.g., can be realized by using a frequency converter to feed the drive motor. In most elevator systems with drum drive known today, the hoisting machine 14 with the drive drum 18 is arranged at the bottom, in contrast to the simplified depiction of FIG. 1.

3.5 Gear

For hoisting machines 14 of elevator systems, often a worm gear is used. The worm gear can transfer high power at high transmission ratios and is characterized by compact design and quiet running. With equal axis distance, the transmission ratios can be varied within a large range, so that one machine type can be used for elevators of very different capacities.

Alternatively, form-locking friction gearing, planetary gearing, bevel gearing, and worm gears combined with back gearing can be used.

Below, particularly advantageous drive units will be described.

In the following, another preferred variant of a hoisting machine according to invention will be explained in more detail, which can be used in analogy to or as substitution of the shown drive unit 14 with motor 16, traction sheave 26, and brake.

The drive unit for an elevator comprises, according to invention, of end shields, a motor, a traction sheave, and a brake, where a shaft carrying the rotor of the motor and the traction sheave is carried by the end shields, and the motor and the traction sheave are arranged between the end shields, and a drive frame is conceived that comprises the end shields and of frame elements connecting the end shields, with the frame elements carrying the stator of the motor and transferring the forces to the end shields.

On the basis of FIGS. 1G1, 2G1, 3G1, 4G1, 5G1, 6G1, 7G1, 8G1, the further preferred variant of a hoisting machine/drive unit will be explained in more detail.

FIG. 1G1 shows a drive unit 1g1 according to invention with drive frame 2g1. In the shown embodiment variant, the drive frame 2g1 spanning a rectangular parallelepiped comprises a first end shield 3g1, and of a second end shield 4g1, and of frame elements 5g1 connecting the end shields 3g1, 4g1, with one frame element 5g1 being conceived for each longitudinal edge of the rectangular parallelepiped. Further frame elements 5g1 can be conceived between the shown frame elements 5g1 and parallel to them. The rectangular parallelepiped may also have only one respective frame element 5g1 at each of two diagonally opposite longitudinal edges, or two frame elements 5g1 arranged on one long side of the rectangular parallelepiped, or one respective frame element 5g1 at each of two opposite long sides. The frame elements 5g1 also serve as carriers for parts of a motor 6g1 and/or a gear, for instance an electric motor with rotor 7g1 and stator 8g1. Alternatively, a hydraulic motor or a pneumatic motor can be conceived according to invention.

On each side of the motor 6g1, a hood 9g1 covers the stator 8g1. The rotor 7g1 is arranged at a so-called drive shaft, denoted in the following description as shaft 10g1, and drives the latter. Shaft 10g1 and end shields 3g1, 4g1 are positioned perpendicular to each other. The stator 8g1 is carried by the frame elements 5g1, which transfer the forces onto the end shields 3g1, 4g1. A first bearing 11g1 supports the one end of the shaft 10g1 at the first end shield 3g1, and a second bearing 12g1 supports the other end of the shaft 10g1 at the second end shield 4g1. Between first end shield 3g1 and motor 6g1, the shaft 10g1 is embodied as traction sheave 13g1 for at least one suspension element described elsewhere in this document, and between second end shield 4g1 and motor 6g1 also as traction sheave 13g1 for at least one suspension element.

At the inner side of the first end shield 3g1, a first brake disk 14g1 is conceived at the shaft 10g1, which can be braked by means of a first brake unit 15g1 arranged at the first end shield 3g1. At the inner side of the second end shield 4g1, a second brake disk 16g1 is conceived at the shaft 10g1, which can be braked by means of a second brake unit 17g1 arranged at the second end shield 4g1. Each end shield 3g1, 4g1 is equipped with shield pedestals 18g1, at which vibration absorbers 19g1 are arranged. The vibration absorbers 19g1 isolate the drive unit 1g1 against a carrying construction (not depicted) with respect to vibrations.

By Ag1, an intersecting plane is denoted that is laid through the centre of shaft 10g1. The thus produced sectional view of the drive unit 1g1 is shown in FIG. 2G1.

FIG. 2G1 shows a section through the symmetric drive unit 1g1 according to invention. In the symmetric drive unit 1g1, the motor 6g1 is preferably centrally arranged between the end shields 3g1, 4g1. The motor 6g1 can, however, also be arranged as shifted a bit out of the centre. The diameter Dg1 of the shaft is largely the same over the whole shaft length. The diameter Dg1 can, however, also differ in the traction sheave area from the diameter in the rotor area.

Fine grooves 20g1, arranged at the shaft 10g1 at a distance of each other, function as traction sheave 13g1 or traction sheave section, and receive corresponding longitudinal ribs of a suspension element described elsewhere in this document. At both sides of the entirety of grooves of a traction sheave, or at both sides of the grooves of a traction sheave section receiving a single suspension element, respective flanged wheels can be conceived, which prevent the suspension element from getting significantly out of its reference position on the traction sheave section. The diameter Dg of a traction sheave section can, for instance, be chosen as ranging between 60 mm and 1200 mm.

In the shown embodiment examples, shaft 10g1 and traction sheaves 13g1 are preferably made of one piece. In particular with greater traction sheave diameters, the traction sheave 13g1 can be alternatively mounted on shaft 10g1 as a separate component. The minimal diameter Dg1 is preset by the type of the suspension element.

The rotor 7g1 driving the shaft 10g1 can be embodied as a synchronous motor with permanent magnets, or as a squirrel-cage rotor, or as an asynchronous motor. Between rotor 7g1 and stator 8g1, an air gap is conceived. The stator 8g1 carried by the frame elements 5g1 has windings 22g1 laid in grooves that are covered by means of the hoods 9g1. For each shaft end, respective brake disks 14g1, 16g1 are conceived, on which brake units 15g1, 17g1 act in case of braking. The brake unit 15g1, 17g1 basically comprises a brake magnet 23g1, 25g1, arranged as floating at the end shields 3g1, 4g1, which, if power-supplied, activates a brake anchor 24g1, 26g1 and thereby counteracts brake springs (not depicted) and releases the brake.

The compact-building drive unit 1g1 is suitable for being arranged in a separate machine room or in the elevator well and, with 2×2 suspension elements in the form of flat belts of a width of 30 mm, has for instance a length L of 750 mm, a height H of 500 mm, and a width B of 400 mm. Larger or smaller dimensions are, of course, possible. Furthermore, it is advantageous that the drive unit can be easily adapted to the elevator disposition and to the suspension element position: in elevators with 1×2, or 2×1, or 2×2, or n×m suspension elements, the position of the individual traction sheaves or traction sheave sections in the drive unit required by the drive disposition can be chosen with the length of the drive shaft. Here, the notion of, e.g., a “2×1 suspension element” is to be understood as follows: a first suspension element is guided over the shaft or over traction sheave sections between motor and a first end shield, and a second suspension element between motor and a second end shield. “n” hence means the number of shaft sections with traction sheaves, and “m” the number of traction sheaves per shaft section. n=2 in a symmetric motor arrangement, and n=1 in an asymmetric motor arrangement. As suspension elements, belts or ropes described elsewhere in this document are conceived.

FIG. 3G1 shows the drive unit 1g1 according to invention with brake disks 14g1, 16g1 arranged outside the end shields 3g1, 4g1, and with at least two brake units 15g1, 17g1 per brake disk. The shaft 10g1 is elongated beyond the end shields 3g1, 4g1, the protruding shaft stubs 27g1 carry the brake disks 14g1, 16g1. Per brake disk 14g1, 16g1, the brake unit 15g1, 17g1 is at least doubly equipped, where a plate 28g1 connects and stabilizes the two brake magnets 23g1, 25g1. Power-supplied brake magnets 23g1, 25g1 counteract brake springs (not depicted) and release the brake, with the brake disks 14g1, 16g1 being moved in axial direction each. In braking, the brake disk 14g1, 16g1 is pressed against the end shield 3g1, 4g1 by means of the brake springs. With the brake disks 14g1, 16g1 arranged outside the end shields 3g1, 4g1, more room between end shield 3g1, 4g1 and motor 6g1 is left for the two traction sheaves 13g1.

The frame elements 5g1 carry the stator 8g1, with the stator 8g1 according to invention having a weight of about 120 kg. It is conceived here that the frame elements 5g1 transfer the torque generated by motor 6g1, e.g. a starting moment of 950 Nm, onto the end shields 3g1, 4g1, and stand a braking torque of, e.g., 1200 Nm. In this, only a minimal torsion of the drive frame 2g1 occurs, so that the size of the air gap 21g1 between stator 8g1 and rotor 7g1 is not inadmissibly changed.

FIGS. 4G1 and 5G1 show another asymmetric drive unit 1g1 according to invention with a drive frame 2g1. The motor 6g1 is arranged at one end on the one end shield 3g1, 4g1 and at the other end on the frame elements 5g1. Between the motor 6g1 and the other end shield 3g1, 4g1, a traction sheave 13g1 for 1×4 suspension elements is conceived. At the end shield 3g1, 4g1 side-of-traction-sheave, the brake disk 15g1, 16g1 is arranged outside, with the brake disk 15g1, 16g1 being mobile in axial direction and having a brake lining 30g1 on both sides. In braking, brake springs (not depicted) press the brake disk 15g1, 16g1 against the end shield 3g1, 4g1 and generate the braking force. With power-supplied brake magnets 23g1, 25g1, the brake is released, and the brake disk 15g1, 16g1 is elevatored off the end shield 3g1, 4g1.

In FIG. 6G1, AAg1 denotes an intersecting plane laid through the centre of motor 6g1, vertically to the shaft 10g1. The thus generated sectional view of drive unit 1g1 is shown in FIG. 7G1.

FIG. 7G1 shows a section through motor 6g1 and through the frame elements 5g1. The sheet metal package 31g1 of stator 8g1 has round recesses 32g1 at the corners, over the length of motor 6g1, into which tube-shaped frame elements 5g1 fit. Further inside, and in parallel to the recesses 32g1, grooves 33g1 are conceived into which flat irons 34g1 equipped with threads fit. The tube-shaped frame elements 5g1 are connected with stator 8g1, for instance by means of screws 35g1, with the screws 35g1 engaging with the threads of the flat irons 34g1 laid into the grooves 33g1. As an alternative type of connection, the tube-shaped frame elements 5g1 can be pasted or pressed into the recesses 32g1 or be welded with metal sheet package 31g1. A combination of at least two of the mentioned connection types is also possible.

FIG. 8G1 shows the symmetric drive unit 1g1 according to invention, in exploded representation. Each frame element 5g1 comprises three parts, with the centre part 5.1g1 being connected with the metal sheet package 31g1. The outer parts 5.2g1, 5.3g1 serve as spacers between the motor 6g1 and the respective end shield 3g1, 4g1, where further screws 36g1, penetrating the outer parts 5.2g1, 5.3g1, connect the end shield 3g1, 4g1 with the centre part 5.1g1. The frame element 5g1 can also be made in one piece.

The proposed construction can also be used in geared drives.

The advantages achieved with the represented hoisting machine 14 essentially lie in the fact that the hoisting unit with drive frame is supported in an isostatic bearing, and can be embodied as particularly stable, and is suited for the arrangement in machine room or elevator well. With the proposed construction, a great performance range can be covered. Drive variables outside this performance range—whether exceeding it or falling below—can easily be realized with the same construction type by changing few parameters, measures, and dimensions. With the drive concept according to invention, also the motor size can easily be changed. Both the stator and the rotor can be enlarged or made smaller in length and/or width and/or height. According to available space between the end shields, the respective brake disk and corresponding brake can be arranged inside or outside the respective end shield.

The drive shaft, preferably also serving as traction sheave, can easily be changed in diameter according to the needs of the suspension element. In that way, the drive unit can be used for different suspension elements described elsewhere in this document, according to invention in particular for round or non-round steel ropes, round or non-round plastic-sheathed steel ropes, round or non-round aramid ropes, or belts with inserted steel or synthetic fibre traction elements.

Favourably, the above-described motor with the preferably used traction sheave or drive shaft can also be conceived in the elevator systems described elsewhere in this document.

Furthermore, according to invention, a motor 16 is conceived the torque of which can be adjusted in its manufacturing, by change of stator and/or rotor winding, and/or change of the length of its drive shaft, and/or change of its current feed, and/or change of its diameters, where at the same time the diameters of a traction sheave or a shaft section can be chosen. As each type of suspension element requires its specific (minimal) traction sheave diameter or shaft diameter, the motor 16 according to invention can be adapted to the respective suspension element by varying the mentioned parameters. Hence there is a series of motors of basically the same construction type which only differ in one to four basic parameters, so as to particularly be adaptable to different types of suspension elements or to the same types of suspension elements with different dimensions.

With advantage, the above-described motor can also be conceived in the elevator systems described elsewhere in this document. Furthermore, several motors of basically the same construction type can be conceived for the operation of a single elevator system (possibly comprising several cars in a well), as this is also described exemplarily in detail elsewhere in this document. Moreover, several motors according to invention can be coupled by means of one or more couplings or be coupled to a joint drive shaft.

As another drive unit according to invention, in analogy to hoisting machine 14 with motor 16, traction sheave 26, and brake, a drive unit according to FIGS. 1G2, 2G2, 3G2, and 4G2 is conceived.

In an elevator or elevator system according to invention, with an elevator car traversable in an elevator well and a counterweight traversable in an elevator well, suspension elements connect and carry the elevator car and the counterweight, where a drive unit drives the suspension elements, and at least one resilient element acting as energy store at the drive unit is conceived, which elevators the drive unit in case of a relief of the suspension element, and at least one sensor is conceived that detects the elevatoring of the drive unit and switches the motor of the drive unit off. With particular preference, the suspension elements described elsewhere in this document can be used in the context of the device described below.

FIG. 1G2 shows an elevator 1g2 with an elevator car 3g2 traversable in an elevator well 2g2. The elevator well 2g2 is bordered by walls of the well 4g2, a well pit 5g2, and a well ceiling 6g2. Suspension elements 7g2 carry and connect the elevator car 3g2 with a counterweight 8g2 traversable in the elevator well 2g2. Guide rails for the elevator car 3g2 and the counterweight 8g2 as well as landings with entrances/exits are not depicted. In alternative embodiment examples, the counterweight is traversable in a well of its own, and/or the car is arranged as traversable in an at least unilaterally open casing or a casing equipped with a glass wall. Further alternative embodiment examples for well configurations or elevator systems according to invention in which the drive unit according to invention can be used are described elsewhere in this document.

A drive unit 9g2 supported on resilient elements 22g2 acting as energy store, in a machine room 13g2 (or alternatively above a supporting structure within the elevator well) drives the elevator car 3g2 and the counterweight 8g2, with the resilient elements 22g2 resting on a structural body 27g2 (or the supporting structure). The drive unit 9g2 can also be arranged on the bases of the structural body 27g2 supporting the resilient elements 22g2. The drive unit 9g2 comprises a motor unit 14g2, with or without gear, and a deflection unit 17g2, with the two units 14g2, 17g2 being connected by means of spacers 23g2.

The drive unit 9g2 has a length L ranging between 500 mm and 950 mm, a height H=360 mm, and a width B=625 mm. Larger or smaller dimensions are, of course possible.

As suspension element 7g2, at least one steel rope, or at least one synthetic fibre rope, or at least one flat belt, or at least one toothed belt, or at least one longitudinally ribbed belt, or at least one V-ribbed belt are conceived. Further details about suspension elements to be used are described elsewhere in this document. The suspension element 7g2 is fixed at its one end at a first suspension element fixing point 10g2, then guided over a first deflecting pulley 11g2 of elevator car 3g2, then guided over a traction sheave 12g2 of motor unit 14g2, then guided over a deflection pulley 15g2 of motor unit 14g2, then guided over a second deflecting pulley 16g2 of deflection unit 17g2, then guided over a third deflecting pulley 18g2 of counterweight 8g2, and fixed at its other end at a second suspension element fixing point 19g2. The shown suspension element guiding has a 2:1 transmission ratio, i.e., elevator car 3g2 or counterweight 8g2 will move vertically by half a metre if 1 m of the suspension element 7g2 is moved at traction sheave 12g2. Other transmission ratios, in particular a 1:1-transmission of the suspension element, are also possible in the context of the invention. A first buffer 20g2 for elevator car 3g2, and a second buffer 21g2 for counterweight 8g2 are conceived in the well pit 5g2.

FIG. 2G2 shows an arrangement variant of drive unit 9g2 preferred according to invention, which can also be used in the context of elevator systems described elsewhere in this document. The drive unit 9g2 is suspended at the well ceiling 6g2, with supporting bolts 24g2 being supported on resilient elements 22g2 by means of nuts 25g2. The resilient elements 22g2, in turn, are supported on plates 26g2 resting on the structural body 27g2.

FIG. 3G2 shows the drive unit 9g2 with a monitoring device 28g2 according to invention, to monitor a non-desired or not allowed elevatoring of the elevator car 3g2. The motor unit 14g2 of the drive unit 9g2 comprises a motor 30g2, which, by means of V-belt drive 31g2, comprising of a pulley 32g2 and a (transmission) belt 33g2, drives the traction sheave 12g2. The monitoring device 28g2 comprises at least one resilient element 22g2 acting as energy store, and at least one sensor 29g2 that detects distance changes or spatial elevatoring and/or lowering of the drive unit 9g2.

FIG. 4G2 shows an embodiment variant of deflection unit 17g2 with the monitoring device 28g2 according to invention. The second deflecting pulley 16g2 is surrounded by a casing 34g2 and is supported by the latter. Between a console 35g2 and the casing 34g2, at least two compression springs 36g2 acting as resilient elements 22g2 and as energy store are conceived. As suspension element 7g2, two belts are conceived, which carry the counterweight 8g2. According to load or relief of the suspension elements 7g2, or according to suspension element load, the compression springs 36g2 deflect more or less. In normal operation, the compression springs 36g2 are deflected most, or the distance Ag2 between casing 34g2 and console 35g2 is minimal. If the suspension element load decreases, the compression springs 36g2 release, or the distance Ag2 increases, or the deflection unit 17g2 is elevatored. If, for instance, the counterweight 8g2 rests on the second buffer 21g2, the compression springs 36g2 completely release, or the distance Ag2 becomes maximal, or the deflection unit 17g2 is maximally elevatored. Maximal deflection or minimal distance Ag2 are limited preferably by means of adjustable stops 37g2. The stop 37g2 can, for instance, comprise a threaded bolt screwed into a thread arranged at the casing 34g2 and secured by means of a locking nut.

The change of distance Ag2 can be monitored by means of the sensor 29g2 arranged at the side of casing 34g2. For instance, an electromechanical limit switch is conceived, which is adjusted to the maximum deflection of the compression springs 36g2 and which, with a release of the springs, at e.g. 8mm will change its switching position. With particular preference, the switching contact is connected into the safety circuit of the elevator. If the compression springs 36g2 release, or the casing 34g2 is elevatored, the motor 30g2 of drive unit 9g2 is hence switched off via safety circuit. As sensor, alternatively or complementarily a magnetic pick-up can be conceived, which is adjusted to the (maximum) deflection of the compression springs 36g2. Preferably with a release of the springs, the sensor changes its switching position, and with a deviation from its predetermined reference state interrupts the safety circuit. Here, the reference state of the sensor correlates with a reference position of the casing and/or a reference state of the spring(s). In this context, one or more (electric) threshold values can be defined and stored in an elevator control, so as to define the reference state of the sensor. Thus, in case of a deviation of the sensor signal from a reference value, the motor 30g2 of the drive unit 9g2 is switched off or throttled with respect to power/speed.

In a modified embodiment example, at least one optical sensor is conceived, which monitors the position of casing 34g2. In another modified embodiment example, a mechanical/electric switch is conceived, which, with a predetermined deviation of the casing from its reference position, transmits a control signal and/or interrupts a measuring current.

In the embodiment variant according to FIG. 4G2, the compression springs 36g2 are arranged between casing 34g2 and console 35g2. In another embodiment variant, at least one compression spring 36g2, preferably two or four compression springs can be arranged at each side of casing 34g2, with the compression spring 36g2 being supported at its one end at a bracket arranged at casing 34g2, and at its other end at the console 35g2. The change of distance Ag2 can be monitored by the sensor 29g2 arranged at the side of casing 34g2. Here, too, among other things the mentioned sensors for monitoring the casing position and/or for monitoring the spring status are conceivable.

As shown in FIG. 3G2, also in the motor unit 14g2 a monitoring device 28g2 can be conceived, which detects a bottom contact of elevator car 3g2. With a suspended drive unit 9g2 as shown in FIG. 2G2, a monitoring device 28g2 can be conceived, too, which, for instance, records movements of the supporting bolt 24g2 relative to plate 26g2, with the resilient element 22g2 being embodied as compression spring. The monitoring device 28g2 according to invention can be used for any type of drive unit, in particular for all drive units described in this document.

In the shown example of an embodiment of drive unit 9g2 with a motor unit 14g2 and a deflection unit 17g2, the total compressive force TSF for both compression springs 36g2 of deflection unit 17g2 is calculated as follows:

TSF=(WDP+(NTM·WTM·LTM))·g[1], with
WDP=weight of the drive unit 9g2 at the side of the deflection unit 17g2—ranging between 40 kg and 100 kg according to invention
WTM=weight of the suspension element 7g2 [in kilogram per metre]—ranging between 0.1 kg/m and 0.5 kg/m according to invention
NTM=number of suspension elements 7g2—according to invention, 2-20 are conceived, in particular 4-18 individual suspension elements
LTM=maximum length of suspension element 7g2, e.g. 60 m
gravitational acceleration g=9.81 m/s²

If counterweight 8g2 bears on buffer 21g2, this will result in TFS=1000N, if

WDP=42 kg

WTM=0.25 kg/m

NTM=4

LTM=60 m

The advantages reached by means of the invention comprise, on the one hand, particularly in simplified modernizations of elevator systems. The drive unit is easily exchangeable.

On the other hand, a safety device to monitor the suspension element according to invention for slackness or unallowed elevatoring of elevator car or counterweight can be used with advantage: If the counterweight gets stuck in the elevator well or impacts on the buffer arranged in the well pit, the suspension element side-of-counterweight becomes slack. The traction of the suspension element on the traction sheave, may, however, still be sufficient for the drive unit to elevator the empty or only slightly loaded elevator car. Danger of the elevator car or the counterweight being elevatored exists in particular with belts or synthetic fibre ropes with non-slip riding surfaces serving as suspension elements. An elevatoring of the elevator car may entail dangerous situations, in which the traction would no longer be sufficient and the elevator car would fall back or crash down. In the reverse travel direction, an elevatoring of the counterweight is equally undesirable. According to EN 81-1, paragraph 9.3 c), it is to be avoided in the context of the present invention, too, that an empty elevator car is elevatored by a drive device if the counterweight rests on the buffers.

With the monitoring of the suspension element for slackness, according to invention, no dangerous statuses can develop in extreme situations. As soon as the vertical load generated by elevator car and counterweight decreases at the drive unit, the drive unit will be elevatored. The vertical movement of the drive unit is monitored electrically or electronically. As soon as the drive unit is elevatored due to load reduction, the drive motor will be switched off. Besides, it is of advantage that the monitoring device according to invention is usable for all drive units or elevator systems described in this document.

4. Suspension Elements

4.1 Structure

As suspension elements for mechanical drives, today rope-type suspension elements (wire ropes, sheathed ropes), chain-type suspension elements, and quite recently in increasing numbers also belt-type and/or sheathed non-round suspension elements (suspension belts) are found in elevator systems. The present invention relates, among other things, to the improvement of belt-type suspension elements.

Structure, functioning, and manufacturing procedures for a sheathed, belt-type or non-round suspension element for an elevator system according to the present invention are described below, with reference to FIGS. 3-11.

FIG. 3 schematically shows the basic structure of a belt-type suspension element 20 for an elevator system.

In FIG. 3, several tension members, in particular several rope-type tension members 42, can be seen, embedded in a belt-type moulded body (belt body) 44. As rope-type tension members 42, in the context of the present invention particularly ropes, strands, cords, or braidings of metal wires, steel, synthetic fibres, mineral fibres, glass fibres, carbon fibres, and/or ceramic fibres can be used. The rope-type tension members 42 can be made of one or more single elements, or of singly or multiply stranded elements. Further variants and possibilities to dimension and design the tension members are described in more detail elsewhere in this document.

In one embodiment of the invention, each tension member 42 comprises a two-layered core strand with a core wire (e.g. of 0.19 mm diameter), and two wire layers laid around the latter (e.g. of 0.17 mm diameter), as well as one-layered outer strands arranged around the core strand, with a core wire (e.g. of 0.17 mm diameter), and a wire layer laid around the latter (e.g. of 0.155 mm diameter). Such a structure of a tension member, comprising for instance a core layer with 1+6+12 steel wires (i.e., 1 central wire surrounded by a first ring of 6 further wires—first wire layer—as well as a second ring of 12 further wires—second wire layer), and 8 outer strands with 1+6 steel wires, has proved in tests as advantageous regarding strength, manufacturability, and bendability. Here, the two wire layers of the core strand favourably have the same angle of lay, while the direction of lay of the one wire layer of the outer strands is opposite to that of the core strand, and the direction of lay of the outer strands around the core strand is opposite to that of their own wire layer. But of course, the present invention is not restricted to tension members 42 with this particular structure.

The use of rope-type tension members 42 (sometimes also called cords) with low diameters (or thickness) perpendicular to the longitudinal extension of the suspension element 20 allows the use of traction sheaves 26 and idler pulleys 30, 34a, 34b with small diameters. The diameter of the tension members 42 preferably ranges from 1 mm to 4 mm.

As is illustrated in FIG. 3, the belt body 44 of the suspension element 20 is constructed of a first belt layer 46 made of a first plasticizable material, and a second belt layer 48 made of a second plasticizable material, and has a first exterior surface 50 of the first belt layer 46, a connection plane 52 between first and second belt layer 46, 48, as well as a second exterior surface 54 of the second belt layer 48. The several tension members 42 are embedded in the two-layered belt body 44 in the area of the connection plane 52.

The first exterior surface 50 of the first belt layer 46 of belt body 44 for instance engages with the traction surface of traction sheave 26, while the second exterior surface 54 of the second belt layer 48 engages with the riding surfaces of the counterweight idler pulley 30 and the two car idler pulleys 34a, 34b. Of course, the suspension element 20 of the invention can also be employed in the opposite mode in an elevator system with traction drive as depicted in FIGS. 2A and 2B. I.e., the first exterior surface 50 of the first belt layer 46 of belt body 44 can equally engage with the traction surface of traction sheave 26, while the second exterior surface 54 of the second belt layer 48 engages with the riding surfaces of the counterweight idler pulley 30 and the two car idler pulleys 34a, 34b.

The first material for the first belt layer 46, and the second material for the second belt layer 48 are chosen, for instance, of an elastomer. For example, polyurethane (PU), polyamide (PA), polyethylene terephthalat (PET), polypropylene (PP), polybutylene terephthalat (PBT), polyethylene (PE), polychloroprene (CR), polyethersulphone (PES), polyphenylsulfide (PPS), polytetrafluoroethylene (PTFE), polyvinyl chloride (PVC), ethylene propylene diene rubber (EPDM), and the like can be used for the belt layers 46, 48 to form the moulded body 44 of the suspension element, but the invention is not to be restricted to the mentioned materials. Furthermore, also special adhesion mediators can be added to the materials of the first and second belt layer 46, 48, so as to increase the strength of the connection between the belt layers 46, 48 and between the first belt layer 46 and the tension members 42. Insertion of further tissues, tissue fibres, or other filling materials is equally possible.

As is explained below in more detail, the first and the second belt layer are each formed in an extrusion procedure. Basically, also a vulcanizable rubber material can be employed here, in which case the definite vulcanization can take place only after the extrusion procedure, so that the material for the extrusion process is flowable.

According to invention, the same material with the same properties, the same material with different properties, or different materials can be used for the first belt layer 46 and the second belt layer 48. As properties of the material(s) for the moulded body 44, in particular hardness, flowability, compriseence, properties of connectability with the rope-type tension members 42, colour, and the like are relevant here.

In particular embodiments of the invention, at least one of the belt layers 46, 48 can be formed of a transparent material, so as to facilitate a test of suspension element 20 for damages. Besides, the first and/or the second belt layer can be embodied in anti-static quality. In another embodiment, for instance the second belt layer can be embodied as luminescent, so as to make the rotation of the traction sheave or the drum recognizable or to produce certain optic effects.

The embedding of the rope-type tension members 42 into the first belt layer 46 effects a lubrication of their individual wires in their movement against each other during use in an elevator system. Besides, in that way the tension members 42 are additionally protected against corrosion and kept exactly in their desired positions.

To increase the contact pressure of the suspension element 20 onto a traction sheave 26, it is advantageous in view of an increase in the tractive capacity to embody the contact surfaces of the belt body 44 interacting with traction sheave 26, i.e. the first or the second exterior surface 50, 54, with so-called (V-)ribs (not depicted in FIG. 3). The said ribs extend as longish elevations in the direction of the longitudinal extension of the suspension element 20, and preferably engage with correspondingly shaped grooves on the riding surface of traction sheave 26. With their engaging with the grooves of traction sheave 26, the V-ribs at the same time provide a lateral guiding of suspension belt 20 on traction sheave 26.

Furthermore, the two exterior surfaces 50, 54 of the suspension element 20 of the invention may have, over their whole length or only in respective partial sections in which they contact with the traction sheave 26 and the various hitch and deflecting pulleys of the elevator system, a special surface quality that particularly affects the slide properties of the suspension belt 20. For instance, the exterior surface 50, 54, combing with the traction surface of traction sheave 26, can be equipped with a traction-reducing or traction-increasing coating, surface structure, or the like. Alternatively, the suspension belt 20 can also be sheathed with a tissue or the like on one or both exterior surfaces 50, 54, to influence the properties of the suspension belt surface.

Basically, it is possible to conceive several differently embodied suspension belts 20 of the described type, in different grouping, in the context of a force transfer arrangement in an elevator system.

In FIGS. 1aQ, 1bQ, 1cQ, 2aQ, 2bQ, 2cQ, 2dQ, 3aQ, 3bQ, 3cQ, 3dQ, 4aQ, 4bQ, 4cQ, 4dQ, 4eQ, 4fQ, 5aQ, 5bQ, 5cQ, 5dQ, 5eQ, 6aQ, 6bQ, 6cQ, 6dQ, 7aQ, 7bQ, 7cQ, 8aQ, 8bQ, 8cQ, and 9aQ, further different variants of suspension elements according to invention are schematically represented, each in cross-sectional view. Besides, a respective interaction with a traction sheave and/or a guide pulley is outlined in the said figures. A suspension element has a (total) height H perpendicular to a traction surface 3q at which the suspension element interacts with a traction sheave or drive shaft. Equally acting functional elements are assigned equal reference signs.

The following elements, described below, are of particular relevance in FIGS. 1aQ-9aQ:
1q: tension member or rope of steel, aramid, etc., comprising several strands, with the strands being made of individual fibres or wires
1aq: separate sheathings of the individual ropes 1q (possibly transparent or multi-coloured or of different colours)
Dq: diameter of a tension member
2q: bed—one-layered or multi-layered—of elastomer, in particular of polyurethane (PU), which encloses the tension members or ropes in a circumferential area ranging from 60°±40° to 200°±40°, and in particular also amounting to 180°±40°, and to 200°±20°
2aq: traction layer (possibly adjusted to friction, possibly with longitudinal grooves)
2bq: central layer or core layer (adjusted to fixation, possibly divided in longitudinal direction)
2cq: guide/protection sheathing (possibly U-shaped, adjusted to wear)
3q: traction surface, with a cylindrical, or concave (possibly toothed, roughened, smooth), or also adapted profile, in particular with a profile corresponding to longitudinal grooves
3aq: coating or sheathing of the traction sheave or traction surface, made of an elastomer, metal, ceramics, natural material
3bq: guide rings
4q: backside “open” or with protection layer, at backside and perhaps laterally, maybe with guiding section for guide pulleys
5q: guide pulley engaging at backside 4q, possibly contoured

Shortly summarized, FIGS. 1aQ-9aQ show the following:
FIG. 1aQ: two ropes 1q enclosed on their front side facing traction surface 3q by a bed 2q in a circumferential area of about 200°±20°, backside 4q “open” or with protection layer, traction surface 3q cylindrical, or convex (possibly toothed, roughened, smooth)
FIG. 1bQ: like FIG. 1aQ, but ropes 1q with a separate, possibly transparent sheathing 1aq, enclosed by a bed 2q in a circumferential area of about 180°±40°
FIG. 1cQ: like FIG. 1aQ, but the “open” backside 4q interacts with a guide pulley 5q
FIG. 2aQ: like FIG. 1aQ, but the two ropes 1q, instead of being enclosed on their front side, are enclosed by bed 2q on their backside 4q looking away from traction surface 3q, in a circumferential area of about 200°±20°. The opposite front side is “open” and interacts with an adaptedly profiled traction surface 3q, which encloses the ropes 1q in a circumferential area of about 140°±40°. The backside 4q can additionally have a protection layer.
FIG. 2bQ: like FIG. 2aQ, but each rope 1q has an individual sheathing 1aq and is enclosed on its backside by bed 2q in a circumferential area of about 200°±40°
FIG. 2cQ: like FIG. 2aQ, but the ropes 1q have individual sheathings 1aq, the circumferential area of the backside bed 2q around the ropes 1q amounts to about 200°±40°, the backside protection layer does not only cover the backside 4q but also the narrow sides
FIG. 2dQ: like FIG. 2aQ, but the backside 4q has no protection layer, while traction surface 3q has a coating or sheathing 3aq made of an elastomer, metal, ceramics, natural material
FIG. 3aQ: like FIG. 1aQ, but the bed 2q is embodied as multi-layered, with the layers extending essentially in longitudinal and width direction of the suspension element
FIG. 3bQ: like FIG. 3aQ, but the traction surface 3q has lateral guide rings 3bq. The bed 2q is again multi-layered. At the front side facing traction surface 3q, a traction layer 2aq is conceived (adjusted to friction). Farther away from traction surface 3q, the bed 2q has a central layer 2bq (adjusted to fixation). At the backside, on the central layer 2bq, a guide or protection sheathing 2cq is arranged, adjusted to wear, embodied as U-shaped and enclosing the ropes 1q, the central layer 2bq, and the traction layer 2aq
FIG. 3cQ: like FIG. 3aQ, but the ropes 1q have a separate sheathing 1aq.
FIG. 3dQ: like FIG. 3cQ, but the “open” backside interacts with a correspondingly contoured guide pulley 5q
FIG. 4aQ: like FIG. 1cQ, but the bed 2q encloses the ropes 1q around their central plane, in an area of 60°±40°, so that bed 2q centrally encloses the ropes and possibly penetrates them (cf. FIG. 4bQ). The suspension element is “open” towards front side and backside, with a guide pulley 5q interacting at the backside with the suspension element having a contour adapted to the diameter Dq of the ropes 1q. The backside can also have a protection layer. Traction surface 3q is also adaptedly profiled and encloses the ropes 1q in an area of 140°±40°. It may also have a coating.
FIG. 4bQ ???
FIG. 4cQ: like FIG. 4aQ, but with “open” backside 4q, without backward guide pulley 5q, and with a coating/sheathing 3aq on the adaptedly profiled traction surface 3q of the traction sheave
FIG. 4dQ: like FIG. 4cQ, but backside 4q and lateral surfaces of bed 2q with a sheathing
FIG. 4eQ: like FIG. 4aQ, but the ropes 1q with individual sheathings 1aq (possibly transparent, multi-coloured, etc.)
FIG. 4fQ: like FIG. 4dQ, but the ropes 1q with individual sheathings 1aq, and the sheathing of the backside 4q extending also over the lateral surfaces and the front side. The coating/sheathing 3aq of traction surface 3q is not depicted.
FIG. 5aQ: like FIG. 1aQ, but with 5 ropes 1q being conceived, and the one-part bed 2q enclosing the ropes 1q in a circumferential area of 200°+40°/−20°. On its side-of-traction front side, the bed 2q has ribs and longitudinal grooves separating the ribs. The traction surface 3q is correspondingly profiled with longitudinal grooves.
FIG. 5bQ: like FIG. 5aQ, but with ropes 1q with transparent individual sheathing 1aq, and with a one-part bed 2q enclosing the ropes 1q in a circumferential area of 200°±40°
FIG. 5cQ: like FIG. 5aQ, but the bed 2q is multipartite and encloses the ropes 1q in a circumferential area of 200°±40°
FIG. 5dQ: like FIG. 5aQ, but the backside has a (in particular transparent) protection layer, and a one-part bed encloses the ropes 1q in a circumferential area of 200°±40°
FIG. 5eQ: like FIG. 5dQ, but here not four ribs and grooves are assigned to two ropes 1q, but instead one rib is assigned to each two ropes 1q
FIG. 6aQ: like FIG. 5aQ, but five ropes 1q are conceived, enclosed by a one-part bed 2q in a circumferential area of 200°±40°, the backside 4q has a centrally arranged guide section interacting with a central guide pulley 5q
FIG. 6bQ: like FIG. 6aQ, but backside 4q with guide section(s) (at its outer sides)
FIG. 6cQ: like FIG. 6aQ, but the central guide section at backside 4q has a triangular cross-section, and the central guide pulley 5q interacting with it is embodied as counter-equal to the guide section. Bed 2q can be one-part or multipartite.
FIG. 6dQ: like FIG. 6cQ, but the guide pulley 5q engages unilaterally at the guide section on the backside 4q. Bed 2q is embodied in one part, but can also be multipartite.
FIG. 7aQ: like FIG. 6aQ, but there are no ribs and grooves side-of-traction. The traction surface 3q is profiled or roughened, bed 2q encloses ropes 1q in a circumferential area of 200°±40°, and is embodied in one part.
FIG. 7bQ: like FIG. 7aQ, but with multipartite bed 2q. The layers extend in longitudinal and width direction, the layer side-of-traction does not contact with the ropes 1q, only the central layer contacts with the ropes 1q.
FIG. 7cQ: like FIG. 7bQ, but the layer of bed 2q side-of-traction has many grooves and ribs, traction surface 3q has a marked profile or longitudinal grooves
FIG. 8aQ: like FIG. 7bQ, but the guide pulley 5q extends over the whole width of the suspension element and may have lateral guide rings. Bed 2q is multipartite. It has a core layer 2bq separated in longitudinal direction, with each longitudinal section having at least one tension member or rope 1q. Side-of-traction, a traction layer 2aq is conceived, via which the longitudinal sections of core layer 2bq are interconnected in width direction. Traction surface 3q has lateral guide rings 3bq.
FIG. 8bQ: like FIG. 8aQ, but backside 4q is “open” except of a centrally arranged guide section. The backside guide pulley 5q is embodied as counter-equal to the open backside, with central guide section.
FIG. 8cQ: like FIG. 8aQ, but traction layer 2aq is profiled with longitudinal grooves, and traction surface 3q is profiled or roughened.
FIG. 9aQ: ???

According to FIGS. 1aQ, 1bQ, 1cQ, preferably a basically cylindrical traction surface with major or minor surface roughness and optionally with groove-type and/or tooth-type surface structures is conceived. According to FIGS. 2aQ, 2bQ, 2cQ, 4aQ, etc., the traction sheave has, for instance, ring-shaped grooves correlating with the diameter Dq of the respective tension member. According to FIGS. 2dQ, 4cQ, etc., a traction sheave, in the area of its traction surface, optionally has a sheathing or coating 3aq of an elastomer, metal, ceramics, or a natural material. The coating, here, has again a structure correlating with the tension members 1q. According to FIGS. 5aQ, 5bQ, 5cQ, 5dQ, 6aQ, 6bQ, 6cQ, 6dQ, etc., a traction sheave or drive shaft has a multitude of basically identical or similar grooves. Identical or similar ribs arranged at the traction side of the suspension element engage into these grooves. Details regarding the design of preferred variants of ribs in suspension elements are described elsewhere in this document.

Preferably, in many variants the cross-sectional shapes and/or contours of indentations and elevations side-of-traction-sheave are preferably basically identical over the whole traction sheave or drive shaft. There is hence an extended traction section, the grooves and elevations of which have basically the same distance to each other and on which, at an arbitrary site, several, in particular three or more, similar suspension elements may run side by side. Preferably, the distance between two suspension elements equals the width of a groove. The traction sheave section is hence embodied such that during operation of the elevator system a suspension element can basically adopt at least five, in particular at least seven or at least nine different operation positions on the traction section (essentially invariant in axial direction of the traction sheave/shaft), and the (possible) operation positions of the one suspension element are shifted against each other by the same distance from the respective neighbouring operation position.

The suspension elements according to invention (without reference sign) comprise several ropes 1q embodied as tension members which, in turn, are made of several strands (reference is here made to the details revealed elsewhere in this document). The strands are set up of a multitude of fibres or wires twisted with each other. The ropes are assigned a cross-sectional diameter Dq (with experts knowing that usual ropes have no exactly round cross-section). As materials, all materials revealed in this document in the context of tension members according to invention can be used, in particular high-strength steel or aramid.

The (several) tension members 1q of a suspension element are each assigned a bed or moulded body 2q, made of an elastomeric and possibly plasticizable plastic. Here, several tension members are, at least by half their volume, embedded into a common bed 2q, so that they are at least half surrounded or enclosed by the plastic of the bed/moulded body. Preferably, about 180°-200° (±20°) of the circumferential contour of the essentially cylindrical tension members 1q is enclosed by the material of the bed/moulded body 2q. In particular, the height h of bed 2q is smaller than the height H of the suspension elements, preferably h<H*0.8.

According to FIGS. 1bQ, 2bQ, 2cQ, 3cQ, 3dQ, etc., the rope-type tension members 1q can each be assigned an own, separate, possibly tube-type sheathing 1aq, made of a preferably transparent plastic. Such a separate sheathing can be conceived complementarily in all other variants, too, in particular in those according to FIGS. 6aQ ff.

According to FIGS. 1aQ, 1bQ, 1cQ, etc., the moulded body 2q contacts with the correlated traction sheave in the area of the traction surface 3q over a certain surface, and is hence suitable and conceived to transfer traction forces onto the embedded tension members 1q. It can, however, be conceived, for instance, as shown in FIGS. 3aQ, 3bQ, 3cQ, 3dQ, 5cQ, etc., to arrange an additional traction layer 2aq in form of a separate layer at the traction side. The additional traction layer 2aq preferably has properties differing from those of bed 2q, with the bed hence being also definable as central layer 2bq (cf. FIG. 3bQ). Bed 2q or central layer 2bq surround the tension members 1q preferably along a cross-sectional area of 60° (±40°). Alternatively or complementarily, the material of bed 2q or of the central layer penetrates the tension members 1q—as is shown in FIG. 4bQ. Here, all rope-type tension members described in more detail elsewhere in this document can be used according to invention.

According to FIGS. 2aQ, 2cQ, 3bQ, 4dQ, 4fQ, 5dQ, and 5eQ, an additional protection layer 2cq is conceived according to invention at a backside or guide side 4q looking away from the traction side. The backside protection layer 2cq preferably has properties differing from those of bed 2q, with the bed being hence also definable as a central layer 2bq (cf. FIG. 3bQ). The backside protection layer 2cq preferably also extends along the (narrow) lateral surfaces of the suspension element, as is shown in FIGS. 2cQ, 3bQ, 4dQ, and 4fQ.

According to FIGS. 1cQ, 3dQ, 4aQ, 4eQ, 6aQ, 6bQ, etc., at least one guide pulley 5q is conceived, which engages with the suspension element at its backside and positions the suspension element in a form-locking manner between itself and the traction sheave. According to invention, the guide pulley engages with at least one (possibly sheathed) tension member 1q (and, to this end, has a rounded groove according to the diameter Dq of the tension member), and/or the guide pulley 5q grips at the moulded body 2q, or at the protection sheathing 2cq of the latter. In the latter case, guide pulley 5q and moulded body 2q have contours adapted to one another, in particular at least one guide section can be conceived at the moulded body 2q in the area of its backside 4q upon which the pulley 5q rolls, contacting with it (cf. FIGS. 6aQ, 6bQ, 6cQ, etc.).

According to FIGS. 5aQ, 5bQ, 5cQ, 5dQ, 5eQ, 6aQ, 6bQ, 6cQ, and 6dQ, several ribs oriented in the longitudinal direction of the suspension element are arranged at the bed/moulded body 2q, side-of-traction, which each have an approximately triangular or trapezoidal cross-section. In the drawings, the latter are outlined rather schematically, as mentioned. In a preferred manner (not depicted), all grooves have about the same cross-sectional profile, both side-of-traction-sheave and side-of-suspension-element, and engage in an exactly fitting way with each other, with a bit of “air” being conceived at the groove bottom.

According to FIGS. 6cQ and 6dQ, a guide section in the form of a rib oriented in longitudinal direction of the suspension element is conceived at the backside of the suspension element, which has a basically triangular or trapezoidal cross-section and interacts with a correspondingly shaped guide pulley. The guide pulley is preferably arranged in such a manner that it secures the suspension element against an elevatoring off the traction sheave. However, in an alternative embodiment example, the guide pulley can be positioned at a distance of more than 20 mm from the traction sheave, in particular more than 50 mm, in particular more than 1000 mm. The guide pulley is preferably supported in a (maybe flexible or rotatable) bearing at a machine casing or a machine carrier. Evidently, other suspension elements according to invention described in this document (in particular significantly narrower ones) can also be guided in this manner. Besides, further details regarding the guiding of the different suspension elements according to invention are given elsewhere in this document.

According to FIGS. 7bQ, 7cQ, 8aQ ff., further embodiment examples of the suspension element according to invention have a traction layer 2aq side-of-traction, and a (central or backside) core layer 2q, 2bq linked to the traction layer. The core layer 2q, 2bq can be embodied such that it essentially encloses at least one tension member 1q and/or is subdivided, in longitudinal direction of the suspension element, into several separate individual strands, possibly at a distance of each other. In the latter case, the traction layer 2aq constitutes the link between a multitude of individual strands forming the core layer, to which strands, in turn, one or more tension members can be assigned. As is shown in FIG. 8cQ, the traction layer can have several ribs oriented in longitudinal direction of the suspension element, which can engage with corresponding grooves of the traction sheave. The geometry of the ribs can correspond with the geometry of the grooves in the other suspension elements according to invention. Furthermore, a special form, combinable with the other variants, is represented in FIG. 9aQ: the suspension element here has a common traction layer 2aq and several individual strands 2bq (at a distance of each other), which each completely or sectorially enclose two tension members 1q. As in the other embodiment examples, a pinch roller/guide pulley 5q can be arranged at the backside, which presses the suspension element against the traction sheave/drive shaft.

4.2 a) Manufacturing of a Suspension Element

On the basis of FIGS. 4-7, a first manufacturing procedure of a suspension element according to invention in form of the suspension belt 20, as well as the corresponding device to manufacture the suspension belt, will now be explained in detail. Of course, further modified manufacturing procedures may be applied as well, in particular those that are also exemplarily described elsewhere in this document. At this point, it is to be made clear once again that the notion of “belt” is to be understood as referring to all sheathed suspension elements (independent of the cross-sectional shapes of their tension members and/or their sheathing).

The procedure to manufacture the suspension belt 20 with a first belt layer 46 and a second belt layer 48 and rope-type tension members 42 embedded in it is a two-step procedure. The first manufacturing station of this two-step manufacturing procedure is illustrated in FIG. 4A, and the second manufacturing station in FIG. 4B. It is to be taken into account that the first and the second manufacturing station are either organized as separate manufacturing stations, or are, within an integral manufacturing process, series-connected immediately after one another.

As depicted in FIG. 4A, the first manufacturing station for the belt-type suspension element 20 of the invention comprises a first rotating moulding wheel 56 and a first guide 58 wrapping a partial section of this first moulding wheel 56. This first guide 58 can, for instance, be formed of an endless moulding band, which is guided over several pulleys and, together with the exterior circumferential surface of the first moulding wheel 56, forms a mould cavity, as it is revealed, for instance, in the initially mentioned DE 102 22 015 A1. Alternatively, the first guide to form the mould cavity can also comprise a stationary moulded body, which is equipped with a sliding element to allow a relative movement between the stationary moulded body and the moulded body moving with moulding wheel 56.

The exterior circumferential surface of the first moulding wheel 56 is embodied with several longitudinal grooves 60, which extend along the circumferential direction of the moulding wheel, as depicted in FIG. 4B. The width of the exterior circumferential surface of moulding wheel 56, preferably bordered by suitable lateral guide elements 61 (cf. FIG. 5) corresponds with the desired width of the suspension element 20, and the number of longitudinal grooves 60 in the exterior circumferential surface of the first moulding wheel 56 corresponds with the desired number of rope-type tension members 42 in the suspension element 20.

As is illustrated in FIG. 4B, the width b of the grooves 60 is chosen smaller than the diameter d of the tension members 42. For instance, width b of grooves 60 ranges from about 70% to 95% of diameter d of the tension members 42, more preferably from about 75% to 90%. Besides, the depth t of the longitudinal grooves 60 ranges from about 25% to 50%, preferably from about 30% to 40% of the diameter d of the tension members 42.

In the first manufacturing station of FIG. 4A, now the rope-type tension members 42 are fed from a stock reel 62 to the first moulding wheel 56, being guided in the longitudinal grooves 60 of the exterior circumferential surface of the first moulding wheel 56, and preferably being kept under pre-tension. Due to the above-described dimensioning of width b and depth t of the longitudinal grooves 60 in relation to diameter d of the tension members 42, the tension members 42 are only partly received in the longitudinal grooves 60, and between the tension members and the first moulding wheel 56, clear spaces form in the areas of the longitudinal grooves 60.

From a first extruder 64, a flowable stream of the first material is brought, basically without pressure, into the mould cavity formed between the first moulding wheel 56 and the first guide 58, with the at least one tension member 42 bearing on the exterior circumferential surface of the first moulding wheel 56 before the stream of the first material enters the mould cavity. The material stream out of the first extruder 64 is pressed by the first guide 58 against the tension members 42 and the first moulding wheel 56, thus getting its definite shape, and finally forms the partial belt 66 with the first belt layer 46 and the tension members 42 embedded in it. Here, the first exterior surface 50 of partial belt 66 or suspension element 20 is facing guide 58, and the surface of partial belt 66 forming the connection plane 52 is facing the first moulding wheel 56.

As illustrated in FIG. 5, in this embedding process the flowable first material also flows into the cavities within the rope-type tension members 42, and through these cavities as well as through the clear spaces between the tension members 42 and the first moulding wheel 56 formed through the twisting of the tension members 42 (cf. flow lines 67 indicated by arrows in FIG. 5) also into the clear spaces of the mould cavity formed between the tension members 42 and the respective grooves 60. In that way, the cavities within the rope-type tension members 42 are, at least partly, filled with the first material, which results in a very good connection between the tension members 42 and the first belt layer 46 comprising of the first material. Besides, the tension members 42 are embedded as completely as possible in the first belt layer 46, so that there is no direct contact between the embedded tension members 42 and the adjacent second belt layer 48.

The properties of the first plasticizable material (especially its flowability) and the procedural parameters of the first manufacturing station (especially temperature and pressure) are to be chosen here such that in the embedding step the first material can enter the cavities within the rope-type tension members 42 and the cavities between tension members 42 and first moulding wheel 56, as is explained above, on the basis of FIG. 5.

In the embodiment example represented in FIGS. 4-5, the at least one tension member 42 of the suspension belt 20 protrudes by about 5%-20% from the connection plane 52 of partial belt 66 after the first manufacturing step in the first manufacturing station. At the same time, more than 80%, preferably more than 90%, more preferably more than 95% of the surface of the at least one tension member 42 are covered with the first plasticizable material of the first belt layer 46.

To further improve the connection between the first plasticizable material for the first belt layer 46 and the tension members 42 to be embedded, it is of advantage to heat the tension members 42 during this embedding process. To this end, for instance upstream of the first extruder 64, a first heating device 68 is arranged to heat the tension members 42 to be fed to the first moulding wheel 56.

Though not depicted in FIGS. 4 and 5, the first guide 58 can be structured at its inner side facing the first moulding wheel 56, so as to give the first exterior surface 50 of partial belt 66 or of the finished suspension element 20 a profile. In particular, the first exterior surface 50 of suspension belt 20 can be equipped with V-ribs extending in longitudinal direction, as will be discussed later in the context of special embodiments of suspension element 20, on the basis of FIGS. 8-10. Alternatively or additionally, also further surface structures can be applied to this first exterior surface 50.

The profiling or structuring of the first exterior surface 50 of suspension belt 20 preferably occurs during the step of embedding the at least one tension member 42 into the first belt layer 46. Alternatively, however, the first exterior surface 50 of suspension belt 20 may also be mechanically or chemically treated in a separate further manufacturing step, after the second manufacturing step described below.

In an advantageous further embodiment of the invention, the first moulding wheel 56 or its exterior circumferential surface is embodied such that the connection plane 52 of partial belt 66 is equipped with a surface structure during the embedding step. As indicated in FIG. 6, preferably at least the sections of connection plane 52 between the tension members 42 are embodied with a surface structure 70, e.g. in the form of a raster-shaped or irregular roughening or grooving. Additionally, of course, also the areas of the tension members 42 in connection plane 52 can be embodied with a surface structure 70. Such a surface structure 70 enlarges the surface of connection plane 52, thus improving its later connection with the second belt layer 48.

After the finishing of partial belt 66 in the first manufacturing station of FIGS. 4A and 4B, the suspension belt 20 is completed in a second manufacturing station, shown exemplarily in FIGS. 7A and 7B.

As depicted in FIG. 7A, the second manufacturing station for the belt-type suspension element 20 according to invention comprises, similarly to the first manufacturing station, a second moulding wheel 72 rotating in counter-clockwise sense, and a second guide 74 wrapping a partial section of this second moulding wheel 72. This second guide 74 can, for instance, again be formed by an endless moulding band that is guided over several pulleys, or alternatively also comprise a stationary moulded body equipped with a sliding element.

In contrast to the first manufacturing station of FIGS. 4A and 4B, the second moulding wheel 72 of the second manufacturing station is embodied with an exterior circumferential surface corresponding with the profile of the first exterior surface 50 of the first belt layer 46 or the partial belt 66. In the embodiment example shown in FIG. 7B, a flat exterior circumferential surface is conceived for the second moulding wheel if the first exterior surface 50 of suspension element 20 is to have no profile or maybe a flat surface structure. The width of the exterior circumferential surface of the second moulding wheel 72, preferably limited by suitable lateral guide elements (not depicted), equals the desired width of suspension element 20.

In the second manufacturing station of FIG. 7A, the partial belt 66 produced in the above-described first manufacturing station is fed to the second moulding wheel 72 in such a manner that the first exterior surface 50 of partial belt 66 is in contact with the exterior circumferential surface of the second moulding wheel 72. From a second extruder 76, a flowable stream of the second plasticizable material is brought, basically without pressure, into the mould cavity formed between the second moulding wheel 72 and the second guide 74. The material stream from the second extruder 76 is pressed against the connection plane of partial belt 66 by the second guide 74, in that way getting its definite shape, so that finally the complete suspension element 20 is formed, with first and second belt layer 46, 48 and the tension members 42 embedded between them. In this process, the second exterior surface 54 of suspension belt 20 faces guide 74.

As illustrated in FIG. 7B, in this moulding process the flowable second material flows completely against the surface of partial belt 66 forming the connection plane 52. If this connection plane 52 has a surface structuring 70 as explained above, the connection between first and second belt layer 46, 48 is particularly good. Since the tension members 42 have been embedded as completely as possible into the first belt layer 46 in the first manufacturing station, the second belt layer 48 does hardly or not at all contact with the tension members 42.

To further improve the connection between the second plasticizable material for the second belt layer 48 and the partial belt 66 produced before, it is of advantage to heat the partial belt 66 during this moulding process. To this end, for instance upstream of the second extruder 76, a second heating device 78 is arranged to heat the partial belt 66 to be fed to the second moulding wheel 72 to a desired temperature.

Though not depicted in FIGS. 7A and 7B, the second guide 74 can be structured at its inner side facing the second moulding wheel 72, so as to give the second exterior surface 54 of the complete suspension belt 20 a profile. In particular, the second exterior surface 54 of suspension belt 20 can also be equipped with V-ribs running in longitudinal direction, as will be discussed later in the context of special embodiments of suspension element 20, on the basis of FIGS. 8-10. Alternatively or additionally, also further surface structures can be applied to this second exterior surface 54.

This profiling or structuring of the second exterior surface 54 of suspension belt 20 preferably occurs during the moulding step, in the second manufacturing station. Alternatively, however, the second exterior surface 54 of suspension belt 20 can also be treated mechanically or chemically after the second manufacturing step, in a separate further manufacturing step (possibly together with the first exterior surface 50).

As already mentioned above, optionally the same materials, or different materials with the same or different properties can be used for first and second belt layer 46, 48. Due to the two-step manufacturing procedure, it is of advantage if the second material has a lower flow or melting temperature than the first material, so that the material stream fed by the second extruder 76 in the second manufacturing station may at most plasticize the surface of the first belt layer 46 at the connection plane 52 to reach a better connection between the two materials, but not the whole partial belt 66, thus ensuring that the shape of the tension members 42, enclosed by the first material as completely as possible, will be maintained.

In a preferred embodiment example, a softer material is conceived for the second belt layer 48 of suspension belt 20 than for the first belt layer 46 of suspension belt 20. For instance, the first material for the first belt layer 46 has a Shore hardness of about 85 at room temperature, while a second material with a Shore hardness of about 80 at room temperature is used for the second belt layer 48.

In the above-given embodiment example of the manufacturing procedure, it was described that the first and the second exterior surfaces 50, 54 can be embodied in the first or the second manufacturing stations optionally with even surfaces or with profiles. Furthermore, it is possible to equip one or both exterior surfaces 50, 54 with an additional coating, vapour-coating, flocking, or the like (not described), so as to selectively modify the surface properties, in particular the friction properties of the surfaces of the suspension element 20. This surface treatment can be optionally applied to the complete exterior surfaces 50, 54, or to only a part of the exterior surfaces, as for instance the flanks of respective V-ribs. For the second belt layer 48, which gets in contact with the deflecting pulleys, for instance a friction coefficient of μ≦0.3 is preferred.

4.2 b) Further Manufacturing Procedures

Another procedure to manufacture a preferably one-layer belt-type suspension element for an elevator system comprises in particular the steps of the exact positioning of at least one rope-type tension element, and the embedding of the at least one rope-type tension element into a moulded body of a first plasticizable material, and the forming of the external contour of the moulded body.

In a preferred embodiment according to invention, the whole external contour or at least parts of the external contour of the moulded body are formed simultaneously with the embedding of the at least one tension member.

In another embodiment, the moulded body is manufactured with the tension members and a preliminary shape of the moulded body as a primary product. In a further step, at least a first part of the external contour is formed. This can be done by plastic forming, or by material-abrading procedures, in particular machining procedures like milling, grinding, or cutting.

In another preferred embodiment according to the present invention, a moulded body of a belt-type suspension element according to invention is produced of two belt layers. In another embodiment of the procedure to manufacture a belt-type suspension element, the procedure contains the steps of positioning at least one rope-type tension member, embedding the at least one rope-type tension member in a first belt layer of a first plasticizable material, and moulding a second belt layer of a second plasticizable material to the first belt layer in such a manner that a suspension element with embedded tension members is produced.

In a special embodiment of this procedure, the procedure contains the steps of positioning at least one rope-type tension member, embedding the at least one rope-type tension member in a first belt layer of a first plasticizable material such that a partial belt with a first exterior surface and a surface forming a connection plane is created, in which the at least one tension member partly protrudes from the connection plane of the partial belt, and the protruding section of the at least one tension member is at least partly covered by the first plasticizable material. Further steps are the moulding of a second belt layer of a second plasticizable material to the connection plane of the first partial belt and the protruding section of the at least one tension member such that a suspension element is created with a first exterior surface at the side of the first belt layer and a second exterior surface at the side of the second belt layer.

For the first belt layer and the second belt layer, optionally different materials, materials of the same material class, the same material with different properties, or the same material with the same properties can be used, and in particular an identical material for both layers.

In a special embodiment of the invention, a first partial belt is produced with a surface forming a connection plane. This surface of the first partial belt is at least partly enlarged before the step of moulding the second belt layer to it, by giving it a structure. This can be done by mechanically roughening the surface, by impressing on it or fusing in it a certain roughness or pattern, by etching it, or by using similar procedures to enlarge the physical surface. The enlarged surface allows a better chemical and/or physical connection with the second belt layer to be moulded to it later. In a particular cost-effective way, a surface structure of the connection plane is formed already during production of the first partial belt, by using a respective melting mould with pattern or great roughness in the area of the connection plane. Other options to improve the connection between a first and a second belt layer are impregnating or coating with an adhesive, heating or fusing the surface of the first belt layer immediately before the moulding step, and/or applying a plastic adhesive, possibly also a plastic-metal adhesive. The latter is favourable above all if the tension members are made of metal and are not completely embedded in one of the belt layers.

In another embodiment of the invention, the first exterior surface and/or the second exterior surface are embodied with at least one rib extending in longitudinal direction of the suspension element. The forming of the ribs, too, is preferably done during the embedding step or the moulding step.

In another embodiment of the invention, the step of embedding the tension members into a first belt layer is performed as a procedure of extruding the first plasticizable material, and the step of moulding the second belt layer is performed as an extruding of the second plasticizable material onto the first belt layer.

In another embodiment of the invention, the first belt layer and the second belt layer are produced with the same or different procedural parameters (e.g. temperature, pressure, rotation speed of the moulding wheel, etc.), which are adapted to the first or the second plasticizable material, respectively.

In a modified embodiment of the invention, the first partial belt and the second partial belt are produced as primary products with the same or different parameters, and of the same or of different material(s). The two primary products are then assembled to a suspension belt, by welding their respective (long) sides embodied as connection planes, and/or fusing them, and/or pasting them, and/or calendering them. Preferably before assembling the belt layers, the tension members are embedded into one or both belt layers, preferably already during production of the belt layer(s). Alternatively or complementarily, (one or more) tension members are positioned onto a surface of at least one of the two belt layers embodied as connection plane and are preferably fixed there.

Subsequently, the belt layers are assembled. The fixing can be done by pasting, by attaching with mechanical means, like clamps etc., or by melting, or fusing, or pressing the tension members onto or into the connection plane of the respective belt layer.

In another embodiment of the invention, the at least one tension member is positioned under pre-tension during the embedding step.

To better connect a tension member with a first belt layer, preferably the at least one tension member is heated during the embedding step, and to better connect first and second belt layer, preferably the connection plane of the partial belt is heated during the moulding step, and/or the surface is enlarged by roughening or generating a pattern, or is impregnated with an adhesive.

In general, the known procedures of plastics engineering are used here, and are combined with each other according to material, need, and requirement profile. Evidently, the individual known procedural steps or procedures can be combined with one another. The known procedures of plastics engineering which are used here on their own or in combination, in succession or toothed with one another, are, for instance explained in “Oberbach et al., Saechtling Kunststoff Taschenbuch, 29th edition, Hanser, Munich 2004”, in chapter 4, in particular in sections 4.2.3 and 4.3.5, in particular in 4.2.5.4, 4.2.5.5, 4.2.5.9, and 4.2.5.10, as well as 4.2.6, 4.2.7, in particular in 4.2.7.1 and 4.2.7.2, in 4.2.9, 4.3.3, 4.4.1, 4.4.2, 4.4.3, 4.4.4, 4.4.5. According to invention, the procedures and procedural steps described in “Oberbach et al., Saechtling Kunststoff Taschenbuch” are drawn upon to produce belt-type suspension elements according to invention, and therefore the mentioned book is here referred to in full. Modifications and further developments of the basically known procedures are supplementarily described in this document. Both with known and with modified procedures, suspension elements for elevators can be produced simply and cost-effectively, and/or their quality can be improved.

4.2 c) Manufacturing Procedure on the Basis of Different Examples

FIG. 1Δ shows a cross-section through a suspension belt 12δ according to another embodiment of the present invention. This suspension belt 12δ comprises a hose arrangement with several individual hoses 15δ made of a thermoplastic synthetic material, in the embodiment example of polyamide. In each of the hoses, one tension member 14δ is arranged, with the tension member comprising of a steel wire rope twisted of strands which, in turn, are twisted of steel wires.

To produce elevator belt 12δ, the individual tension members are spray-coated with polyamide, where also the interspaces between the steel wires are filled with polyamide as completely as possible. Subsequently, a belt body 13δ made of an elastomer, in the embodiment example of polyurethane, is extruded onto the hose arrangement. The individual hoses have a larger cross-section than the tension members 14δ arranged in them. Thereby, in the extrusion process they can be better guided in positions accurate to each other and to the emerging belt body 13δ, in particular to the V-ribs 13.1δ of the latter. To achieve a particularly highly loadable connection between the hoses and the elastomer of the belt body, the hoses can be coated with an adhesion mediator, preferably in form of an adhesive.

With particular advantage, two tension members 14δ are assigned to each V-rib 13.1δ, so that any tension member 14δ is assigned one flank of this V-rib 13.1δ, via which, essentially, a traction force is transferred from a traction sheave to this tension member.

In a not-depicted modification of the first embodiment, the contact surface formed by the V-ribs 13.1δ has a thin coating, e.g. of polyamide, to reduce the friction coefficient. This may be reasonable if the elevator belt has too high a tractive capacity for the application in a specific elevator. Such a polyamide coating moreover reduces the wear of the contact surface as well as the danger of the V-ribs of the elevator belt 12δ getting stuck in the grooves of a traction sheave.

FIG. 2Δ shows a cross-section through another, modified embodiment of a suspension belt 12δ. Components corresponding with the previous embodiment are denoted with the same reference signs, so that below only differences to the first embodiment will be discussed.

In the embodiment of FIG. 2Δ, the two respective hoses 15δ of the hose arrangement assigned to one V-rib 13.1δ are interlinked by a web 15.1δ. This web is arranged centrically to the tension members 14δ and the hoses 15δ surrounding them concentrically. The webs give the structures of two respective interlinked hoses 15δ and tension members 14δ an increased stiffness in transverse direction, which makes the suspension belt 12δ extend in a perfectly straight line also on long, non-guided belt sections, and prevents it from tending to vibrate.

To manufacture the elevator belt according to the embodiment of FIG. 2Δ, the hose pairs of the hose arrangement are extruded under high pressure, with the tension members 14δ being fed to an extrusion nozzle in such a manner that in each hose 15δ a tension member 14δ is essentially centrally arranged, with favourably the second material of the hose 15δ filling the existing interspaces between the individual wires of the tension member 14δ as completely as possible. In a next step, the hose pairs are, again in accurate positions, fed to an extruder, in which the belt body 13δ is extruded and simultaneously the hose arrangement is embedded into the latter. Here, the webs 15.1δ are bilaterally enclosed by the material of the belt body 13δ. Since two respective hoses 15δ with embedded tension members 14δ are positioned non-shiftably at a distance of each other and the hose pairs form greater units, these can be more easily assigned to the respective V-ribs 13.1δ in accurate positions.

FIG. 3Δ shows a cross-section through another embodiment of suspension belt 12δ. In this embodiment, the webs 15.1δ—which interlink two respective hoses 15δ with tension members 14δ arranged in them assigned to a V-rib 13.1δ—are arranged tangentially to these hoses 15δ. In that way, they form a part of the backside of suspension belt 12δ (in FIG. 3Δ at the bottom). The friction coefficient of this belt backside parts 15.1δ, reduced in comparison to the friction coefficient of the elastomer of belt body 13δ, gives the suspension belt 12δ favourable properties with respect to its deflection around non-profiled deflecting pulleys. Here, too, the webs 15.1δ give the suspension belt 12δ a higher stiffness in transverse direction.

FIG. 4Δ shows another embodiment of the suspension belt 12δ, in cross-sectional view. This embodiment differs from the embodiment in FIG. 3Δ in that all hoses 15δ with tension members 14δ arranged in them are interlinked by one single web 15.1δ. The web 15.1δ is arranged tangentially to the hoses 15δ. It essentially forms the backside of elevator belt 12δ, which is conceived to be deflected over deflecting pulleys. The backside, thus basically comprising of polyamide, is more abrasion-resistant and has a lower friction coefficient, so that with deflection around the backside of elevator belt 12δ less wear occurs and the energy demand to move the elevator belt is reduced. In a non-depicted modification, the web 15.1δ extends up to the side margins of suspension belt 12δ, hence forming the entire backside of elevator belt 12δ.

A modification of the embodiment shown in FIG. 1Δ is shown in cross-sectional view in FIG. 5Δ. The hoses 15δ known from FIG. 1Δ, with tension members 14δ embedded in them, are combined in pairs and assigned to respective V-ribs 13.1δ. The pairs of hoses 15δ with tension members 14δ are not positioned at a distance of each other but contact with each other. Thus, the distance of the tension members 14δ to the flanks of V-ribs 13.1δ favourably equalizes. In that way, it is, for instance, prevented that the distance of a tension member 14δ to its assigned flank between rib peak and rib base varies heavily. This contributes to a better distribution of the transferred forces in belt body 13δ.

To produce the elevator belt according to FIG. 5Δ, the tension members 14δ are individually spray-coated with polyamide, with preferably all interspaces between the individual wires of the tension member being filled. Subsequently, two hoses 15δ are each coated with a thermal adhesive and are jointly fed to the extruder, which extrudes the belt body 13δ. During extrusion, the hoses 15δ of the hose pairs are embedded in the belt body 13δ, in which process they interlink both with the belt body 13δ and with each other, through the thermal adhesive activated here.

Of course, the hoses of the hose pairs represented in FIG. 5Δ can also be extruded jointly and thereby be firmly connected in the area of their common contact zone. With this embodiment, too, an increased transverse stiffness with the already described advantages results.

Another embodiment is illustrated in FIGS. 6Δ and 7Δ. A first belt layer, forming the backside of the suspension belt 12δ, has V-shaped grooves 15.1δ. A second belt layer forms a belt body 13δ made of polyurethane, with trapezoidal V-ribs 13.1δ, which constitutes the major part of the volume of suspension belt 12δ. In the polymer mass of suspension belt 12δ, tension members 14δ are embedded, with each trapezoidal V-rib 13.1δ being assigned two tension members 14δ.

Such a belt can, for instance, be manufactured by means of extrusion, with the grooves 15.1δ favourably being embodied already in the original moulding process. To keep the bending strain on the first belt layer or backside 15δ during its being deflected around belt rollers as low as possible, the latter has a thickness of at most 2 mm, or at most one third of the whole belt thickness.

To produce the belt 12δ, at first a tension member 14δ is arranged in each groove 15.1δ of the backside 15δ represented in FIG. 6Δ. In a way not described in more detail, the tension member is embodied as cord of a fibre rope, or of a wire rope, or of wire strands, which, in turn, are composed of individual steel wires stranded with each other.

If different belts with different tensile strengths are to be produced with the same first belt layer as a platform, not necessarily every groove has to be assigned a tension member. So, for instance, every second groove can be left free, which—with the same first belt layer—results in a suspension belt with essentially half the tensile strength, yet with higher flexibility. The usability of the same first belt layers or backsides for different elevator belts favourably reduces the costs for tools, storage, etc.

The tension members 14δ, with a slight pre-tension, are pressed from above into the V-shaped grooves 15.1δ, whereby the latter deform elastically and basically adopt the contour of the tension members. It is also possible to heat the first belt layer 15δ, in a subsequent step of the manufacturing procedure (not explained in more detail here), to a degree that the thermoplastic synthetic material is plasticized again that far that the grooves adapt to the tension members 14δ under plastic deformation. In another embodiment of a manufacturing procedure according to invention, the tension members 14δ can also be laid into the grooves, essentially stress-free, and are arranged by the latter in accurate positions to each other. Laying the tension members in is here to be understood as each form of feeding them.

Subsequently, the second belt layer 13δ, which constitutes the major portion of the volume of suspension belt 12δ and is hence also called belt body 13δ, is extruded, of polyurethane, onto the first belt layer 15δ with tension members 14δ arranged in its grooves 15.1δ. The polyurethane of belt body 13δ here encloses the still uncovered surface of the tension members 14δ and at the same time thermally connects with backside 15δ. The adhesion between the backside 15δ and the tension members 14δ partly embedded in it is big enough to transfer the tractive forces occurring in the elevator system from a traction sheave via the backside 15δ to the tension members 14δ.

On its side looking away from the first belt layer or backside 15δ, the belt body 13δ has V-ribs 13.2δ with a flank angle γ of 90°. These V-ribs can be produced by finish-machining or, preferably, during the moulding of belt body 13δ, for instance by introducing the polyurethane between the first belt layer or backside 15δ and a moulding band of the extrusion facility (not depicted), which is positioned at a distance of the backside equaling the height of the belt body and has a respective complementary V-rib profile. Usually, belt 12δ contains several tension members 14δ, and the first belt layer 15δ has several grooves 15.1δ guiding the tension members 14δ, with the distances between neighbouring grooves or tension members being embodied such that an equal number of tension members 14δ can be assigned to each of the V-ribs 13.2δ, and the respective group of tension members 14δ assigned to a V-rib 13.2δ is arranged symmetrically to the central axis 13.3δ of this V-rib

The first belt layer 15δ forms a sliding surface at its side looking away from the second belt layer 13δ (in FIG. 1Δ at the bottom), which is conceived for deflection around a deflection element. This sliding surface of polyamide has a low friction coefficient and at the same time a high abrasion resistance. In that way, the friction force to be overcome for guiding the belt on a deflecting pulley is favourably reduced, and hence also the lateral load of the belt, e.g. by flanged wheels of traction sheaves, and consequently also the required drive power. At the same time, the service life of the belt and the deflection element is prolonged.

At its side looking away from backside 15δ (in FIG. 1Δ at the top), the belt body 13δ or second belt layer forms a traction surface equipped with V-ribs 13.2δ, which is conceived for interacting with a traction sheave. If another friction coefficient than that given by the polyurethane of belt body 13δ is desired, the belt can have a coating on its traction surface (not depicted). For instance, the flanks of the V-ribs 13.2δ getting in contact with a corresponding V-rib profile of the traction sheave can be coated with a thin polyamide foil. To facilitate production, also the whole traction surface can be coated with such a foil.

In another embodiment of the present invention, belt 12δ comprises a third belt layer 16δ of polyethylene, arranged at the side of the first belt layer 15δ looking away from belt body 13δ. In FIG. 6Δ, this further embodiment or the third belt layer 16δ is indicated by a dashed line.

In FIG. 8Δ, another embodiment of a suspension belt 12δ is depicted, in which tension members 14δ are arranged on a tissue-reinforced backside 15δ. The tension members 14δ are embedded in pairs into individual belt bodies 13δ, which, at a defined distance 18δ, are firmly connected to the backside 15δ. Each belt body is embodied as a sort of V-rib in such a manner that, together with the neighbouring belt bodies 13δ, it approximately forms a V-rib surface of a suspension belt. The backside in this example is made of polyamide-impregnated nylon tissue, the belt body 13δ of a polyurethane mixed with adhesives, and the tension members 14δ of fibre ropes or wire ropes.

Such a belt 12δ can be produced, for instance, by pasting the tension members 14δ onto a first belt layer which is to become the backside 15δ of suspension belt 12δ, welding them onto it or pressing them into it, at a defined distance of each other. Then, the belt bodies are extruded onto the side of backside 15δ which carries the tension members 14δ. This is preferably done in a device with a respectively designed moulding wheel, so that the distances 18δ between the individual belt bodies 13δ in the complete suspension belt are well-defined.

Another way to produce such a belt comprises in introducing the tension members 14δ into a moulding wheel and positioning them there, pre-tensioned, on so-called ‘winding noses’. Simultaneously, the moulding material for the belt bodies 13δ is extruded into the cavity of the moulding wheel. The moulding material polyurethane flows around the tension members 14δ, with the exception of the small bearing surfaces of the tension members on the ‘winding noses’. The thus produced belt bodies are received by a conveyor that guides the belt bodies in grooves at a defined distance to each other. Then, the second belt layer, the backside 15δ, is fed to the conveyor. During being conveyed on the conveyor, belt bodies 13δ and backside 15δ are firmly interlinked to form the complete suspension belt 12δ, by being either welded or pasted together.

Under deformation of backside 15δ, the individual V-ribs 13δ are movable relative to each other and can thus counterbalance deviations of position and shape of the ribs and grooves. In particular, two neighbouring V-ribs can change their distance of each other both in transverse and in height direction of belt 12δ, thus being able to engage with grooves in a traction sheave of different distances, different depths, and/or different shapes.

4.2 d) Device to Manufacture a Belt-Type Suspension Element

According to another aspect of the invention, a manufacturing device for a belt-type suspension element for an elevator system is conceived. The suspension elements for elevator systems described in more detail elsewhere in this document are preferably produced by means of the manufacturing devices or facilities described below, using the procedures also described in this document.

In a special embodiment, the device to manufacture a belt-type suspension element for an elevator system has a first manufacturing station to form a first belt section or belt layer with a first exterior surface and a surface forming a connection plane, and a second manufacturing station to form a (complete) suspension element with the first exterior surface and a second exterior surface. The first manufacturing station has a first moulding wheel, a first guide wrapping a partial circumference of the first moulding wheel, a device to feed at least one (preferably rope-type) tension member to the first moulding wheel, and a first extruder to feed a first plasticizable material into a mould cavity formed between the first moulding wheel and the first guide. The second manufacturing station has a second moulding wheel, a second guide wrapping a partial circumference of the second moulding wheel, a device to feed the belt section/belt layer produced in the first manufacturing station to the second moulding wheel, and a second extruder to feed a second plasticizable material into a mould cavity formed between the second moulding wheel and the second guide. The exterior circumferential surface of the first moulding wheel of the first manufacturing station defines the form of the connection plane of the first belt layer produced in the first manufacturing station. According to invention, it has a longitudinal groove extending in the circumferential direction of the first moulding wheel, into which the at least one tension member is fed and positioned. The depth of the longitudinal groove is smaller here than the radius of the tension member, so that the at least one tension member is embedded only with a part of its diameter in the first belt section, and with the other part protrudes from the connection plane.

The depth of the longitudinal grooves of the exterior circumferential surface of the first moulding wheel preferably ranges from about 25%-50% of the diameter of the tension members, preferably from about 30%-49%.

In another embodiment of the invention, a first manufacturing station moreover has a device to feed a tension member under pre-tension to the first moulding wheel, and a first heating device to heat the tension member before its being fed to the first moulding wheel.

In another embodiment of the invention, a first guide of the first manufacturing station is equipped at its side facing the first moulding wheel with a cavity structure, so as to profile the first exterior surface of the partial belt or suspension belt (e.g. with V-ribs).

In another embodiment of the invention, a first moulding wheel is structured at its exterior circumferential surface, in the area between the longitudinal grooves, so as to give the partial belt surface constituting the connection plane a corresponding surface structure. The structure has a microscopic surface roughness greater than Rz=10, in particular greater than Rz=20, so that the surface is physically enlarged, thereby contributing to a better connection between first and second belt layer of the suspension belt. Alternatively or additionally, the structure has macroscopic grooves with a depth of more than 15 μm, in particular of more than 25 μm. Preferably, grooves are conceived that run towards each other at an acute angle and form a regular or irregular pattern. Furthermore alternatively or additionally, the structure has undercuts.

In another embodiment of the invention, the second manufacturing station has a (preferably second) heating device, to heat the first belt layer before its being fed to the second moulding wheel. The second guide of the second manufacturing station is, at its side facing the second moulding wheel, optionally equipped with a cavity structure able to give the second exterior surface of the suspension element a profile, e.g. in the form of ribs or teeth.

In a modified embodiment, in a work station subsequent to the second manufacturing station, a plastic forming of the suspension element is executed, in particular by using a forming machine.

In another embodiment, a(nother) manufacturing station is conceived, in which the surface of the suspension element undergoes a material-abrading machining to reach a desired surface quality and/or surface shape. In particular, the suspension element is finish-machined by cutting, grinding, or milling.

4.3.1 Preferred Embodiments of Suspension Elements According to Invention

Referring to FIGS. 8-10, different preferred embodiments of a belt-type suspension element 20 will be described below that can be produced by means of the above-described manufacturing procedure of the invention. The said suspension elements can be combined arbitrarily to force transfer arrangements according to invention, to equip an elevator system or elevatoring gear according to invention.

In the first embodiment example of FIG. 8, the suspension belt 20 has a moulded body 44 formed of a first belt layer 46 and a second belt layer 48, in which a tension member arrangement with a total of four rope-type tension members 42 is arranged. The first exterior surface 50 of the first belt layer 46 is conceived for contacting with traction sheave 26. To this end, it has two traction ribs in the form of V-ribs 80, which engage with assigned grooves of traction sheave 26 and are laterally guided by the latter, so that the contact pressure and hence the tractive capacity of the drive increase.

The second exterior surface 54 of the second belt layer 48 is conceived for contacting with the car idler pulleys 34a, 34b, and to this end has a guide rib in the form of a V-rib 82, which engages with an assigned roller of the deflecting pulley 34a, 34b and is laterally guided by the latter.

In the embodiment example of FIG. 8, the total height of suspension belt 20 is dimensioned as greater than its total width. Thereby, the bending stiffness of suspension belt 20 around its transverse axis is increased, which counteracts its getting stuck in the grooves of traction sheave 26 and of the idler pulleys 34a, 34b. In the example shown, the width/height ratio amounts to about 0.90.

The flank angle α of the traction ribs 80 of the first belt layer 46 is defined as the interior angle between the two flanks of a traction rib 80, and in the embodiment example amounts to about 90° (generally ranging between 60° and 120°). The correspondingly defined flank angle β of the guide rib 82 of the second belt layer 48 in this example amounts to about 80° (generally ranging between 60° and 100°).

As can be seen in FIG. 8, the flank height of guide rib 82 is bigger than the flank height of the two traction ribs 80. In that way, guide rib 82 can dive more deeply into a respective groove of the deflecting pulleys 30, 34a, 34b than the traction ribs 80 dive into the assigned grooves of traction sheave 26. Equally, it can be seen in FIG. 8 that the flank width of guide rib 82 is bigger than that of the two traction ribs 80. Due to the bigger flank width of guide rib 82, the suspension belt 20 is guided at its second exterior side 54 over a wider area in transverse direction.

As is indicated in FIG. 8, the V-ribs 80, 82 have a flattened top each, with a certain width that equals at least the minimal distance of the respective counter-flanks of the grooves of the sheaves/pulleys 26, 30, 34a, 34b. In that way, the edge embodied in these counter-flanks does not contact with the flanks of the V-ribs 80, 82, so that the latter are protected against a respective notching effect.

The first exterior surface 50 can—at least in the areas of the V-ribs 80 which contact with frictional grip with the flanks of traction sheave 26—have a coating with a PA foil, a nylon tissue, or the like. Furthermore, a V-rib 80 can optionally be given a friction-coefficient-reducing and/or noise-reducing coating.

A suspension belt 20 as described above on the basis of FIG. 8 is, for instance, explained in detail in the so far unpublished European patent application EP 06127168.0 of the applicant, which is referred to with respect to structure and form of the suspension belt 20.

The second embodiment example of a suspension belt 20, illustrated in FIG. 9, differs from the above-described example in that only one V-rib 80 is embodied instead of two V-ribs 80 at the side of the first belt layer 46. This one V-rib 80, too, has a flank angle α of about 90° (generally ranging between 60° and 120°) and a flattened top. As a result, this suspension belt 20 has V-profiles both at its first and its second exterior side 50, 54.

FIG. 10 shows a third embodiment example of suspension belt 20. It differs from the suspension belt 20 shown in FIG. 9 in that the V-rib 80 of the first belt layer 46 is embodied as overall rounded.

Of course, the embodiments of FIGS. 8-10 are only examples and are not meant to restrict the invention to these special shapes of suspension belt 20. Further variants of suspension elements that can be produced with the above-described manufacturing procedure of the invention are described in detail elsewhere.

While in the embodiment examples of FIGS. 8-10 the total height of suspension belt 20 was dimensioned as larger than its total width, the invention is, of course, not restricted to such a relation. As is indicated in FIGS. 11A and 11B, the present invention comprises both suspension belts 20 in which the height exceeds the width (FIG. 11A) and suspension elements 20 in which the width exceeds the height (FIG. 11B). Moreover, both rectangular and square cross-section forms are possible for suspension belt 20. Preferably, the ratio of total width to total height of the (non-round, sheathed) suspension belt 20 ranges from 0.8 to 1.2, in particular from 0.9 to 1.1.

In the embodiment example given above, the manufacturing of a suspension belt 20 with a certain width and a certain number of embedded tension members 42 and V-ribs 80, 82 was described. In particular in the case of narrow suspension belts 20 (i.e., height/width>1), as they are exemplarily shown in FIGS. 8-10, however, it is also possible in the context of the invention to produce several such suspension belts 20 simultaneously, placed side by side, and/or in one piece.

With this variant, it is possible to produce at first a broad suspension belt (primary product) with a great number of tension members 42, and subsequently separate it into several individual suspension belts 20 of smaller width. To this end, various mechanical procedures, like cutting, sawing, etc., may be applied. To facilitate the separation process, respective predetermined breaking lines and/or perforations can be conceived in the primary product comprising several suspension belts 20. Furthermore, for severing the individual narrow suspension belts 20, a traction sheave 26 can be conceived in which individual grooves have a greater distance of each other than two ribs to be made engage with them of two neighbouring suspension belts to be separated, so that the primary product is spread apart at these sites and eventually is severed in the elevator system into several narrow suspension belts 20.

For simpler handling, the broad suspension belt 20 can be equipped with a support band or mounting band, e.g. of plastic, or with foil-type clamps, or the like, which may remain in place even after the severing process and are possibly removed only in the mounting of suspension belt 20 in an elevator system. This procedure is, for instance, explained in detail in the European patent application EP 06118824.9 of the applicant, which is referred to in this respect.

4.3.2 Further Variants of Suspension Elements According to Invention

According to another aspect of the invention, a belt-type suspension element for an elevator system is conceived (in the following simply denoted as “suspension belt” or “belt”), which is described below.

In a preferred embodiment of a suspension element according to invention, a multitude of rope-type tension members are arranged in one or more common sheathing(s), where a sheathing—in particular an external sheathing—has a non-round cross-section. An external sheathing preferably constitutes a shape-determining and/or function-determining moulded body of the suspension element. Number and arrangement of the tension members in the moulded body are preferably chosen such that a compensation of different torques or torsional moments is realized in the suspension element. Optionally, individual tension members are assigned individual sheathings, which are sectionally or completely embedded in the moulded body. The moulded body preferably has a triangular, square, pentagonal, hexagonal, or polygonal cross-section, which basically remains constant over the whole length of the suspension element. The moulded body may, however, have a preferably regular toothing along its longitudinal extension, which assigns the moulded body at least two different cross-section shapes alternating along the longitudinal extension of the suspension element.

The moulded body of the suspension element has at least one traction side, via which the suspension element can be brought into contact with a so-called traction sheave or drive shaft, as this is described in detail elsewhere in this document. Furthermore, the moulded body preferably has a guide side, looking away from the traction side, via which the suspension element can particularly be made engage with guide pulleys and/or deflecting pulleys. In a modified embodiment example, the moulded body of the suspension element has two traction sides (particularly located opposite each other), which can be made engage with a traction sheave or drive shaft each.

In one embodiment, the moulded body (seen in cross-section to its longitudinal axis) has at least two areas or layers with different properties: a first area interacting during operation with the traction sheave (also called traction side), and an area opposite to the latter, which either serves to protect the tension members against environmental influences or to guide and/or deflect (guide side). Between these areas, a base body can be conceived as another area (arranged centrally between traction side and guide side). A tension member can be arranged completely or partly in one of these areas. Preferably, all tension members are arranged in the base body or in the area of the guide side. In one embodiment, one or more so-called “irrotational” ropes on steel basis or synthetic-fibre basis are embedded in the base body as tension members. As a steel rope, for instance an irrotational steel rope in accordance with DIN 3071 is conceived.

In another embodiment, at least two tension members are conceived, the torques or torsional moments of which counterbalance each other in such a manner that the whole suspension element is almost irrotational and/or torque-free.

In another embodiment, the suspension element has at least one tension member and on its traction side at least one V-rib, with the at least one tension member being centrically or force-symmetrically assigned to the V-rib. In a modified embodiment example, the suspension element has at least two times two tension members, which are centrically and/or symmetrically assigned to at least two V-ribs side-of-traction, and centrically and/or symmetrically to at least one V-rib side-of-guide.

A modification of the suspension element conceives a one-layer moulded body with one or more embedded tension members, with the suspension element comprising at least one respective rib extending in longitudinal direction of the suspension element and/or at least one groove extending in longitudinal direction of the suspension element, preferably at two (preferably in particular opposite) sides of the moulded body. In another modification, the belt-type suspension element has at least one moulded body, constituted by two belt layers, with one or more embedded tension members.

In a preferred embodiment, a belt-type suspension element according to invention for an elevator system has a first belt layer made of a first plasticizable material, with a first exterior surface, and a surface constituting a connection plane, as well as at least one rope-type tension member, which is embedded in the first belt layer such that it partly protrudes from the connection plane of the first belt layer, and the protruding section of the at least one tension member is at least partly covered by the first plasticizable material. Furthermore, the belt-type suspension element comprises a second belt layer, made of a second plasticizable material, which is moulded to the connection plane of the first belt layer and the protruding sections of the at least one tension member, and forms a second exterior surface of the suspension element.

The first belt layer and the second belt layer of the suspension belt can be made optionally of a material of the same material group (e.g. the group of thermoplastic elastomers), of the same material (e.g. an EPDM with identical composition), of a similar material with different properties (e.g. a thermoplastic polyurethane, and the same thermoplastic polyurethane with a plasticizer as additive), or of different materials, in particular very different plastics (e.g. a thermoplastic elastomer, and a vulcanizable synthetic rubber, or a tissue, in particular an impregnated tissue).

In one embodiment of the invention, the first exterior surface of the first belt layer is embodied with at least one first rib extending in longitudinal direction of the suspension element, which preferably has the form of a V-rib with a flank angle ranging between 50° and 130° and/or has a flattened top.

In another embodiment of the invention, the second exterior surface of the second belt layer is embodied with a second rib extending in longitudinal direction of the suspension element, which preferably has the form of a V-rib with a flank angle ranging between 50° and 120° and/or has a flattened top. Embodiments with a first V-rib on the first exterior surface, or with only a second V-rib on the second exterior surface, or with V-ribs on first and second exterior surface, opposite or alternately opposite each other, are conceivable.

In still another embodiment of the invention, the ratio of the total height of the suspension element to its total width is greater than 1, with the height extension being aligned as basically perpendicular to a (possibly imaginarily cylindrical) traction surface of an assigned traction sheave. Alternatively, this ratio may, however, also amount to approximately 1 or be smaller than 1.

FIG. 1aS shows another, modified (flat) suspension belt 20 for the elevator system according to invention which has a moulded body formed in one piece. During operation, one side of the suspension belt 20 (a traction side 50) is facing a traction sheave 26. This side 50 is embodied with V-ribs 80. The V-ribs 80 are oriented in longitudinal direction of belt 20. The moulded body 44 of the V-ribbed belt 20 is preferably made of polyurethane, and harbours tension members 42 oriented in longitudinal direction of the flat belt 20. The tension members 42 give the V-ribbed belt 20 the required tensile strength and/or longitudinal stiffness. They can be made of metallic materials and/or non-metallic materials, like natural and/or synthetic/chemical fibres, and can be embodied as tissues, in particular as flat-spread tissues, and/or as rope-type tension members 42, as it is depicted here. Further possible variants regarding the choice of materials and shapes for the tension members and the sheathing are mentioned elsewhere in this document and are applicable in the present embodiment example.

With the choice of a V-ribbed belt 20 as suspension element for the elevator according to invention, a traction sheave 26 with a diameter of 70 mm-100 mm, preferably of 85 mm, can be used to transfer the required tractive force onto suspension element 20 while avoiding an inadmissibly high bending strain of suspension element 20. The mounting space for the drive can thus be designed as more narrow. With given tractive force, the torque to be provided at the drive shaft is correspondingly lower thanks to the smaller traction sheave diameter. The drive torque required from hoisting machine 14 can be further reduced with the help of a V-belt drive (not depicted). Since the diameters of electric motors are approximately proportional to the torque generated, the dimensions of hoisting machine 14 and hence the whole mounting space for the described drive arrangement can be kept minimal. Modified variants of hoisting machines to be used according to invention and conceived according to invention are mentioned and described in detail elsewhere in this document. In the present elevator system, they can be used with advantage.

In the embodiment according to FIG. 1aS, the ribs 80 are separated by grooves from each other, with both ribs and grooves having a triangular cross-section. The angle b between the flanks of a rib 80 or a groove affects the operation properties of the V-ribbed belt 20, and in particular its quiet running and its tractive capacity. Tests have shown that, within certain limits, the following holds: the greater angle b, the better the quiet running and the worse the tractive capacity. Taking the requirements regarding quiet running and tractive capacity into account, angle b should range between 80° and 100°. An optimal compromise between the contrasting requirements is achieved with V-ribbed belts the angle b of which amounts to about 90°.

In another embodiment, the flat-belt type suspension element 20 has at least two tension members 42 per rib, oriented in longitudinal direction of the suspension element, with the total cross-sectional surface of all tension members 42 amounting to 15%-30% of the cross-sectional surface of the suspension element, in particular to 20%, or to more than 25%.

Another possibility of embodying the V-ribbed belt 20 can be seen in FIG. 1bS. In this example, the ribs 80 separated from each other by grooves have a trapezoidal cross-section each. Besides, transverse grooves 81 are conceived apart from the V-ribs 80 on the side 50 facing the traction sheave, which intersect grooves and ribs 80. These transverse grooves 81 improve the bending flexibility of the V-ribbed belt 20, so that the latter can interact with traction sheaves 26 with particularly small diameters. The surfaces of a traction sheave 26 conceived for interaction with the V-rib-type, flat suspension elements 20 described here can be cylindrically even, and/or equipped with shaped grooves, and/or with grooves arranged in circumferential direction to receive the V-ribs 80. Further particularly preferred variants of traction sheaves are described elsewhere in this document and can be used in the present embodiment examples with advantage.

Besides, radial ribs in parallel to the axis of traction sheave 26 can be conceived to interact with a suspension element 20 according to FIG. 1bS, which—similar to a toothed belt with a toothed wheel—interact with the transverse grooves 81 of suspension belt 20, and counteract a sliding of belt 20 on traction sheave 26. The transverse grooves 81, here, preferably have a depth of 0.01 mm-0.5 mm, and no corresponding “teeth” on the part of the suspension belt have to be conceived.

FIG. 1cS shows another embodiment of a V-ribbed belt 20 with transverse grooves 81, as it is already known from FIG. 1bS, with the transverse grooves 81 in this embodiment example being arranged on the side 2.1 opposing the V-ribs 80. Such a V-ribbed belt can not only serve as a suspension element and drive element for the elevator car, but also to record the position of the elevator car. The transverse grooves 81 form a toothing at the deflection side 2.1 of belt 20, with teeth oriented transversely to its longitudinal direction that engage in a form-locking manner with a toothed wheel of a detector.

FIG. 1dS shows an elevator system with a toothed wheel 3A of a position detector. The elevator car 10 of this elevator system is vertically traversable in a well 12. For elevatoring and lowering car 10, a belt 20 is fixed at its one end in the elevator well, and from there runs over two car idler pulleys 34a, 34b (deflecting pulleys) arranged at the roof of car 10, and a traction sheave 26 driven by an electric motor (not depicted), to a counterweight idler pulley (deflecting pulley) at the counterweight 32. Traction sheave and deflecting pulleys can be modified here in a similar way as the other traction sheaves and/or deflecting pulleys described in this document. Instead of a belt 20, the other suspension elements according to invention described in this document can be applied.

The suspension element 20 (here exemplarily embodied as flat belt) wraps the traction sheave and the car idler pulleys 34a, 34b with a second flat side 2.2 with V-ribs 80 running in the longitudinal direction of the belt. The V-ribs 80 interact with complementary grooves in traction sheave 26 and the car idler pulleys 34a, 34b. Thereby, the belt tension can be significantly decreased, and simultaneously a sufficient tractive capacity of traction sheave 26 can be ensured.

Since belt 20 wraps traction sheave 26 and the neighbouring car idler pulley 34a, 34b in opposite senses (in FIG. 1, belt 20, starting from counterweight 32, is deflected around traction sheave 26 in a mathematically negative sense, around the following car idler pulley 34a, 34b in a mathematically positive sense), belt 20 is twisted by 180° around its longitudinal axis between these two rollers 26, 34a, 34b, so that in each case its second side, the flat side 2.2 with the V-ribs, engages with the guiding surfaces of the rollers 26, 34a, 34b. In that way, the second flat side 2.2 is used both as guide side and as traction side of the suspension element.

In a modified embodiment example, the second flat side 2.2 is conceived as traction side of the suspension element, while the first flat side 2.1, opposite of the second flat side 2.2, is used as guide side of the suspension element and also has a rib and/or a groove. The second flat side 2.2 thus engages in operation with at least one not driven deflecting pulley/guide pulley.

At the first flat side 2.1 of belt 20, opposite of the second flat side 2.2, a toothing is embodied, with which a toothed wheel 3A of a detector (not depicted) engages. This toothing can be conceived irrespective of the fact whether the suspension element has a groove and/or rib oriented in longitudinal direction on its first flat side or not. The toothing can be quasi built onto one or more ribs.

The toothed wheel 3A is arranged in the elevator well 12, as inertia-resistant, near traction sheave 26, so that belt 20 is guided by the traction sheave 26 and the toothed wheel 3A. If toothed wheel and traction sheave are arranged closely enough to each other, in particular only separated by a gap which essentially has the thickness of the belt, favourably the traction sheave presses the belt onto the toothed wheel, thus preventing a skipping of teeth and hence improving the precision of the position recording.

The toothed wheel 3A is linked to a rotary encoder (not depicted), which determines the relative angle position of the toothed wheel, e.g. its revolution modulo 2π, and puts a respective signal out to a processing unit (preferably to a central elevator control unit). The latter determines the absolute position of belt 20, by adding the already occurred complete revolutions according to their sign (e.g. by subtracting revolutions in the opposite sense), and multiplying the resulting total angle (relative angle position plus complete revolutions) with the pitch radius of the toothed wheel 3A. If a 2:1 block-and-tackle arrangement of belt 20 has to be taken into account, the processing unit subsequently halves this value and from the result, determines the position of car 10 in well 12.

If car 10 actuates a contact switch (e.g. arranged close to a landing door, not depicted), a correction unit records this actual position of car 10 relative to the contact switch and compares it with the theoretical value determined from the belt position. If the value determined from the belt position deviates from the thus recorded actual position of car 10 (for instance due to a belt expansion or the skipping of teeth in the toothed wheel 3A), the correction unit logs this deviation and subsequently adds it to the theoretical car position determined from the position of the toothed wheel.

Since the belt position is recorded rather precisely and with high resolution by the mechanical pick-off, speed or acceleration of the belt (and hence also of car and counterweight) can also be determined precisely, by differentiating once or twice with respect to time, where, in particular, a steady belt expansion can remain unconsidered. This allows to monitor maximally occurring speed and acceleration values, to follow preset speed profiles, and to assess the total car mass from the quotient of the tractive force exerted by traction sheave 26 on belt 20 and from the resulting acceleration.

In an alternative embodiment, a toothed wheel, instead of being mounted at the car ceiling, is arranged rotatably at car 10. The toothed wheel is arranged close to the one car idler pulley 34a, 34b, so that belt 20 is guided between car idler pulley 34a, 34b and toothed wheel 3A. The teeth 81 on the first side 2.1 (guide side) of the suspension belt 20 engage with the toothed wheel, while the V-ribs 80 on the second side 2.2 (traction side) of belt 20 engage with the grooves of the car idler pulley.

The toothed wheel is, preferably via a scaling, coupled with a rotary encoder (not depicted) such that a travelling of the elevator car 10 between a topmost and a downmost position, during which the toothed wheel performs several complete revolutions, corresponds just with one complete revolution of the encoder disc. In that way, the absolute angle position of the encoder disc directly represents the absolute position of belt 20, from which—as in the first embodiment—the position of car 10 can be determined.

The proposed measuring arrangement is applicable for all elevator systems and elevatoring gears described elsewhere in this document, with all suspension elements described elsewhere in this document being usable. So far, the recording and tracing of the position of the suspension element by means of a toothed wheel and a corresponding toothing on the part of the suspension element engaging with it in a form-locking way has been described. Analogously, however, also a metering wheel rolling on the suspension element in a friction-type-locking way can be conceived, or a wheel arrangement with several wheels enclosing the suspension element, which, in turn, can be pressed against the suspension element by means of at least one spring. The metering wheel can be installed in an inertia-resistant position in an elevator well, or equally at the car or at the counterweight.

Further advantages of a suspension element equipped with teeth are explained in the following figures.

FIG. 1eS a) shows a suspension belt 20 which interacts as toothed belt with a traction sheave and has straight teeth, seen in a top view onto the teeth.

The advantage here lies in the fact that a traction sheave for this suspension belt embodiment can be easily manufactured by milling. Such suspension belts are to be guided by special measures, e.g. by flanged wheels placed laterally at the traction sheaves and deflecting pulleys. The tooth engagement, which with straight teeth occurs simultaneously over the whole tooth width, means a relatively heavy noise emission during operation.

The load-carrying capacity of the teeth of a suspension belt and the number of teeth engaging determine the transmission capacity. Ideally, the suspension belt has bent teeth or teeth arranged in arrow-shape, as it is depicted in FIGS. 1eS b) and 1eS c). In that way, the suspension belt centres itself on the traction sheave. Besides, the quiet running is thereby improved. Normally, the riding surface of the traction sheave is adapted to the form of the teeth of the suspension belt, i.e., the traction sheaves have a counter-toothing corresponding to the belt toothing.

FIG. 1eS b) shows a suspension belt 20 with arcuate teeth. This belt toothing, together with a corresponding counter-toothing of a traction sheave or deflecting pulley, acts as self-centring. Since not the whole tooth width engages simultaneously, also the operation noise is reduced.

In FIG. 1eS c), a suspension belt 20 with herringbone toothing is depicted. The teeth in the left and the right belt half are arranged in an arrow shape with respect to each other, and in longitudinal belt direction are shifted against each other by half a tooth spacing, respectively. Such suspension belts work at low noise since the tooth engagement between belt and sheave/pulley occurs at different times in different areas of the belt width, and they self-centre on the counter-toothing of a traction sheave.

FIG. 1eS d) shows a toothed sheave 26, 26′ for a suspension belt with herringbone toothing. The toothing is produced either by milling or by rolling. The represented sheave 26, 26′ is embodied as bipartite, so as to enable the milling of the toothing.

FIG. 1eS e) shows a traction sheave or deflecting pulley 26, 26′ for straight-toothed suspension belts 20, which has two flanged gears 27 screwed to it to laterally guide the suspension belt 20. In that way, a suspension belt with self-centring toothing can also be guided when it runs around a deflecting pulley 26′ with its non-toothed side.

In FIG. 1eS f), a suspension belt 20 with a guide rib 82 on its non-toothed backside 54 is depicted. The guide rib serves to guide the suspension belt 20 if it runs around a pulley with its non-toothed side. In that case, the riding surface of such a pulley has a corresponding guide groove. This situation is given in elevator systems in which the suspension belt is guided over pulleys/sheaves such that it is bent in both directions. A guide rib may also be placed at one of the lateral edges or at both lateral edges.

The suspension elements shown in FIGS. 1eS a) to 1eS d) and 1eS f) contain tension members 42 oriented in their longitudinal direction, which comprise metal strands (e.g. steel strands) or non-metallic strands (e.g. of chemical fibres). Such tension members 42 give the transmission elements according to invention the required tensile strength and/or longitudinal stiffness. Preferred embodiments of suspension elements according to invention contain tension members of Zylon fibres. Zylon is a trade name of the firm Toyobo Co. Ltd., Japan, and refers to chemical fibres of poly(p-phenylene-2,6-benzobisoxazole) (PBO). These fibres are superior to steel strands and to other known fibres in their properties relevant for the application according to invention. By use of Zylon fibres, the linear expansion and the metre weight of the transmission element can be reduced, while at the same time a higher break strength results. Aramid fibres, too, are very suitable. Further variants can be found in other sections of this document, where tension members according to invention for suspension elements that can also be applied in the present embodiment example are described in general. Combinations of ribs and teeth in a suspension element according to invention can also be favourably conceived.

As compared to suspension elements working with frictional grip, the suspension belt 20 embodied as toothed belt has the advantage that the extent of the force transfer between a traction sheave and the suspension element depends significantly less on the extent of the tractive forces in the strands of the suspension element running in and off. If a suspension belt embodied as toothed belt is used as a transmission element for an elevator car with counterweight, this advantage means that also a very light elevator car can interact with a much heavier counterweight without the transmission element sliding on the traction sheave.

Ideally, the tension members 42 should be embedded in suspension belt 20 in such a manner that neighbouring fibres or strands do not contact with each other. Belts with a width of about 30 mm and a thickness (without toothing) of 3 mm, which have a tension member filling degree—i.e. a ratio of total cross-section of all tension members and belt cross-section—of at least 20% have proved to be ideal for elevator construction.

In FIGS. 2aS-2gS, examples of steel-rope-type tension members and their possible embodiments and possible components are represented. The terms used in the context of the tension members largely conform with the nomenclature usual for wire ropes and used in standard EN 12385-2:2002 (D).

According to invention, the steel-rope-type tension members 42 in an elevator system according to invention can be embodied as analogue to the spiral ropes, round-strand ropes, flattened-strand ropes known from normal, non-sheathed wire ropes. The ropes can be singly, doubly or triply stranded. An embodiment as plaited ropes may also be possible (then mostly together with spiral ropes and/or round-strand ropes), where the singly stranded and plaited variants (see example in FIG. 2cS b) are as conceivable as are doubly stranded and sewed, clamped (see example FIG. 2cS c) or woven forms.

FIG. 2aS shows standardized round-strand ropes according to DIN 3055, DIN 3056, DIN 3057, DIN 3058, DIN 3059, DIN 3060, DIN 3061, DIN 3062, DIN 3063, DIN 3064, DIN 3065, DIN 3066, DIN 3067, DIN 3068, DIN 3069, DIN 3071, source: K. Feyrer; Drahtseile: Bemessung, Betrieb, Sicherheit; 2nd edition, Springer, Berlin, 2000, p. 38. The mentioned documents are referred to in full as regards the designing, conceiving, and dimensioning of tension members for suspension elements according to invention for elevator systems or elevatoring gear. In particular, not only belt-type suspension elements with a transverse toothing are equipped with them but also, and especially, the sheathed suspension elements according to invention with at least one longitudinal groove and non-round cross-section.

Instead of cores of plastic or synthetic fibres, as depicted in FIG. 2aS, the tension members 42 of a flat-belt-type suspension element 20 according to invention can also comprise steel cores. Some examples of this are depicted in FIG. 2bS. FIG. 2bS a) shows a wire strand core, shortly WSC. FIG. 2bS b) shows an independent wire rope core, shortly IWRC. Another wire rope core, but a parallel-laid one, is shown in FIG. 2bS c), shortly SESP ((PWRC ?)). Still another wire rope core, sheathed with plastic, is shown in FIG. 2bS d), short: an SESU. ((SWRC ?))

In another embodiment, the tension members can be embodied as cable-laid ropes, as one is depicted exemplarily in FIG. 2cS a).

In general, apart from round strands as they are depicted in the round-strand ropes of FIGS. 2aS-2cS, also triangular strands (FIG. 2dS a), compacted strands (FIG. 2dS b), or flattened strands (FIG. 2dS c) can be processed in the rope-type tension members 42.

With the use of triangular strands and flattened strands, rope-type tension members 42 with lower torques can be produced. The use of compacted strands is also of advantage because they enable weight reduction with equal tensile load. This variant can be successfully applied with materials that keep their compacted form after compacting.

FIGS. 2eS a) and 2eS b) each depict a flattened-strand rope, with a flattened strand and two triangular strands in a joint sheathing serving as core in the flattened-strand rope of FIG. 2eS a). The flattened-strand rope of FIG. 2eS b), on the other hand, has a plastic core. As compared to the flattened-strand rope of FIG. 2eS b), the flattened-strand rope according to invention of FIG. 2eS a), due to its core combined of triangular strands and a flattened strand, is more rotation-resistant, which is very favourable in suspension elements with few tension members. In FIG. 2eS c), a triangular-strand rope with a plastic core, according to invention, for an elevator system is depicted. Triangular-strand ropes are also very rotation-resistant and hence optimally suited for the use as tension members in a suspension element. Apart from the triangular-strand rope with plastic core shown here, it is, according to invention, also possible in an elevator system to use triangular-strand ropes with steel core, e.g. comprising equally of at least two further triangular strands twisted with each other, or, as shown in FIG. 2eS a), of two triangular strands and one flattened strand. All described triangular-strand and flattened-strand ropes can also comprise further wire layers.

In another embodiment, tension members of a suspension element according to invention of an elevator system according to invention can also be embodied in the form of spiral ropes. The following forms are eligible here: open spiral rope, as depicted in FIG. 2fS a), half-locked coil rope, as depicted exemplarily in FIG. 2fS b), full-locked coil rope as depicted exemplarily in FIG. 2fS c). As can be seen from FIGS. 2eS and 2fS, for certain embodiments special wire forms are needed. Examples of such wire forms are depicted in FIG. 2gS.

Although the above-given descriptions refer to steel tension members or wire ropes, it has turned out that the described options for embodiments of wire ropes can basically also be applied to the embodiments of fibre ropes. That is, tension members 42 in a suspension element of an elevator system according to invention can be structured as described in FIGS. 2aS-2gS, with the respective number of strand layers, the respective numbers, diameters, and geometries of the strands, the respective twisting of the strands and wires or fibre bundles. The fibre bundles themselves can here be conceived as twisted fibre bundles or bundles with parallel fibres. If, for special embodiments of tension members, certain external geometries of the fibre bundles are needed (see FIG. 2gS)—as they can be produced with wires without any problem due to the plasticity of metal—the fibre bundles can be wrapped in respectively shaped plastic sheathings which give the fibre bundles the desired geometry. Of course, the calculation variables then will be different, due to the different properties and in particular due to the lower density of the tension members. Basically, the tension members can be made of natural fibres, and/or synthetic fibres, and/or steel wires, but polyamide fibres and in particular aramid fibres are preferred because of their specific weight, their reverse bending strength, and their high tensile strength. Fibre materials and geometries mentioned elsewhere in this document can also be applied.

Optionally, also signal-transporting lines can be worked in into the tension members, which serve to determine the position of the elevator car and/or to monitor the suspension belt and its readiness for disposal. These can, e.g., be electric conductors or glass fibre conductors. An example for a suspension belt with such an electrically conducting element is, for instance, represented in more detail in EP1674419A1, paragraphs 14-19, and FIGS. 3A-10, including their descriptions, the contents of which is herewith referred to in full.

In another embodiment, the above described embodiments of ropes, strands, and wires, or fibre bundles and fibres can also be used as tension members on their own, i.e., they do not necessarily have to be embedded into a belt for being used as a suspension element in an elevator system according to invention. They may hence operate as tension members of an elevator system according to invention even without further tension members and/or without sheathing.

The above-described embodiments of ropes, strands, and wires, or fibre bundles and fibres serve as an example of the realization of suspension elements and elevator systems according to invention.

The expert knows that different elements of the individual embodiments represented here can be reasonably combined with other elements and features.

The starting point for the above presented explanations were flat belts 20 manufactured in one layer, as they are depicted in FIGS. 1aS and 2bS. Apart from these flat-rope-type suspension belts embodied in one layer, flat-belt-type suspension elements 20 can also be embodied as two-layer or multi-layer suspension belts.

FIG. 3 schematically shows the basic structure of a two-layer belt-type suspension element 20 for an elevator system. As can be seen, the suspension element 20 comprises a belt body 44, also called moulded body 44, with a first belt layer 46 made of a first plasticizable material, and a second belt layer 48 made of a second plasticizable material. The belt body 44 has a first exterior surface 50 at the side of the first belt layer 46. Between the first and the second belt layer 46, 48, there is a connection plane 52. Furthermore, the belt body 44 has a second exterior surface 54 of the second belt layer 48, at its side opposing the first exterior surface 50. In the area of the connection plane 52, several rope-type tension members 42 are embedded in the two-layer belt body 44.

In the context of the present invention, in particular ropes, strands, cords, or braidings of metal wires, steel, synthetic fibres, mineral fibres, glass fibres, carbon fibres, and/or ceramic fibres can be used as rope-type tension members 42 (as was mentioned before). The rope-type tension members 42 can be formed of one or more single elements or of singly or multiply stranded elements.

In one embodiment of the invention, each tension member 42 comprises a two-layer core strand with a core wire (e.g. of 0.19 mm diameter) and two wire layers (e.g. of 0.17 mm diameter) laid around it, as well as one-layer outer strands with a core wire (e.g. 0.17 mm diameter) arranged around the core strand, and a wire layer (e.g. 0. of 155 mm diameter) laid around it. Such a tension member structure, which, for instance, may comprise a core strand with 1+6+12 steel wires and eight outer strands with 1+6 steel wires, has proved in tests as advantageous regarding strength, manufacturability, and bendability. Favourably, here, the two wire layers of the core strand have the same angle of lay, while the one wire layer of the outer strands is laid in the sense opposing the direction of lay of the core strand, and the outer strands are laid in the sense opposing the direction of lay of their own wire layer around the core strand. But, of course, the present invention is not restricted to tension members 42 with this special tension member structure.

The use of rope-type tension members 42 (partly also called cords) with small diameters (or thickness) transverse to the longitudinal extension of the suspension element 20 allows the use of traction sheaves 26 and idler pulleys 30, 34a, 34b with small diameters. The diameter of the tension members 42 preferably ranges from 1.5 mm to 4 mm.

In the embodiment of suspension belt 20 shown in FIG. 3, the first exterior surface 50 (traction side) of the first belt layer 46 of belt body 44 engages during operation with the traction surface of traction sheave 26, while the second exterior surface 54 (guide side) of the second belt layer 48 for instance engages with the riding surfaces of the counterweight idler pulley 30 and the two car idler pulleys 34a, 34b. But of course, the suspension element 20 of the invention can also be used in the reverse mode in an elevator system with traction drive, as is depicted in FIGS. 2A and 2B. That is, the first exterior surface 50 of the first belt layer 46 of belt body 44 may as well engage with the traction surface of traction sheave 26, while the second exterior surface 54 of the second belt layer 48 engages with the riding surfaces of the counterweight idler pulley 30 and the two car idler pulleys 34a, 34b.

The first material for the first belt layer 46 and the second material for the second belt layer 48 can be the same material, the same material with different properties, materials of the same material class, or else different materials, in particular different synthetic materials. For instance elastomers like the following are eligible as materials for the belt layers 46, 48: polyurethane (PU), polyamide (PA), polyethylene terephthalat (PET), polypropylene (PP), polybutylene terephthalat (PBT), polyethylene (PE), polychloroprene (PCP), polyethersulphone (PES), polyphenylsulfide (PPS), polytetrafluoroethylene (PTFE), polyvinyl chloride (PVC), ethylene propylene diene monomer rubber (EPDM). The list of the mentioned materials is non-conclusive, and the selection of a material for the belt layers 46, 48 as well as for the formation of the moulded body 44 of suspension element 20 is not restricted to the listed materials. In addition, special adhesion mediators can be added to the materials for the first and the second belt layer 46, 48; so as to increase the strength of the connection between the belt layers 46, 48 and between the belt layers 46, 48 and the tension members 42. Equally, the incorporation of further tissues, and/or tissue fibres, and/or carbon, glass, or polyamide fibres, in particular aramid fibres, and/or finely dispersed particles of metals and/or metal oxides, or other filling materials is possible. Further materials, combinations of materials, and admixtures that are advantageous and usable or combinable according to invention are described elsewhere in this document, as are further geometries and application fields of the suspension elements according to invention or of their moulded bodies.

To optimize the required properties, like friction coefficient, transverse stability, quiet running, noise reduction, and torsion stiffness, also coatings on the first and/or the second exterior surface 50, 54 can be conceived (not depicted here, complementarily described elsewhere). They may, for instance, be tissues of metal and/or synthetic and/or natural fibres, and/or thin layers of plastic, and/or composite materials with metal and/or synthetic and/or natural fibres, and or with finely dispersed particles of metals and/or metal oxides. Such coatings can also be conceived as sacrificial layers regarding wear.

In a possible manufacturing procedure, the first and the second belt layer are formed in an extrusion procedure each. Basically, a vulcanizable thermoplastic elastomeric material can be employed here as well, e.g. EPDM, in which case, of course, the vulcanization can only take place after the extrusion procedure, and preferably after the production of an at least approximate definite form.

According to invention, it is possible to use, for the first belt layer 46 and the second belt layer 48, respectively, the same material with the same properties, the same material with different properties, or different materials. The properties of the material(s) of relevance for the moulded body 44 include in particular hardness, flowability, compriseence, properties of connection with the rope-type tension members 42 and/or the second material of the other belt layer, reverse bending strength, tensile strength, compressive strength, wear properties, colour, and the like.

In special embodiments of the invention, at least one of the belt layers 46, 48 can be made of a transparent material, so as to facilitate a check of the suspension element 20 for damages. Besides, the first and/or second belt layer can be embodied in anti-static quality. In another embodiment, the second belt layer can, for instance, be embodied as luminescent, so as to make the rotation of the traction sheave or the drum recognizable, or to achieve certain optic effects.

In another embodiment, the belt layers 46, 48 can be embodied as of different thickness, as is depicted in FIGS. 4S and 5S. With belt layers of different thickness, the tension members 42 can, according to requirement profile, be located in the centre t/2 of the moulded body 44, as is shown in FIG. 4S, or in the connection plane 52 between the belt layers 46, 48 (cf. FIG. 5S), or somewhere in between (not depicted).

In the example of FIG. 4S, belt layer 48 is thinner than belt layer 46, with the latter moreover comprising V-ribs 80. The tension members 42 are arranged approximately in the centre of moulded body 44 and are completely embedded in the thicker belt layer 46. In the example of FIG. 5S, on the other hand, the tension members 42 are arranged in the connection plane 52 and embedded about equally deeply in both belt layers 46, 48. Due to the different thickness of the two belt layers 46, 48, however, they are not located in the centre t/2 of the suspension element 20. This non-central position of the tension members 42 influences the contact pressure and its distribution onto the traction sheave side with the first exterior surface 50, and onto the opposing side.

In a modified embodiment of suspension element 20, as it is, for instance, depicted in FIG. 6S, the belt layers 46, 48 are of different thickness. The tension members 42 are located approximately in the centre of the moulded body 44. According to the thickness ratio of belt layers 46, 48, the tension members 42, in this example, are embedded deeper in the first belt layer 46 than in the second belt layer. Of course, it is also possible that the tension members 42 are instead embedded deeper in the second belt layer 48, or are completely enclosed by the material of either of the two belt layers 46, 48 in the belt body 44, cf. also FIG. 4S. The distribution of the contact pressure and its possible difference on the traction side and on the opposite side of the suspension element 20, often used as deflection side, does, however, not only depend on the arrangement of the tension members in the moulded body 44. The distribution of the contact pressure may also depend on the material properties of the tension members as well as of the two belt layers 46, 48, and on the force transfer properties of the connection between tension member(s) 42 and belt layers 46, 48. Potentially existing coatings on the exterior surfaces 50, 54 or on the tension members 42 may also play a role. According to invention, the thickness of the belt layers 46, 48, their material, and the position of the tension members 42 within the moulded body 44 are adjusted precisely to one another, so as to optimize all important properties of the suspension element.

In another embodiment, the material for at least one belt layer 46, 48, in which the tension member(s) 42 is/are at least partly embedded, is chosen such that the rope-type tension member(s) 42 is/are lubricated. The lubrication creates wear-resistant or at least wear-reduced conditions in possible movements of individual elements of which a tension member 42 is composed, like strands, wires, fibre bundles, etc. At the same time, a protection effect against environmental influences, like corrosion, infestation with living organisms, and similar problems is effected. This contributes considerably to a prolonged service life of the suspension element 20.

An alternative to the lubrication via the material in which a tension member is embedded is the use of self-lubricating elements for the tension member, or a respective structure in combination with a material that makes a lubrication at least largely superfluous. Besides, the tension members 42 are kept in their desired positions and protected against corrosion by the material of the belt layers 46, 48.

To increase the contact pressure of the suspension element 20 onto a traction sheave 26, it is advantageous with respect to an increase in the tractive capacity to embody the contact surfaces of belt body 44 which interact with traction sheave 26, i.e. the first or the second exterior surface 50, 54, with so-called (V-)ribs 80, as can be seen in FIGS. 1aS, 1bS, and 4S-6S, at the side of the first belt layer 46 interacting with traction sheave 26, and as it has already been described elsewhere in this document. The said ribs 80 extend as longish elevations in the direction of the longitudinal extension of suspension element 20, and preferably engage with correspondingly shaped grooves on the riding surface of traction sheave 26. At the same time, the V-ribs 80 ensure by their engagement into the grooves of traction sheave 26 a lateral guiding of suspension belt 20 on traction sheave 26.

If it is planned to bring, during operation, the exterior surface 54 of suspension belt 20, which opposes the exterior surface 50 side-of-traction, as a deflection side (guide side) into contact with a deflecting pulley, it may be of advantage to embody the exterior surface 54 with V-ribs 80, too, as is depicted in FIGS. 5S-7S. The resulting advantages are, among other things, equivalent to those at the traction side.

The ribs 80 are either manufactured already during the extrusion of the respective belt layer 46, 48, or after the production of a flat belt layer 46, 48 or a flat belt body 44 by forming, or by material-abrading machining, like milling, cutting, material abrasion by means of laser, and the like.

Furthermore, the two exterior surfaces 50, 54 of the suspension belt 20 of the invention may have a special surface property, over their whole length or only in respective partial sections in which they contact with the traction sheave 26 and the various hitch and deflecting pulleys of the elevator system, which, in particular, influences the sliding properties of suspension belt 20. For instance, the exterior surface 50, 54 of the suspension belt combing with the traction surface of traction sheave 26 can be equipped with a traction-optimizing (that is, according to situation, traction-reducing or traction-increasing) coating, surface structure, or the like. Alternatively, the suspension belt 20 can also be sheathed at one or both exterior surfaces 50, 54 with a tissue or the like, so as to influence the properties of the suspension belt surface.

In the embodiment of FIG. 5S, the total height of the suspension belt 20 is dimensioned as exceeding its total width. Thereby, the bending stiffness of suspension belt 20 around its transverse axis is increased, thus counteracting a getting stuck in the grooves of traction sheave 26 and idler pulleys 30, 34a, 34b. In the shown example, the ratio width/height amounts to about 0.90. The height dimension is here oriented about perpendicular to an imaginary cylindrical traction sheave surface.

The flank angle α of the traction ribs 80 of the first belt layer 46 is defined as interior angle between the two flanks of a traction rib 80, and in the embodiment example amounts to about 90° (generally ranging from 60° to 120°). The respectively defined flank angle β of guide rib 82 of the second belt layer 48 in this example amounts to about 80° (generally ranging from 60° to 100°).

As can be seen in FIG. 5S, the flank height of the guide rib 82 exceeds the flank height of the two traction ribs 80. In that way, the guide rib 82 can dive deeper into a respective groove of the deflecting pulleys 30, 34a, 34b than the traction ribs 80 dive into the assigned grooves of traction sheave 26. Equally, it can be seen in FIG. 5S that the flank width of guide rib 82 also exceeds that of the two traction ribs 80. Due to the greater flank width of guide rib 82, the suspension belt 20 is guided at its second exterior side 54 in transverse direction over a wider area.

As is indicated in FIG. 5S, the V-ribs 80, 82 have a flattened top each, with a certain width that equals at least the minimal distance of the respective counter-flanks of the sheaves/pulleys 26, 30, 34a, 34b. In that way, the edge embodied in these counter-flanks does not contact with the flanks of the V-ribs 80, 82, so that the latter are protected against a respective notching effect.

The first exterior surface 50 can have a coating with a PA foil or the like, at least in those areas of the V-ribs 80 that contact with frictional grip with the flanks of traction sheave 26. Furthermore, there is the option to equip a V-rib 80 with a friction-coefficient-reducing and/or noise-reducing coating.

The embodiment example of a suspension belt 20 illustrated in FIG. 6S differs from the above-described examples in that only one V-rib 80 is embodied at the side of the first exterior belt layer 46 instead of two V-ribs 80. This one V-rib 80, too, has a flank angle α of about 90° (generally ranging from 60° to 120°) and a flattened top. On the whole, this suspension belt 20 has a V-profile both at its first and at its second exterior surface 50, 54.

FIG. 7S shows an embodiment example of suspension belt 20 the V-rib 80 of the first belt layer of which has an overall rounded (dashed line 51) or at least partly rounded shape (uninterrupted line 51).

Of course, the embodiments of FIGS. 5S-7S are to be understood as examples only and are not meant to restrict the invention to these special shapes of suspension belt 20. Experts will have no problem to recognize numerous further variants of the suspension belt depicted here. In particular, modifications and fields of use represented in the present document can be combined with each other at will, irrespective of the width-height ratio of the suspension element cross-section.

While in the embodiment examples of FIGS. 5S-7S the respective total height of suspension belt 20 exceeds its total width, the invention is, of course, not restricted to such a ratio, as can be seen in the suspension elements 20 of FIGS. 1aS and 1bS as well as 3, the width of which exceeds their height. Furthermore, on principle, rectangular, square, oval, and circular cross-section shapes are conceivable for the belt-type suspension element 20. The ratio of total width to total height of suspension belt 20 preferably ranges between 0.8 and 1.2, more preferably between 0.9 and 1.1. In modified embodiment examples of the invention, the width-height ratio of the suspension element cross-section ranges from 0.8 to 10.

In the embodiment example given above, the production of a suspension belt 20 with a certain width and a certain number of embedded tension members 42 and V-ribs 80, 82 has been described. In particular in the case of narrow suspension belts 20 (i.e. height/width>1), as they are exemplarily shown in FIGS. 5S-7S, it is also possible in the context of the invention to simultaneously manufacture several such suspension belts 20 placed side by side.

To this end, at first a very broad belt with a very large number of tension members 42 is produced as intermediate product. This belt is severed into several individual suspension belts 20 of smaller width. This may be done by different mechanical procedures, like cutting, sawing, etc. To simplify the severing process, in the joint manufacturing respective predetermined breaking lines between the individual suspension belts 20 can be conceived (cf. FIG. 6M). Furthermore, for severing the individual narrow suspension belts 20, a traction sheave 26 can be conceived in which individual grooves have a greater distance from each other, so that the intermediate product of the interlinked suspension belts 20 is spread apart at these predetermined breaking lines and eventually several narrow suspension belts 20 are used in the elevator system (cf. FIG. 7M).

For simpler handling, the broad intermediate-product belt can be equipped with a support band or mounting band, e.g. of plastic or the like, which may remain in place even after the severing process and is possibly removed only in the process of mounting suspension belt 20 in an elevator system.

4.3.3 Still Further Variants of Suspension Elements According to Invention

In FIGS. 8S-10S, another embodiment of a belt-type suspension element 20 according to invention is depicted the width of which exceeds its height. The two belt layers employed in this embodiment variant have different thickness, so that the centre of the moulded body 44 and the connection plane 52 of the two belt layers are far apart. The second belt layer 48 is embodied as a tissue. In particular, a nylon tissue is conceived, which is impregnated or coated, but may also be connected with the first belt layer 46 as an untreated tissue. The connection can be achieved by pressing the second belt layer into the first one, fusing it into the first layer, or by pressure-welding and/or agglutinating it with the first belt layer 46. The second belt layer 48 is embodied as a plane surface, both at its second exterior surface 54 and in the area of the connection plane 52. For the production process, the tension members are placed onto the prefabricated second belt layer 48, in pairs, parallel to each other, in the longitudinal direction of the belt, and the second belt layer 48 is applied, preferably by extruding, onto the first belt layer, on which the tension members 42 are placed in correct position and fixed there for instance by pasting or by means of a moulding wheel. The V-ribs 80 of the first belt layer 46 are preferably generated during extrusion already, or else, for reasons of increased precision of the result, are produced in a subsequent procedural step at the first exterior side 50 of the first belt layer 46 by machining techniques, preferably by milling, grinding, or cutting. Further features and variants regarding possible manufacturing procedures are described elsewhere in this document. These manufacturing procedures can be favourably applied and combined with each other, independent of the height-width ratio of the suspension element cross-section.

The V-ribs 80 are separated from each other by recesses 84, with the flanks of the recesses 84 and the flanks of the V-ribs 80 showing an angle of about 90° between themselves and between each other, as can be seen in FIGS. 9S and 10S. The recesses 84 between the V-ribs 80 have basis 86 which is preferably rounded, so as to not generate a wedge effect.

The tension members 42 are assigned in pairs to a respective V-rib 80, and in their direction of lay and the resulting torques offset each other as far as possible, so as to represent as pairs an element as torque-free as possible. The direction of lay or the resulting torque are denoted by L or R, according to their being directed to the left or to the right.

In one embodiment of suspension belt 20, the tension members 42 are arranged in an alternating L-R-L-R series (cf. FIG. 9S, right side), and/or are arranged in subsequent R-L-L-R series (cf. FIG. 9S, left side, and FIG. 10S). Further variants of tension members are described elsewhere in this document, they can be applied here as well—independent of the material of the moulded body or the tension members, and independent of the width-height ratio of the suspension element cross-section.

In another embodiment according to FIG. 10S, a belt as it is shown in FIG. 9S represents an intermediate product in the manufacturing of a belt-type suspension element 20 for an elevator system according to invention. The belt-type suspension element 20 produced of this intermediate product has a lower width than the intermediate product and is yielded by severing the intermediate product into individual suspension elements 20, either at the end of the production process or during the mounting of the elevator system according to invention. An individual suspension belt 20 preferably has 1-6 V-ribs 80, more preferably 1-2 V-ribs 80, and the width of the suspension element 20 results accordingly.

The intermediate product is preferably severed in the area of the respective basis 86 of a groove 84 arranged between the V-ribs 80. Potentially, a V-rib 80 might be severed centrally, yielding V-ribbed belts with half ribs at their edges, which could, e.g., favourably be used for guiding purposes (not depicted). The partial belt 20 to be severed or separated from the intermediate product is preferably to be chosen in such a manner that the torque in the resulting belt part equals zero (at least theoretically or approximately).

In another embodiment, the wedge surfaces and the surface of the traction sheave of an elevator system (or elevatoring gear) according to invention are especially matched with a suspension element according to invention. In this context, the suspension elements described in detail elsewhere in this document are used with advantage.

A suspension element roller according to invention to suspend a car and/or a counterweight of the elevator system according to invention, used as traction sheave, can transfer tractive forces onto a suspension element insofar as the suspension element is radially pressed against the periphery of the traction sheave, with the achievable tractive force equaling the product of the sum of the normal forces occurring between traction sheave and suspension element and the existing friction coefficient.

Portions of radial forces that are transferred in the area of the inclined flanks of the ribs or grooves are augmented, due to the wedge effect between the flanks, to higher normal forces acting on the flanks—which, in turn, can generate higher tractive forces—than portions of radial forces that are essentially transferred in radial direction. Since with completely complementarily embodied corresponding ribs and grooves of the suspension element and the suspension element roller it is not clearly determined which portion of the radial forces acting between suspension element and suspension element roller is transferred in the area of the inclined flanks of the ribs and grooves, and which portion is transferred in approximately radial direction in the area of rib crests and groove bottoms, the resulting tractive force is, in the case of a suspension element roller serving as traction sheave, on the one hand, not sufficiently determinable in advance and, on the other hand, not constant over a longer operation time, due to plastic deformations and abrasion at the suspension element.

If the contours of the V-ribs and the contours of the grooves of the traction sheave are embodied as exactly counter-equal, dirt and abrasion may be compacted and hardened by the taut suspension element. In that way, both the tractive capacity and the lateral guide between traction sheave and suspension element may be impaired, and wear between traction sheave and suspension element may be increased.

In FIG. 5Ξ, a section through a suspension element 12.3Θ according to invention is depicted, and in FIG. 6Ξ, the corresponding periphery of a suspension element roller 4.3θ is depicted. FIG. 7Ξ shows a section through suspension element 12.3θ according to FIG. 5Ξ and traction sheave 4.3θ according to FIG. 6Ξ, in a state in which the suspension element, due to its tensile load, is pressed against the suspension element roller. FIG. 8Ξ shows a magnified section of FIG. 7Ξ, so as to make details recognizable.

The suspension element 12.3θ depicted in FIGS. 5Ξ-8Ξ comprises a belt body 15.3θ and several tension members 18.3θ embedded in it. The belt body 15.3θ is made of an elastic material. To this end, for instance natural rubber or a great variety of synthetic elastomers can be used. The flat side 17θ of the belt body 15.3θ can be equipped with an additional cover layer 25.3θ, preferably a tissue layer. Details regarding usable materials and possible modifications are represented elsewhere in this document and can be applied advantageously also in the context of this embodiment example—analogously without a difference between suspension elements with bigger or smaller height-width ratio of the suspension element cross-section.

The suspension element 12.3θ has several ribs and/or grooves extending in its longitudinal direction, which, on the one hand, serve the lateral guiding of the suspension element on a suspension element roller 4.3θ, and on the other hand, improve the tractive relation between suspension element roller and suspension element, if the suspension element roller is used as traction sheave.

In FIGS. 5Ξ-8Ξ, it can be seen that the grooves 23.3θ and ribs 22.3θ of the suspension element roller are not embodied as completely complementary to the corresponding ribs 20.3θ and grooves 21.3θ of the suspension element. In the areas where the rib crests 30θ, 31θ oppose the rib bottoms 32θ, 33θ, cavities 34θ, 35θ exist, so that it is ensured that, with suspension element 12.3θ bearing on the suspension element roller 4.3θ, the ribs 20.3θ or grooves 21.3θ of the suspension element 12.3θ and the corresponding grooves 23.3θ or corresponding ribs 22.3θ of suspension element roller 4.3θ mainly contact with each other in the area of their inclined flanks 28θ, 29θ. By these measures, the radial forces acting between suspension element 12.3θ and suspension element roller 4.3θ are transferred basically via the inclined flanks 28θ, 29θ of the ribs and grooves, which have a constant and uniform flank angle β. Thus, it is ensured that the radial force portions occurring between suspension element and suspension element roller are augmented, due to the wedge effect caused by the inclined flanks, to increased normal forces between the flanks of the suspension element and the suspension element roller. With a suspension element roller 4.3θ acting as traction sheave, this results—as is described above—in a tractive capacity that is increased and constant over a long operation time.

The mentioned cavities 34θ, 35θ also serve the purpose to receive contaminations which in the course of elevator operation deposit on the traction surfaces of the suspension element 12.3θ and the suspension element roller 4.3θ. In that way it is achieved that with the use of the suspension element roller as traction sheave the tractive capacity is not impaired, and that in all suspension element rollers the lateral guide of the suspension element on the suspension element rollers provided by interaction of ribs and grooves of the suspension element and the suspension element roller is maintained. The cavities 34θ, 35θ can be cleaned on occasion of a periodical maintenance of the elevator system or elevatoring gear.

As shown in FIGS. 5Ξ-8Ξ, the cavities 34θ, 35θ required according to invention in the area of opposite rib crests 30θ, 31θ and rib bottoms 32Θ, 33Θ can be created in different ways. For reasons of a simplified representation, different embodiments of cavities at the same suspension element and the same suspension element roller are shown in FIGS. 6Ξ-8Ξ.

In an especially simple embodiment, the rib crests 30θ of the suspension element 12.3Θ, or the rib crests 31θ of the suspension element roller 4.3θ are flattened to create cavities.

According to another embodiment, in particular visible in FIG. 8Ξ, cavities 34Θ are created by embodying the rib crests 30θ of the ribs 20.3θ of the suspension element 12.3θ, or the rib crests 31θ of the ribs 22.3θ of the suspension element roller 4.3θ as rounded, with the rounding radius of this rounding being considerably larger than the rounding radius of a potentially existing rounding at the bottom of the corresponding groove. Equally, the rib crests of both the suspension element and the suspension element roller can be equipped with such roundings. Embodiments with heavily rounded rib crests have proved as particularly wear-resistant and excel by their quiet running.

In an embodiment of the invention especially suitable for solving the contamination problem, the groove bottoms 33θ of the V-shaped grooves 23.3θ of the suspension element roller 4.3θ are deepened by circumferential grooves 36θ, 37θ in the suspension element roller, as this can be seen in particular in FIG. 8Ξ. Favourably, these grooves 36θ, 37θ have rectangular or semi-round cross-sections.

In FIG. 8Ξ, Bθ denotes the widths of the inclined contact surfaces of suspension element 12.3θ and suspension element roller 4.3θ, projected onto the axis of the suspension element roller. Tests have shown that favourably the sum of the widths Bθ of all contacting flanks of ribs or grooves projected onto the axis of the suspension element roller 4.3θ is restricted to at most 70% of the total width of the suspension element 12.3θ. In that way, it is achieved, on the one hand, that all contact surfaces of the suspension element at any time have ample contact with the corresponding contact surfaces of the suspension element roller, whereby an optimally stable, low-vibration, and low-noise running of the suspension element 12.3θ is achieved. On the other hand, due to the limitation of the projected total width of the contact areas, a sufficient surface pressure in the area of the contact surfaces is ensured. With respect to a traction sheave, this means a lower negative influence on the traction behaviour by contaminations like oil, soot, dust grains, etc., since the contamination components, due to the high surface pressure, are either driven away from the contact area (preferably into the mentioned cavities), or—e.g. in the case of relatively coarse dust grains—are pressed into the elastic material of the suspension element 12.3θ by the traction sheave, so that the contact between suspension element and traction sheave 4.3θ is maintained as best as possible.

The limitation of the mentioned projected total width of the contact surfaces is done preferably by choosing the width of the cavities 34θ, 35θ according to invention between corresponding rib crests and groove bottoms.

The cavities 34θ, 35θ according to invention between corresponding rib crests and groove bottoms have another advantageous effect: In the case of a heavy suspension element deflection, the ribs 20.3θ of suspension element 12.3θ are exposed to high compressive stress in the area of the rib crests 30θ, which results in a bulging of the ribs in the said area. The above-mentioned cavities 34θ, 35θ allow the ribs of the suspension element to expand in the area of their rib crests into these cavities. This measure contributes to making the suspension element according to invention usable in combination with suspension element rollers with low external diameters. Concretely, suspension element rollers can be used as traction sheaves and deflecting pulleys the external diameter of which is normally lower than 80 mm, but can even be lower than 65 mm if required. This allows to integrate the traction sheave into the output shaft of a drive unit or to couple it in the form of a suspension element drive shaft with the output shaft of the drive unit.

In the embodiment of the invention shown in FIGS. 5Ξ-8Ξ, the suspension element 12.3θ has several parallel ribs and grooves, which are arranged as distributed over the whole width of the suspension element. A suspension element according to invention can, however, also be equipped with only one rib or groove, and this, of course, also holds for the corresponding suspension element roller. Favourably, in the suspension element such a rib or groove is arranged in the middle of the suspension element width, with the width of the rib or groove being bigger.

The suspension element represented in FIGS. 5Ξ-8Ξ has a preferred flank angle β of about 90°. Tests have shown that the flank angle β has an important influence on noise emission and on the emergence of vibrations in the suspension element, and that flank angles β ranging from 80° to 100° are to be preferred for a suspension element. With flank angles β of less than 60°, the suspension element tends to vibrate, and with flank angles β of more than 100°, the security against lateral shifting of the suspension element on the suspension element roller is no longer ensured. Nevertheless, the expert is free to enlarge the described angle area, thus accepting the mentioned disadvantages.

In another embodiment of a suspension element according to invention, the suspension element is again embodied as a so-called belt 12.3θ, and is equipped at its backside with a layer 54θ (as shown in FIG. 9Ξ), which preferably has good sliding properties. This layer 54θ can, for instance, be a tissue layer. With multi-roped elevator systems, this facilitates mounting.

Besides, this embodiment has a flat-spread tension layer 51θ as the core of the V-ribbed belt 12.3θ, instead of the tension members 18.3θ of metal or non-metallic strands mentioned in the context of FIGS. 5Ξ-8Ξ, with this tension layer 51θ basically extending over the whole belt length and the whole belt width. The tension layer 51θ can comprise an unreinforced material layer, e.g. a polyamide foil, and/or a foil reinforced with chemical fibres. Such a reinforced foil could, for instance, contain Zylon fibres, embedded in a suitable synthetic material matrix.

The tension layer 51θ gives the suspension element according to invention an increased tensile strength and creep strength, but is also flexible enough to bear a sufficiently high number of bending processes during deflection around a traction sheave and/or deflecting pulley. Next to the tension layer 51θ, at its side opposing cover layer 54θ, there is a V-rib layer 53θ. The V-rib layer 53θ can, e.g., be made of polyurethane, or of an NBR elastomer (nitrile butadiene rubber), and is connected—with its whole surface with or parts of it directly or via an interlayer—with tension layer 51θ. The V-ribbed belt equipped with a whole-surface tension layer can also have a guide rib, as has already been described in the context of FIG. 1eS f). Furthermore, the described variants may be combined with other embodiment examples described elsewhere in the present document.

Between the mentioned main layers, there may be interlayers 56θ, as they are represented in FIG. 10Ξ by the example of a flat belt 50θ without V-ribs. The interlayers 56θ procure the required adhesion between the mentioned layers and/or increase the flexibility of the suspension element. The flat belt 50θ is hence composed of several layers of different materials. In its core, it contains at least one flat-spread tension layer 51θ, which, e.g., comprises an unreinforced polyamide foil, or of a plastic foil reinforced by chemical fibres embedded in the synthetic material matrix. Besides, the flat belt 50θ has an external front-side friction layer 55θ (traction side), e.g. made of an NBR elastomer (nitrile butadiene rubber), as well as an external backside friction layer 54θ, which, according to elevator system, is embodied as friction or slide lining.

The interlayers 56θ procure the required adhesion between the mentioned layers and/or increase the flexibility of the flat belt. To optimize the afore-mentioned rope tension relation, friction layers with friction coefficients of 0.5-0.7 with respect to steel rollers are to be preferred, which, in addition, are very abrasion-resistant.

Another embodiment of a suspension element according to invention, in the form of a flat belt, is shown in FIG. 2Σ. Evidently, the exemplarily described features also refer to non-flat suspension elements.

The flat belt 23σ according to invention shown in FIG. 2Σ comprises a belt body 23.1σ with a first belt riding surface 23.5σ, a back reinforcement layer 23.3σ, as well as several tension strands/tension members 23.2σ embedded in the belt body. The belt body 23.1σ comprises an elastic and wear-resistant material, preferably of an elastic plastic, like, e.g., polyurethane (PU), or ethylene propylene diene rubber (EPDM). To somewhat reduce the laterally directed guiding forces that have to be received by the engaging guide ribs and guide grooves, an additive can be added to the elastic material of belt body 23.1σ that reduces the friction coefficient of the latter with respect to the belt roller, e.g. silicon, polyethylene, or cotton fibres. Round or flat-spread strands of fine steel wires or of high-strength plastic fibres, e.g. aramid fibres, can be used as tension members 23.2σ, or else the tension members or tension elements described elsewhere in this document. The back reinforcement layer 23.3σ can comprise a tissue of cotton or plastic fibres, or of a foil, e.g. a polyamide foil. It protects the belt body 23.1σ for instance against mechanical damages. In modified embodiment examples, the sheathings and tissues described elsewhere in this document are applied.

A belt roller 27σ, which in the elevator may have the function of a traction sheave or a deflecting pulley, is according to invention produced of steel, grey cast iron, or spheroidal-graphite cast iron, but can also comprise a plastic, like, e.g., polyamide. For reasons of an optimal use of the available well space and a torque required at the hoisting machine as low as possible, the belt rollers have diameters D of less than 100 mm. Details and variants regarding modified embodiments of traction sheaves according to invention are described elsewhere in this document and can be referred to in full for the embodiment examples described here.

To ensure that during elevator operation the flat belt 23σ is always guided on the roller riding surface 27.1σ of belt roller 27σ, the belt roller 27σ is equipped with a guide rib 27.2σ, which engages with a guide groove 23.4σ in the flat belt 23σ. In the arrangement shown in FIG. 2Σ, the guide rib 27.2σ of belt roller 27σ as well as the guide groove 23.4σ of flat belt 23σ have trapezoidal, basically complementarily embodied cross-sections. Sufficient clearance in axial and radial direction exists between guide rib 27.2σ and guide groove 23.4σ to ensure that no V-belt effect will occur, so that the conceived tractive force is never exceeded if the belt roller is used as a traction sheave. In that way, the risk is avoided that the tractive force between traction sheave and flat belt remains so high that the elevator car or the counterweight are moved further upwards if, in case of a control or drive failure the elevator car or the counterweight bear on their lower track limits. With belt rollers acting as deflecting pulleys, the said clearance ensures that no V-belt effect occurs which would incite vibrations in the flat belt.

By V-belt effect, clamping effects between a V-groove of a V-belt roller and a V-belt running in that V-groove are to be understood. These clamping effects, on the one hand, lead to an increase in the normal forces occurring between V-groove and V-belt and hence in the achievable tractive force. On the other hand, they may incite vibrations in the running-off V-belt strand during the guiding of the V-belt off the V-groove of the V-belt roller.

FIG. 3Σ again shows a flat belt 33σ bearing with its first belt riding surface 33.5σ on a belt roller 37σ. In contrast to the arrangement according to FIG. 2Σ, the flat belt 33σ here has two guide grooves 33.4σ, with one of two guide ribs 37.2σ of belt roller 37σ engaging with one guide groove, respectively. Hence the guiding force required to avoid a lateral drifting off of flat belt 33σ is distributed onto two flanks of the two guide grooves 33.4σ, which significantly increases functional safety and wear resistance of the belt guidance.

FIG. 4Σ shows a flat belt 43σ, which, with its second belt riding surface 43.6σ (belt back) contacts with a belt roller 47σ in the area of the roller riding surface 47.1σ. The flat belt 43σ is—apart from a guide groove 43.4σ in its first belt riding layer 43.56σ—equipped with a backside guide rib 43.8σ protruding from its (backside) second belt riding surface 43.6σ that interacts with a roller guide groove 47.4σ of belt roller 47σ in the roller riding surface 47.1σ. A backside reinforcement layer 43.3σ can act here as wear protection for the backside guide rib 43.8σ. Such a backside reinforcement layer is not absolutely required. The embodiment represented in FIG. 4Σ allows to realize suspension element arrangements in elevator systems with guided flat belts, in which the flat belts run around several belt rollers arranged such that the flat belts are deflected in opposing directions. Elevator systems according to invention with modified configurations and further details are described elsewhere in this document, so that these description passages and embodiment examples can be referred to for further embodiments.

In FIGS. 2Σ, 3Σ, and 4Σ, it can be seen that the tension members 23.2σ, 33.2σ, 43.2σ embedded in the belt bodies 23.1σ, 33.1σ, 43.1σ have larger distances from each other in the areas of the guide grooves 23.4σ, 33.4σ, 43.4σ than outside these areas. This allows to equip the flat belts with a maximum number of tension members 23.2σ, 33.2σ, 43.2σ arranged side by side, so as to generate flat belts with a maximum admissible tension.

FIGS. 5Σ-8Σ show, in magnified views, details of differently shaped and embodied guide grooves and guide ribs of flat belts and of belt rollers interacting with them.

FIG. 5Σ shows, in magnification, a guide rib 57.2σ of a belt roller 57σ and the corresponding guide groove 53.4σ of a flat belt 53σ, with the embodiment and the arrangement of these elements basically equalling the corresponding elements according to FIGS. 2Σ and 3Σ. If the first belt riding surface 53.5σ of the flat belt bears on the roller riding surface 57.1σ, preferably an axial clearance Sₐ as well as a radial clearance Sᵣ exist between guide rib 57.2σ and guide groove 53.4σ, so as to avoid (as has been explained above) a traction increase due to a V-belt effect. To ensure a flawless guide effect, it is of advantage if the axial clearance Sₐ measured in the direction of the belt roller axis amounts to 0.1 mm-3 mm, or to 0.5%-10% of the width of the flat belt.

To optimize or avoid a tangential running-in of flat belt 53σ onto belt roller 57σ and guide rib 57.2σ (in particular in the case of the direction of the longitudinal belt axis deviating from the direction of the tangent on the belt roller), the flanks 57.3σ of guide rib 57.2σ as well as the flank 53.7σ of guide groove 53.4σ are preferably embodied as inclined with respect to each other. Accordingly, the angle α between the flanks of the guide groove or the guide rib ranges from 0° to 120°, preferably from 10° to 60° in the case of a guide groove or a guide rib with trapezoidal or triangular cross-section (cf. FIG. 7Σ).

FIG. 6Σ also shows a guide rib 67.2σ of a belt roller 67σ, and a corresponding guide groove 63.4σ of the flat belt 63σ, with trapezoidal cross-sections, and with the surface of the guide groove 63.4σ of the flat belt being equipped with a friction-reducing and/or wear-reducing protection layer 63.9σ. The protection layer 63.9σ can, for instance, have the form of a tissue reinforcement, or a plastic foil. Other variants of a protection layer or sheathing are described elsewhere in this document and are applicable with advantage in the present embodiment example.

FIG. 7Σ shows an advantageous embodiment of a belt guide acting between a flat belt 73σ and a belt roller 77σ. It is characterized by the belt roller 77σ having a triangular guide rib 77.7σ, which engages with a triangular guide groove 73.4σ of the flat belt 73σ. This belt guide takes little space in the direction of the width of the flat belt, and therefore allows a maximum number of tension members 73.2σ to be embedded side by side in the belt body.

FIG. 8Σ shows another possible embodiment of a belt guide acting between a belt roller 87σ and a flat belt 83σ, in which there is at least one guide groove 83.4σ in flat belt 83σ and one guide rib 87.2σ at belt roller 87σ, respectively, which have circle-segment-type cross-sections.

FIG. 9Σ shows a belt roller 97σ, on which two flat belts 93σ bear, arranged in parallel, with guide grooves 93.4.1σ and 93.4.2σ. The belt roller 97σ comprises two roller riding surfaces 97.1.1σ, 97.1.2σ arranged aside one another, each of which is equipped with a guide rib 97.2.1σ, 97.2.2σ.

On such a belt roller, also more than two flat belts can be arranged, where each of the flat belts can have more than one guide groove, and each roller riding surface more than one guide rib. In modified embodiment examples, the other suspension elements described in this document are conceived for use, where in particular the height-width ratio of the cross-section of the suspension element or its material are not of crucial importance.

Of course, the above-given information on the number of guide ribs and corresponding guide grooves, on the clearances Sₐ and Sᵣ between guide rib and guide groove, as well as on the use of a backside guide rib is applicable to all shown embodiments of guide ribs and guide grooves. This also holds for the use of a protection layer to reduce friction and wear at the surface of guide grooves of the flat belt, as well as for the use of a backside reinforcement layer in the area of the second belt riding surface.

Another embodiment of a suspension element according to invention, in the form of a suspension belt 12λ, is shown in FIG. 1A. The suspension element comprises a (V-)rib arrangement 15λ with individual ribs 15.1λ of polyurethane, and a back layer 13λ of polyamide connected to it.

Sectionally, ribs or V-ribs 15.1λ of the (V-)rib arrangement 15λ have a preferably at least approximately wedge-shaped or trapezoidal cross-section. Furthermore, they preferably have a flank angle β of 120°. The (V-)rib arrangement is, preferably at a contact side or traction side of elevator belt 12λ. (in FIG. 1A at the top), conceived for engagement with a traction sheave or a deflecting pulley. An advantageous arrangement for the transfer of tractive or frictional forces between a traction sheave and the suspension element results, as is described in detail elsewhere in this document, which description can be referred to analogously in full.

Between suspension element and traction sheave or drive shaft, a friction configuration with a material-dependent friction coefficient results. If another friction coefficient than the one given by the polyurethane of the V-ribs 15.1λ is desired, the elevator belt can be coated on its contact side. Respective possible details and variants are described elsewhere in this document. Of course, also coatings on the traction sheave can be conceived, as is equally described in detail elsewhere. For instance, the flanks of the V-ribs 15.1λ contacting with an at least partly complementary V-groove profile of traction sheave 4 can be coated with a thin polyamide foil of 1 μm-10 μm thickness. For reasons of simplified production, also the whole contact side can be coated with such a foil.

In each V-rib 15.1λ, two tension members 14λ are arranged in parallel in its basis facing back layer 13λ. The tension members 14λ are embodied, as is described in more detail elsewhere, as wire ropes of several wire strands, which, in turn, are composed of individual wires (preferably of steel) twisted with each other around a synthetic material core. Evidently, the other rope-type tension members described in this document can equally be employed. An in-depth discussion of the respective details is hence not necessary here.

The back layer 13λ preferably has longish webs 13.1λ extending in the longitudinal direction of the suspension element, with preferably rectangular cross-section, which protrude from the back layer of elevator belt 12λ (in FIG. 1A at the bottom) towards its contact side. Between each two neighbouring V-ribs 15.1λ separated by a continuous groove 16λ in longitudinal direction of the suspension belt, a respective web 13.1λ is arranged such that it protrudes into groove 16λ and preferably extends basically up to the height of the tension members 14λ. The webs 13.1λ or the grooves 16λ are arranged in the area of the deepest point of a V-groove bottom between neighbouring V-ribs 15-1λ, respectively.

If the V-rib arrangement 15λ engages with the basically complementary V-rib profile of the traction sheave, an area load acts on it that deforms the individual V-ribs 15.1λ. A compression of the individual V-ribs 15.1λ towards the backside of the elevator belt 12λ caused by the area load results in a tendency of the V-ribs to expand in the transverse direction of the belt (left-right in FIG. 1A). Shear loads, too, which may, for instance, be induced by a misalignment between non-aligned traction sheaves and deflecting pulleys due to a twisting of suspension belt 12λ around its longitudinal axis between belt rollers, or by rib distances of a belt roller deviating from the rib distances of the V-rib arrangement 15λ, cause a tendency of the individual V-ribs 15.1λ to deform in the transverse direction of the belt.

Such deformations are counteracted by the webs 13.1λ of the back layer 13λ, on which the individual V-ribs 15.1λ are supported in their basis areas with rectangular cross-section. The back layer 13λ as well as the webs 13.1λ are made of a material (e.g. polyamide) with a higher stiffness than the elastomeric material (e.g. polyurethane) of the V-rib arrangement 15λ. By presetting the web height, the stiffness of elevator belt 12λ in transverse direction can be influenced here. Thus, relatively low webs—e.g. of at most 30% of the height of V-ribs 15.1λ—allow a more significant deformation of the V-ribs 15.1λ in their areas above the webs 13.1λ. If the webs for instance extend up to the level of the rectangular basis areas of the V-ribs 15.1λ where these basis areas change into trapezoidal areas, these basis areas can hardly deform, which results in a considerable stiffening of the whole V-rib arrangement.

The back layer 13λ with the webs 13.1λ can, for instance, be produced by extrusion. A belt 12λ according to the first embodiment of the present invention, too, is preferably produced in an extrusion procedure. To this end, in an extrusion apparatus the back layer 13λ as well as two tension members 14.1λ, 14.2λ per V-rib 15.1λ of the V-rib arrangement 15λ are fed, in correct position, from wheel to an extrusion nozzle, in which the back layer and the tension members are embedded into the hot and hence viscous elastomeric material of the V-rib arrangement, and the whole elevator belt is formed. The two tension members assigned to respective a V-rib are embedded here on the upper side of the back layer 13λ looking away from the backside (in FIG. 1 at the top), between two respective webs 13.1λ, into the elastomeric material of the V-rib arrangement. This material encloses the accessible surface of the tension members 14.1λ, 14.2λ and at the same time links with the back layer 13λ along its surface that faces the V-rib arrangement and is not covered by tension members. The link is created—depending on the material combination—with or without a so-called adhesion mediator, which may, for instance, be applied on the back layer before the extrusion process. Further details and modifications of the present production procedure are to be chosen in analogy to the manufacturing procedures described elsewhere in this document, and therefore these description passages are referred to.

Preferably, the webs 13.1λ embodied in the area of the continuous grooves 16λ of the V-rib arrangement 15λ prevent a tension member 14λ from shifting during the manufacturing process to a position where it would only insufficiently be integrated in the V-rib arrangement. In particular, each web 13.1λ ensures a minimal distance of neighbouring tension members 14.1λ, 14.2λ of neighbouring V-ribs 15.1λ. To this end, it is of advantage if the webs 13.1λ have a height equalling at least half the height of the tension members 14.1λ, 14.2λ (here, the height is oriented perpendicular to the backside, towards the traction side).

The back layer 13λ, on its backside looking away from the V-rib arrangement 15λ (in FIG. 1A at the bottom), forms a sliding surface (deflection side), which in a deflection around a deflecting pulley contacts with the periphery of the latter. This sliding surface of polyamide (or similar materials) preferably has a lower friction coefficient than the traction side, and at the same time a high abrasion resistance. In that way, preferably, the guiding forces between lateral flanged wheels of the deflecting pulleys and lateral guide flanges of the elevator belt, required for lateral guiding of the suspension belt on deflecting pulleys, are reduced. Thereby, the lateral friction load in a deflection of the elevator belt and hence the required driving power of the elevator system is reduced. At the same time, the service life of the elevator belt and the deflecting pulley is prolonged.

FIG. 2A shows an elevator belt 12λ according to another embodiment of the present invention. The elements corresponding to those of the embodiment according to FIG. 1A are assigned the same reference signs here as in FIG. 1A, so that in the following, only differences between the embodiment according to FIG. 1A and the embodiment according to FIG. 2A will be discussed.

In the embodiment according to FIG. 2A, the (V-)ribs 15.1λ of the (V-) rib arrangement 15λ are connected in one piece with each other above the webs 13.1λ, of the back layer 13λ, which here are embodied as shorter. Hence the (V-)rib arrangement overarches the webs 13.1λ, in the area 17λ, of the V-groove bottom of the ribs. Thus, between two neighbouring tension members 14.1λ, 14.2λ of neighbouring V-ribs 15.1λ, the webs 13.1λ protrude into the V-rib arrangement 15λ and are enclosed by the latter at three sides. In that way, a continuous contact surface results on the traction side of the V-rib arrangement 15λ. Together with the connection of area 17λ of the V-rib arrangement 15λ with the upper side of the webs 13.1λ, this provides a firmer connection of the V-rib arrangement 15λ with the back layer 13λ. This embodiment can be extruded without problems. Preferably, the web height in this embodiment is at most half the height of the tension members 14λ, which has the advantage of resulting in reduced bending stress in the webs as compared to the bending stress in the embodiment of FIG. 1A. The suspension element according to invention outlined in that way is used with advantage in the elevator systems and elevatoring gears described elsewhere in this document. Traction sheaves, drive shafts, deflecting pulleys, and guide pulleys in effective connection with the suspension element are also described elsewhere in this document, with the suspension element being combinable with them in any variant.

In another embodiment of a suspension element according to invention, as depicted in FIG. 3A, a first layer 15λ is conceived to form a moulded body of the suspension element, with several tension members 14.1λ being embedded in the first layer. The first layer is conceived as the traction side of the suspension element and in the area of the surface contacting with an assigned traction sheave has a (V-)rib arrangement. At the opposite side, looking away from the traction sheave, preferably a back layer 13λ is conceived. The back layer 13λ forms a sliding surface (deflection/guide side) at its backside looking away from the V-rib arrangement 15λ (in FIG. 3A at the bottom), as it has already been described for FIGS. 1A and 2A. Further functionalities of traction side and deflection/guide side are described in more detail in the context of other embodiment examples of suspension elements according to invention, which passages are hence referred to here.

The cross-section of the tension members is to be dimensioned according to need. In FIG. 3A, just as an example, a larger cross-section is chosen for the centrally arranged tension members than for the marginally arranged ones. Furthermore according to invention, a profile body 16.1λ, 16.2λ of a plastic, in particular of a polyamide or similar materials, is arranged between each two neighbouring tension members 14.1λ, 14.2λ. Both the tension members and the profile bodies are embodied with a longish shape here and extend preferably parallel to each other in the direction of the longitudinal extension of the suspension element. Here, between two neighbouring tension members 14.1λ of the outer V-ribs 15.1λ, profile bodies 16.1λ with essentially round cross-section are placed. Between the two neighbouring tension members 14.2λ of the central V-rib 15.1λ, which have a larger diameter, a double-T-shaped or sandglass-shaped profile body 16.3λ is arranged. Neighbouring tension members 14.1λ, 14.2λ of neighbouring V-ribs 15.1λ are kept at a defined distance by basically rectangular profile bodies 16.2λ. The proposed selection and arrangement of the profile bodies is to be understood as an example only and can be modified according to need. In particular, shapes and geometries of the profile bodies are adapted to the distances of neighbouring tension members.

The tension members 14.1λ, 14.2λ and the profile bodies 16.1λ, 16.2λ are positioned in the transverse direction of the belt (left-right in FIG. 3A) as contacting with each other. In that way, it is achieved that the tension members 14.1λ, 14.2λ support each other in the said direction via the profile bodies 16.1λ, 16.2λ, which results in a higher transverse stiffness of the complete suspension element 12λ.

For illustration purposes, in the embodiment according to FIG. 3A, the tension members 14.1λ, 14.2λ have different diameters, and the profile bodies 16.1λ, 16.2λ, and 16.3λ have different cross-sectional shapes. Tension members with different diameters are positioned here in such a manner that their centres are on the same straight line. To this end, the back profile 13λ is preferably embodied with a variable thickness. The expert is free to choose one or two geometric solutions from the variants summarized in FIG. 3A.

In another embodiment, not depicted, all tension members and/or all profile bodies of a suspension element have similar or identical cross-sections, which facilitates manufacturing and stockpiling and leads to a homogeneous elevator belt 12λ.

In another embodiment of a suspension element according to invention, depicted in FIG. 4A, first profile bodies 16.1λ, which each are arranged in the centre of a V-rib 15.1λ, have the same cross-sections. Second profile bodies 16.2λ, which are arranged between two neighbouring V-ribs 15.1λ, also have the same cross-sections. Preferably, however, the second profile bodies 16.2λ have, in particular, a larger width than the first profile bodies 16.1λ. Thus it is ensured that the tension members 14.1λ have a sufficient distance from the groove bottom 18λ between two neighbouring V-ribs 15.1λ.

The production of suspension elements 12λ with profile bodies 16.1λ, 16.2λ, 16.3λ and back layer 13λ is preferably done in an extrusion procedure. There, the tension members 14.1λ, 14.2λ, the profile bodies 16.1λ, 16.2λ, 16.3λ, as well as the back layer 13λ are fed continuously and correctly positioned to a belt extrusion tool, with tension members and profile bodies being guided in such a manner that there is practically no interspace between them. An elastomer strand, made flowable by heat and moulded by a moulding nozzle, is continuously pressed out of the belt extrusion tool. This elastomer strand forms the belt body 15λ and receives the fed tension members as well as the profile bodies, while at the same time linking with back layer 13λ. The profile bodies prevent major lateral deviations of the tension members from their conceived position in the belt body in the described production process. Further details about production procedures for suspension elements according to invention are described elsewhere in this document. All described embodiment examples can draw on concrete embodiments of the other production procedures described in this document.

In FIGS. 3M and 4M, further embodiments of the suspension element according to invention are depicted, as they are ideally used in an elevator system 100m according to invention as it is depicted in FIG. 1M. Such suspension elements interact with traction sheaves, deflecting pulleys, and suspension element end fixations according to invention, as they are described elsewhere in this application.

The embodiment of an elevator system 100m according to invention shown in FIG. 1M, with suspension elements embodied as V-ribbed belts 1m, is depicted in a sectional view of an elevator well 12m. The elevator system 100m comprises a drive fixed in elevator well 12m, with a traction sheave 20m, an elevator car 10m guided at car guide rails 11m, with two deflecting pulleys in the form of car idler pulleys 21.2m, 21.3m mounted below the car bottom, a counterweight 13m with another deflecting pulley in the form of a counterweight idler pulley 21.1m, and several suspension elements for elevator car 10m and counterweight 13m, embodied as V-ribbed belts 1m, which transfer the driving force from the traction sheave 20m of the drive unit to the elevator car and the counterweight.

Each V-ribbed belt 1m is fixed at one of its ends below the traction sheave 20m at a first belt fixing point 14.1m. From there, it extends downwards to the counterweight idler pulley 21.1m, wraps it, and then extends to the traction sheave 20m, wraps it, and then runs downwards along the car wall side-of-counterweight, wraps by about 90° the car idler pulleys 21.2m, 21.3m positioned below elevator car 10 at both sides, respectively, and then runs upwards along the car wall looking away from counterweight 13m, to a second belt fixing point 14.2m.

The plane of traction sheave 20m can be arranged as perpendicular to the car wall side-of-counterweight, and its vertical projection may lie outside the vertical projection of elevator car 10m. The traction sheave 20m hence has preferably a small diameter, of ≦220 mm, preferably <180 mm, preferably <140 mm, preferably <100 mm, preferably <90 mm, preferably <80 mm, so that the distance between the car wall side-of-counterweight and the opposing wall of the elevator well 12m can be dimensioned as small as possible. Besides, a small diameter of traction sheave 20m allows the use of a gearless drive motor with relatively low driving torque as a drive unit. The belt fixing points 14m are devices known to the expert, in which the V-ribbed belt 1m is clamped between a wedge and a casing.

FIGS. 3M and 4M show a sectional view perpendicular to the longitudinal axis of the V-ribbed belt 1m of FIG. 1M. The latter has a base body 2m, in which a tension member arrangement of four tension members 5m is arranged. As is indicated in FIGS. 3M and 4M, in this embodiment each tension member 5m is embodied as a steel wire rope, which preferably comprises a two-layer core strand with a core wire of a diameter of 0.19 mm, a wire layer of six wires of a diameter of 0.17 mm laid around it in S-lay, and a wire layer of 12 wires of a diameter of 0.17 mm, equally laid around it in S-lay, as well as 8 one-layer outer strands with a core wire of a diameter of 0.17 mm, and a wire layer of 6 wires of a diameter of 0.155 mm, laid around it in Z-lay, which are laid around the core strand in S-lay.

A traction side of suspension element 1m (in FIG. 3M at the bottom) is conceived for contact with traction sheave 20m and counterweight idler pulley 21.1m. To this end, it has two traction ribs in the form of V-ribs 3m, which, as is shown in FIG. 3M, engage with assigned grooves 20.1m of traction sheave 20m and are laterally guided by the latter. Due to their wedge effect, with a constant tractive force in the suspension element 1m, the V-rib-type traction ribs increase the normal forces acting on the flanks of the traction ribs 3m and hence the tractive capacity of the drive. In addition, they favourably guide the suspension element 1m in transverse direction on traction sheave 20m.

A deflection side (in FIG. 4M at the top) of the suspension element 1m is conceived for contact with the car idler pulleys 21.2m, 21.3m, and to this end has a guide rib in the form of a V-rib 4m, which—as is shown in FIG. 4M—engages with an assigned groove 21.5m of the respective deflecting pulley 21.2m, 21.3m and is laterally guided by the latter.

In FIG. 2M, the dimension variables of the suspension element 1m are shown schematically. Here, the flank heights h3m of a traction rib 3m, or h4m of guide rib 4m are the projections of the ribs onto the median plane of the suspension element 1m, which is spanned by longitudinal axis and height axis of the latter (vertical in FIG. 2M). The total height h1m of suspension element 1m is hence composed of the flank heights h3m, h4m of the traction rib 3m and the guide rib 4m as well as of the height h2m of the base body 2m. Due to the large flank height h4m, this total height h1m exceeds the width wm of suspension element 1m, which favourably increases the bending stiffness of the latter around its transverse axis, thus counteracting its getting stuck in grooves 20.1m or 21.5m. In the embodiment example, the ratio w/h1 amounts to 0.906.

Analogously, the flank widths t3m of a traction rib 3m or t4m of the guide rib 4m are the projections of the ribs onto the base body 2m of the suspension element 1m, e.g. perpendicular to the flank height (horizontal in FIG. 2M). The total width is denoted by wm. The width of a rib results from its two flank widths tm and the width of a (flattened) top. Hence, the width of a traction rib 3m, for example, amounts to 2×t3m+d3m (cf. FIGS. 2M, 3M).

The flank angle α4m of guide rib 4m is the interior angle between the two flanks of guide rib 4m, and in the embodiment example amounts to 80°. The correspondingly defined flank angle α3m of the traction ribs 3m amounts in the embodiment example to 90°.

According to one embodiment of the present invention, traction sheave 20m and/or deflecting pulley 21.1m, 21.2m, 21.3m of an elevator system 100m have an assigned groove 20.1m, 21.5m for each traction rib or guide rib 3m, 4m such that with the suspension element 1m being laid in, the flanks of the traction rib or guide rib 3m, 4m contact with respective counter-flanks of the assigned groove 20.1m, 21.5m. The grooves 20.1m, 21.5m are preferably embodied as corresponding with the ribs 3m, 4m of suspension element 1m: If guide rib 4m or traction rib 3m has a certain flank height hm, flank width tm, and/or a certain flank angle am, the counter-flanks of the assigned groove 20.1m, 21.5m favourably have basically the same flank height hm, and/or flank width tm, and/or basically the same flank angle am. In particular, it is to be preferred that the depth of a guide rib 4m diving into a groove 21.5 of a deflecting pulley 21.1m, 21.2m, 21.3m exceeds the depth of at least one traction rib 3m diving into a groove 20.1m of a traction sheave 20m.

The flank height hm determines the radial shift which the suspension element 1m is allowed to undergo relative to a traction sheave or deflecting pulley unless rib 3m, 4m comes completely out of an assigned groove 20.1m, 21.5m in the exterior circumference of the traction sheave or deflecting pulley 20m, 21.1m, 21.2m, 21.3m and is no longer guided in transverse direction. As can be seen in FIG. 2M, the flank height h4m of the one guide rib 4m exceeds the flank height h3m of the two traction ribs 3m. In that way—as the comparison of FIG. 3M and FIG. 4M shows—the guide rib 4m can dive deeper into an assigned groove 21.5m in deflecting pulley 21.3 than this is the case with the traction ribs 3m and the assigned grooves 20.1m of the traction sheave 20m. With a microscopic or macroscopic slackening of the suspension element 1m, the higher guide rib 4m can radially move farther away from a deflecting pulley without completely losing the transverse guide. Therefore, with a radial elevatoring-off (downwards in FIG. 4M), which may, for instance, occur with a suspension element slackness due to the own weight of suspension element 1m, the guide rib 4m remains longer in groove 21.5m. If the suspension element 1m tightens again, the guide rib 4m, which due to its greater height still partly dives into groove 21.5m of the deflecting pulley, can favourably autonomously centre the suspension element 1m again on deflecting pulley 21.1m, 21.2m, 21.3m. Additionally, the flank surface of the guide rib engaging with the groove in the deflecting pulley circumference increases, which allows to ensure a sufficient transverse guide even with lower deflection angles. Therefore, with a suspension element according to the first embodiment of the present invention, also a bigger deflecting pull, up to 4%, can be realized.

Flank height h4m of guide rib 4m is bigger than flank height h3m of traction ribs 3m. Therefore, the change of distance and/or the maximum distance of the tension members 5m to the traction side can be chosen as lower than to the guide side, as is depicted in FIGS. 2M-7M. This leads to a more homogeneous force distribution between traction side and tension member arrangement 5m, which prolongs the service life of suspension element 1m.

Preferably, the ratio of flank height h4m of a guide rib 4m to flank height h3m of a traction rib 3m is at least 1.5, preferably at least 2.0, and with particular preference at least 2.5. Smaller ratios are suitable to, e.g., compensate a rather bad guide situation due to lower angles of wrap. A rather bad guide situation due to the own weight can be compensated by medium height ratios, and high deflecting pulls by high height ratios of up to 2.5.

As can equally be seen in FIG. 2M, the flank width t4m of guide rib 4m also exceeds the flank width t3m of the two traction ribs 3m. The ratio can again range from at least 1.5 to 2.5, with the analogue compensation properties as they have been mentioned for the flank height. By the choice of a higher flank width h4m of guide rib 4m as compared to that of traction rib 3m, the guiding properties in transverse direction can also be improved. If the suspension element 1m deviates outwardly on a sheave/pulley 20m, 21m by maximally its flank width tm, it is set back by the inclined flanks. Due to the greater flank width t4m, the suspension element 1m is thus guided on its deflection side in transverse direction over a wider area. This, in particular, also allows a heavier deflecting pull, since even a suspension element running in rather angularly is still “caught” by the respective groove 21.5m of the deflecting pulley, due to its greater flank width.

This is particularly favourable, since due to mounting tolerances in the deflecting pulleys 21.2m, 21.3m as well as their low distance of each other, a heavier deflecting pull may occur, which is counteracted by the improved guide at the deflection side. Between deflecting pulley 21.3m and belt fixation point 14.2m, greater tolerances can also be accepted, since the broader and higher guide rib 4m allows a greater deflecting pull. Between traction sheave 20m and deflecting pulley 21.2m, such a deflecting pull can be partly compensated by deformation of the suspension element 1m, so that the shorter and narrower traction ribs 3m run in into the traction sheave with lower deflecting pull.

Another advantage lies in the additional volume of suspension element 1m in the direction of its height h1m. This additional volume favourably damps vibrations, relieves shocks, and reduces the shear deformation of the suspension element occurring due to the transfer of the peripheral force. This equalizes the running of such a suspension element 1m and prolongs its service life. The force distribution has proved as especially favourable in suspension elements 1m in which the traction side has two or three traction ribs 3m, and the deflection side has one guide rib 4m.

The two traction ribs 3m in FIGS. 2M-4M are assigned a guide rib 4m that basically extends over the whole width wm of the suspension element 1m and is hence about double as broad as the two traction ribs 3m. To further increase the diving depth, the flank angle α4m of the guide rib 4m is, with 80°, embodied as more acute than the flank angle α3m of the traction ribs 3m.

In all, the guide rib 4m thus has a significantly greater flank surface f4=4(t4²+h4²) than the traction ribs 3m with f3=4(t3²+h3²), which significantly improves the guiding at the deflection side. At the other side, the tension members 5m are arranged close to the traction side, with the distance to the traction side varying less due to the flatter flank angle α3m.

For an optimized force distribution and a modularly adaptable structure, it has turned out as advantageous to assign one or two tension members 5m each to a traction rib 3m. Here, each traction rib 3m is assigned two tension members 5m, whereby the frictional forces of the traction sheave 20m are transferred essentially via a respective flank of a traction rib 3m onto an assigned tension member 5m. This results in a particularly homogeneous force distribution in the traction ribs 3m and contributes to a prolonged service life of the suspension element 1m.

As schematically indicated in FIG. 3M, the flattened top of a traction rib 3m has a width d3m as broad as or broader than the minimal distance d20m of the two counter-flanks of groove 20.1 in traction sheave 20m. Thereby, the edge embodied in these counter-flanks, in which the inclined counter-flanks change into a rectangular groove with a width d20m in the groove bottom, does not contact with the flanks of the traction ribs 3m, so that the latter are protected against a respective notching effect. The analogous holds for guide rib 4m and the groove 21.5m assigned to it, as can be seen in FIG. 4M.

The counter-flanks of neighbouring grooves 20.1 of the traction sheave 20m change into one another with a radius R20m, which exceeds a radius R3m with which flanks of neighbouring traction ribs 3m facing each other change into one another. Thereby, the contact between the flanks of the traction ribs 3m and the counter-flanks of the grooves 20.1m is smooth and without major notching effects.

The traction side can, at least in the areas of its traction ribs 3m that contact with frictional grip with the flanks of traction sheave 20m, have a coating (not depicted), for instance with a PA foil or a PA tissue. Advantageously, the whole traction side of the suspension element 1m is coated in a continuous or discontinuous procedure, which facilitates production. As an alternative to coating, also vapour-coating and/or flocking can be conceived. The vapour-coating is, for instance, a metal vapour-coating. The flocking is, for instance, a flocking with short synthetic or natural fibres. A vapour-coating or flocking can also extend over the whole traction side and be applied in continuous or discontinuous procedures. On principle, with pairs of V-ribs and grooves in which only the flanks of the V-ribs contact with frictional grip with the grooves, it is also possible to equip only these flanks of the V-ribs with a coating or vapour-coating and/or flocking, so that the areas between the rib flanks that are not in contact with traction sheave 20m are uncoated. Furthermore, there is the possibility to equip the rib 4m with a friction-coefficient-reducing and/or noise-reducing coating.

As is indicated by dashed lines in FIGS. 3M, 4M, one or more further suspension elements, preferably of the same construction type, are arranged beside suspension element 1m, and distanced from each other by a gap 23m which suffices to prevent a mutual contact of the suspension elements on the traction sheaves or deflecting pulleys, even if the suspension elements 1m deform. By such a suspension element compound, any desired width can be simply and quickly composed on site of individual, narrow, easily manageable suspension elements, which significantly facilitates production and storage, transport, and mounting or dismantling. Due to the embodiment with two traction ribs 3m, to which the four tension members 5m are assigned, the total load-carrying capacity of the suspension element compound can be adapted in fine grades by adding individual suspension elements. With the narrow individual suspension elements, it can be prevented that a suspension element compound with n suspension elements has to be reinforced by another load-carrying capacity component of equal size in form of another broad suspension element (n+1) and hence be clearly over-dimensioned if the load-carrying capacity provided by n suspension elements falls only slightly below the required total force.

With a respective choice of materials and dimensioning of the tension members 5m as well as of a sheathing 8m enclosing the tension members 5m, the suspension belts 1m have very small possible bending radiuses, which allow to work with very small traction sheave diameters. This also allows to connect the traction sheave 20m with the drive as a separate component, or else integrate traction zones into an output shaft of the drive. Separate traction sheaves 20m and output shafts equipped with traction zones are hence uniformly referred to as traction sheaves 20m. Favourably, the diameter of such a traction sheave 20m is ≦220 mm, preferably <180 mm, preferably <140 mm, preferably <100 mm, preferably <90 mm, preferably <80 mm.

In a modified embodiment, the good traction properties of the suspension elements 1m with traction sheave 20m enable the operation of the elevator system 100m according to invention with suspension elements 1m that wrap one or more traction sheaves 20m by less than 180°. Favourably, a suspension element 1m wraps a traction sheave 20m with an angle of wrap of 180°, preferably of less than 180°, preferably less than 150°, with particular preference less than 120°, and in particular of 90°.

In another embodiment, several suspension elements 1m, which are to interact as a suspension element compound in an elevator system 100m with a traction sheave 20m, can be produced on the basis of a primary product 7m, as is shown in FIGS. 5M and 6M.

In the example shown here, the primary product 7m comprises two or more suspension elements 1m with one-piece base body 2m. The primary product 7m in FIG. 6M is partly separated between traction ribs 3m and/or guide ribs 4m, so that the individual suspension elements 1m are interlinked by at least a thin base body web 17m. These webs 17m facilitate production and storage of the suspension elements 1m without constraining their flexible use in optional numbers according to the required load-carrying capacity. Before the elevator system 100m starts regular operation, or before its mounting, the primary product 7m can be severed into individual suspension elements 1m. Due to the nature of the co-produced webs 17m, this is done more easily in the example of FIG. 6M than a separation of the base body 2m in the example of FIG. 5M. For the separation of the primary product into individual elevator belts 1m, the mechanics or else the pulleys and/or traction sheaves 20m can be equipped with respective separation tools able to effect a tearing, cutting, milling, or a separation of the web material by means of heat, light, ultrasound, etc.

According to the embodiment of FIG. 6M, three suspension elements 1m are interlinked by means of two base body webs 17m at the deflection side of the suspension elements 1m. The traction sides of the individual suspension elements 1m are hence freely accessible, even in the compound. In the compound, the individual suspension elements 1m can be laid into corresponding grooves 20.1m of the traction sheave 20m with their traction sides. Here, the base body webs 17m can also guarantee the correct lateral distance 23m of the suspension elements 1m to one another on traction sheave 20m. To this end, the suspension elements 1m are interlinked via the base body webs 17m in lateral mounting distances of each other which basically equal the lateral distances 23m of the individual suspension elements 1m on the traction sheave 20m. After mounting, the base body webs 17m can tear, for instance because they are slightly smaller than the lateral distances 23m of the suspension elements 1m on the traction sheave 20m, which makes them tear in a controlled way under tension. Of course, it is also possible to conceive the base body webs 17m at the traction side of the suspension elements 1m, in which case the tools or the interaction with the tools has to be adjusted to the traction side.

Alternatively, as is shown in FIG. 7M, also several suspension elements 1m can be interlinked by a mounting band 30m for the purpose of mounting. The mounting band 30m at least partly encloses the suspension elements 1m. For instance, two, three, four, six, or eight suspension elements 1m, partly enclosed by the mounting band 30m, form a compound which, reeled up as a coil, can be transported simply and without problems into the elevator well 12m. The mounting band 30m is, for instance reversibly or irreversibly, fixed as adhesively bonded to the suspension elements 1m. Favourably, it is a thin plastic band and/or a thin plastic foil with unilateral adhesion layer. The mounting band is connected to the suspension elements 1m via the adhesion layer. With reversible adhesive bond, the adhesion band can be stripped off the suspension elements 1m, thereby individualizing the detached suspension elements. Favourably, the mounting band 30m is attached at the deflection side of the suspension elements, so that the traction sides of the individual suspension elements 1m are freely accessible even in the compound. In particular, the individual suspension elements 1m can, as a compound, be placed with their traction side into corresponding grooves of traction sheave 20m. Here, the mounting band 30m can also ensure the correct lateral distance 23m of the suspension elements 1m to one another on traction sheave 20m. To this end, the suspension elements 1m are connected with the mounting band 30m at lateral mounting distances to one another which basically equal the lateral distances 23m of the individual suspension elements 1m on traction sheave 20m. Of course, it is also possible to attach the mounting band 30m at the traction side of the suspension elements 1m.

For mounting purposes, the suspension elements 1m to be mounted can also be kept together at both sides by a mounting band, or be enclosed with a mounting envelope. Another possibility of simplifying the mounting of several suspension elements of the said type to be arranged side by side comprises in combining the suspension elements 1m by means of retaining clips arranged at a distance of each other in longitudinal direction of the suspension elements 1m and being unfixed after mounting either manually or, with larger well heights, automatically. To this end, the retaining clips can, for instance, be opened by clip openers arranged at the pulleys 21.1m, 21.2m, 21.3m and interacting with the clamping device of the retaining clips. The clamping device is, for instance, a mechanical spring lock, or maybe an electromagnetic lock.

FIG. 8aM shows, in cross-sectional view, another embodiment of the suspension element 1m according to invention. This embodiment, too, is conceived for the interaction with traction sheaves, deflecting pulleys, and suspension element end fixations according to invention described elsewhere in this application. In this embodiment, too, the two-layer belt body 44 comprises a first belt layer 46 and a second belt layer 48. Both belt layers are firmly connected at a connection surface 52, which is schematically depicted as plane, although it may have recesses, with which corresponding elevations of the other belt layer engage, so as to reinforce the interconnection of the two belt layers 46, 48.

A first exterior surface 50 of the first belt layer 46 again has two V-ribs 80 for contact with the traction sheave, which can engage with largely complementary grooves of traction sheave 26. Thereby, they are laterally guided, and the contact pressure and hence the tractive capacity of drive 2 are thus increased.

At the opposite exterior surface 54 of the second belt layer 48, again two V-ribs 84 are conceived, for interaction with car idler pulleys or deflecting pulleys, which also can engage with largely complementary grooves of these pulleys and are laterally guided by them.

In another embodiment, depicted in FIG. 8bM, the second exterior surface 54 has only one V-rib 84, serving for laterally guiding belt 20 in the car idler pulleys or deflecting pulleys.

In the first belt layer 46, four tension members 42 in the form of stranded steel wires or synthetic fibres are arranged side by side. But also more—e.g. 5 tension members—or less—e.g. 3 tension members—can be arranged side by side. The individual tension members can also be arranged as shifted relative to each other in the height direction of belt 20.

The tension members 42 are arranged in the neutral zone of the moulded body 44, in which only low tensile or compressive stresses occur if belt 20 wraps a belt roller, in particular traction sheave 26, or a drive shaft equipped for the traction function. Due to the larger distance of the second exterior surface 54 from the neutral base body, the expansions occurring in the second belt layer 48 during wrapping are greater than the compressive deformations in the first belt layer 46. To reduce the tensile stresses occurring in the second belt layer 48, a rather soft elastomer is chosen as material for the second belt layer 48, in the embodiment example of a Shore hardness of 80° Sh, as compared to a Shore hardness of 85° Sh of the first belt layer 46. In the second embodiment according to FIG. 8bM, the second belt layer 48 has a smaller cross-section than the first one, and in particular has only one V-rib 84. This contributes to shifting the neutral zone into the area of the tension members 42.

The first exterior surface 50, at least in the areas of its V-ribs 80 which contact with a frictional grip with the flanks of traction sheave 26 or a drive shaft, has a coating 88, e.g. of a PA foil. Favourably, the whole first exterior surface 50 is coated, in a continuous or discontinuous procedure, which simplifies production. As an alternative to coating 88, also a vapour-coating and/or a flocking can be conceived. The vapour-coating is, for instance, a metal vapour-coating. The flocking is, for instance, a flocking with short synthetic or natural fibres. This vapour-coating or flocking can also extend over the whole first exterior surface 50 and be applied in continuous or discontinuous procedures. On principle, in largely complementarily shaped pairs of V-ribs 80, 84 and grooves of the traction sheaves or deflecting pulleys, in which only the flanks of the V-ribs contact with frictional grip with the grooves, it is also possible to equip only these flanks of the V-ribs with a coating 88 or a vapour-coating and/or a flocking, so that the areas between the rib flanks—which are not in contact with the groove bottoms and groove tops—are uncoated.

According to invention, the ratio of maximum width w to maximum height t of the belt body including V-ribs 80 ranges from 0.8 to 1.2. In the embodiment example, the ratio basically equals 1. An embodiment with relatively large height t makes the belt-type suspension element 20 stiffer with respect to deflections around its transverse axis—even in the embodiment shown in FIG. 8bM. The resulting higher pre-tension in wrapping a belt roller with grooves reduces the risk of the belt getting stuck in the belt roller.

The second belt layer 48 damps vibrations and absorbs shocks. Moreover, it reduces shearing stresses in the first belt layer 46, which occur in the transfer of tensile forces onto the tension members 42. Finally, via its additional volume and its surface, it increases heat emission. In that way the service life of this belt-type suspension element 20 according to invention is favourably prolonged.

In the wrapping of deflecting pulleys, e.g. of car idler pulleys installed below an elevator car, a lateral guide between the car idler pulleys and the V-ribbed belts 80 or 84 is provided by the chosen form of the suspension element 20, in contrast to traditional elevator systems, since the V-ribbed belt 20 has also ribs on its side looking away from the car idler pulleys.

In FIG. 10M, an embodiment analogous to that of FIG. 8aM is shown. It differs from the embodiment in FIG. 8aM in that it is made of one piece and that the tension members 42 are arranged in about the centre of belt 20, in the neutral base body. In this embodiment, the elastomer material of the sheathing is extruded onto the tension members 42 in such a manner that it encloses the latter completely and makes the tension members 42 lie about centrally in belt body 20 with respect to its maximum height t.

FIG. 9M shows another embodiment, in which several belt-type suspension elements can be interconnected in their transverse direction, so as to be composed to a broader suspension element 20′. To this end, at least one jut 20.8 of a first belt 20 engages with a corresponding recess 20.9 of a neighbouring second belt 20, which further improves the lateral guide and reduces twisting or bending of the whole belt arrangement, above all in the free strand area. In an alternative embodiment, not depicted, every second belt 20 can have juts at both transverse sides, which engage with corresponding recesses in the neighbouring first belts 20. Favourably, the outermost belts of a belt arrangement interlinked by means of juts do not have any recesses or juts.

By such a composite belt arrangement, a suspension element 20′ of arbitrary width can be composed on site, simply and quickly, of narrow, easily manageable individual belts 20, which significantly facilitates production and storage, transport, and mounting/dismantling.

To manufacture a belt according to invention, at first the first belt layer 46 can be extruded such that it completely or partly encloses the tension member arrangement 42. In a next step, the second belt layer 48 can be extruded onto the first belt layer 46 such that the tension member arrangement is completely arranged within belt 20. In that way, existing machines for the production of belts the width of which exceeds their height can be used with little modifications also for the production of a belt 20 according to invention with a width/height ratio of about 1.

FIGS. 11M-14M exemplarily refer to a possible way of mounting belt-type suspension elements 20 as they are depicted, for instance, in FIG. 8aM, in an elevator system according to invention. FIG. 11M shows several belts 20, which are interlinked by a mounting band 30m. The mounting band 30m encloses the belts 20 at least partly. For instance three, four, six, or eight belts 20 form a compound 120, partly enclosed by mounting band 30m, which, reeled up as a coil, can be easily and without problems transported into an elevator well 12. The mounting band 30m is, for instance reversibly or irreversibly, fixed as adhesively bonded to belt 20. Favourably, it is a thin plastic band with unilateral adhesion layer. The plastic band is connected to the belts 20 via the adhesion layer. With reversible adhesive bond, the adhesion band can be stripped off the belts 20, thereby individualizing the detached belts 20. Favourably, the mounting band 30m is attached at the second exterior surfaces 54 of the respective moulded bodies 44, opposite of the first exterior surfaces 50, so that the exterior surfaces 50 of the individual belts 20 are freely accessible even in the compound 120. In particular, the individual belts 20 can be placed, as compound 120, with their exterior surfaces 50 into corresponding grooves of the traction sheaves. Here, the mounting band 30m also ensures the correct lateral distance of the belts 20 to one another. To this end, the belts 20 are interlinked by mounting band 30m at lateral mounting distances 30.1m to one another which basically equal the lateral distances of the individual belts 20 on the traction sheaves.

For mounting the compound 120 in the elevator system, the following steps are executed: The compound 120 is laid onto traction sheave 26.1m and deflecting pulleys 2.26m, 26.3m, and the belts 20 are fixed at their ends 20.1, 20.2 of compound 120 at belt fixing points 14.1m, 14.2m. The belts 20 of compound 120 are laid onto traction sheave and deflecting pulleys 26.1m, 26.2m, 26.3m at mounting distances 30.1m.

To this end, it is expedient to use an auxiliary elevatoring gear 22m, which in the present example of FIGS. 12M-14M is fixed at the ceiling of elevator well 12. As auxiliary elevatoring gear 22m, preferably a block-and-tackle-type device attached in the uppermost well area is used. It would also be possible to use a fluid elevatoring device (e.g. a hydraulic system) arranged in the downmost well area, or else a crane.

The elevator car 10 is existing at least in structure form. The final completion of elevator car 10 can be done later. The elevator car 10 has a floor plate, or a lower structure part with a bottom surface 6m, at which first car deflecting pulleys 26.2m and second car deflecting pulleys 26.3m are arranged, as well as a top plate (or an upper structure part), which in the present example constitutes a type of work platform. The work platform can also be constituted by the floor plate of elevator car 10 if the existing structure form of the elevator car 10 does not yet comprise side walls.

Elevator car 10 can be coupled to the auxiliary elevatoring gear 22m and is traversable by the latter upwards and downwards in elevator well 12. As soon as elevator car 10 is coupled to the auxiliary elevatoring gear 22m and is fixed, compound 120 is installed in elevator well 12 according to FIG. 12M.

According to FIG. 12M, the compound 120, in the form of a coil 20.3, is transported onto the roof of elevator car 10, where it is deposited and partly unreeled. To this end, elevator car 10 is favourably located in the well pit, so that the mechanic can easily put the coil 20.3 from the ground floor of the building onto the roof of elevator car 10. The one end 20.2 of the unreeled compound is let down at one side of elevator car 10, is guided below elevator car 10 to the opposite side of elevator car 10, and from there upwards again to the roof of elevator car 10. Of course, the mechanic can at first lay the compound 120 around the car idler pulleys 26.2m, 26.3m and then deposit the coil 20.3 on the roof of elevator car 10. Then, the belts 20 of the compound 120 are laid, with their exterior surfaces 50, into the respective grooves of the car idler pulleys 26.2m, 26.3m. Optionally, derailing protections not depicted in the figures are installed at the car idler pulleys 26.2m, 26.3m, which prevent a derailing the belts 20 in case of suspension element slackness, both in radial and in axial direction. The end 20.2 is provisionally fixed on the roof of elevator car 10. Then, elevator car 10 is traversed into the well headroom by the auxiliary elevatoring gear 22m. The individual belts 20 of end 20.2 are individually fixed definitively at a second belt fixing point 14.2 each.

In a further mounting step, according to FIG. 13M, the coil 20.3 is unreeled from the roof of elevator car 10 into the pit of elevator well 12. Here, the other end 20.1 of the unreeled compound 120 is held and guided around traction sheave or drive shaft 26.1 and let down into the pit of elevator well 12. If there is enough space, the mechanic can also guide the whole coil 20.3 around the traction sheave or drive shaft 26.1 and then let it down into the pit of elevator well 12. Then, the belts 20 of the compound 120 are laid, with their exterior surfaces 50, into the respective grooves of traction sheave or drive shaft 26.1. Again, optionally, derailing protections are installed at traction sheave or drive shaft 26.1.

In the following mounting step, according to FIG. 14M, the other end 20.1 of compound 120 is laid around a counterweight idler pulley 26.4 in the well pit. The elevator car 10 is traversed into the well pit by the auxiliary elevatoring gear 22m, and the other end 20.1 is provisionally fixed at the roof of elevator car 10. Then, elevator car 10 is traversed by the auxiliary elevatoring gear 22m into the well headroom, and the belts 20 of the compound 120 are laid, with their exterior surfaces 50, into the corresponding grooves of the counterweight idler pulley 26.4. Optionally, derailing protections are installed at counterweight idler pulley 26.4. The individual belts 20 of the other end 20.1 are then definitively fixed, individually, at a first belt fixing point 14.1m each. Only at that point in time, when the belts 20 are completely laid in elevator well 12, is the mounting band 30m removed from the compound.

In another embodiment, the suspension element is equipped with a safety section, which prevents an elevatoring of the empty or almost empty elevator car (called overtravel), and prevents an overtravel of the counterweight in case of a failure of the drive control or another malfunction in the elevator system.

To this end, the suspension element has a safety section as it is represented in detail in EP1748016, which is referred to here in full. The safety section is arranged such that it interacts with the traction sheave when the elevator car approaches the upper well end. As the safety section is deliberately embodied such that there is a great slip between traction sheave and suspension element, with a run-in of the safety section onto the traction sheave the drive is no longer able to transport the elevator car further upwards. The invention is applicable both to belt-type suspension elements 13 as shown in FIG. 3 of EP1748016, and to rope-type suspension elements, e.g. sheathed steel ropes, or the like.

If belt-type suspension elements are used, they have, for instance, several longitudinal ribs running in parallel to the longitudinal axis of the suspension element. In the area of the safety section, the ribs are embodied differently or are lacking at all. For a better guide of the suspension belt also in the safety section, individual ribs can extend at the two lateral margins, or over the whole length of the suspension belt, hence also across the safety section. Due to the low traction in the safety section, a “desired sliding” of the suspension element occurs in this section. To achieve this deliberate slip in the safety section, also the surface structure of the suspension element in this section can be changed; e.g. by a low-friction coating. This measure on its own may already be sufficient, or else it may contribute to the design of the safety section in combination with other measures. Instead of interrupting the longitudinal ribs in this section, also all or individual ribs can be reduced in their height.

The expert knows that the embodiments of a suspension element according to invention shown here are not to be understood as restricting, and in what ways the individual elements of the described suspension elements can reasonably be combined. Basically, it is also possible to conceive several differently embodied suspension belts of the above-described type in an elevator system, in which case the expert also knows or can easily find out by means of calculations what combinations make sense.

With belt-type suspension elements, the base body, one or more traction ribs, and/or one or more guide ribs can be embodied in a one-piece or multi-piece way, of an elastomer, in particular of polyurethane (PU), polychloroprene (CR), natural rubber, and/or ethylene propylene diene rubber (EPDM). The polyurethane may contain different additives. An example for such an additive is wax to adjust the friction coefficient. Here, especially waxes on paraffin basis are suitable. Another possibility are, for instance, flame-resistant additives as they are commonly used for polyurethane materials. The said materials are particularly suited to translate frictional forces acting on the traction side of the belt-type suspension elements into tractive forces in the tension members, and, besides, favourably damp vibrations of the suspension element. For reasons of protection against abrasion and dynamic destruction, the traction side and/or deflection side can have one or more sheathings and/or coatings, e.g. of a textile tissue.

A one-part embodiment provides a particularly compact, homogeneous suspension element. If, on the other hand, a group of one or more traction ribs is embodied as multipartite with a group of one or more guide ribs, where the suspension element is, e.g., built up of two parts—a first layer comprising the traction ribs and a second layer connected to the first one comprising the guide ribs—, the material properties can be different at the traction side and at the deflection side. For instance, the traction side may have a lower hardness, in particular a lower Shore hardness, and/or a higher friction coefficient than the deflection side, so as to achieve a better tractive capacity, while the lower friction coefficient of the deflection side, on the other hand, reduces the energy loss during deflection.

In particular to this end, the traction side and/or the deflection side of the suspension element can additionally or alternatively have a coating, the friction coefficient, hardness, and/or abrasion resistance of which differs from that of the base body. This coating can be of metal, ceramics, or a composite material, like, e.g., fibre-reinforced PU, or a plastic with finely dispersed particles of metals, and/or metal oxides, and/or nitrides, with a particle size in the nanometre to micrometre range. Also carbon particles in the form of nano-tubes, nano-plates, or spherical nano-particles, or black carbon can be used in such composite materials, which can be helpful above all with the occurrence of electrostatic problems. But also a tissue of synthetic fibres or natural fibres may serve as coating, and again nylon, Nomex®, Kevlar®, hemp, sisal, etc. may serve as fibres here. Such a tissue can also be sheathed or impregnated with a thermoplastic, or elastomeric, or thermo-elastomeric plastic. For instance the following plastics can be applied here: polyamide (PA), polyethylene (PE), polyester, in particular polyethylene terephthalat (PET) and/or polycarbonate (PC), polypropylene (PP), polybutylene terephthalat (PBT), polyethersulphone (PES), polytetrafluoroethylene (PTFE), polyvinyl chloride (PVC), or a polyblend of several thermoplastic synthetic materials.

As an alternative to a coating, also a vapour-coating or flocking can be conceived. Favourably, the coating covers the whole traction side and/or the whole deflection side, and may also sheathe the suspension element completely. If only one side is coated, or if the two sides are differently coated, it is of advantage if the coating does not reach beyond the margins of the respective side. In special cases it may also be reasonable to only partly coat one or both sides of the suspension element.

Due to the multipartite embodiment of traction rib and guide rib, and/or due to the coating of traction side and/or deflection side, a suspension element according to the present invention can have preferred friction coefficients. The friction coefficients cart differ between the base body, and the coatings of the respective sides, or between the first layer at the traction side of the suspension element and the second layer of the suspension element at its guide side or side looking away from the traction side. The friction coefficient μ at the traction side ranges from 0.1 to 1, preferably from 0.2 to 0.6, with particular preference: μ<0.3. At the deflection side, the friction coefficient μ also ranges from 0.1 to 1, and preferably: μ≦0.3.

4.3.4 Suspension Elements: Material of the Tension Members

The tension members of a suspension element according to invention, which again is usable in elevator systems described elsewhere in this document to suspend a car and/or a (counter-)weight, can be made of metal wires, in particular of steel wires, and/or natural fibres, and/or synthetic fibres. The said steel wires have, in particular, a round cross-section, with a diameter of 0.1 mm-0.25 mm. The synthetic fibres have, in particular, a round cross-section, with a diameter of 0.02 mm-0.1 mm.

The steel wires preferably used in a suspension element according to invention are, in particular, made of a carbon steel with a carbon content of 0.4%-1%, preferably of 0.78%-0.88%, in particular with 0.86% carbon. Preferably, a deoxidized, plain carbon steel is used. Preferably, the use of such plain carbon steels is conceived the content of sulphur, phosphorus, nickel, and chromium of which is low, since these elements rather unfavourably affect the toughness of the steel. cf. K. Feyrer, Drahtseile, Bemessung, Betrieb, Sicherheit, 2nd edition, Springer, Berlin 2000. pp. 1ff

In another embodiment, the tension members are made of a high-alloy, preferably stainless CrNi-steel or CrNiMo-steel with a carbon content of 0.01%-0.2%, in particular of 0.02%-0.05%, a chromium content of 15%-19%, in particular with 17% chromium, a nickel content of 5%-15%, with nickel contents of 7%, 12%, and 13% being particularly favourable. CrNiMo-steels additionally contain 1%-7% molybdenum, in particular 2%, 3%, or 7% molybdenum, and with higher molybdenum contents, in particular contents exceeding 3%, a lower nitrogen content is favourable. cf. K. Feyrer, Drahtseile, Bemessung, Betrieb, Sicherheit, 2nd edition, Springer, Berlin 2000. pp. 1ff

Suspension elements with tension members of high-alloy, stainless steels are favourably used in elevator systems located in corrosive environments, like industrial areas with high sulphur or nitrogen pollution of the air. Suspension elements with tension members of carbon steels are favourably used under normal conditions and in regions with high salt content of the air, as, for instance, in elevator systems according to invention in ships and in the neighbourhood of sea coasts, in salt production facilities or their surroundings.

In a preferred embodiment, the individual tension members are impregnated before being processed, for instance with an adhesion-promoting agent.

Instead of steel strands and steel wires, also fibre strands, or fibre bundles, or a combination of fibre strands and fibre bundles can be conceived for the production of tension members according to invention for suspension elements according to invention. In a modified embodiment example, a combination of steel wires and fibre strands or fibre bundles is conceived. The fibre strands or fibre bundles may contain fibres of sisal, hemp, nylon, rayon, Teflon®, polyamide, polyester, aramid, glass, and/or carbon, in any variant of mixtures, or fibres of only one material.

On principle, the tension members can be manufactured of natural fibres, and/or synthetic fibres, and/or steel wires.

Preferably used steel wires in the elevator system according to invention are, in particular, manufactured of carbon steel with a carbon content of 0.4%-1%, preferably of 0.78%-0.88%, in particular with 0.86% carbon. Preferably, a deoxidized, plain carbon steel is used. With particular advantage, such plain carbon steels are used the content of sulphur, phosphorus, nickel, and chromium of which is very low, since these elements rather unfavourably affect the toughness of the steel. cf. K. Feyrer, Drahtseile, Bemessung, Betrieb, Sicherheit, 2nd edition, Springer, Berlin 2000. pp. 1ff

In another embodiment, the tension members are manufactured of a high-alloy, preferably stainless CrNi-steel or CrNiMo-steel with a carbon content of 0.01%-0.2%, in particular of 0.02%-0.05%, a chromium content of 15%-19%, in particular with 17% chromium, a nickel content of 5%-15%, with nickel contents of 7%, 12%, and 13% being particularly favourable. CrNiMo-steels additionally contain 1%-7% molybdenum, in particular 2%, 3%, or 7% molybdenum, and with higher molybdenum contents, in particular contents exceeding 3%, a lower nitrogen content is favourable. cf. K. Feyrer, Drahtseile, Bemessung, Betrieb, Sicherheit, 2nd edition, Springer, Berlin 2000. pp. 1ff

Suspension elements with tension members of high-alloy, stainless steels are favourably used in elevator systems located in corrosive environments, like industrial areas with high sulphur or nitrogen pollution of the air. Suspension elements with tension members of carbon steels are favourably used under normal conditions and in regions with high salt content of the air, as, for instance, in elevator systems according to invention in ships and in the neighbourhood of sea coasts, in salt production facilities or their surroundings.

In a preferred embodiment, the individual tension members are impregnated before being processed, for instance with an adhesion-promoting agent.

Instead of steel strands and steel wires, the tension members can, however, also comprise fibre strands, or fibre bundles, or a combination of fibre strands and fibre bundles, and tension members made of and/or containing fibres may have fibres of sisal, and/or hemp, and/or nylon, and/or rayon, and/or polyamide, and/or polyester, and/or aramid, and/or carbon.

In another, modified embodiment example, the tension members are made of a material with high tensile strength, like, e.g., steel, and/or natural fibres, and/or synthetic fibres. The fibres are combined to thin fibre bundles and are processed like thin wires. According to requirement profile, the thin fibre bundles and/or the thin wires are twisted to strands. But they can also be contained as parallel bundles in the strand. The strands are preferably twisted to a rope, which is denoted here as tension member. Of course, the fibre bundles or wires can also be twisted in themselves and then be twisted as parallel strands, in the same sense or in opposite sense, or be used as strands helically guided around a core. A layer of strands extending in parallel to each other can be sheathed with a plastic and thus be kept in position. But it can also be kept in position by, e.g., plastic clamps, or by another layer of strands wound helically around it. There are manifold combination options here.

In a particular embodiment, the tension members are, at least partly, made of flattened strands and/or triangular strands. In that way, tension members with only little twisting tendency can be produced.

With particular advantage, the suspension element according to invention is produced with compacted steel strands. This allows, with the same tensile load, the use of thinner and hence less heavy tension members, which, in turn, allows the use of traction sheaves with lower diameters, and of motors with lower performance and lower weight.

Twisted wires or fibre bundles and strands formed of the latter can either be twisted in opposite sense or in the same sense. The twisting angle or steepness with which the individual elements are twisted, and the twisting direction of the twisted fibres or wires, and the twisting angle or steepness and the twisting direction of the strands formed thereof and/or of different strand layers relative to each other are typically chosen such that the tendency of the finished tension member to un-twist is as low as possible. The strands can be formed without a core, i.e., the fibre bundles and/or wires are twisted around each other, or they are twisted around a core. The core itself can here be built up of parallel or twisted fibre bundles or wires. The strands, in turn, enclose a core in parallel arrangement or wrap it helically. But they may also be twisted with each other without a core, and then, for instance, represent already a tension member, or serve as a core for another strand layer arranged in parallel or helically. There is hence a great variety of respective options to form a tension member.

In a first preferred embodiment, round-strand ropes are conceived as tension elements the structure of which is basically designed according to DIN 3055, DIN 3056, DIN 3057, DIN 3058, DIN 3059, DIN 3060, DIN 3061, DIN 3062, DIN 3063, DIN 3064, DIN 3065, DIN 3066, DIN 3067, DIN 3068, DIN 3069, DIN 3071, where the strands can be made of wire ropes, or of fibre bundles, and as a core, either another strand or a fibre core can be conceived, as described.

It has turned out that the options to embody wire ropes described in these standards can basically also be applied to the embodiment of fibre ropes. Of course, due to the different compactness of the tension members, the calculation variables then have different values. On principle, tension members can be made of natural fibres, and/or synthetic fibres, and/or steel wires.

The diameter of the wires, and their material, the type of their fibres, and their dimension, as well as the number of wires or fibre bundles per strand, and the total number of the strands, as well as the number of strands per strand layer, and the number of strand layers per tension member are chosen according to the concrete requirements.

The diameter of the tension members preferably ranges from 1.5 mm to 4 mm. Such tension members have a sufficient bendability around, traction sheaves and deflecting pulleys, and, on the other hand, a sufficient strength, and are easily embedded in the base body.

The proposed variants of tension members can be used in all suspension elements according to invention.

4.3.5 Suspension Elements: Material of the Moulded Bodies

The moulded body, including potentially existing traction ribs and/or guide ribs, is embodied as one-piece or multi-part object, of an elastomer, in particular of polyurethane (PU), polychloroprene (CR), natural rubber, and/or ethylene propylene diene rubber (EPDM). The said materials are particularly suited to translate frictional forces acting on the traction side into tensile forces in the tension members, and in addition favourably damp vibrations of the suspension element during operation. Alternative novel materials with favourable wear and/or friction properties can, of course be employed. For reasons of protection against abrasion and dynamic destruction, the traction side and/or the deflection side can have one or more sheathings and/or coatings, e.g. of a textile tissue.

A one-piece embodiment yields a particularly compact, homogeneous, and simply manufacturable suspension element. A group of one or more traction ribs (in the area of a traction side) can be embodied as multipartite with a group of one or more guide ribs, by structuring the suspension element, for instance as bipartite, of a first layer (comprising the traction ribs) and a second layer, connected to it (comprising the guide ribs). If a multi-part arrangement is used, the material properties can be different at the traction side and the deflection side. Optionally, this can be realized with further layers put in between, where the (potentially different) layers are interlinked as adhesively bonded and/or form-locking to form an integral moulded body during the production process (described exemplarily elsewhere in this document). By means of different materials, different requirements regarding the operation of the suspension element can here be taken into account. For instance, a traction side can have a lower hardness, in particular a lower Shore hardness, and/or a higher friction coefficient than the deflection/guide side, so as to achieve a better tractive capacity, while the lower friction coefficient of the deflection/guide side, on the other hand, reduces the energy loss during deflection.

Especially to this end, the traction side and/or the deflection/guide side may additionally or alternatively have a coating, the friction coefficient, hardness, and/or abrasion resistance of which differ from those of the base body.

The material of the (whole) moulded body, or the material of a belt layer, and/or of a coating can be a metal, ceramics, and/or an organic/synthetic material. In particular, according to invention, a composite material is conceived, like, e.g., fibre-reinforced PU, or a plastic with finely dispersed particles of metals, and/or metal oxides, and/or nitrides. According to invention, the particles have a spherical, cylindrical, or amorphous basic shape, and extend maximally in the nanometre to micrometre range. An admixture of such particles, which are hard as compared to the basic material of the layer, can effect an increase in the abrasion resistance and stiffness of the respective layer. Also carbon nano-particles, in the form of “nano-tubes”, “nano-plates”, or spherical nano-particles, or “black carbon” can be used in such composite materials, which can be helpful above all with the occurrence of electrostatic problems. In another embodiment example, fibres of cotton, sisal, chemical pulp, silk, or bast are admixed to the basic material of a moulded body of a suspension element, at a volume fraction of up to 5%.

Also a tissue of synthetic fibres or natural fibres may serve as coating and/or belt layer, and again nylon, Nomex®, Kevlar®, hemp, sisal, etc. may serve as fibres here. For the use as a coating, such a tissue can also be sheathed or impregnated with a thermoplastic, or elastomeric, or thermo-elastomeric synthetic material. Again, the following plastics may be applied here: PU, polyester, polyamide, EPDM. In a moulded body, or as reinforcement of a belt layer, such a tissue is embedded into the material of the moulded body.

As an alternative to a coating, also a vapour-coating or flocking can be conceived. Favourably, the coating covers the whole traction side and/or the whole deflection/guide side, and may also sheathe the suspension element completely. If only one side is coated, or if the two sides are differently coated, it is of advantage if the coating does not reach beyond the margins of the respective side. In special cases it may also be reasonable to only partly coat one or both sides of the suspension element.

In a multi-part embodiment of the suspension element, with traction rib and guide rib, and/or with a coating of traction side and/or deflection side, a suspension element according to the present invention can preferably have different friction coefficients at traction side and guide side. If a coating is conceived, the friction coefficients of the coating may also differ from the friction coefficients of the material of the respective side of the moulded body below, and/or a respective a difference may also exist between the first area of the moulded body, at the traction side of the suspension element, and the second area of the moulded body, at the guide side or side looking from the traction side.

The friction coefficient μ at the traction side ranges from 0.1 to 1, preferably from 0.2 to 0.6, with particular preference: μ<0.3. At the deflection side, the friction coefficient μ also ranges from 0.1 to 1, and preferably: μ≦0.3.

The proposed variants of moulded bodies can be used in all suspension elements according to invention.

### 4.4 End Fixation Means (to Fix the Free Ends of the Suspension Element)

For a safe fixing of the free ends 28a, 28b of the rope-type or belt-type suspension elements 20, different end fixation means can be conceived. The free ends of wire ropes can be fixed for instance by wedge locks, by casting, splicing, or other procedures—the free ends of suspension belts are usually fixed by wedge locks.

Below, the fixing points 28a, 28b, also called suspension element fixing points, will be explained in more detail.

The friction coefficients of elastomer-sheathed or plastic-sheathed belts or synthetic fibre ropes at the traction sheave are generally higher than the friction coefficients of steel wires. With application of the drive brake, e.g. in an emergency stop triggered by the safety circuit, the slip at the traction sheave is much lower in plastic-sheathed suspension elements than in steel ropes. As a consequence, much higher deceleration values occur at and in the elevator car. With the fixing point for suspension element end connections according to invention, the travel comfort can be maintained with modern suspension elements even in an emergency stop situation. In particular with fast running elevators, a soft emergency stop has to be ensured, too high decelerations would lead to accidents and injuries of the elevator passengers. In normal operation, the fixing point according to invention is firmly connected with the guide rail or the elevator well. In an emergency stop triggered by the safety circuit, the fixing point is released by means of a mechanism, with the mechanism and the drive brake being triggered simultaneously. But the mechanism releases the fixing point before the braking torque for decelerating the elevator car generated by the drive brake is built up. With the braking torque building up, a deceleration of the elevator car occurs, and a damping pad of the released fixing point deflects, thereby weakening the deceleration to a degree that is tolerable for the elevator passengers. The safety circuit comprises a series connection of contacts to monitor, e.g., door positions, over-speeds, supply voltage, well end, etc. If one of the contacts of the safety circuit opens, an emergency stop is triggered—as described above—and the drive brake is engaged. Subsequently or simultaneously, the fixing point is released.

In the elevator according to invention, comprising of a counterweight and an elevator car traversable in an elevator well along guide rails, elevator car and counterweight are connected with each other via a suspension element guided over rollers. For each suspension element end, a fixing point is conceived, with a drive driving the suspension element, and at least one fixing point comprising a slide that carries the suspension element end, which can be released in an emergency stop situation. In that case, deceleration forces of the elevator car and the counterweight will effect a shift of the slide contrary to the damping power of a damping pad, and/or contrary to the elastic force of a spring. For reasons of simplification, a spring will be subsumed under the notion of damping pad in some of the following description sections. Furthermore, a fixing point according to invention preferably comprises a fixing element to couple suspension element and slide in a friction-type-locking and/or form-locking manner. Also preferably, clamping elements self-locking under load, and/or screwings may be conceived.

On the basis of FIGS. 1G3, 2G3, 3G3, 4G3, 5G3, 6G3, 7G3, the device according to invention will be explained in more detail.

In FIG. 1G3, an elevator referred to as 1g3 is depicted, comprising of an elevator car 3g3 traversable in an elevator well 2g3, and a counterweight 4g3. The elevator car 3g3 is guided by means of a first guide rail 5g3 and a second guide rail 6g3. The counterweight 4g3 is guided by means of a third guide rail 7g3 and a fourth guide rail not depicted. The guide rails are supported in a well pit 8g3, and the vertical forces are guided into the well pit 8g3. The guide rails 5g3, 6g3, 7g3 are connected by means of brackets 5.1g3, 6.1g3, 7.1g3 with the wall of the well 2.2g3. In the well pit 8g3, buffers 9g3 are arranged, on which buffer plates 10g3 of the elevator car 3g3 or the counterweight 4g3 can land.

As a suspension element and/or traction element, at least one belt 11g3, e.g. an elastomer-sheathed belt with longitudinal ribs, with a 2:1-suspension is conceived. Other suspensions, like, e.g. 4:1, are also possible. In modified embodiment examples, the suspension elements described elsewhere in this document, in single or multiple arrangements, are conceived as suspension elements and/or traction elements to suspend and drive the car and/or the counterweight.

To receive the suspension elements (belts) 11g3 guided in parallel, traction sheave 13g3, deflecting pulleys 16g3, 18g3, 20g3, profiled pulley 17g3, and fixing points 14g3, 15g3 are embodied with the respective contours. If a drive unit 12g3, for instance arranged in the well headroom 2.1g3, at the second guide rail 6g3 and the third guide rail 7g3, drives belt 11g3 forward by means of a traction sheave 13g3 by one length unit, the elevator car 3g3 or the counterweight 4g3 move by half a length unit. The first end of belt 11g3 is arranged at a first fixing point 14g3, and the second end of belt 11g3 is arranged at a second fixing point 15g3. Belt 11g3 is guided over a first deflecting pulley 16g3, over a profiled pulley 17g3, over the second deflecting pulley 18g3, over traction sheave 13g3, and over a third deflecting pulley 20g3. The first deflecting pulley 16g3, the second deflecting pulley 18g3, and the profiled pulley 17g3 are integrated in the bottom 21g3 of the elevator car 3g3, with the belt running in a bottom canal 21.1g3. The profiled pulley 17g3 can also be omitted. The bottom canal 21.1g3 then runs horizontally. The profiled pulley 17g3 has a toothing corresponding with the longitudinal ribs of belt 11g3. The first deflecting pulley 16g3 and the second deflecting pulley 18g3 guide the belt 11g3 on the non-toothed side, by means of flanges arranged at the front side. The traction sheave 13g3 engages with its toothing corresponding with the longitudinal ribs of belt 11g3 with these ribs. The drive unit 12g3 has a brake for normal operation and for emergency stop operation. The motor(s) for traction sheave 13g3 is/are not depicted. The fourth deflecting pulley 20g3 is arranged at the counterweight and is comparable in its structure with the first deflecting pulley 16g3 or the second deflecting pulley 18g3.

FIG. 2G3 shows a side view of the first fixing point 14g3, which is conceived at the upper end of the first guide rail 5g3. The first fixing point 14g3 can also be arranged at the wall of the well 2.2g3 or at the well ceiling 2.3g3. As shown in FIG. 1G3, the second fixing point 15g3 is equipped with length-compensating springs 15.1g3, which compensate different lengths of the belts 11g3 guided in parallel. The second fixing point 15g3 can be structured equally as the first fixing point, and be equipped with length-compensating springs 15.1g3. The first fixing point 14g3 basically comprises a slide 19g3, movable along guide rail 5g3, which is guided by means of guide shoes 22g3 at the free leg 5.2g3 of guide rail 5g3 and carries a yoke 23g3. At the guide rail 5g3, a console 24g3 is arranged at which a damping pad 25g3 is supported. The end of belt 11g3 is held by means of a connection element 26g3. The connection element 26g3 is suspended by means of a tie-brace 27g3 and nuts 28g3 at the yoke 23g3.

In an alternative embodiment example, the fixing points comprise a so-called sealing or fixing element according to U.S. Pat. No. 6,854,164 B2, which is referred to in full with respect to structure and mode of action of the fixing element described there. In column 2, line 63—column 3, line 52 of U.S. Pat. No. 6,854,164 B2, a so-called wedge lock for a sheathed aramid rope with round cross-section is described, which can also be used for sheathed or non-sheathed steel wires with round cross-section. In a respective modification of the used wedge or of its all-around groove 103, as well as in a corresponding modification of the casing or of its surfaces 110, 110′, the geometry can be adapted to non-round suspension elements. According to invention, the modification aims at adapting the shape of the wedge as well as of the casing to the cross-sectional shape of the suspension element such that the latter has a surface contact with wedge and casing during operation, so that a homogeneous distribution of the pressing is achieved. A deviation between wedge angle and casing angle of 0.1°-5° may, however, be conceived, so that a pressing in the wedge lock changing along the length of the suspension element results.

In an alternative embodiment example, a flat, elastomer-sheathed suspension element is conceived that is fitted into a fixing element in the form of a wedge lock according to US 2001/0014996 A1.

FIG. 3G3 shows the suspension element fixing point 14g3 at the end of an emergency stop situation triggered by the safety circuit, where the brake of drive unit 12g3 has decelerated the elevator car 3g3 up to a standstill. The deceleration forces occurring here are transferred to yoke 23g3 by means of belt 11g3, connection element 26g3, and tie-brace 27g3, and effect a shifting of slide 19g3 by the distance Bg3 into the jounce position contrary to the damping power of the damping pad 26g3. The damping pad 26g3 can, for instance, be a spring, or a buffer, or a hydraulic damper, or a hydraulic damper with a spring. With damping elements that rebound after deflecting—like, e.g., a compression spring—a detent can be conceived that keeps the slide 19g3 in the jounce position shown in FIG. 3G3. With the slide in the position shown in FIG. 3G3, the elevator car is only traversable at a creep rate. Between console 24g3 and yoke 23g3, an auxiliary spring can be conceived that brings the slide 19g3 back into its starting position after belt 11g3 has been unloaded by means of a buffer travel of the elevator car. The jounce position of slide 19g3 as shown in FIG. 3G3, and its starting position as shown in FIG. 2G3 can, for instance, be monitored by means of limit switches.

FIG. 4G3 shows a view of fixing point 14g3, seen from the free leg 5.2g3 of guide rail 5g3, and FIG. 4aG3 shows a sectional view along line A-A. The fixing point 14g3 is designed for four flat, elastomer-sheathed belts 11g3 guided in parallel. The yoke 23g3 is arranged between the wall of the well 2.2g3 and the guide rail 5g3, and slides along guide rail 5g3. The slide 19g3 comprises side walls 29g3 supporting yoke 23g3, which are connected by webs 30g3. To each web 30g3, a guide shoe 22g3 is arranged, which is guidable by means of the free leg 5.2g3.

FIG. 5G3 shows a mechanism 31g3, arranged on guide rail 5g3, for releasing the fixing point 14g3. At yoke 23g3, a fishplate 32g3 with a first bolt 33g3 is arranged, where a hook latch 35g3, rotatable around a first pivot 34g3, grips behind the first bolt 33g3. A toggle 36g3 is hinged with its one end at hook latch 35g3, and with its other end is rotatable around a second pivot 37g3. In the shown neutral position, the toggle bears against a limit stop 38g3. A two-armed lever 40g3, rotatable around a third pivot 39g3, serves for locking and operating toggle 36g3. In the shown position, the two-armed lever 40g3, by means of a cam 41g3, locks toggle 36g3, which in that way cannot buckle in any direction. A reel 42g3 releases a second bolt 43g3, which, by means of the elastic force of a compression spring 44g3, rotates the two-armed lever 40g3 around the third pivot 39g3. In this process, the two-armed lever 40g3 releases with its cam 41g3 the toggle 36g3, while simultaneously buckling toggle 36g3, as shown in FIG. 6G3. Due to the gravitational force of elevator car 3g3, the first bolt 33g3 leaves hook latch 35g3, pushing the latter further back, as shown in FIG. 7G3. In this position, toggle 36g3 is completely buckled.

In the following, further suspension element end connections used for fixing points 28a, 28b are explained in more detail.

On the basis of FIGS. 1G4, 2G4, 3G4, 4G4, 5G4, 6G4, 7G4, 8G4, and 9G4, a sealing or fixing element for suspension elements according to invention is explained in more detail.

FIG. 1G4 shows a so-called sealing or fixing element in the form of a suspension element end connection 1 g4, comprising of a wedge 2g4, which can be installed in a casing 3g4. The casing 3g4 can be embodied as a one-piece cast body and essentially comprise a back wall 4g4, a front wall 5g4, an upper opening 11g4, and a lower opening 12g4. Back wall 4g4 and front wall 5g4 form an angle alpha 1g4 according to the depiction. As for the rest, the detailed design can and should be done according to EN81-1:1998 and/or according to ANSI A17.1:2000. As to the design of a suspension element end connection for suspension elements with round cross-section (sheathed or non-sheathed), the mentioned standards are referred to in full. As to the design of a suspension element end connection with non-round cross-section, the mentioned standards are referred to with the proviso that (initially starting from the standard) the geometries of casings and clamping elements are adapted to the cross-section contour of the suspension element. In particular, it is proposed according to invention to vary all end connection variants proposed in the standards with respect to their width, length, and cross-section dimensions in such a manner that one or more non-round suspension elements (as described elsewhere) can be fitted in analogously to a round suspension element, instead of the latter.

Bottom and top of the casing 3g4 are open. A supporting bolt 6g4 connects casing 3g4 with a supporting structure of the elevator. The supporting bolt 6g4 can, for instance, be connected with a suspension element fixing point arranged at the top of the elevator well, or be integrated into a suspension element fixing point.

As suspension element a V-ribbed belt 8g4 with a riding side 9g4 and a backside 10g4 is conceived. The riding side 9g4 has longitudinal ribs, and the backside 10g4 has a longitudinal comb. Other suspension elements, like, e.g., toothed belts, are also possible, especially the suspension elements described elsewhere in this document can be favourably fitted into the described fixing element. The suspension element 8g4 (in this example of belt type) is laid around wedge 2g4 in a loop, with the backside 10g4 with a longitudinal comb being laid onto wedge 2g4.

Wedge 2g4 forms an angle alpha2g4 (preferably ranging between 12° and 28°), which may slightly exceed angle alpha1g4 of casing 3g4. In that way, the clamping effect or the pressing of suspension element 8g4 at the upper opening 12g4 of casing 3g4 is increased. The geometry of wedge 2g4 is chosen in such a manner that, once fitted into casing 3g4 through the upper opening 11g4 of the latter, the wedge 2g4 cannot get out through the lower opening 12g4 (even if no suspension element 8g4 is laid on it). A nose 13g4 in connection with supporting bolt 6g4 serves as torsion protection for supporting bolt 6g4 and keeps the suspension element loop close to wedge 2g4.

FIGS. 2G4 and 3G4 show casing 3g4 and the wedge 2g4, which is introduced into casing 3g4 through the upper opening 11g4. A groove 23g4 is conceived at the wedge 2g4, into which the backside 10g4 of the V-ribbed belt 8g4 fits with its longitudinal comb.

FIGS. 4G4-8G4 schematically show embodiment variants of wedge 2g4. The different geometries of the wedge 2g4 serve for adjusting the pressing of the suspension element sheathing, to which end elevated structures, recesses, or ribs/vaults 14g4 are conceived along a wedge surface. In FIG. 7G4, several ribs/vaults are embodied as rolls 15g4, mutually independent or interlinked via connection elements. Optionally, recesses oriented in parallel to the longitudinal direction of the suspension element that is fitted in are conceived in the structures or rolls.

In FIG. 8G4, the rolls 15g4 are held by means of a (not depicted) cage or a ring-shaped supporting frame, and are pivoted. Preferably, here, each (essentially cylindrical) roll is assigned a bearing axis as well as a bore hole, with the bearing axis gripping through the bore hole and being supported at the cage or supporting frame. Preferably, recesses in circumferential direction are assigned to the cylindrical rolls, which correspond in their contour with the contour of the suspension element fitted in.

FIG. 9G4 shows a suspension element strand 16g4 with several suspension element end connections 1g4. For each supporting bolt 6g4, a compression spring 17g4 is conceived which, at its one end, fixes the supporting bolt 6g4 and at its other end is supported at a console 18g4. The effective length of supporting bolt 6g4 is adjusted by means of a nut 19g4. The console 18g4 can be arranged at a guide rail, at the well ceiling, at the drive console, or at a wall of the well. If a suspension element 8g4 expands, the expansion is compensated by the compression spring 17g4. At each supporting bolt 6g4, another nut 20g4 is conceived, with the nuts 20g4 of all supporting bolts 6g4 loosely carrying a tripping plate 21g4. If a suspension element 8g4 expands, the respective compression spring 17g4 moves the supporting bolt 6g4 upwards, whereby the tripping plate 21g4 is also moved upwards, and a switch 22g4 is operated by tripping plate 21g4, which sets the elevator to a standstill.

If the fixing point is conceived at the elevator car or at the counterweight, the above explanations apply analogously. Furthermore, the described fixing points or suspension element end connection variants are applicable in all elevator systems described elsewhere in this document and for the fixation of all suspension elements described in this document. An adaptation of the geometry of the suspension element end connector to the geometry of the suspension element is self-evident (where ISO 815-1:2007(E) holds).

On the basis of FIGS. 1G6, 2G6, 3G6, 4G6, 5G6, another embodiment example of a fixing element according to invention for the suspension elements described elsewhere is explained in more detail.

FIGS. 1G6 and 2G6 show a suspension element end connection 1g6 comprising of a first cylindrical wrap element 2g6 and a second cylindrical wrap element 3g6, which are firmly arranged in a casing 4g6. The casing 4g6 can be embodied, together with the wrap elements 2g6, 3g6, as a one-piece cast body, or the wrap elements 2g6, 3g6 can be welded with the casing. The casing essentially comprises a back wall 5g6, a first side wall 6g6, and a second side wall 7g6. The casing side opposite of back wall 5g6 is open. In upward direction, the side walls 6g6, 7g6 taper and, together with back wall 5g6 and a yoke 8g6, form a supporting element 9g6 to receive a supporting bolt 10g6. The supporting bolt 10g6 is connected to a supporting structure of an elevator. For instance, supporting bolt 10g6 can be connected with a suspension element fixing point arranged at the top of the elevator well, or be integrated into the latter. If the suspension element end connection 1g6 is used as rotated by 180° around the height axis, for instance a yoke of the elevator car or a frame of a counterweight may serve as supporting structure for supporting bolt 10g6.

As suspension element 11g6, a V-ribbed belt 11g6 is conceived. Other suspension elements, like, e.g., flat belts or toothed belts, are also possible. The belt 11g6 is laid in a first loop 12g6 around the first wrap element 2g6, and then in a second loop 13g6 around the second wrap element 3g6, with the belt back 14g6 looking away from the wrap elements 2g6, 3g6. Then, belt 11g6 is guided, in a third loop 15g6 in the sense opposing that of the first loop 12g6, again around the first wrap element 2g6, and then the end 16g6 of belt 11g6 is fixed by means of a clamping device 17g6 opposite of the supporting element 9g6. As is shown in FIG. 5G6, the ribs 18g6 of the first loop 12g6 engage with the ribs 18g6 of the third loop 15g6, which additionally increases the friction coefficient in this section.

A nose 19g6 in connection with supporting bolt 10g6 serves as torsion protection for the supporting bolt 10g6 and holds the loops 12g6, 13g6, 15g6 pulled tight with a slack belt 11g6.

The clamping device 17g6 comprises a web 20g6 arranged at casing 4g6, with a through-hole 21g6 for the belt end 16g6 and for a wedge 23g6 adjustable by means of a screw 22g6, which clamps belt end 16g6 at the web 20g6. The clamping at belt end 16g6 increases the safety against belt sliding with vibrating load.

FIGS. 3G6 and 4G6 show a suspension element end connection 1g6 comprising of a third wrap element 24g6 and a fourth wrap element 25g6, arranged in casing 4g6, with the third wrap element 24g6 being movable and the fourth wrap element 25g6 being firmly connected to casing 4g6. The casing 4g6 can be embodied as a one-piece cast body together with the fourth wrap element 25g6. Besides, casing 4g6 of FIGS. 3G6 and 4G6 is structured similarly as casing 4g6 of FIGS. 1G6 and with the exception of the clamping device 17g6. The wrap elements 24g6, 25g6 have wedge-shaped cross-sections.

As suspension element 11g6, a V-ribbed belt 11g6 is conceived. Other suspension elements, like, e.g., flat belts or toothed belts, are also possible. The belt 11g6 is laid in a fourth loop 26g6 around the third wrap element 24g6, and then in a fifth loop 27g6 around the fourth wrap element 25g6, with the belt back 14g6 looking away from the wrap elements 24g6, 25g6. Then, the belt 11g6 is again guided around the third wrap element 24g6 in a sixth loop 28g6, the sense opposing that of the fourth loop 26g6, and then the end 16g6 of belt 11g6 is fixed by means of bands 29g6 guided around belt 11g6. As is shown in FIG. 5G6, the ribs 18g6 of the fourth loop 26g6 engage with the ribs 18g6 of the sixth loop 28g6, which additionally increases the friction coefficient in this section. The third wrap element 24g6 wrapped twice is supported via belt 11g6 at the fourth wrap element 25g6 wrapped once and at the back wall 5g6 of casing 4g6. In cross-section, the wrap elements 24g6, 25g6 have a the shape of a wedge, with an angle αg6 of, for instance, 30°.

A nose 19g6 interlinked with the supporting bolt 10g6 serves as torsion protection for the supporting bolt 10g6 and holds the loops 26g6, 27g6, 28g6 pulled tight with a slack belt 11g6.

FIG. 5G6 shows the loops 12g6, 15g6 of the first wrap element 2g6 running in opposite senses, or the loops 26g6, 28g6 of the fourth wrap element 24g6 running in opposite senses. The belt ribs 18g6 of the loops 12g6, 15g6, 26g6, 28g6 guided in opposite senses engage with each other, with the loops being shifted against each other in transverse direction by half a rib 18g6. Instead of orienting ribs 18g6 towards ribs 18g6, in another embodiment variant also back 14g6 of belt 11g6 can be oriented towards back 14g6. The rib material can differ from the back material, in which way different friction coefficients can be achieved, or different belt traction forces can be decreased.

To improve the friction coefficient, the second wrap element 3g6 or the fourth wrap element 25g6 can have longitudinal grooves into which the belt ribs 18g6 fit.

The suspension element end can also be guided over at least one further couple of wrap elements, with again one wrap element being wrapped twice and in opposite senses and one wrap element being wrapped once, as described above.

The advantages achieved by the invention basically lie in the fact that with the frictional-grip suspension element end connection according to invention the clamping effect increases with increasing tractive force. By the multiple deflection of the suspension element, a wrap of several times 180° is created, in which suspension element on suspension element with opposite senses and higher friction coefficient is conceived sectionally. Furthermore, the suspension element end connection according to invention is easily unfastened.

In the device according to invention, at least two wrap elements are conceived, where the one wrap element is wrapped by one suspension element loop and by another suspension element loop running in the opposite sense to the first one, and the other wrap element is wrapped by one suspension element loop.

5. Operation and Indication Devices

An elevator system contains operation and indication devices, both in elevator car 10 and outside elevator well 12, in the areas of the respective stops. Apart from these operation and indication devices conceived for users, there are, of course, still further devices for the respective technical staff to monitor and maintain the elevator system.

In the areas of the stops, usually call panels to call the elevator car 10 to the respective stop are conceived. Possible indications include a simple “used”-indication, position and travel direction indications, the call indication, the out-of-service indication, and the like.

In elevator car 10 itself, mostly there is a push-button panel with push buttons to choose the desired target stop, an emergency call button, and an emergency brake. An indication informs the users about the current position and possibly about the current travel direction (upwards, downwards). Optionally, also a car switch control to choose destinations is conceivable, if, for instance, there are only few stops.

The present invention is basically applicable in elevator systems with arbitrary types of operation and indication devices.

6. Further Variants

The belt-type suspension element according to invention is favourably also used in elevator systems that comprise two or more wells in which several elevator cars move in one-way traffic. With such an operation mode, elevator systems needing little space can be realized.

The new elevator system basically has only wells in which elevator cars move, but no parking wells, so that the space needed for a one-way movement of the elevator cars is as small as possible. The drive systems are assigned to the wells, with at least two drive systems existing per well. With four drive systems, at least three elevator cars are conceived, and usually there are at most as many elevator cars as drive systems, although additional redundant drive systems may be conceived, too.

With only two wells, four elevator cars can be operated—in that way the traffic capacity is greater than that of two traditional elevators with one well each and a total of only two elevator cars. The passenger does not need much orienting about at which landing door to enter the elevator car, as in traditional elevator systems with two separate elevators, because each well is assigned one travel direction.

Each elevator car can preferably approach all floors, hence operate over the whole travel height. In a preferred embodiment example of the new elevator system, there are four drive systems—two per well—and a total of four elevator cars. It is presupposed here that passengers use the elevator system both in upward and in downward direction.

The elevator system can also be conceived for upward travel only, while downwards a staircase system or an escalator is to be used. In such a case, there may be three drive systems in one well, and in the other well only one drive system, so that in one well three elevator cars can simultaneously transport passengers upwards, at a relatively slow speed, while in the other well only one respective elevator car travels downwards rather quickly. The travel directions of the elevator cars can also be changed, so that, according to passenger numbers, the well with the three drive systems can be used for upward or downward travel of the passengers—in an office building for instance for upward travels at the beginning of work and for downward travels at the end of work.

The new elevator system preferably has a central control to control the movements of the elevator cars. Thereby, the movements of the elevator cars are controlled in a way that the number of the elevator cars simultaneously located in one well is limited to the number of the drive systems assigned to this well. Hence with the usual arrangement with two drive systems per well, maximally two elevator cars are located in one well.

Besides, the central control serves to avoid collisions between elevator cars. It ensures that a certain safety distance is always maintained between two respective elevator cars. To avoid congestion situations, the central control can furthermore ensure that an elevator car located at a terminal stop is moved to the other well via the lateral transfer device at the latest when a subsequent elevator car wants to reach just this terminal position.

The wells can be positioned at a certain lateral distance of each other. In that way, enough space for a temporary parking station can be created in the area of the lateral transfer devices. Only little space is needed to this end, since the space between the wells is used for the elevator system only in the area of the lateral transfer devices, while in between it is available for other purposes, e.g. as a storeroom or a broom closet.

With preferred embodiments of the invention, each drive system has a, preferably belt-type, endless traction element to be driven via a traction sheave and equipped with a counterweight.

To couple an elevator car with the endless traction element of the drive system, a coupling mechanism is conceived, e.g. with a coupling body arranged at the endless traction element and a coupling unit arranged at the elevator car.

In the wells, each elevator car is guided by means of sliding and/or rolling guides at one or more vertical guide rails. The lateral transfer devices have lateral guide devices and lateral drive systems for the elevator cars.

In the following, the invention is described in detail by means of different embodiment examples and with reference to the figures. The figures represent:

FIG. 1Az side view of an elevator system according to invention, in simplified representation

FIG. 1Bz the elevator cars of the elevator system including the drive devices, seen from above

FIG. 2Az side view of an upper lateral transfer device for an elevator system according to invention

FIG. 2Bz the lateral transfer device represented in FIG. 2Az seen from above

FIG. 2Cz side view of a lower lateral transfer device for an elevator system according to invention

In the figures, the embodiment examples of the invention are represented in a greatly simplified way, schematic and not-to-scale. Equal or equally operating constructive elements are assigned the same reference signs in all figures, even if they are not identical in every detail. Components that are evidently recognizable are not given a reference sign in some of the figures.

The represented elevator system 1z has two elevator wells 10.1z, 10.2z, and a total of four elevator cars 12.1z, 12.2z, 12.3z, 12.4z.

In FIGS. 1Az and 1Bz, the elevator system 1z is depicted in a state where in each of the elevator wells 10.1z, 10.2z there are two elevator cars. In FIGS. 1Az and 1Bz, well 10.1z intended for upward travel of the elevator cars is arranged at the left side, and well 10.2z intended for downward travel at the right side. The travel directions are depicted by arrows 11.1z, 11.2z. Elevator car 12.4z is located in a downmost position in well 10.1z, elevator car 12.1z in a medium position in well 10.1z, elevator car 12.2z in a topmost position in well 10.2z, and elevator car 12.3z in a medium position in well 10.2z. The elevator cars 12.1z, 12.2z, 12.3z, 12.4z basically comprise a rigid frame and a car body, but also cars with self-supporting structure may be used.

It can be seen in FIG. 1Bz that a total of four drive systems is conceived, namely the drive systems 14.1z, 14.4z in the left well 10.1z, and the drive systems 14.2z, 14.3z in the right well 10.2z.

Each of the drive systems 14.1z, 14.2z, 14.3z, 14.4z comprises an endless traction element 16z, preferably in the form of a sheathed belt. According to invention, an endless traction element 16z has a cross-section that is basically identical with one of the cross-sections of a finite suspension element according to invention depicted elsewhere in this document. In particular, the endless traction element 16z is to have at least one longitudinal rib with a basically wedge-shaped or trapezoidal cross-section, at two opposite sides—a traction side and a deflection/guide side. Similarly, traction sheaves and deflecting pulleys or tension pulleys are designed according to the traction sheaves and pulleys described elsewhere in this document, namely corresponding or complementary to the contour of the suspension element or traction element.

Above, each endless traction element 16z is driven by a drive aggregate, via a traction sheave 18z, and below runs around a return and tension pulley 20z. Furthermore, each of the drive systems 14.1z, 14.2z, 14.3z, 14.4z has a counterweight 22z. Alternatively, the traction sheave could be arranged below and the return and tension pulley above. Equally, deflecting pulleys arranged above or below and lateral tension pulleys could be conceived.

In FIG. 1Az, only the drive systems 14.1z and 14.2z are visible. In FIG. 1Bz, only the elevator cars 12.1z and 12.2z are visible. In the state depicted in FIGS. 1Az and 1Bz, elevator car 12.1z is coupled with drive system 14.1z and elevator car 12.3z with drive system 14.2z. Elevator cars 12.4z and 12.2z are not yet coupled with drive systems. Details regarding this coupling are described below, with reference to FIGS. 2Az-2Cz.

Furthermore, an upper lateral transfer device 24z and a lower lateral transfer device 26z are conceived, both depicted in FIG. 1Az as arrows only. Details regarding the lateral transfer devices 24z, 26z are described below, with reference to FIGS. 2Az-2Cz.

As can be seen in FIG. 1Bz, the drive systems of each well are arranged aside one another at one side of the well, namely the side looking away from the other well. This allows to use elevator cars with two opposite doors, i.e. accessible from both sides. Alternatively, the drive systems can also be located at the side of the well opposing the car door, which reduces the lateral space needed—then, however, only elevator cars with only one door or possibly two adjacent doors arranged at a right angle can be used.

FIGS. 2Az-2Cz show details of the coupling and the lateral transfer devices. FIG. 2Az presents a side view of elevator system 1z, FIG. 2Bz the topmost area of elevator system 1z, seen from above, and FIG. 2Cz a side view of the downmost area of elevator system 1z. FIG. 2Az shows the two wells 10.1z, 10.2z, the empty elevator car 12.1z at the upper terminal stop in well 10.1z, and the other elevator car 12.2z at a medium level, i.e. during its downward travel in well 10.2z.

In each of the wells 10.1z, 10.2z, guide rails 30z arranged side by side are conceived, along which the elevator cars 12.1z, 12.2z are guided by means of guide bodies 31z. The depiction shows sliding guides with guide bodies at the elevator cars embodied as sliding elements, but also rolling guides may be used, which have the advantage of generating less friction losses. 4 guides per well are not absolutely necessary. 2 guide rails per well could suffice. They would then have to be replaced at the topmost and downmost stop, in the areas between the wells, e.g. by swivel guides, as is depicted in FIG. 2Bz.

In the highest and lowest areas in the wells 10.1z, 10.2z, there are no guide rails 30z at the respective sides of the well opposing the drive systems 14.1z, 14.2z. They are replaced there by swivelling guide systems, in the present embodiment example by swivelling guide pulleys. These guide pulleys guide an elevator car when it is not yet received by the respective lateral transfer device 24z. Once the elevator car is effectively received in the lateral transfer device 24z, these swivelling guide systems are swivelled into a release position, so as to enable the horizontal shift of the elevator car. For guiding the elevator cars vertically in the wells, also a so-called “rucksack” guide would be suitable, i.e. a guiding device that guides the elevator cars only at one side, e.g. at the side of the drive systems. In the area of the lateral transfer devices 24z, 26z, such a “rucksack” guide would have to be replaced by a guide system that can be swivelled or shifted.

In FIGS. 2Az and 2Cz, furthermore the traction sheaves 18z can be seen, and in FIGS. 2Az-2Cz the endless traction elements 16z, which run over the traction sheaves 18z and are driven by the latter.

The coupling mechanism by which elevator cars 12.1z, 12.2z can be coupled temporarily with the endless traction elements 16z is structured as follows: Each endless traction element 16z is equipped with a first coupling unit in the form of a coupling plate 32z. Each elevator car 12.1z, 12.2z has a second coupling unit 34z, to couple the elevator car with one of the endless traction elements 16z if needed. In the present example, this coupling unit side-of-car is embodied as a horizontally movable bolt arrangement with several coupling bolts 34z. When engaging with coupling plate 32z, the coupling bolts 34z can be locked by means of a locking device not depicted. Instead of coupling bolts, also meshing hook arrangements can be conceived.

The upper lateral transfer device 24z is shown in FIGS. 2Az and 2Bz. The upper lateral transfer device 24z is located above the elevator cars when these are located in their topmost position. FIGS. 2Az and 2Bz show a state where elevator car 12.1z is not yet decoupled from drive system 14.1z or endless traction element 16z, but is already suspended in the upper transfer arrangement 24z. The upper transfer arrangement 24z comprises two upper profile rails 36z and swivelling pulleys 38z, which, by being swivelled into the profile rails 36z, can be put in a working position in which they engage with the profile rails 36z. As soon as these pulleys 38z are swivelled into their working position, elevator car 12.1z can be decoupled from drive system 14.1z. Before, all passengers have to have left elevator car 12.1z, and all doors of elevator car 12.1z have to be locked. The shift of the now decoupled elevator car 12.1z from well 10.1z to well 12.2z can then occur, via a lateral drive system 40z, in the present example a chain drive system. To this end, there has to be a drive connection between a chain 42z or a belt of the lateral drive system 40z and the elevator car 12.1z or the pulleys 38z, which requires an additional coupling mechanism, not depicted. The lateral drive system 40z is arranged at the profile rails 36z and can be driven by means of an electric motor 44z.

The lower lateral transfer device 26z and the elevator car 12.4z in its downmost position in well 10.1z are depicted in FIG. 2Cz. Basically, the lower lateral transfer device 26z is structured analogously as the upper transfer arrangement 24z, but it is placed below the respective elevator car to be transferred when it latter is in its downmost position. While an elevator car located in the upper lateral transfer device 24z is suspended on the upper profile rails 36z, an elevator car located in the lower lateral transfer device 26z stands on lower profile rails 46z. FIG. 2Cz shows a state after completing the lateral transfer of elevator car 12.4z, but with pulleys 38z still engaging with the guide rails 46z.

The elevator system 1z also has an overspeed governing system (not depicted). This overspeed governing system is optional. An overspeed governor, driven by a friction wheel, can be arranged at each elevator car. If such an uncommon overspeed governor is used, a safety rope has to be coupled with the elevator car when the latter is not received in one of the lateral transfer devices 24z, 26z, or the safety rope has to be firmly linked with the coupling plate. An electronic overspeed governor could be used as well.

Below, the operation of the novel elevator system is described in more detail.

In upward travel, the elevator cars always move from the lowest to the highest possible position, but usually with intermediate stops at the different stations. In doing so, each elevator car going upward answers incoming calls from bottom to top, but, on principle, answers only calls for getting in or out at intermediate stops above the level of its current position. In any case, the elevator car eventually moves to the upper terminal stop, where all remaining passengers have to get out. Subsequently, the elevator car is decoupled from the drive system and, for downward travel, is transferred to the other well by means of the lateral transfer device.

The downward travel takes place in analogy to the upward travel. The elevator car answers the calls in downward direction insofar as stops at intermediate stations are called for that are below the level of its current position. At the bottom terminal stop, the last passengers leave the elevator car, and the car is transferred, by the lateral transfer device, to the other well for another upward travel.

According to number of passengers and their chosen target stations, waiting times may occur, because an elevator car cannot continue its travel—even if there are no calls—if a well is blocked by the preceding elevator car. It would be possible to adapt the speed of the following elevator car, so that no waiting times will occur. If this is done, it is also advantageous to inform the passengers acoustically or visually about the reasons of such decelerations.

The drive systems perform no-load travels to traverse the counterweights without car. These no-load travels can be exerted at high speed, since no passengers are involved.

The whole elevator system has to move in a clocked way. It is possible, with low traffic volume, to only move the called car, but nevertheless, the readiness to answer all possible calls as quickly as possible has to be ensured. To this end, the central control has to continuously monitor the positions of the individual cars and counterweights as a function of the traffic volume. The central control would have to be intelligent and optimize as to traffic performance, waiting times, and energy consumption.

7. Suspension Element Monitoring

Special requirements hold, in particular with the use of (sheathed) suspension elements according to invention, with respect to control or monitoring of the suspension elements. During use, the suspension elements are exposed to various influences. They are subject to continuous wear. In particular at sites of deflection of the suspension elements—e.g. when they are guided over rollers—, they are exposed to an increased risk of individual wires or fibres breaking, or the tension members may be damaged due to extraordinary events, like mounting influences, shocks, corrosion, etc. These influences decrease the load-carrying cross-section and hence the supportable load-carrying capacity of the suspension element, and, in extreme cases, may lead to a failure of the suspension element. With the use of non-sheathed steel ropes, described elsewhere in this document, damages can usually be detected by visual checks. With the sheathed steel ropes or belt-type suspension elements used according to invention, or with suspension elements according to invention with several (individual) steel ropes or steel strands in a common sheathing, damages at the steel rope or at individual steel strands can usually no longer be detected visually. Hence there are especially two fields of tasks for a safe monitoring of sheathed suspension elements:

The first task comprises in determining a status of the sheathing itself. Damages at the sheathing may, for instance, be tears, chippings, thickenings, narrowings, impressed foreign particles, protruding individual wires, or damaged or abraded parts of the sheathing. Such damages can be detected by means of well-tried visual checks, or else by means of electric/mechanical measuring. An elevator system according to invention is hence favourably equipped with a measuring system to determine the status of the sheathing.

For instance, feelers are conceived as mechanical measuring systems, which detect protruding parts or thickenings or narrowings. Electric measuring devices according to invention for instance perform contact monitoring, i.e. detect the contact of a protruding wire, strand, or rope with a deflecting pulley or another contact site. Also, optical sensors can be conceived, able to detect a change in the colour of the sheathing, which, to this end, is, e.g., structured or coated as multi-coloured or phosphorescing. The sheathing itself can, for instance, also include embedded phosphorescing particles or fluids, which, with cracks, become visible at the surface and can thus be detected. In a modified embodiment example of the invention, at least one reservoir for a solid, liquid, or gaseous substance is conceived, embodied as a cavity, within a sheathing of a suspension element according to invention, where the substance is able to trigger a chemical reaction with air, in particular with oxygen, and release radiation or material emissions. Such emissions are preferably recorded by service staff, or by chemical/electrical sensors, and the occurrence of such an emission implies a damage of the suspension element or its sheathing.

The second task comprises in determining a status of the load-bearing steel strand or rope. To this end, the elevator system according to invention preferably comprises a device to monitor the suspension element or the load-bearing part of the suspension element (tension members). According to invention, several alternative or combinable embodiment examples are conceived for the efficient monitoring of tension members as follows:

A first variant is realized according to invention in analogy to a checking procedure for steel-rope-reinforced conveyor belts and multi-rope elevators known from DE3904612A1, where the tension members of a suspension element or the rope are continuously—e.g. with travelling car or with the elevator being driven—magnetized over a limited length and the respective magnetic fields are measured. The magnetization is performed basically up to saturation, axially, with the help of several magnetic fields, and the measuring is realized simultaneously with the magnetization. According to the description of DE3904612A1, column 2, lines 55-68, the monitoring device can be applied both for periodic and for permanent use, with (e.g. steel-rope-reinforced) belts or with elevator ropes running in parallel. Favourably, as described in column 2, lines 47-54, it is equipped with a computer which evaluates the measurements and is able to generate respective warning messages. In the literature, e.g. in K. Feyrer; Drahtseile: Bemessung, Betrieb, Sicherheit, 1994, ISBN 3-540-57861-7, this checking method is described in detail in section 6.3.3. In particular, different alternatives regarding the detailed design of the measuring procedure are described (like, e.g., the use of individual or several measuring coils or Hall generators to record the stray-fields), which are to be used according to invention to monitor the suspension elements described in more detail elsewhere in this document. Further methods are described, like, e.g. the irradiation of suspension elements by X-rays or similar radiation—in special cases, such procedures can be used according to invention, too. In particular, it is conceived according to invention to make radiographs of suspension elements in operation of an elevator system according to invention, over short periods, by means of a mobile, portable X-ray apparatus.

In modified embodiment examples of the present invention, further procedures are conceived to detect the break of a strand of a suspension element in time (and be able to exchange the suspension element in time). So, for instance, in DE3934654A1 a customary belt is prepared as it is represented in perspective in FIG. 3 of DE3934654. In the areas of the ends of the flat belt, the belt body is so-to-speak stripped, so that the load-bearing wire strands lie open. At the end (beginning from the margin), every two wire strands are electrically interconnected in pairs. Such an arrangement is conceived according to invention for the suspension elements described elsewhere in this document in which several electrically conducting tension members are arranged within a common sheathing. The electric connection of two respective strands can here be achieved in different ways. It is, for instance, possible to solder the two strands, to clip them by means of a cable lug, etc. At the other end of the flat belt shown in DE3934654A1 (which is representative for the other, similar suspension elements mentioned in this document), the central strands are interconnected in pairs, so that the individual strands are series-connected and in that way form one single electric conductor. In this conductor, the ends of the outer strands projecting at the stripped end of the flat belt form the conductor ends. These ends are connected with a test voltage source and an ampere meter connected to the latter. An electric current is led from the test voltage source through the belt body comprising of the individual strands, and is indicated by the ampere meter. With a broken strand, the test current is interrupted, which is indicated by the ampere meter. If there is a breakage or rupture of the whole belt, the latter can be exchanged, thus avoiding secondary damages. For the normal expert it is evident at once—as is further explained in DE3934654A1, column 4, from line 32 on—that the ampere meter is the worst of all possible monitoring devices and is only chosen here for reasons of a schematic representation of the rationale of the invention. Instead of the ampere meter, according to invention an electronic circuit can be built in, which, with an interruption of the test current, for instance triggers an acoustic signal, autonomously stops the operation of the suspension element/elevator system, or the like. This allows to also recognize an only short-term interruption of the test current, as it occurs, for instance, if a strand is already broken but the broken ends contact with each other from time to time. Within the electronic circuit, for instance the series-connected individual strands can in turn be series-connected with the base resistance of a transistor connected in common-emitter circuit. From this common-emitter circuit, various other switching stages can then be activated.

In a logical extension of this measurement, a reduced measuring current or an increased resistance could indicate that a cross-section of a rope or a rope strand is reduced, which, in turn, suggests the existence of broken wires. So, it is furthermore conceived according to invention to determine, complementarily or alternatively, a change of the resistance over time. This can be realized with advantage in particular if the suspension element(s) of an elevator system according to invention is/are monitored continuously and/or permanently and/or intermittently during a significant part of the total operation time of the elevator system. A period of, e.g., more than one hour per week, or more than about 50 hours per year is considered as a significant part of the operation time.

Instead of a resistance change, according to invention also a temperature increase in the area of a reduced cross-section can be detected and evaluated, as it is, for instance, explained in EP 1530040 A1. Such a temperature measurement—like the above-mentioned measuring procedures by means of irradiation, ultrasound or magnetic stray-field measurement—has the advantage to allow the determination of the site of damage, while a measurement of current or resistance can only reflect an overall status of the suspension element. Nevertheless, all measuring procedures can be favourably drawn upon, alternatively or cumulatively, for monitoring the suspension elements according to invention described elsewhere. In particular, an unnecessary exchange of the suspension element can be avoided by a conceived permanent and/or periodical intensive monitoring of the suspension element during the service life of an elevator system according to invention. Furthermore, in designing the suspension elements of an elevator system, safety margins can be conceived which, regarding the dimensioning of the admissible load, are lower than the factor 12 frequently used today.

In another embodiment variant, an elevator system according to invention preferably has a recording device to record a status of the suspension element. A recording device according to invention has, in particular, an ultrasound sender to generate ultrasonic waves and couple them into the suspension element or generate ultrasonic waves in the suspension element, as well as an ultrasound receiver to record the ultrasonic waves of the suspension element.

By ultrasound, sound with frequencies above the areas perceived by humans are denoted. The frequencies of ultrasound range from about 20 kHz and 1 GHz to 10 GHz. To generate ultrasound in air, dynamic and electrostatic loudspeakers are suited, and in particular piezoelectric loudspeakers, i.e. membrane-coupled plates of piezoelectric ceramics, which are excited to oscillate due to the reversal of the piezoelectric effect. By means of piezoelectric synthetic materials (PVDF), membranes can also be activated directly, which produces a better transmission behaviour. Formerly, ultrasound in fluids and solids used to be generated by magnetostrictive transducers. According to invention, today preferably piezoelectric quartz or ceramics oscillators are used. An alternating voltage with their natural resonance frequency (or a harmonic of it) is applied to them. The oscillations are then transmitted into the solid, i.e. the suspension element according to invention or its tension members. The reception of ultrasonic waves can basically be performed by the same transducers as they are used to generate them. The received electric signals can be submitted to a frequency, phase, or amplitude evaluation.

Ultrasonic waves allow a simple recording of a status of the suspension element. For instance, a material status, in particular a status of wear or damage of the suspension element, can be recorded. So, the material thickness and hence the wear status of the suspension element can be recorded on the basis of the travel times of the ultrasonic waves in the suspension element. Flaws and cracks in the material change the ultrasonic waves transmitted or reflected in the suspension element, thus allowing to record its damage status. Furthermore, a strength status of the suspension element can be determined on the basis of number, size, and distribution of such cracks or flaws and/or the material thickness. This principle is to be applied according to invention to the tension members conceived in a sheathed suspension element (described elsewhere in this document) and/or to the sheathing of the suspension element itself.

Stresses acting on the suspension element, in particular normal stresses in longitudinal direction of the suspension element, lead to a deformation of the latter, thus also changing its transmission properties regarding ultrasonic waves. Therefore, also a stress status of the suspension element can be determined on the basis of the ultrasonic waves.

If a status of wear and/or damage exceeds preset limits, and/or if a strength status falls below admissible minimum values, the suspension element has to be exchanged. The ultrasonic waves hence also allow to record an exchange status of the suspension element, to assess in detail whether the suspension element has to be exchanged or not. If the statuses of wear, damage, and/or strength approach the preset limits or minimum values without yet actually reaching, exceeding, or falling below them, this suggests that the suspension element has to be subjected to a more precise check, e.g. by means of X-rays, destructive testing of materials, or the like. Hence also an inspection status of the suspension element can be determined on the basis of ultrasonic waves, it can be determined in detail whether the suspension element has to be subjected to an in-depth inspection or not.

The ultrasonic waves can be directly coupled into the suspension element or generated in it, as longitudinal or transverse waves, as shear, surface, or bulk acoustic waves. They can be of the form of continuous sound or sonic pulses. While continuous sound allows a simpler activation of the ultrasound sender, sonic pulses reduce the energy needed to generate the ultrasonic waves and reduces the mutual influence of coupled-in and reflected ultrasonic waves.

In a preferred embodiment of the present invention, the coupling-in or generation of ultrasonic waves is not done directly in the suspension element but indirectly in an axis of a deflecting pulley or traction sheave that is wrapped at least partly by the suspension element. Ultrasonic waves propagating in the longitudinal direction of the axis of a deflecting pulley or traction sheave, and/or ultrasonic waves propagating perpendicular to the longitudinal direction of the axis of a deflecting pulley or traction sheave can be coupled into the axis of the deflecting pulley or traction sheave, or generated in the axis of the deflecting pulley or traction sheave. In both cases, the ultrasound receiver is arranged such that it is able to record ultrasonic waves propagating in the suspension element and/or in the axis of the deflecting pulley or traction sheave transversely to the longitudinal direction of the suspension element.

In another preferred embodiment of the present invention, the ultrasound sender and the ultrasound receiver each comprise at least one piezoelectric crystal coupling directly or indirectly to at least one surface of the suspension element. The activation of the ultrasound sender is done by applying a voltage changing over time, which deforms the piezoelectric crystal. In that way, the piezoelectric crystal modulates ultrasonic waves onto the suspension element, which are transmitted as mechanical waves on the surface or in the interior of the latter. The use of a piezoelectric transducer allows a simple, precise coupling-in of even more complex ultrasonic wave patterns. Accordingly, the ultrasound receiver comprises a piezoelectric crystal, too, which couples to at least one surface of the suspension element, directly or indirectly. Ultrasonic waves in the suspension element hence cause a mechanical deformation of the piezoelectric crystal, which reacts by means of a voltage that can be tapped. The voltage change can be fed to an evaluation device, which thus records the ultrasonic waves. The piezoelectric crystals allow a simple and precise recording of ultrasonic waves here. Besides, the use of an ultrasound sender or receiver on the basis of a piezoelectric transducer allows a simple and reliable check of the suspension element, in particular without interference by magnetic fields as they might, for instance, be caused by a hoisting machine or a control of the elevator system. Nor is there an interference by static charges or the like. Ultrasound sender and receiver also allow the check of suspension element components in which there is only a low magnetic flow.

In another preferred embodiment of the present invention, the ultrasound sender and the ultrasound receiver comprise at least one electromagnetic acoustic transducer (EMAT) each. An electromagnetic acoustic transducer, due to the Lorentz force and/or the magnetostrictive effect, generates ultrasonic waves in a solid, so that no coupling of ultrasonic waves into the solid is necessary. The solid can be the suspension element itself, and/or an axis of a deflecting pulley or traction sheave wrapped at least partly by the suspension element. The electromagnetic acoustic transducer is arranged at a small distance to the solid. Activation of the ultrasound sender is, for instance, effected by an electric current induced by an eddy-current coil. Accordingly, the ultrasound receiver also has an electromagnetic acoustic transducer, so that no decoupling of the ultrasonic waves from the solid is necessary. The ultrasonic waves thus recorded by the ultrasound receiver can be tapped as electric current.

The ultrasonic waves, propagating in the suspension element in its longitudinal direction, can be coupled into the suspension element or generated in it. This is preferably possible at the fixing points of the suspension element, in which the suspension element is fixed in an inertia-resistant way (a more detailed description of fixing points according to invention is found elsewhere in this document).

If the suspension element is, for instance, fixed at both its ends in an inertia-resistant way and in between is guided over deflecting pulleys and traction sheaves, the ultrasound sender can be arranged at one of the two ends of the suspension element in such a manner that it couples ultrasonic waves propagating in longitudinal direction of the suspension element into the latter or generates them in it, with the ultrasound receiver being arranged at the other one of the two ends of the suspension element such that it records these ultrasonic waves propagating in longitudinal direction of the suspension element. Alternatively, the ultrasound receiver can also be arranged together with the ultrasound sender at the same end of the suspension element and record reflected ultrasonic waves propagating in the suspension element in its longitudinal direction.

Additionally or alternatively, the ultrasound sender can also couple ultrasonic waves into the suspension element or generate them in it which propagate in the suspension element in its width direction. This can preferably occur in areas where the suspension element is guided. Accordingly, an ultrasound receiver records these ultrasonic waves propagating in the suspension element in its width direction.

According to another embodiment of the present invention, the transmission of the ultrasonic waves in the suspension element is recorded. Imperfections, in particular voids or cracks in the material, effect for instance an energy decrease in the ultrasound transmitted further and can thus be detected by means of a comparison of the energy of the ultrasonic waves coupled into the suspension element or generated in it and the recorded ultrasonic wave energy of the suspension element.

In another embodiment of the present invention, reflected ultrasonic waves of the suspension element are recorded. Ultrasonic waves are reflected, at least partly, at interfaces of the suspension element, in particular at its surfaces. Ultrasonic waves are, however, also reflected, at least partly, at imperfections of the suspension element. So, by comparison of the travel times of the ultrasonic waves coupled into the suspension element or generated in it and of ultrasonic waves reflected in it, extent and position of such imperfections can be determined.

Such imperfections also cause a shift in the frequencies of the ultrasonic waves. Hence, frequency differences between the ultrasonic waves coupled into the suspension element or generated in it and recorded ultrasonic waves of the suspension element imply imperfections.

The recording of travel time, energy decrease, or a frequency difference between ultrasonic waves coupled into the suspension element or generated in it and recorded ultrasonic waves of the suspension element in an evaluation device also allows to measure the thickness of the suspension element and hence to check its wear status. Because in a thinner suspension element, transmitted ultrasonic waves need less travel time and lose less energy. Also the frequency difference between ultrasonic waves coupled into the suspension element or generated in it and reflected ultrasonic waves of the suspension element changes as a function of the material thickness. The reflected ultrasonic waves preferably differ in their amplitudes and/or frequencies by more than 10% from the generated ultrasonic waves.

The statuses of stress and deformation of the suspension element influence its transmission properties regarding ultrasonic waves. Therefore, the ultrasonic waves recorded by the ultrasound receiver change as a function of the load acting on the suspension element. This allows to record the load status of the suspension element on the basis of the ultrasonic waves, hence in particular to detect a stress in the tension members. To conversely eliminate load-dependent influences on the recording of, e.g., a material status of the suspension element, in another embodiment of the present invention, an compensating strand of the suspension element is checked by means of ultrasonic waves, i.e., ultrasound sender and ultrasound receiver are arranged at an equilibrium strand the stress status of which does not or only insignificantly change.

The above-mentioned embodiments can also be combined. For instance, a first ultrasound receiver can record ultrasonic waves that are transmitted by the suspension element, and a second ultrasound receiver can, simultaneously or alternately, record ultrasonic waves that are reflected in the suspension element.

The coupling of ultrasonic waves into the suspension element or their generation in it, and/or their recording can be restricted to a small space. With a respective recording device, the status of the suspension element can for instance be recorded at significant sites, e.g. especially loaded ones. Alternatively, ultrasonic waves or ultrasound receivers covering only a very restricted area can be moved, manually or automatically, over larger areas of the suspension element and thus sequentially record the status of the suspension element in that larger area.

Preferably, ultrasound sender and ultrasound receiver cover a larger area of a suspension element, in particular a length area of more than 20% of the total length of the suspension element and/or 100% of its width. Accordingly, ultrasonic waves are coupled into the suspension element or generated in it, and transmitted over a larger area of the suspension element, preferably over its whole width or its whole length, before the ultrasonic waves of the suspension element are recorded. Mixed forms are also possible, e.g. one ultrasound receiver receives the ultrasonic waves coupled into the suspension element or generated in it by different ultrasound senders, or, conversely, the ultrasonic waves coupled into the suspension element or generated in it by one ultrasound sender are recorded by several spatially distributed ultrasound receivers. To this end, different frequency bands are assigned to several ultrasound senders. For instance, a first ultrasound sender is assigned a frequency range of 50 kHz-60 kHz, and a second ultrasound sender a frequency range of 100 kHz-120 kHz.

A recording device to record the status of the suspension element according to the present invention can be embodied as a mobile instrument with a mobile ultrasound probe in which ultrasound sender and ultrasound receiver are integrated. Such instruments are known for example from medical diagnostics or non-destructive material testing. Preferably, at least one ultrasound sender and/or at least one ultrasound receiver are arranged as stationary at the suspension element, so as to ensure an invariable position with respect to the suspension element and to thereby improve the recording accuracy. Preferably, ultrasound sender or ultrasound receiver are arranged here such that a part of the suspension element passes by the ultrasound sender or ultrasound receiver if the elevator car is moved, which allows a sectional check of the suspension element.

In a preferred embodiment, the recording device, in particular if it is arranged as stationary at the suspension element, comprises a transmission device to transmit at least one evaluation signal, of the evaluation device in which the ultrasonic waves recorded by the ultrasound receiver are evaluated, to a receiver, which may be arranged outside an elevator well, as mobile, e.g. in a hand-held device for service staff, or as stationary, e.g. in a control room of the elevator system. Thus, the suspension element can be checked without service staff having to descend into the elevator well.

In a preferred embodiment of the invention, the recording device continuously or uninterruptedly records the status of the suspension element during its whole service life, or during those phases in which the drive is operating and/or the car is moved. Preferably, the check is done at preset time intervals (during the service life of the elevator system or during predetermined operation phases), and the result is transmitted via the transmission device. Additionally or alternatively, the recording device can also be activated via remote control, to perform a check if needed. To this end, according to a preferred embodiment of the present invention, the transmission device has a receiver to receive at least one trigger signal, which is, for instance, sent by service staff via a hand-held device or by the control room. When the receiver of the transmission device receives a trigger signal, the ultrasound sender couples ultrasonic waves into the suspension element or generates ultrasonic waves in it, which are recorded by the ultrasound receiver and evaluated by the evaluation device. At least one respective evaluation signal is then transmitted by the transmission device to the mobile receiver or the control room. This enables a remote-control check of the suspension element.

Further tasks, advantages, and features of this checking variant result from the embodiment examples described below. FIGS. 1i, 2i, 3i, 4i, 5i, 6i, 7i, 8i, 9i, 10i, 11i, 12i, 13i, 14i, 15i, 16i, 17i, 18i, 19i, and 20i show further respective details.

An elevator system according to an embodiment of the present invention has a suspension element 2i more closely described in FIGS. 2i-7i in several embodiments, in form of a suspension belt with at least one tension member 2.1i to transfer longitudinal forces, arranged in a belt body 2.2i of a synthetic material. In modified embodiment examples of the invention, the other suspension elements described elsewhere in this document are used. Both round or non-round elastomer-sheathed individual ropes and non-round belt-type suspension elements with a multitude of tension members in a joint sheathing are conceivable.

As is depicted in FIG. 1i, the suspension element 2i is fixed, in an inertia-resistant way, at a first fixing point 5.1i, where an elastic suspension to balance load shocks, indicated by a spring, can be conceived. Further details about the design of the fixing point 5.1i or possible variants are found elsewhere in this document. From fixing point 5.1i, the suspension element 2i is guided around a first deflecting pulley 6i, at which a counterweight 3i is suspended. Further details about the design of the deflecting pulley 6i or possible variants are found elsewhere in this document. From there, the suspension element is guided via a traction sheave 7i to two further deflecting pulleys 6i′, and is fixed in an inertia-resistant way with its other end at a second fixing point 5.2i. Further details about the design of the traction sheave and the further deflecting pulleys or possible variants of these components are found elsewhere in this document. An elevator car 1i is fixed at these further deflecting pulleys 6i′. While the suspension element 2i wraps the first deflecting pulley 6i and the traction sheave 7i by about 180°, it wraps the further deflecting pulleys 6i′ only by about 90°. Further details regarding the concrete design of this 2:1-suspension of suspension element 2i are revealed in WO03043922A1. Other embodiments of suspension element 2i are possible, and are exemplarily described elsewhere in the context of other embodiment examples of the invention. So, also a 1:1-suspension of the suspension element, described elsewhere in this document, is conceived, further details of which are revealed in WO03043926A1. Preferably here, the first and the second fixing point of the suspension element are attached at the counterweight and at the elevator car. Besides, in WO03043926A1 alternative variants of suspension elements are conceived which can be used according to invention here.

A drive unit 4i can apply a torque onto traction sheave 7i, which, with frictional grip, transfers respective longitudinal forces onto suspension element 2i that wraps traction sheave 7i with frictional grip. By a respective rotation of traction sheave 7i by drive unit 4i, elevator car 1i and counterweight 3i can thus be elevatored and lowered in respective opposite senses. In modified embodiment examples, the drive systems revealed elsewhere in this document are conceived instead of drive unit 4i.

For reasons of better orientation, x-y-z coordinates are given in FIGS. 2i-20i. The width of suspension element 2i extends in x-direction, its height in z-direction, and its length in y-direction. Accordingly, the sides of suspension element 2i extending in an x-y plane are called broadsides, and the sides extending in an y-z plane are called long sides.

In the embodiments according to FIGS. 2i-5i, the plastic belt body 2.2i is embodied at least at one broadside as V-ribbed belt. The broadside has V-rib surfaces that extend at angles to the x-y plane of 45°, or 30°, or else 0°. In the embodiments according to FIGS. 6i and 7i, the plastic belt body 2.2i is designed as flat or sine-shaped at its broadsides. The flat broadside lies completely in an x-y plane. The sine-shaped broadside follows the radius of the tension members 2.1i in x-direction and extends in y-direction, following the external contour of the tension members 2.1i in longitudinal direction. The plastic belt body 2.2i of the embodiment according to FIG. 1i is also embodied as flat on one broadside and lies completely in the x-y plane. Accordingly, the flat long sides of the plastic belt bodies 2.2i of the embodiments according to FIGS. 2i-5i lie completely in the y-z plane, while the sine-shaped long sides of the plastic belt bodies 2.2i of the embodiments according to FIGS. 6i and 7i, following the radius, extend in x-direction and in z-direction. Knowing the present invention, the expert can, of course, use further embodiments of plastic belt bodies not shown here, with, for instance, other angles and radiuses of the plastic belt bodies, or with rectangular, square, or round cross-sections of the plastic belt bodies. The plastic belt body 2.2i is, at least partly, made of polyurethane and/or EPDM (ethylene propylene diene monomer), and optionally partly also of a tissue on nylon base. The use of other plastic materials is, of course, also possible.

The plastic belt body 2.2i encloses at least one tension member 2.1i, which is arranged in a neutral phase of the suspension element 2i. Number and diameter of the tension members 2.1i per suspension element 2i vary. While in the embodiments according to FIGS. 2i and 3i, the suspension element 2i has 13 or 12 tension members 2.1i arranged in its plastic belt body 2.2i, in the embodiment according to FIG. 4i it has only 4 tension members 2.1i, in that according to FIG. 5i only one tension member 2.1i, and in the embodiments of FIGS. 6i and 7i two tension members 2.1i in the plastic belt body 2.2i. The tension members 2.1i comprise metal, like steel, or of plastic, like aramid. Their diameters range from 1.5 mm to 12 mm. Each tension member 2.1i comprises several singly-stranded or multiply-stranded strands and a multitude of metal wires or plastic filaments. Further details regarding tension members are known from EP1555234A1 and EP0672781A1. In modified embodiment examples, single or several suspension elements are conceived the details of which are revealed elsewhere in this document.

There is a large range of possible thickness-width ratios of the suspension elements 2i. So, the suspension elements 2i in the embodiments according to FIGS. 3i, 6i, and 7i are broader than thick, while the suspension elements 2i of the embodiments according to FIGS. 4i and 5i are as thick as broad or thicker than broad.

The deflecting pulleys 6i, 6i′, and the traction sheave 7i have corresponding counter-profiles (not depicted), with which the V-ribs of the belt body 2.2i engage. This increases the tractive capacity of traction sheave 7i and improves the guiding of suspension element 2i on the deflecting pulleys 6i, 6i′ or on traction sheave 7i. To this end, the suspension element 2i is twisted by 180° around its longitudinal axis between traction sheave 7i and the further deflecting pulleys 6i′, which is represented by means of a curved arrow. Further details regarding this embodiment are revealed in EP1550629A1.

The recording device to record a status of the suspension element 2i of the elevator system is explained in detail in several embodiments according to FIGS. 8i-20i. The recording device comprises an ultrasound sender 8.1i, an ultrasound receiver 8.2i, and an evaluation unit 8.3i. Both the ultrasound sender 8.1i and the ultrasound receiver 8.2i have, for instance, a piezoelectric transducer and/or an electromagnetic acoustic transducer each, to generate or receive ultrasound. In the embodiments according to FIGS. 8i-16i and 20i, the ultrasound sender 8.1i and the ultrasound receiver 8.2i are arranged directly at the suspension element 2i and/or in contact with it, in the embodiments according to FIGS. 17i-19i, the ultrasound sender 8.1i and the ultrasound receiver 8.2i are arranged indirectly at the suspension element 2i, and/or at a distance to it, or with a separate transmission element being interconnected.

At the piezoelectric transducer, a voltage (e.g. a sine-shaped alternating voltage) is applied to the piezoelectric crystal of the ultrasound sender 8.1i, so that this piezoelectric crystal deforms mechanically. Ultrasound sender 8.1i and suspension element 2i are coupled mechanically, so that the mechanical deformation of the piezoelectric crystal couples into suspension element 2i as ultrasonic waves 8i. The ultrasonic waves 8i pass through suspension element 2i and reach the piezoelectric crystal of the ultrasound receiver 8.2i, which analogously deforms mechanically, and this is tapped as voltage.

With the electromagnetic acoustic transducer, ultrasonic waves are generated by the Lorentz force and/or the magnetostrictive effect in a solid, like the suspension element 2i or an axis of one of the deflecting pulleys 6i, 6i′ or of traction sheave 7i, which are at least partly wrapped by the suspension element 2i. According to invention, the ultrasound sender is activated by an electric current induced by an eddy-current coil, and the ultrasonic waves recorded by the ultrasound receiver can be tapped as an electric current. While in the piezoelectric transducer the ultrasonic waves 8i are generated in the piezoelectric crystal of the ultrasound sender 8.1i and are coupled into suspension element 2i via a mechanical coupling, the electromagnetic acoustic transducer generates the ultrasonic waves directly in the suspension element 2i, so that no mechanical coupling is needed. To this end, the electromagnetic acoustic transducer is arranged at a small distance of the solid.

According to invention, the ultrasonic waves 8i can be coupled into suspension element 2i or generated in it as longitudinal and/or transverse waves, as surface, shear, or bulk acoustic waves. They can be coupled in or generated both as continuous sound or as sonic pulses. While a coupling as continuous sound allows a simpler activation of the ultrasound sender 8.1i, the coupling as sonic pulses reduces the energy needed to generate the ultrasonic waves and reduces the mutual influence of coupled-in ultrasonic waves 8i and reflected ultrasonic waves 8i′. A typical pulse repetition rate amounts to 100 Hz. For a good coupling or a good recording of the ultrasonic waves 8i, 8i′, the ultrasound sender 8.1i and the ultrasound receiver 8.2i are mechanically clamped firmly to the suspension element 2i. The ultrasound sender 8.1i, for instance, generates ultrasonic waves 8i in the frequency range of 20 kHz-1 GHz, which are coupled into suspension element 2i or generated in it. An advantageous frequency of ultrasonic waves 8i, 8i′ amounts to 75 kHz, at which frequency severed steel wires of a suspension element 2i in the embodiment according to FIG. 2i are recorded both in longitudinal through-transmission and in width through-transmission.

Ultrasound sender 8.1i and ultrasound receiver 8.2i are connected via signal lines with an evaluation device 8.3i, which compares the impressed voltage of the piezoelectric transducer or the induced electric current of the electromagnetic acoustic transducer with the tapped voltage of the piezoelectric transducer or the tapped electric current of the electromagnetic acoustic transducer. The at least one output signal of the ultrasound receiver 8.2i is reinforced and processed by suitable means and can be displayed on a screen of an oscilloscope, printed by a printer, and stored as digital file in a digital memory.

At imperfections, e.g. voids or cracks in the material, which may form due to production faults, load peaks, or mechanical or thermal loads in the suspension element 2i, the ultrasonic waves 8i are partly absorbed or reflected. In that way the energy of the transmitted ultrasonic waves 8i further decreases. Thus, a material status, in particular a damage status of suspension element 2i can be determined by comparison of the energies of the ultrasonic waves 8i, 8i′ coupled in and recorded. To this end, the ultrasound sender 8.1i and the ultrasound receiver 8.2i are activated at regular intervals, and the energy decreases between coupled-in and recorded ultrasonic waves 8i, 8i′ in the different measurements are logged. With increasing imperfections, the energy decrease raises. An energy decrease approaching a preset limit—which may, for instance, be determined experimentally—indicates that the suspension element 2i has reached a certain damage status and hence should be checked more closely. In that case, the evaluation device 8.3i transmits at least one evaluation signal to a control room, thereby automatically asking for a closer check of the suspension element 2i, e.g. by X-ray irradiation.

Besides, the suspension element 2i expands according to the load of the elevator car. Accordingly, also the travel time changes which the ultrasonic waves 8i need to get from the ultrasound sender 8.1i to the ultrasound receiver 8.2i. Thus, by comparison of the periods from coupling to recording of the ultrasonic waves 8i, conclusions about the expansion of the suspension element 2i can be drawn and hence its stress status can be recorded.

In the embodiments according to FIGS. 8i-11i, ultrasound sender 8.1i and ultrasound receiver 8.2i are arranged at the suspension element 2i, and the ultrasonic waves 8i pass through the suspension element 2i in longitudinal (y-)direction, over a length li, li′. The suspension element 2i can be through-transmitted in longitudinal direction completely or partly. In a complete longitudinal through-transmission according to FIG. 8i, the whole length li between the two fixing points 5.1i, 5.2i of suspension element 2i is supplied with ultrasonic waves 8i. In a five-floor building and an elevator system with 2:1-suspension of suspension element 2i, the whole length li of suspension element 2i may, e.g., amount to 36m. With a partial longitudinal through-transmission according to FIGS. 9i-11i, only a partial length li′ of the suspension element 2i is supplied with ultrasonic waves. The partial length li′ of the suspension element 2i may amount to a few centimetres but also to several metres. In FIG. 8i, the ultrasonic sender 8.1i and the ultrasonic receiver 8.2i are installed at the front side of suspension element 2i. For instance, the ultrasound sender 8.1i is arranged as stationary at the first fixing point 5.1i, and the ultrasound receiver 8.2i is arranged as stationary at the second fixing point 5.2i. In the embodiment according to FIG. 9i, only the ultrasound receiver 8.2i is arranged as stationary at the second fixing point 5.2i, and the ultrasound sender 8.1i is arranged as mobile at a broadside of suspension element 2i. FIGS. 10i and 11i show embodiments in which the ultrasound sender 8.1i and the ultrasound receiver 8.2i are arranged as mobile at the same broadsides (FIG. 10i), or at different broadsides (FIG. 11i) of the suspension element 2i. Knowing the present invention, the expert can, of course, realize further embodiments that are not depicted. So, in a modification of the embodiment according to FIG. 9i, the ultrasound sender 8.1i can be arranged as stationary at the first fixing point 5.1i, and the ultrasound receiver 8.2i as mobile at a broadside of the suspension element 2i.

In the embodiments according to FIGS. 12i-15i, ultrasonic waves 8i pass through the suspension element 2i in width (x-)direction, over a width wi, wi′. The suspension element 2i can be through-transmitted in width direction completely or partly. For a complete width through-transmission according to FIGS. 12i and 15i, the ultrasound sender 8.1i and/or the ultrasound receiver 8.2i are arranged as either stationary or mobile at the suspension element 2i. According to FIGS. 12i and 15i, the ultrasound sender 8.1i and the ultrasound receiver 8.2i are arranged at the same long sides (FIG. 15i), or at different long sides (FIG. 12i). Ultrasonic waves 8i coupled into the suspension element 2i are not only reflected at the long sides and broadsides of the latter, but also at potential imperfections within it, and in particular at imperfections within the tension members 2.1i. Accordingly, the travel time of the coupled-in and recorded ultrasonic waves 8i shortens in surface areas under which such imperfections exist. Thus, the evaluation device 8.3i can record imperfections and hence a material status of the suspension element 2i. The whole width wi of the suspension element is checked, i.e., the ultrasound sender 8.1i couples ultrasonic waves 8i into the suspension element 2i over the whole width of the latter, which are recorded by ultrasound receiver 8.2i and locally dissolved. In that way, in the evaluation device 8.3i different travel times over width wi of the suspension element 2i can be recorded, which provide information about locally different imperfections, in particular in the tension members 2.1i, but also in the interior of the plastic belt body 2.2i.

In the embodiments according to FIGS. 13i and 14i, ultrasonic waves 8i pass through the suspension element 2i in longitudinal and width direction in the x-y plane, over a length li′ and a width wi′. To this end, the ultrasound sender 8.1i and/or the ultrasound receiver 8.2i are arranged as either stationary or mobile at the same broadside (FIG. 13i) or at different broadsides (FIG. 14i) of suspension element 2i.

In the embodiment according to FIG. 15i, the ultrasound sender 8.1i and the ultrasound receiver 8.2i are arranged at a (common) long side of suspension element 2i. Ultrasonic waves 8i coupled into the suspension element 2i by ultrasound sender 8.1i are reflected in the suspension element 2i, and these reflected ultrasonic waves 8i′ are recorded by ultrasound receiver 8.2i.

Similarly, in the embodiment according to FIG. 16i, the ultrasound sender 8.1i and the ultrasound receiver 8.2i are arranged at the same broadside of suspension element 2i and ultrasonic waves 8i pass through the thickness di of the suspension element 2i. Ultrasonic waves 8i coupled into the suspension element 2i or generated in it by ultrasound sender 8.1i are reflected in the suspension element 2i, and these reflected ultrasonic waves 8i′ are recorded by ultrasound receiver 8.2i. With increasing wear, the thickness of suspension element 2i decreases. Thus, ultrasonic waves also need less time from being coupled in to being received in their travel perpendicular to the longitudinal direction. Based on this data, the evaluation device 8.3i can determine a decrease of the material thickness and hence a wear status of the suspension element 2i. To constantly ensure a sufficient contact with suspension element 2i, the ultrasound sender 8.1i and the ultrasound receiver 8.2i are presprung against the suspension element 2i.

In the embodiments according to FIGS. 17i-19i, an ultrasound sender 8.1i and an ultrasound receiver 8.2i, attached as stationary, are presprung against a front side of an axis 6.1i of a deflecting pulley 6i, or an axis 7.1i of a traction sheave 7i, or an axis 6.1i′ of a deflecting pulley 6i′. The ultrasound sender 81i couples ultrasonic waves 8i propagating in longitudinal direction of the axis into the axis 6.1i, 6.1i′, 7.1i or generates such ultrasonic waves 8i in that axis. The ultrasonic waves 8i propagate from axis 6.1i, 6.1i′, 7.1i into a pulley body 6.2i, 6.2i′ or a traction sheave body 7.2i. The ultrasonic waves 8i are, at the latest, reflected at the broadside of suspension element 2i looking away from the roller body, and the reflected ultrasonic waves 8i′ are recorded by ultrasound receiver 8.2i. In the embodiment according to FIG. 17i, reflected ultrasonic waves 8i′ are received by a suspension element 2i wrapping deflecting pulley 6i or traction sheave 7i by about 180°. In the embodiment according to FIG. 18i, reflected ultrasonic waves 8i′ are received by a suspension element 2i wrapping deflecting pulley 6i′ by about 90°.

Finally, in the embodiment according to FIG. 19i, an ultrasound sender 8.1i and an ultrasound receiver 8.2i, attached as stationary, are conceived at a front side of an axis 6.1i of a deflecting pulley 6i, or an axis 7.1i of a traction sheave 7i. The ultrasound sender 8.1i couples ultrasonic waves 8i into the axis 6.1i, 7.1i, or generates ultrasonic waves 8i in that axis. The ultrasonic waves 8i propagate from axis 6.1i, 7.1i into the pulley body 6.2i or the traction sheave body 7.2i. The ultrasonic waves 8i are, at the latest, reflected at the broadside of suspension element 2i looking away from the roller body, and the reflected ultrasonic waves 8i′ are recorded by ultrasound receiver 8.2i.

In the recording device with stationarily attached ultrasound sender 8.1i and ultrasound receiver 8.2i, the status of the suspension element 2i can be recorded periodically, and be transmitted automatically to a central computer or a central evaluation unit if a closer check is necessary. With the recording device with stationarily attached ultrasound sender 8.1i and ultrasound receiver 8.2i, it is, however, also possible to trigger a measurement via remote control. As is shown in the embodiment according to FIG. 20i, a mobile receiver or a control room 9i sends at least one trigger signal 9.1i to the evaluation device 8.3i, in which a respective receiver receives the trigger signal 9.1i. Then, the evaluation device 8.3i activates the ultrasound sender 8.1i and the ultrasound receiver 8.2i and gets at least one evaluation signal 8.4i, for instance based on the travel time of the ultrasonic waves 8i, 8i′, which it sends back to the mobile receiver or the control room 9i. The transmission of the trigger signal 9.1i and the evaluation signal 8.4i occurs via the conventional telephone network or via a radio link, as is shown exemplarily in FIG. 20i.

Neither the suspension element 2i, nor its guide, nor the correct embodiment and arrangement of ultrasound sender 8.1i or ultrasound receiver 8.2i in the embodiments described above restrict the subject of the present invention. Instead, other embodiments are also possible, in particular suspension elements that comprise several suspension belts, other suspension element guides, and other ultrasound senders or ultrasound receivers.

Other alternative devices or methods to determine the status of the suspension element are conceived as follows. A first such alternative is an analysis of the suspension element by means of time-domain reflectometry (TDR). EP0391312A2 shows such a system to analyse a data transmission cable. According to EP0391312A2, this method is conceived for checking information transmission lines. Basically, a change in the impedance of the information transmission line over its length is recorded. According to an embodiment of the present invention, this system is now used to analyse a suspension element according to invention or to monitor a multitude of suspension elements according to invention. Here, preferably the elevator configurations described elsewhere in this document are to be equipped with the suspension elements also described elsewhere in this document and to be monitored or checked according to invention.

A change of the impedance can be caused by a change in the cross-section or structure of the suspension element, but also by a change in its shielding/sheathing. To determine this impedance change, a respective measuring instrument is connected at one end of the suspension element or of a steel strand or steel rope. The measuring instrument emits a pulse. If the suspension element or the steel strand or steel rope to be tested has a homogeneous structure over its whole length, i.e. has no damage, the entire pulse is absorbed at the end of the suspension element. If, however, there are impedance differences in the suspension element, these discontinuities cause reflections. These reflections are recorded and evaluated by the measuring instrument. On the basis of intensity and duration of the response (which are monitored alternatively or cumulatively according to invention), the site of damage and/or the severity of damage can be determined. It is of advantage here to generate a pulse with a very steep edge, which can, for instance, be achieved by means of a very high measuring frequency, ideally of 1 GHz and more, or even of more than 10 GHz.

In an analogous way, also frequency-domain reflectometry can be employed instead of time-domain reflectometry. This method, too, is used to analyse transmission lines. Here, a frequency behaviour of a transmission element—or of the suspension element—is recorded by frequency-technological means. If there are flaws and effects of wear, the frequency behaviour of a suspension element is changed, which, in turn, can favourably be recorded and evaluated by means of a network analyzer. With this method, too, a site of damage can be determined on the basis of response times. Of course, a change of the suspension element can be detected just by measuring its impedance, yet with this simple method a general status can be determined but not the site of damage.

In the mentioned methods, favourably comparisons with measurement results of definitely intact suspension elements are performed, and deviations are evaluated with respect to the intact suspension element.

Other alternatively or cumulatively applicable devices or methods to determine the status of the suspension element are provided by HF near field techniques. Here, a conductor extending in longitudinal direction of the suspension element (e.g. a load-bearing or non-load-bearing steel strand of the suspension element) is supplied with high-frequency current. The current-fed conductor or current-fed tension member thus acts as a transmitting aerial, which generates a near field according to the current feed. This near field can be measured by guiding a receiver adjusted to the transmission frequency along the suspension element. If there is any disturbance in the conductor, or the steel strand or its sheathing, the field intensity of the radiated field changes, which can be detected by the receiver. In that way, the site of a change can be identified. Of course, the receiver can be of inductive or capacitive type.

Of course, the represented devices and methods are combinable. So, for instance, a broken strand or a significant reduction of the load-carrying capacity could be identified by means of a measuring current, and the site of the defect could be determined by means of a HF near field technique. If the defect is, for instance, located in an end area of the suspension element, the end of the suspension element could be readjusted accordingly. Also time-domain reflectometry could be used for constant monitoring, and if need be, a detailed analysis of the suspension element could be performed by means of a known stray-field measurement.

The represented solutions to monitor suspension elements usually require, depending on the chosen measuring method, an introduction of measuring signals, either by moving a measuring instrument along the suspension element, or by moving the suspension element past the measuring instrument, and/or by introducing the measuring signal via one or both ends of the suspension element. For an arrangement of the measuring device at the ends of the suspension element, it is only necessary to define a connection in the area of the suspension element fixation and to connect the connection points accordingly (as is known in electrical engineering). This can be done by pressing in contact pins (as is usual in network technology), or else clipped connections or soldered connections are possible. It is also possible to strip one or both ends of the suspension element or remove the sheathing in the area of the suspension element end, so that the individual tension members of the suspension element (lying at least partly bare) can be connected to the measuring instrument according to need. The connection of the tension members is done in accordance with the chosen measuring method.

To test the tension members for transmissibility, according to invention (as depicted in FIGS. 3 and 5 of EP1530040A1) the tension members are interconnected at one end, as electrically conducting, and at the other end are selectively, individually, or in pairs led to the measuring instrument. Or, in another embodiment, they are connected in pairs as electrically conducting at one end, and at the other end the interconnected pairs are connected to the measuring instrument, preferably again as selectable. The respective mechanical and electric details of EP1530040A1 are hence referred to in full. In DE3934654A1, another interconnection form according to invention is revealed. Here, as represented in FIG. 3 of DE3934654A1 and the corresponding description, the suspension strands (tension members) of a suspension belt are monitored for breaks, to which end all suspension strands of the suspension belt are connected in pairs in such a manner that a series connection of the individual strands (tension members) results.

Using the above-mentioned ways of interconnection, also several suspension elements can be electrically interconnected analogously. So, several or even all individual suspension elements of an elevator system, including their respective tension members, can, for instance, be electrically interconnected at one end. As has been shown by the example of an individual suspension element, the tension members, at the other end, are connected to the measuring instrument selectively, individually, or in pairs. The expert can thus use the ways of interconnection described for a single suspension element analogously to interconnect several suspension elements.

Other methods to monitor suspension elements introduce special indicator or detector strands or wires into the suspension element. Respective solutions are, e.g., shown in EP0731209A1, where special indicator fibres are revealed with a lower specific expansion and a lower reverse bending strength than the load-bearing strands of aramid fibres. A break of these indicator strands hence suggests increasing wear. FIGS. 2-5 of EP0731209A1 (which is referred to in full in this respect) show a respective plastic fibre rope with indicator strand. Another monitoring device is shown in EP1029973A1. Here, a sheathed suspension element is shown with—integrated in the sheathing—a predetermined breaking point element, which will fail with a predetermined excessive load and can thus be used to detect wear of the sheathing. FIG. 1 of EP1029973A1 reveals a multi-layer aramid fibre rope with a predetermined breaking point element helically wrapped around the rope and embedded in the rope sheathing. The use of such indicator strands or predetermined breaking point elements is also possible for a suspension element reinforced with steel strands, where the use of these strands or fibres allows the detection of a failure of the load-bearing tension members or a failure of the sheathing, respectively.

Hence in the mentioned embodiment examples, indicator strands with, e.g., lower strength, larger diameter, different cross-section (e.g. with triangular or quadrangular cross-section) are used, or the arrangement of the indicator strand is chosen such that, in operation, it is exposed to higher load. The indicator strand is preferably designed such that, in operation, it fails before the load-bearing tension member, and that this failure can be detected simply, e.g. by a transmissibility test. Alternatively or complementarily, the indicator strand can also be embodied as a hollow (tube-shaped) strand, and the cavity can be filled with a medium that provokes a colour change of the sheathing of the suspension belt if it exits due to a damage of the indicator strand. In a suspension element as depicted in FIGS. 3i-5i, for instance, one or more such indicator strands can be arranged in the extreme areas outside the neutral bending axis. In deflection, these extreme areas are exposed to higher alternating load than the tension members i arranged in the area of the neutral bending axis. As a consequence of this higher alternating load, it is expected that the indicator strands arranged there will fail earlier than the actual tension members, which failure can be detected by the above-described transmissibility or resistance analyses.

By means of an indicator strand arranged in the extreme area of the suspension element, alternatively or complementarily according to invention also abrasion or rupture of the sheathing itself can be detected, since such abrasion or rupture also leads to a damage of the indicator strand arranged in this area. The form of the indicator strand can be chosen at will. As already explained, strands, individual wires, moulded strands (tube-shaped, hollow, multi-edged) can be used. Other shapes are possible as well. So, for instance, an indicator braiding can be used, too. The indicator strand can also be shaped as adapted (at least sectionally) to the exterior contour of the suspension element. In that way, it can preferably also effect a transverse stiffening of the suspension element.

Usually, the described analysis methods need a measuring device to record and/or evaluate the measured signals, values, or statuses. If a measuring instrument is used that has to be moved along the suspension element (like, e.g., a magnetic stray-field measuring device), a suitable attachment is to be defined and a respective evaluation of the measurement signal is necessary. If needed, the measuring device can, of course, be held manually and positioned by somebody. Other methods, as described, e.g., in EP1847501A2, propose a fixation of the measuring device in the neighbourhood of the hoisting machine (cf. FIG. 6 and corresponding description of EP1847501A2, which in this respect are also referred to in full).

If the device is conceived for constant monitoring as a permanent component of the elevator system, attachment sites are to be chosen that ensure that the most loaded areas can be reliably recorded. In the book of K. Feyrer on dimensioning, operation, and safety of wire ropes (ISBN 3-540-57861-7; chapters 6.3.1 and 3.4.1), respective methods to identify the most loaded rope part are described, which are to be applied according to invention—in particular for monitoring the suspension element according to invention in novel elevator systems. Furthermore, the elevator system according to invention is equipped with an evaluation unit, as it can be seen, for instance, in FIGS. 9-11 of EP1847501A2 and the corresponding description.

Experts can combine these methods with one another. For instance, indicator fibres or predetermined breaking point elements can, of course, also be used to monitor fibre-reinforced or steel-rope-reinforced suspension elements, or suspension elements equipped in that way can additionally be checked by an external monitoring device, like an ultrasound measuring instrument. The represented checking alternatives allow to determine the readiness for disposal of a suspension element. The readiness for disposal is that point in the operation time of a suspension element at which is to be replaced. Furthermore, the service life of suspension elements according to invention is significantly increased, and/or a required safety margin is reduced if a failure of the suspension element can be assessed in advance by means of the proposed procedures and devices.

### SUMMARY

The invention relates to an elevator system with a car or platform to transport passengers and/or goods as well as with a counterweight, which are arranged as traversable or movable along a track of motion, and which are coupled with each other and/or with a drive by means of a suspension element interrelating their motion, and to an elevator system with a car or platform to transport passengers and/or goods, which is arranged as traversable or movable along a track of motion, and which is assigned a suspension element guided and/or driven by means of a traction sheave and/or a drive shaft and/or a deflecting pulley.

The invention furthermore relates to a sheathed and/or belt-type suspension element for an elevator system, with a first layer of the suspension element made of a first plasticizable and/or elastomeric material, containing a first exterior surface, and with at least one tension member—rope-type, tissue-type, or comprising of a multitude of partial elements—that is embedded in the first layer of the suspension element.

The invention furthermore relates to a manufacturing procedure for one of the mentioned suspension elements.

1. Elevator system with a car or platform to transport passengers and/or goods as well as with a counterweight, which are arranged as traversable or movable along a track of motion and are coupled with each other and/or with a drive by means of a suspension element interrelating their motion

2. Elevator system, in particular according to claim 1, with a car or platform to transport passengers and/or goods, arranged as traversable or movable along a track of motion, and with a suspension element or force transfer arrangement assigned to it that is guided and/or driven by means of a traction sheave and/or a drive shaft and/or a deflecting pulley

3. Elevator system, in particular according to one of claims 1-2, for a building, a bulk transporting system, a mine facility, a water vehicle, or the like, with a suspension element or force transfer arrangement comprising a first layer of a first plasticizable and/or elastomeric material

4. Force transfer arrangement and/or suspension element for an elevator system, in particular for an elevator system according to one of claims 1-3, in which
a force transfer arrangement comprises a multitude of 3-24 suspension elements, in particular several groups of 3-6 suspension elements each

5. Sheathed and/or belt-type suspension element, in particular according to claim 4, for an elevator system, in particular for an elevator system according to one of claims 1-3, with:
a first layer of the suspension element made of a first plasticizable and/or elastomeric material, containing a first exterior surface, and with
at least one tension member—rope-type, tissue-type, or comprising of a multitude of partial elements—that is embedded in the first layer of the suspension element

6. Manufacturing procedure for a suspension element according to one of claims 4-5

7. Procedure to manufacture a belt-type suspension element for an elevator system, including the steps of positioning at least one rope-type tension member, and embedding the at least one rope-type tension member in a first belt layer of a first plasticizable and/or elastomeric material

8. Manufacturing device for a belt-type suspension element, in particular according to one of claims 4 and 5, for an elevator system according to one of claims 1-3, comprising a first manufacturing station to form a partial belt with a first exterior surface and a surface constituting a connection plane, and a second manufacturing station to form the suspension element with the first exterior surface and a second exterior surface

9. Suspension element according to one of claims 4-5, in which
a first exterior surface of the suspension element is embodied with at least one rib extending in longitudinal direction of the suspension element, which is preferably embodied in the form of a V-rib, has a flank angle ranging from 60° to 120°, and/or has a flattened top

10. Suspension element according to one of claims 4, 5, and 9, in which
a second exterior surface of the suspension element is embodied with at least one rib extending in longitudinal direction of the suspension element, which is preferably embodied in the form of a V-rib, has a flank angle ranging from 60° to 100°, and/or has a flattened top

11. Suspension element according to one of claims 4, 5, 9, and 10, in which
the ratio of the total height of the suspension element to its total width is greater than 1

12. Suspension element according to one of claims 4, 5, 9, 10, and 11, in which
the ratio of the total height of the suspension element to its total width amounts to about 1, with a cross-section of the suspension element being embodied as non-round

13. Force transfer arrangement for an elevator system, comprising in particular one or more suspension elements 20 according to one of claim 4, 5, or 9-12, in which a suspension element is equipped with
at least one force transfer element or tension member (1q), to which
a base body (2q) is assigned at which the force transfer element or tension member (1q) is attached in such a form-locking manner that the base body (2q) at least sectionally encloses the force transfer element (1q)

14. Suspension element for an elevator system, in particular a suspension element according to one of claim 4, 5, or 9-13, with
at least one force transfer element or tension member (1q), to which
a base body (2q) is assigned at which the force transfer element or tension member (1q) is attached in such a form-locking manner that the base body (2q) at least sectionally encloses the force transfer element (1q), and
the base body (2q), along a first longitudinal section, has a height (h) that is smaller than a thickness of an assigned force transfer element and/or is smaller than a diameter (Dq) of an assigned force transfer element (1q), and/or
the base body (2q), along a first longitudinal section, has a height (h) that is smaller than the total height (H) of the suspension element

15. Suspension elements for an elevator system, in particular according to one of the previous claims, with
at least one force transfer element or tension member (1q), to which
a base body (2q) is assigned at which the force transfer element (1q) is attached in such a form-locking manner that the base body (2q) at least sectionally encloses the force transfer element (1q), and
at least one force transfer element (1q), along a first longitudinal section, has an at least approximately constant first cross-section contour, which, to a defined portion, is enclosed by the base body (2q), with the defined portion amounting to less than 100% of the first cross-section contour

16. Suspension element according to claim 15, in which
the defined portion ranges from 10% to 90%, in particular from 50% to 90% of the cross-section contour

17. Suspension element according to one of claims 15-16, in which
the first cross-section contour is embodied as approximately circular, or as an in particular regular polygon, with the number of corners of the polygon being preferably chosen as more than 5, in particular as more than 7

18. Suspension element according to one of the preceding claims, in which
the first longitudinal section extends at least approximately over the whole length of the force transfer element or tension member (1_{q})

19. Suspension element according to one of the preceding claims, in which
a force transfer element or tension member (1q) as well as the base body (2q) have about the same total length, which is about the same as that of the suspension element, with the total length being particularly many times bigger than the width of the base body (2q)

20. Suspension element according to one of the preceding claims, in which
the base body (2q) has a width (b) and a height (h), with the width (b), particularly over approximately the whole length, amounting to many times the size of the height (h), in particular to at least five times, at least eight times, or at least ten times the size of the height (h)

21. Suspension element according to one of the preceding claims, in which
the base body (2q) is basically embodied in one piece, or of several layers of basically similar materials

22. Suspension element according to one of the preceding claims, in which
the base body (2q) has several layers of different materials, which, in particular, are interconnected as adhesively bonded

23. Suspension element for an elevator system, in particular according to one of the preceding claims, with
at least one force transfer element or tension member (1q), to which
a base body (2q) is assigned at which the force transfer element (1q) is attached in such a form-locking manner that the base body (2q) at least sectionally encloses the force transfer element (1q), and
the base body (2q) has at least one subdivided layer, which is embodied as subdivided in parallel to the longitudinal extension of the force transfer element

24. Suspension element according to one of the preceding claims, in which
a subdivided layer of the base body comprises at least four, in particular at least six partial strands

25. Suspension element according to one of the preceding claims, in which
each partial strand comprises a force transfer element or tension member, or several force transfer elements or tension members

26. Suspension element according to one of the preceding claims, in which
each partial strand comprises an even number of force transfer elements, where
each force transfer element comprises several wires and/or strands, and
two force transfer elements of a partial strand have opposite twisting or lay directions

27. Suspension element according to one of the preceding claims, in which
a subdivided layer of the base body is connected with a layer that basically extends over the width of the base body

28. Suspension element according to one of the preceding claims, in which
the base body (2q) has at least one layer that basically extends over the whole width of the base body, and/or
the base body (2q) has at least one layer that basically extends over the whole length of the base body

29. Suspension element according to one of the preceding claims, in which
the base body (2q) has at least one layer made of an elastomer, in particular of a polyurethane (PU), a polychloroprene (CR), a natural rubber, and/or an ethylene propylene diene rubber (EPDM)

30. Suspension element according to one of the preceding claims, in which
the base body (2q) comprises at least one first layer that has a lower hardness, in particular a lower Shore hardness, and/or a higher friction coefficient than a second layer of the base body and/or a sheathing of a force transfer element

31. Suspension element according to one of the preceding claims, in which
a force transfer element (1q) is made, at least partly and/or proportionately, of a first material chosen as adhesively bondable or identical with the material of which at least one layer of the respective base body is made

32. Suspension element according to one of the preceding claims, in which
a force transfer element (1q) is assigned a sheathing (1aq) of a second material, chosen as adhesively bondable or identical with the material of which at least one layer of the respective base body (2q) is made

33. Suspension element according to one of the preceding claims, in which
a force transfer element (1q) has a sheathing (1aq) of a second material, with the first cross-section contour being determined by the exterior, preferably cylindrical surface of the sheathing

34. Suspension element according to one of the preceding claims, in which
a force transfer element (1q) has a preferably cylindrical sheathing (1aq) made of a transparent second material

35. Suspension element according to one of the preceding claims, in which
a force transfer element or tension member comprises a core strand with
a core wire and one or more wire layers laid around it, and
outer strands arranged around the core strand, which comprise a core wire and one or more wire layers laid around the latter

36. Suspension element according to claim 35, in which
two wire layers of the core strand have the same angle of lay, and one wire layer of the outer strands is laid in the sense opposing the direction of lay of the core strand

37. Suspension element according to one of claims 35-36, in which
the outer strands are laid around the core strand in the sense opposing the direction of lay of an own wire layer

38. Suspension element according to one of claims 35-37, in which
the outer strands are laid around the core strand in the sense opposing the direction of lay of an own wire layer

39. Suspension element according to one of claims 35-38, in which
a defined multitude of outer strands are arranged around the core strand, with this defined multitude being chosen as greater than three, preferably equalling five, six, seven, or eight

40. Suspension element according to one of the preceding claims, in which
a force transfer element or tension member comprises several strands with several wires and/or several wire layers each, where several strands and/or several wires are assigned a coating of a non-metallic material, in particular a third material

41. Suspension element according to claim 40, in which
the coating is made of a material that
is adhesively bondable with the material of which the respective base body (2q) is made, or
is basically identical with the material of which the respective base body (2q) is made

42. Suspension element according to claims 40-41, in which
the coating is made of a material that
is adhesively bondable with the material of which a respective sheathing (1aq) of the force transfer element or tension member (1q) is made, or
is basically identical with the material of which the respective sheathing (1aq) of the force transfer element (1q) is made

43. Suspension element according to one of the preceding claims, in which
a force transfer element comprises several strands with several wire layers each, where an intermediate layer of a non-metallic material, in particular of a fourth material is arranged between several strands and/or between several wire layers

44. Suspension element according to claim 43, in which
the intermediate layer is made of a material chosen as adhesively bondable or identical with
the material of the base body,
the material of the sheathing, and/or
the material of the coating

45. Suspension element according to one of the preceding claims, in which
the base body has a first traction surface which
can be made engage with a particularly cylindrical pulley or sheave, and
has a transverse contour aligned as transverse to the longitudinal direction of a force transfer element (1q) and embodied as linear approximately over the whole width of the base body

46. Suspension element according to one of the preceding claims, in which
the base body has a first traction surface which
can be made engage with a particularly profiled pulley or sheave, and
has a transverse contour aligned as transverse to the longitudinal direction of a force transfer element (1q) and embodied as non-linear, in particular as toothed or undulated

47. Suspension element according to claim 46, in which
the first traction surface is shaped as corresponding with a force transfer surface of a particularly profiled pulley or sheave such that, at least sectionally, a flat-spread contact between traction surface and force transfer surface can be achieved, without plastic deformation of base body or pulley/sheave.

48. Suspension element according to one of claims 46-47, in which
the first traction surface has at least one elevation extending in parallel to the longitudinal direction of a force transfer element, as well as at least one recess extending in parallel to the longitudinal direction of a force transfer element

49. Suspension element according to claim 48, in which
the recess and the elevation, with an approximately constant cross-section, extend at least approximately over the whole length of the base body, and form at least one groove

50. Suspension element according to one of the preceding claims, in which
the base body has a second traction surface, arranged opposite a first traction surface, where the first traction surface can be made engage with a first pulley or sheave and the second traction surface with a second pulley or sheave

51. Suspension element according to one of the preceding claims, in which
the base body has a second traction surface, which
can be made engage with a particularly profiled second pulley or sheave, and
has a non-linear, in particular toothed or undulated transverse contour aligned transversely to the longitudinal direction of a force transfer element (1q), where
the transverse contour of the second traction surface is identical with that of the first traction surface or not identical with that of the first traction surface

52. Suspension element according to one of the preceding claims, in which
the first traction surface and/or the second traction surface have a lining or coating the friction coefficient, hardness, and/or abrasion resistance of which differ from the respective values of the base body

53. Suspension element according to one of the preceding claims, in which
a third, in particular vaulted, traction surface is embodied at at least one force transfer element or tension member (1q) and/or its sheathing

54. Suspension element according to claim 53, in which
the third traction surface is constituted by an exterior surface of at least one force transfer element, and/or by at least one exterior surface of at least one sheathing of a force transfer element

55. Suspension element according to one of the preceding claims, in which
several, in particular similar or identical force transfer elements (1q) are assigned exactly one common base body (2q), which at least sectionally encloses all force transfer elements

56. Suspension element according to one of the preceding claims, in which
several, in particular similar or identical force transfer elements (1q) are assigned several interlinked base bodies (2q), which each, at least sectionally, enclose several force transfer elements each

57. Suspension element according to claim 56, in which
several interlinked base bodies (2q) have the same height (h), the same length (L), and/or the same width (b), respectively

58. Suspension element, in particular according to one of the preceding claims, in which
several, in particular similar or identical force transfer elements (1q) are assigned exactly one common base body (2q), where
at least one force transfer element (1q) has, along a first longitudinal section, an at least approximately constant first cross-section contour, enclosed to a defined portion by the base body (2q), with this defined portion amounting to less than 100% of the first cross-section contour, and
at least one force transfer element (1q) has, along a second longitudinal section, a second cross-section contour, enclosed completely by the base body

59. Suspension element according to claim 58, in which
the first longitudinal section and the second longitudinal section are arranged basically in parallel side by side, and/or
the first longitudinal section and the second longitudinal section extend basically over the whole length of the respective force transfer elements or tension members (1q)

60. Suspension element according to one of the preceding claims, in which
one or more, in particular similar or identical force transfer elements or tension members (1q) are assigned exactly one common base body (2q), which encloses all force transfer elements at least sectionally, so that a first belt-type object is formed, where
this first belt-type object as well as at least one further belt-type object, basically identical to the first one, is fixed at a common mass element, in particular an elevator weight, and/or at an elevator car

61. Suspension element according to one of the preceding claims, in which
for the formation of a belt-type object, several, in particular similar or identical force transfer elements (1q) are assigned exactly one common base body (2q), with a layer extending, at least sectionally, over approximately the whole width of the base body, as well as with a subdivided layer, where the subdivided layer is embodied as subdivided in parallel to the longitudinal extension of a force transfer element, and
several, basically identical, belt-type objects are fixed at a common mass element, in particular at an elevator weight, and/or at an elevator car

62. Suspension element according to one of the preceding claims, in which
a belt-type object is assigned a fixing element with a casing as well as with a wedge-shaped or roll-type clamping element, where the casing and/or the clamping element have a profile serving to fix the position of the subdivided layer

63. Elevator system with at least one first elevator car, which, via at least one force transfer arrangement according to one of the preceding claims, is linked to an elevator weight, a second elevator car, and/or a driving or hoisting device

64. Elevator system according to one of the preceding claims, in which
an elevator car, an elevator weight, and/or a driving or hoisting device have at least one rotatable, at least sectionally axial-symmetric sheave, pulley or drive shaft, at which a force transfer surface is conceived with a longitudinal profile corresponding at least sectionally with the transverse contour of a force transfer element

65. Force transfer arrangement according to one of claims 4 and 13, in which
a groove with a radius is embodied between at least two, preferably between all neighbouring traction ribs (3q), with the ratio of this radius to a radius embodied on an assigned rib of a traction sheave of the elevator system being smaller than 1

66. Force transfer arrangement according to one of claims 4, 13, and 65, in which
the base body (2q), at least one, preferably all traction ribs, and/or at least one, preferably all guide ribs are embodied in one piece or several pieces, of an elastomer, in particular of polyurethane (PU), polychloroprene (CR), natural rubber, and/or ethylene propylene diene rubber (EPDM)

67. Force transfer arrangement according to one of claims 4, 13, 65, and 66, in which
the traction side and/or the deflection side have a lining or coating the friction coefficient, hardness, and/or abrasion resistance of which differ from those of the base body

68. Force transfer arrangement according to one of claims 4, 13, and 65-67, in which
a group comprising at least one, preferably all traction ribs, and a group comprising at least one, preferably all guide ribs is embodied as multipartite, with the group of the traction ribs having a lower hardness, in particular a lower Shore hardness, and/or a higher friction coefficient than the group of the guide ribs

69. Force transfer arrangement according to one of claims 4, 13, and 65-68, in which
at least one, preferably each traction rib is assigned at least one, preferably two tension members

70. Force transfer arrangement according to one of claims 4, 13, and 65-69, in which
the diameter of the tension members ranges from 1.0 mm to 4 mm

71. Force transfer arrangement according to one of claims 4, 13, and 65-70, in which
the distance of the tension member arrangement to the traction side is lower than its distance to the deflection side
